(19) United States
(12) Patent Application Publication
(10) Pub. No.: US 2005/0114023 A1
(43) Pub. Date: May 26, 2005

(54) Fault-tolerant system, apparatus and method

(76) Inventors: Walton Ross Williamson, Sherman Oaks, CA (US); Jason Lee Speyer, Los Angeles, CA (US); Dale L. Cooper, Santa Clarita, CA (US)

Correspondence Address: MICHAEL BLAINE BROOKS, A PROFESSIONAL CORPORATION, 5010 NO. PARKWAY CALABASAS, SUITE 104, CALABASAS, CA, 91302-3913, US

(21) Appl. No.: 10/997,192

(22) Filed: Nov. 24, 2004

Related U.S. Application Data
(60) Provisional application No. 60/525,816, filed on Nov. 26, 2003.
(60) Provisional application No. 60/529,512, filed on Dec. 12, 2003.
(60) Provisional application No. 60/574,186, filed on May 24, 2004.

(51) Int. Cl. G01C 21/00

(52) U.S. Cl. 701/214; 701/200; 342/358

(57) ABSTRACT

A method, apparatus and system are described having a minimum variance estimator of state estimates typically in navigation embodiments where a sensor and/or effecter fault detecting module is adapted to execute residual testing steps using the Multiple Hypothesis Wald Sequential Probability Ratio test, the Multiple Hypothesis Shiryayev Sequential Probability Ratio test, the Chi-Square test and combinations thereof to determine the likelihood of sensor and/or actuator fault occurrences and thereafter isolate the effects of the one or more identified fault from the state estimates.

### CROSS-REFERENCE TO RELATED APPLICATIONS

This application claims the benefit of U.S. Provisional Patent Application Ser. No. 60/525,816 filed Nov. 26, 2004, U.S. Provisional Patent Application Ser. No. 60/529,512 filed Dec. 12, 2004, and U.S. Provisional Patent Application Ser. No. 60/574,186 filed May 24, 2004, all three of which are hereby incorporated by reference herein for all purposes.

### BACKGROUND

This invention relates to fault-resistant systems and apparatuses and particularly to methods for fault detection and isolation and systems adapted to detect subsystem faults and isolate the systems from these faults.

Fault detection and isolation techniques have been applied to aeronautic applications to increase system reliability and safety, improve system operability, extend the useful life of the system, minimize maintenance and maximize performance. Present approaches include the training of auto-associative neural networks for sensor validation, a real-time estimator of fault parameters using model-based fault detection, and heuristic knowledge used to identify known component faults in an expert system. These approaches may be applied separately, or in combination, to various classes of faults including those in sensors, actuators, and components.

The need for system integrity is pervasive as autonomous systems become more common. There remains a need to build into the autonomous system an adaptation for self-examination through which failures in subsystems may be detected. A new system and method for examining a plurality of systems in a blended manner in order to detect failures in any given subsystem is described.

### SUMMARY

The first preferred embodiment features an apparatus for maintaining the integrity of an estimation process associated with time-varying operations. The integrity apparatus preferably comprises: a first processing means adapted to determine one or more state vectors for characterizing the estimation process, each state vector comprising one or more state parameters to be estimated; one or more sensing devices adapted to acquire one or more measurements indicative of a change to at least one of said system state vectors; a second processing means adapted to generate one or more dynamic system models representative of changes to said system state vectors as a function of one or more independent variables and one or more external inputs in the form of sensing device measurements; a third processing means adapted to generate one or more fault models characterizing the affect of a fault of at least one of said sensing devices on at least one of said state parameters; a residual processor adapted to generate one of more residuals, each residual representing the difference between one of said state parameters and one of said sensing device measurements; a projector generator adapted to generate a projector representative of one or more estimation process faults based on the one or more fault models and said dynamic system models; gain processing means for generating one or more gains, each gain being associated with one of said residuals; a state correction processing means for generating system state updates for said state vectors, each of the state vector updates being the product of one of said residuals and the associated gain; an updated residual processing means for generating one or more updated residuals based on the difference between said system state updates and at least one of said sensing device measurements; a projection generator adapted to generate a fault free residual based on said updated residuals and a projection; a residual testing processor adapted to determine the probability of occurrence of a sensing device fault based on a probability estimation, said dynamic system model, and said one or more fault models; a declaration processing means for determining whether the sensing device fault based upon the determined probability of a sensing device fault, a degraded state estimate, and one or more of the modeled failures; and a propagation stage adapted to predict a next system state based upon said dynamic system models, said system state updates, and an updated fault model. The probability estimation may be determined using one or more of the following: Multiple Hypothesis Wald Sequential Probability Ratio Test, the Multiple Hypothesis Shiryayev Sequential Probability Ratio test, or the Chi-Square Test.

Another embodiment of the integrity apparatus is adapted to perform fault tolerant navigation with a global positioning satellite (GPS) system. In this embodiment, the integrity apparatus further comprises: a GPS receiving device adapted to provide one or more GPS measurements including one or more pseudorange measurements and one or more associated time outputs from one or more GPS frequencies including L1, L2, or L5 from any of the coded C/A, P, or M signals; and a fourth processing means for generating one or more state vector estimates based on said pseudorange measurements and said time outputs. The time outputs and measurements may then be introduced into one or more of the processing operators of the first embodiment for purposes of generating a fault free state estimate representative of a fault direction within one or more of the pseudorange measurements.

In another embodiment, the integrity apparatus is incorporated in a system for providing autonomous relative navigation. In this embodiment, the integrity apparatus comprises: (a) a target element including: a global positioning system (GPS) target element assembly having one or more GPS antennas, and one or more GPS receivers operably coupled to the antennas; a first processor for generating a target position estimate, a target velocity estimate, a target attitude solution for the target element; and a transmitter for transmitting the position estimate, velocity estimate, target-based attitude solution, and one or more GPS measurements from any of the one or more GPS receivers; and (b) a seeker element—incorporated into an aircraft, for example—including: a GPS seeker element assembly having one or more GPS antennas, and one or more GPS receivers operably coupled to the one or more GPS antennas; a seeker receiver for receiving the transmitted target position estimate, velocity estimate, target attitude solution, and said GPS measurements; and a second processor for generating a seeker-relative position estimate, seeker-relative velocity estimate, seeker-based attitude solution for the target element. In some embodiments, the first processor, the second processor, or both are adapted to apply one or more integrity apparatuses as fault detection filters.

Using analytic redundancy and fault detection filter techniques combined with sequential probability testing, the integrity monitoring device is adapted to detect, and isolate, a fault within the system in minimal time and is adapted to then reconfigure the system to mitigate the effects of the fault. The system is described in example embodiments that may be applied to systems comprising a GPS receiver and an IMU. The GPS receiver is used to provide measurements to an Extended Kalman Filter which provides updates to the IMU calibration. Further, the IMU may be used to provide feedback to the GPS receiver in an ultra-tight manner so as to improve signal tracking performance. Further examples of embodiments of the present invention include autonomous systems such as automatic aerial refueling, automatic docking, formation flight, and automatic landing of aircraft.

### DESCRIPTION OF THE DRAWINGS

In furthering the understanding of the present invention in its several embodiments, reference is now made to the following description taken in conjunction with the accompanying drawings where reference numbers are used throughout the figures to reference like components and/or features, in which:

FIG. 1. Integrity Machine Process Flow

FIG. 2. Fault Tolerant Navigator for Gyro Faults

FIG. 3. Fault Tolerant Navigator for Accelerometer Faults

FIG. 4. GPS Receiver Generic Design

FIG. 5. Two Stage Super Heterodyne Receiver Architecture

FIG. 6. Single Super Heterodyne Receiver Architecture

FIG. 7. Direct Conversion to In-Phase and Quadrature in the Analog Domain

FIG. 8. Digital RF Front End.

FIG. 9. GPS Receiver Standard Early/Late Baseband Processing with Ultra-Tight Feedback

FIG. 10. GPS Receiver Digitization Process

FIG. 11. GPS Receiver Phase Lock Loop Baseband Representation with output to GPS/INS EKF

FIG. 12. Ultra-Tight GPS Code Tracking Loop at Baseband

FIG. 13. Ultra-Tight GPS Carrier Tracking Loop at Baseband

FIG. 14. Adaptive Estimation Flow in EKF

FIG. 15. LMV GPS Early/Prompt/Late Tracking Loop Structure

FIG. 16. Ultra-tight GPS/INS

FIG. 17. Aerial Refueling Between Two Aircraft

FIG. 18. Aerial Refueling Drogue with GPS Patch Antennae

FIG. 19. Aerial Refueling Drogue and Refueling Probe on Receiving Aircraft.

FIG. 20. Aerial Refueling Drogue Electronics Block Diagram.

### DETAILED DESCRIPTION

Integrity Machine

The integrity machine includes steps, that when executed, protect a state estimation process or control system from the effects of failures within the system. Subsequent sections provide detailed descriptions of the models and underlying relationships used in this structure including fault detection filter theory, change detection and isolation and adaptive filtering.

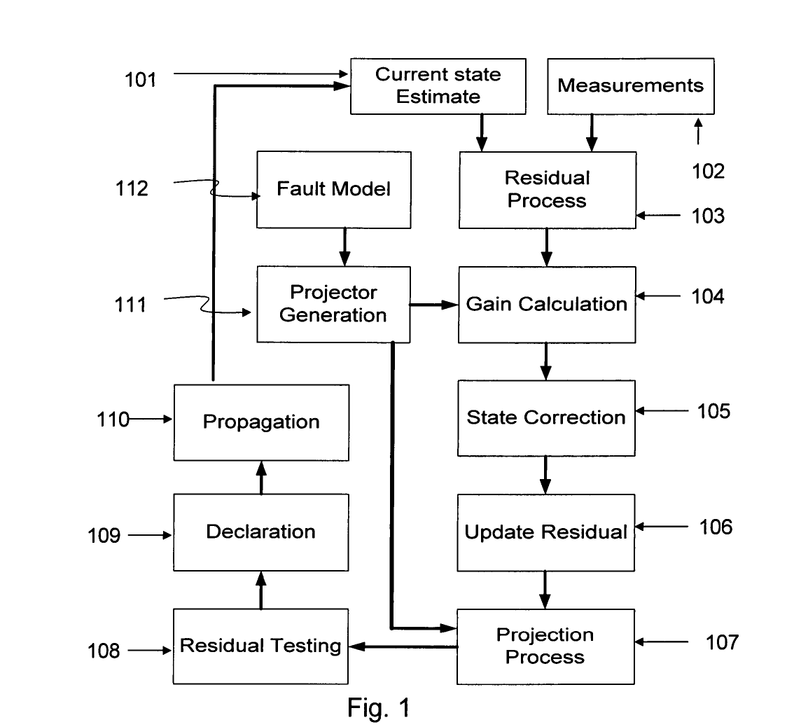

FIG. 1 shows a flow diagram of the process as a sequential set of steps. The primary goal of the filter is to define and estimate a system state 101, a set of measurements 102, and a set of failure modes 112. Then a filter structure may be defined that adequately estimates the system state and blocks the effect of a failure mode on the system state. To execute these estimation steps, the filter structure generates a residual 103 with the measurements, calculates a filter gain 104 used to correct the state estimate with the residual 105. The residual is then updated with the new estimate of the state 106. A projector 111 is created which blocks the effect of the failure mode in the residual. The projector projects out in time the effect of the failure 107 and then tests the projected residual 108 to determine if the fault is present. Based on the output of the test, the system may declare a fault 109 take action to modify the estimation the process in order to alert the user or continue operating in a degraded mode. If no fault occurs, the system propagates forward in time 110 to the next time step.

Single Failure Integrity Machine

In order to provide a clear understanding of the present invention in its several embodiments, the single failure mode is analyzed first. That is, the steps of addressing multiple failures are addressed after the basic structure is defined.

Dynamic System

The state to be estimated is defined in terms of the dynamic system which models how the system state changes as a function of the independent variable, in this case time:
x(k+1)=Φ(k)x(k)+Γω(k)+Fμ(k)+Γ_{c}u(k) (1)
where x(k) is the state at time step k to be estimated and protected, ω is process noise or uncertainty in the plant model, Φ(k) is the linearized relationship between the state at the previous time step and the state at the next time step, and μ is the fault. The term u(k) is the control command into the dynamics from an actuator and Γ_{c} is the control sensitivity matrix. The issue of an actuator fault is a common problem. For the time being, the control variables will be ignored. Inserting a known control back into the filter is a trivial problem defined in Section 6.

Two states are defined. The first state x₀ is the state that assumes no fault occurs. The second state x₁ assumed the fault has occurred. Each state starts with an initial estimate of the state \overline{x}₀(k) and \overline{x}₁(k) which may be zero. Further, the initial error covariance for both, referred to as P₀(k) and Π₁(k) are specified as initial conditions and used to initialize the filter structures.

Measurement Model

The measurements are modeled as:
y(k)=C(k)x(k)+v(k) (2)
The measurements y are also corrupted by measurement noise, v(k). The treatment of failures within the measurement is described below and effectively generalizes to the case where a fault is in the dynamics.
Fault Model

In the dynamic system defined in Eq. 1, the signal μ is assumed unknown. However, the direction matrix F is known and is defined as the fault model; the direction in which a fault may act on the system state through the associated dynamic system. Several other initial conditions with regards to the fault model are important. For instance, the probability of a failure between each time step is defined as p and is used in the residual testing process. The initial probability that the failure has already occurred is represented by φ₁(k).

Residual Process

Using the models defined in Eq. 1, both states, and Eq. 2, the estimation process is initially defined. A residual is generated using the initial conditions \overline{x}₀(k) and \overline{x}₁(k) as well as the measurement y(k) as:
\overline{r}₀(k)=y(k)−C(k)\overline{x}₀(k) (3)
and
\overline{r}₁(k)=y(k)−C(k)\overline{x}₁(k). (4)
Projection Generation Process

Since the residual operates on the state estimate and since the state estimate is affected by the fault μ, then a projector is created which blocks the effect of the fault in the residual. The projector is calculated according to the steps represented as:
H(k)=I−(CΦⁿF)[(CΦⁿF)^{T}(CΦⁿF)]⁻¹(CΦⁿF)^{T}, (5)
in which n is the smallest, positive number required.
Gain Calculation

A gain is calculated for the purposes of operating on the residual in order to update the state estimate. For the healthy assumption, the gain K₀ is calculated according to the steps represented as follows:
M₀(k)=P₀(k)−P₀(k)C^{T}(V+CP₀(k)C^{T})⁻¹CP₀(k); and (6)
K₀=P₀(k)C^{T}V⁻¹, (7)
where K₀ is similar to the Kalman Filter Gain.

For the system that assumes a fault, the gain K₁ is calculated according to the following steps using the following relationships:
R=V⁻¹−HQₛH^{T}; (8)
M₁(k)=Π₁(k)−Π₁(k)C^{T}(R+CΠ₁(k)C^{T})⁻¹CΠ₁(k); (9)
and
K₁=Π(k)C^{T}(R+CΠ(k)C^{T})⁻¹. (10)

In this case, V is typically a weighting matrix associated with the uncertainty of the measurement noise. Traditionally, if the measurement noise v is assumed to be a zero mean Gaussian process, then V is the measurement noise covariance. The matrix Qₛ is defined to weight the ability of the filter to track residuals in the remaining space of the filter. This matrix is a design parameter allowed to exist and should be used judiciously since it can cause a violation of the positive definiteness requirement of the matrix R. Finally, Π(k) is a matrix associated with the uncertainty in the state \overline{x}(k). In a general sense, Π(k) is analogous to the inverse of the state error covariance. From these relationships, the value of the gain K is calculated.

State Correction Process

The updated state estimate \hat{x}₀(k) is calculated as:
\hat{x}₀(k)=\overline{x}₀(k)+K₀(y(k)−C\overline{x}₀(k))=\overline{x}₀(k)+K₀\overline{r}₀(k). (11)

The updated state estimate \hat{x}₁(k) is calculated as:
\hat{x}₁(k)=\overline{x}₁(k)+K₁(y(k)−C\overline{x}₁(k))=\overline{x}₁(k)+K₁\overline{r}₁(k). (12)
Updated Residual Process

An updated residual for each case is generated using the updated state estimate:
\hat{r}₀(k)=y(k)−C(k)\hat{x}₀(k) (13)
and
\hat{r}₁(k)=y(k)−C(k)\hat{x}₁(k). (14)
Projection Process

Using the projector, the updated fault-free residual is calculated for the system that assumes a fault as:
\hat{r}_{F1}(k)=H(k)\hat{r}₁(k). (15)
Residual Testing

The fault-free residual is now tested in either the Wald Test, Shiryayev Test, or a Chi-Square test. The details of the Wald and Shiryayev Test are presented in below. For purposes of clarity, only the Shiryayev Test is presented since the other tests are a subset of this test.

A simple two state case is described. In this case, two hypotheses are presented. The first hypothesis is defined as a state in which the system is healthy (μ=0). The second hypothesis is defined as a system in which the state is unhealthy (μ≠0). The Shiryayev Test assumes that the system starts out in the first hypothesis and may, at some future time, transition to the H₁ faulted hypothesis. The goal is to calculate the probability of the change in minimum time. The probability that the hypothesized failure is true is φ₁(k) before updating with the residual, \hat{r}_{F1}(k). The probability that the system is healthy is likewise φ₀(k)=1−φ₁(k). A probability density function f₀(\hat{r}₀,k) and f₁(\hat{r}_{F1},k) is assumed for each hypothesis. In this case, if we assume that the process noise and measurement noise are Gaussian, then the probability density function for the residual process is the Gaussian using

$${f}_{1} ( {\hat{r}}_{F1} , k ) = \frac{1}{{( 2 π )}^{n / 2} ‖ {P}_{F1} ‖} exp \{ - \frac{1}{2} {\hat{r}}_{F1} ( k ) {P}_{F1}^{- 1} {\hat{r}}_{F1} ( k ) \} , \qquad ( 16 )$$

where P_{F1} is the covariance of the residual \hat{r}_{F}(k) and ∥.∥ defines the matrix 2-norm, and n is the dimension of the residual process. The covariance P_{F1} is defined as:
P_{F1}=H(CM₁C^{T}+R)H^{T}. (17)

Note that the density function f₀(k) for the first hypothesis is computed in the same manner with a residual that assumes no fault; the projector matrix H=I, the identity matrix. The probability density function assuming a Gaussian is:

$${f}_{0} ( {\hat{r}}_{0} , k ) = \frac{1}{{( 2 π )}^{n / 2} ‖ {P}_{F0} ‖} exp \{ - \frac{1}{2} {\hat{r}}_{0} ( k ) {P}_{F0}^{- 1} {\hat{r}}_{0} ( k ) \} , \qquad ( 18 )$$

where
P_{F0}=CM₀C^{T}+V. (19)

Note that the assumption of a Gaussian is not necessary, but is used for illustrative purposes. Other density functions may be assumed for an appropriately distributed residual process. Accordingly, if the residual process was not Gaussian, then a different density function would be chosen.

From this point, it is possible to update the probability that a fault has occurred. The following relationship calculates the probability that the fault has occurred:

$${G}_{1} ( k ) = \frac{{ϕ}_{1} ( k ) {f}_{1} ( {\hat{r}}_{F1} , k )}{{ϕ}_{1} ( k ) {f}_{1} ( {\hat{r}}_{F1} , k ) + {ϕ}_{0} ( k ) {f}_{0} ( {\hat{r}}_{0} , k )} . \qquad ( 20 )$$

Note that in Section 4, the notation is slightly different when describing the Shiryayev Test. In that section, the variable G₁ is replaced with F₁. This notation is not used since it would conflict with the fault direction matrix F₁.

From time step to time step, the probability must be propagated using the probability p that a fault may occur between any time steps k and k+1. The propagation of the probabilities is given as:
φ₁(k+1)=G₁(k)+p(1−G₁(k)) (21)
Note that for any time step, the H₀ hypothesis may be updated as:
G₀(k)=1−G₁(k) (22)
and
φ₀(k+1)=1−φ₁(k+1) (23)
Declaration Process

In order to declare a fault, the system examines either probability F₁(k) or F₀(k). If the probability F₁ reaches a threshold that may be defined by those of ordinary skill in the art or it reaches a user defined threshold, a fault is declared. Otherwise, the system remains in the healthy mode.

Propagation Stage

The updated state estimates \hat{x}₀(k) and \hat{x}₁(k) are propagated forward in time using the following relationship:
\overline{x}₀(k+1)=Φ(k)\hat{x}₀(k) (24)
\overline{x}₁(k+1)=Φ(k)\hat{x}₁(k) (25)

Further, the matrices M₁(k) and M₀(k) are defined in Eq. 9 is propagated forward as:
P₀(k+1)=Φ(k)M₀(k)Φ^{T}(k)+W (26)
and

$${Π}_{1} ( k + 1 ) = Φ ( k ) {M}_{1} ( k ) {Φ}^{T} ( k ) + \frac{1}{γ} {FQ}_{F} {F}^{T} + W . \qquad ( 27 )$$

Where Q_{F} and γ are tuning parameters used to ensure filter stability.

The process then repeats when more measurements are available and accommodates instances where the multiple propagation of stages may be necessary.

Multiple Failure Integrity Machine

The process presented by example is now generalized for multiple faults. In this example, the filter structure for each system is designed to observe some faults and reject others.

Dynamic System

The state to be estimated is defined in terms of the dynamic system which models how the system state changes as a function of the independent variable, in this case time:

$$x ( k + 1 ) = Φ ( k ) x ( k ) + Γ ω ( k ) + {\sum }_{i = 1}^{N} {f}_{i} {μ}_{i} ( k ) \qquad ( 28 )$$

where x(k) is the state at time step k to be estimated and protected, ω is process noise or uncertainty in the plant model, Φ(k) is the linearized relationship between the state at the previous time step and the state at the next time step, and μᵢ are the set of faults. In this example, a maximum of N faults are assumed.

A set of N state estimates are formed; there being one filter structure for each fault. Note that faults may be combined so that the number of filters used is a design choice based upon how faults are grouped by the designer. Each state is given a number xᵢ where again x₀ represents the healthy, no fault system. Each state starts with an initial estimate of the state \overline{x}ᵢ(k). Further, the initial error covariance for both, referred to as P₀(k) and Πᵢ(k) are specified as initial conditions and used to initialize the filter structures.

Measurement Model

The measurements are unchanged from the previous case and are modeled as:
y(k)=C(k)x(k)+v(k) (29)

The measurements y are also corrupted by measurement noise v(k).

Fault Model

In the dynamic system defined in Eq. 28, the signal μᵢ is assumed unknown. However, the direction matrix Fᵢ is known and is defined as the fault model; the direction in which a fault may act on the system state through the associated dynamic system. Again, the probability of a failure between each time step is defined as p and is used in the residual testing process. The initial probability that the failure has already occurred is defined as φᵢ(k). Note that

$${\sum }_{i = 0}^{N} {ϕ}_{i} ( k ) = 1.$$

Residual Process

A residual is generated for each state as:
\overline{r}ᵢ(k)=y(k)−C(k)xᵢ(k) (30)
Projection Generation Process

A projector is created which blocks the effect of the fault in the residual. The projector is designed to block one fault in the appropriate state estimate. The projector for each state is calculated as:
Hᵢ(k)=I−(CΦⁿFᵢ)[(CΦⁿFᵢ)^{T}(CΦⁿFᵢ)]⁻¹(CΦⁿFᵢ)^{T} (31)
in which n is the smallest, positive number required. In this case, the fault to be rejected is also referred to as the nuisance fault.
Gain Calculation

Again, a gain is calculated for the purposes of operating on the residual in order to update the state estimate. For the healthy assumption, the gain K₀ is calculated as follows:
M₀(k)=P₀(k)−P₀(k)C^{T}(V+CP₀(k)C^{T})⁻¹CP₀(k) (32)
K₀=P₀(k)C^{T}V⁻¹ (33)
which is the Kalman Filter Gain.

For the each system that assumes a fault, the gain Kᵢ is calculated using the following relationships:
Rᵢ=V⁻¹−HᵢQₛᵢHᵢ^{T}; (34)
Mᵢ(k)=Πᵢ(k)−Πᵢ(k)C^{T}(Rᵢ+CΠ(k)C^{T})₋₁CΠᵢ(k); (35)
and
Kᵢ=Π(k)C^{T}(Rᵢ+CΠ(k)C^{T})⁻¹. (36)

V retains the same meaning as previously. The matrix Qₛᵢ is defined to weight the ability of the filter to track residual in the remaining space of the filter. This matrix is a design parameter allowed to exist and should be used judiciously since it can cause a violation of the positive definiteness requirement on the matrix Rᵢ. From these relationships, the value of the gain Kᵢ is calculated.

State Correction Process

The updated state estimate \hat{x}ᵢ(k) is calculated as:
\hat{x}ᵢ(k)=\overline{x}ᵢ(k)+Kᵢ(y(k)−C\overline{x}ᵢ(k))=\overline{x}ᵢ(k)+Kᵢbarrᵢ(k) (37)
Updated Residual Process

An updated residual for each case is generated using the updated state estimate:
\overline{r}ᵢ(k)=y(k)−C(k)\hat{x}ᵢ(k) (38)
Projection Process

Using the projector, the updated fault free residual is calculated for the system that assumes a fault as:
\hat{r}_{Fi}(k)=H(k)\hat{r}ᵢ(k) (39)
Residual Testing

The fault free residual is now tested in the Wald Test, Shiryayev Test, or a Chi-Square test. Only the Shiryayev Test is presented since the other tests are a subset of this test. Again, each state hypothesizes the existence of a failure except the baseline, healthy case. Each hypothesized failure has a an associated probability of being true defined as φᵢ(k) before updating with the residual \hat{r}_{Fi}(k). The probability that the system is healthy is likewise

$${ϕ}_{0} ( k ) = 1 - {\sum }_{i = 1}^{N} {ϕ}_{i} ( k ) .$$

A probability density function f₀(\hat{r}₀,k) and fᵢ(\hat{r}_{Fi},k) is assumed for each hypothesis. In this case, if we assume that the process noise and measurement noise are Gaussian, then the probability density function for the residual process is the Gaussian using

$${f}_{i} ( {\hat{r}}_{Fi} , k ) = \frac{1}{{( 2 π )}^{n / 2} ‖ {P}_{Fi} ‖} exp \{ - \frac{1}{2} {\hat{r}}_{Fi} ( k ) {P}_{Fi}^{- 1} {\hat{r}}_{Fi} ( k ) \} , \qquad ( 40 )$$

where P_{Fi} is the covariance of the residual \overline{r}_{F}(k) and ∥.∥ defines the matrix 2-norm. The covariance P_{Fi} is defined as:
P_{Fi}=Hᵢ(CMᵢC^{T}+Rᵢ)Hᵢ^{T} (41)

Note that the density function f₀(k) for H₀ is computed in the same manner with a residual that assumes no fault; the projector matrix H₀=I, the identity matrix. The probability density function, assuming a Gaussian function, is:

$${f}_{0} ( {\hat{r}}_{0} , k ) = \frac{1}{{( 2 π )}^{n / 2} ‖ {P}_{F0} ‖} exp \{ - \frac{1}{2} {\hat{r}}_{0} ( k ) {P}_{F0}^{- 1} {\hat{r}}_{0} ( k ) \} \qquad ( 42 )$$

where
P_{F0}=CM₀C^{T}+V (43)

From this point, it is possible to update the probability that a fault has occurred for all hypotheses. The following relationship calculates the probability that the fault has occurred.

$${G}_{i} ( k ) = \frac{{ϕ}_{i} ( k ) {f}_{i} ( {\hat{r}}_{Fi} , k )}{{\sum }_{i = 1}^{n} {ϕ}_{i} ( k ) {f}_{i} ( {\hat{r}}_{Fi} , k ) + {ϕ}_{0} ( k ) {f}_{0} ( {\hat{r}}_{0} , k )} \qquad ( 44 )$$

From time step to time step, the probability must be propagated using the probability p that a fault may occur between any time steps k and k+1. The propagation of the probabilities is given as:

$${ϕ}_{i} ( k + 1 ) = {G}_{i} ( k ) + \frac{p}{N} ( 1 - {\sum }_{i = 1}^{N} {G}_{i} ( k ) ) \qquad ( 45 )$$

Note that for any time step, the healthy hypothesis may be updated as:

$$\begin{matrix}{G}_{0} ( k ) = 1 - {\sum }_{i = 1}^{N} {G}_{i} ( k ) and & ( 46 ) \\ {ϕ}_{0} ( k + 1 ) = 1 - {\sum }_{i = 1}^{N} {ϕ}_{1} ( k + 1 ) & ( 47 )\end{matrix}$$

Declaration Process

In order to declare a fault, the system examines the probabilities Fᵢ(k). If any of the probabilities Fᵢ reaches a threshold defined by one of ordinary skill in the art or it reaches a user defined threshold, a fault is declared. Otherwise, the system remains in the healthy mode.

Propagation Stage

The updated state estimates \hat{x}ᵢ(k) are propagated forward in time using the following relationships:
\overline{x}ᵢ(k+1)=Φ(k)\overline{x}ᵢ(k) (48)

Further, the matrices Mᵢ(k) and M₀(k) are propagated forward as:
P₀(k+1)=Φ(k)M₀(k)Φ^{T}(k)+W (49)
and

$$\begin{matrix}{Π}_{i} ( k + 1 ) = Φ ( k ) {M}_{i} ( k ) {Φ}^{T} ( k ) + \frac{1}{γ} {F}_{i} {Q}_{Fi} {F}_{i}^{T} + W - & ( 50 ) \\ {\sum }_{j = 1}^{N} {F}_{j} {Q}_{Fj} {F}_{j}^{T} ⋁ j \neq i , & \end{matrix}$$

Mᵢ(k)>0 (51)
where Q_{Fi}, Q_{Fj}, and γ are tuning parameters used to ensure filter stability.

The process then repeats when more measurements are available.

### Alternative Embodiments

Several alternative embodiments are are described below.

Alternate Residual Tests

The Wald Test may be used to evaluate the probability of a failure. In this case, the Wald Test does not assume any difference between the healthy state or the faulted states. The residuals are calculated as before. Eq. 44 is used to calculate probability updates. Eq. 45 is not used. Instead, Φᵢ(k+1)=Gᵢ(k). The declaration process is unchanged.

The Chi-Square test may also be employed on a single epoch basis. In this case, the value for each Chi-Square is calculated as:
Xᵢ²=\hat{r}_{Fi}(k)P_{Fi}⁻¹\hat{r}_{Fi}(k) (52)

The declaration process then to examine each value generated and determine which has exceeded a predefined threshold. If a failure occurs, every Chi-Square test will exceed the threshold except for the filter structure designed to block the fault.

Transitions from Wald to Shiryayev

The Wald test is ideal for initialization problems where the system state is unknown whereas the Shiryayev test detects changes. In this way, the filter may be constructed to start using the Wald Test until the test returns a positive declaration for a healthy system or else for a failure mode. The hypothesis with the highest probability is then set to the baseline hypothesis for the Shiryayev test. Then, the probabilities for each hypothesis are reset to zero while the probability for the baseline hypothesis is set to one. Then, on the next set of measurement data, the Shiryayev test is employed to detect changes from the baseline (which may actually be a faulted mode) to some other mode.

Shiryayev Reset

As discussed, the Shiryayev test detects changes. If a change is detected and declared, then the Shiryayev test must be reset before operation may continue. Two options are possible in this example. The filter structure may continue to operate, discarding all of the hypothesized state estimates except the one selected by the declaration process. In this example option, no more fault detection is possible. The residual testing process is no longer used because it has served its purpose and detected the fault.

The other option resets the Shiryayev test on a new set of hypotheses by setting all probabilities to zero except for the hypothesis selected previously by the declaration process which is set to one and used as the baseline hypothesis. Then the Shiryayev Test may continue to operate until a new change or failure is declared.

Explicit Probability Calculation

The residual testing process may be configured to either calculate the existence of a failure or attempt to calculate the probability of a particular failure in a set of failures. The difference is that in one case, all of the failures Fᵢ are lumped into a single fault direction matrix F=[F₁F₂ . . . F_{N}]. Then the system becomes a binary system as described in Section 1. When the residual testing process operates, it only calculates the probability that a failure has occurred, but cannot distinguish between any particular fault Fᵢ.

In contrast, when each fault direction is separated as in Section 2, then a separate probability is calculated for each fault direction.

Fault Identification

If a separate probability is calculated for each hypothesized fault, then the particular failure mode may be identified based upon the probability calculated. In this case, the declaration process not only determines that a fault has occurred but outputs which failure direction Fᵢ is currently present in the system. This information may be used in other processes.

Declaration Notification

The declaration process provides steps to identify the fault. The thresholds set can be used to determine when a failure has occurred. Further, the declaration process helps to determine which state is still healthy. As a result, the declaration process provides a tangible output on the operation of the filter. The declaration process may be used to notify a user that a fault has occurred or that the system is entirely healthy. Further, the declaration process may be used to notify the user of the healthiest estimate of the state given the current faulted conditions.

Automatic Reconfiguration

The declaration process may also be used to automatically reconfigure the filtering system. Several options have already been presented. These filter structure variations may be triggered as a result of crossing a threshold within the declaration process.

Residual Testing Variations

The residual testing process may operate on the a priori residual from each fault mode \overline{r}ᵢ or a projected residual Hᵢ\overline{r}ᵢ rather than the updated and projected residual \hat{r}_{Fi}. The resulting density functions must be updated accordingly to properly account for the covariance of the residual. The result is sometimes less reliable and slower to detect failures since the state estimate has not been updated. It is also possible to develop the residual testing processes to work and analyze both the residual process and the updated residual process in order to fully examine the effect of the update on the system.

Reconfiguration

Once a failure is declared, the system designer may chose not to operate the same estimation scheme. A different scheme may be implemented. For instance, as already mentioned, if a failure occurs in one state, then all other states may be discarded and only the filter related to that particular failure needs to continue operating. The residual projection, residual update, residual testing, and declaration process would all be discarded. Only the particular state xᵢ would be propagated or corrected.

In addition, the declaration process may be used to trigger more filter structures. If a failure is declared, new states with new hypotheses could be generated and the process restarted. For instance, after the fault is declared the dynamics matrix Φ may be replaced with a different dynamics matrix and the process restarted.

Algebraic Reconstruction

After a fault is declared, the following update is used in order to maintain the estimates of the total states. The update of the state is now performed as:
\hat{x}ᵢ(k)=P(k)\overline{P})i⁻¹(k)[\overline{x}ᵢ(k)]+Pᵢ(k)C^{T}V⁻⁻¹y(k) (53)
where the values for Pᵢ are initialized by Mᵢ for a fault detection filter or simple P₀ for the healthy filter. Then the state is propagated as before and the covariance is updated and propagated using the following definitions:
Pᵢ(k)=(\overline{P}ᵢ⁻¹(k)+C^{T}V⁻¹C)⁻¹; (54)
\overline{P}ᵢ⁻¹(k+1)=Nᵢ⁻¹(k)−Nᵢ⁻¹(k)Φ[Φ^{T}Nᵢ⁻¹(k)Φ+Pᵢ⁻¹(k)]⁻¹Φ^{T}Nᵢ⁻¹(k); (55)
and
Nᵢ⁻¹(k)=W⁻¹[I−Fᵢ(Fᵢ^{T}W⁻¹Fᵢ^{T})⁻¹Fᵢ^{T}W⁻¹], (56)
where here it is assumed that Γ=I for simplicity, although this does not have to be the case.

Note that this filter structure may be used as the primary filter structure to begin with since the effect is again to eliminate the effect of the fault on the state estimate and to operate from the start with algebraic reconstruction. If a failure occurs in a measurement, a simpler option is possible in which the system may begin graceful degradation by eliminating that measurement from being used in the processing scheme. Further, in order to continue operating, the system may elect to perform algebraic reconstruction of the missing measurement. The preferred reconstructed measurement is:
\overline{y}ᵢ=C(k)\overline{x}ᵢ(k) (57)

This new measurement is different for each state. The residual processes are generated with each appropriate state estimate. The residual testing scheme is unchanged, operating on each set of residuals as before. Alternatively, the algebraic reconstruction may use the healthy state which combines all available information. The new measurement becomes:
\overline{y}=C(k)\overline{x}₀(k) (58)
and the measurement is the same for all of the state estimates. This same method could be used for any of the states \overline{x}ᵢ(k) providing an algebraically reconstructed measurement for all of the other state estimates.
Reduced Order Dynamics

Another variation considers a method of operation whereby the dynamics and measurement model are changed so as to reduce the order of the state estimate xᵢ corrupted by the failure. If a failure direction only affects one state element directly, then that state element may be removed from the dynamics and measurement model.

The new dynamics have reduced order so as to reduce the computational burden or, since the fault exists, to simply eliminate that part of the state the fault influences and provide graceful degradation. The new dynamics and new state estimation process are restarted as before.

No System Dynamics

If the system dynamics are not present, then the propagation stage may be neglected and the system will continue to operate normally. The propagated state estimate \overline{x}ᵢ(k+1) is set equal to the updated estimate \hat{x}ᵢ(k+1) and the processing continues.

If the measurement noise matrix V is chosen so as to model the measurement noise covariance, then this filter is said to be the “least squares” fault detection filter structure.

Use of Steady State Gains

For some systems, the gains Kᵢ, the covariances Mᵢ, or the projection matrices Hᵢ do not change significantly with time. For these cases, the steady state values may be used. In these instances, one or all of the matrices is calculated a priori and the covariance update and covariance propagation stages are not used.

Nuisance vs. Target Faults

The particular system embodiment explained by example used one fault Fᵢ as a nuisance fault and all other faults were defined as target faults. Because of the construction of the system, the projector effectively eliminates the nuisance fault from the particular state. The residual testing process is positive for that hypothesis only if the nuisance fault is present. Alternatively, an opposite testing result may be used. That is, the system may block all of the faults except one target fault. If the target fault occurred, the residual testing process detects and isolates in a similar manner to the previously described testing result. In this way, the remaining filter structures would not have to be discarded and multiple faults could be detected.

Adaptive Estimation

The adaptive estimator is used to estimate a change in the measurement noise mean and variance. Using this method, integrity structure defined updates the values of the residual process and measurement noise covariance using the values determined adaptively from the healthy state. Either the limited memory noise estimator or the weighted memory noise estimator process is employed. Using the limited memory method, the modifications are described. For an exemplary sample size of N, the unbiased sample variance of the residuals is expressed by each hypothesized state as

$${\overline{S}}_{i} = \frac{1}{N - 1} {\sum }_{k = 1}^{N} ( {\hat{r}}_{i} ( k ) - {\overline{v}}_{i} ) {( {\hat{r}}_{i} ( k ) - {\overline{v}}_{i} )}^{T} , \qquad ( 59 )$$

where \overline{v} is the sample mean of the residuals given by:

$${\overline{v}}_{i} = \frac{1}{N} {\sum }_{k = 1}^{N} {\hat{r}}_{i} ( k ) . \qquad ( 60 )$$

Given the average value of C(k)Mᵢ(k)C^{T}(k) over the sample window given by:

$$\frac{1}{N} {\sum }_{k = 1}^{N} C ( k ) {M}_{i} ( k ) {C}^{T} ( k ) . \qquad ( 61 )$$

Then the estimated measurement covariance matrix at time k is given by:

$$\begin{matrix}{\overline{V}}_{i} ( k ) = \frac{1}{N - 1} {\sum }_{k = 1}^{N} [ ( {\hat{r}}_{i} ( k ) - {\overline{v}}_{i} ) {( {\hat{r}}_{i} ( k ) - {\overline{v}}_{i} )}^{T} - & ( 62 ) \\ \frac{N - 1}{N} C ( k ) {M}_{i} ( k ) {C}^{T} ( k ) ] . & \end{matrix}$$

The above relations are used at time step k for estimating the measurement noise mean and variance at that time instant. Before that, the filter operates in the classical way using a zero mean and a pre-defined variance for measurement statistics V. Recursion relations for the sample mean and sample covariance for k>N are formed as:

$$\begin{matrix}{\overline{v}}_{i} ( k + 1 ) = {\overline{v}}_{i} ( k ) + \frac{1}{N} ( {\hat{r}}_{i} ( k + 1 ) - {\hat{r}}_{i} ( k + 1 - N ) ) and & ( 63 ) \\ {\overline{V}}_{i} ( k + 1 ) = {\overline{V}}_{i} ( k ) + \frac{1}{N - 1} [ ( {\hat{r}}_{i} ( k + 1 ) - {\overline{v}}_{i} ( k + 1 ) ) ( \hat{r} ( k + 1 ) - & ( 64 ) \\ { {\overline{v}}_{i} ( k + 1 ) )}^{T} - ( {\hat{r}}_{i} ( k + 1 - N ) - & \\ {\overline{v}}_{i} ( k + 1 - N ) {( {\hat{r}}_{i} ( k + 1 ) - {\overline{v}}_{i} ( k + 1 - N ) )}^{T} + & \\ \frac{1}{N} ( {\hat{r}}_{i} ( k + 1 ) - {\hat{r}}_{i} ( k + 1 - N ) ) ( {\hat{r}}_{i} ( k + 1 ) - & \\ { {\hat{r}}_{i} ( k + 1 - N ) )}^{T} - \frac{N - 1}{N} ( C ( k + 1 ) {M}_{i} ( k + 1 ) & \\ {C}^{T} ( k + 1 ) - C ( k + 1 - N ) {M}_{i} ( k + 1 - N ) & \\ {C}^{T} ( k + {1}_{N} ) ) ) ] . & \end{matrix}$$

The sample mean computed in the first equation above is a bias that has to be accounted for in the filter update process. Thus the filter update for each stage is calculated as:
\hat{x}ᵢ(k)=\overline{x}ᵢ(k)+Kᵢ(k)[\overline{r}ᵢ(k)−\overline{v}ᵢ(k)], (65)
where the gain matrix Kᵢ is now calculated using the following process:
Rᵢ=\overline{V}ᵢ⁻¹−HᵢQₛᵢHᵢ^{T}; (66)
Mᵢ(k)=Πᵢ(k)−Πᵢ(k)C^{T}(Rᵢ+CΠᵢ(k)C^{T})⁻¹CΠᵢ(k); (67)
and
Kᵢ=Π(k)C^{T}(Rᵢ+CΠ(k)C^{T})⁻¹. (68)

For the healthy case, the gain K₀ is calculated as:
M₀(k)=P₀(k)−P₀(k)C^{T}(\overline{V}₀+CP₀(k)C^{T})⁻¹CP₀(k) (69)
and
K=P₀(k)C^{T}\overline{V}₀⁻¹, (70)
which is the adaptive Kalman Filter Gain.

In other embodiments, the residual \hat{r}ᵢ(k) and matrix Mᵢ could be replaced with \overline{r}ᵢ(k) and matrix Πᵢ for slightly different effects. Finally, as before one state may be selected to provide the best estimate of the noise variance for all of the filter structures. Typically, this would be the healthy state estimate using the adaptive Kalman Filter. The estimated mean and variance are used in all of the hypothesized state update systems rather than each calculating a separate estimate of the measurement noise. The declaration process is then used to turn on and turn off the adaptive portion of the filter as required based on the current health of the system. If a fault is declared the system may elect to turn off the adaptive estimation algorithm in order to degrade gracefully.

Fault Reconstruction

The fault signal in the measurements may be reconstructed using:
H_{d}(k)E\hat{μ}(k)=H_{d}(k)(y(k)−C(k)\overline{x}(k))=H_{d}(k)(Eμₘ+v(k)) (71)
where the term H_{d}(k)=(I−C(k)(C^{T}(k)C(k))⁻¹C^{T}(k)) acts as a projector on the measurement annihilating the effect of the state estimate. The fault signal may then be reconstructed using a least squares type of approach. Further, the ability to estimate the fault signal separately from the state estimate enables the system to attempt to diagnose the problem. The Wald test, Shiryayev Test, or Chi-Square test may be invoked to test hypotheses on the type of failure present. For instance, one hypothesis might be that an actuator is stuck and that the fault signal matches the control precisely except for a bias. Another embodiment includes parameter identification techniques employed to diagnose the problem. Once the hypothesis has been tested and a probability assigned, the declaration process may declare that the fault is of a particular type based on the probability calculated in the residual processor. Using this method, the declaration process commands changes in the estimation process through the use of different dynamics, different measurement sets, or different methods of processing similar to those presented here to aid in further diagnosing the problem, further eliminating the effect of the problem from the estimator, and finally providing feedback to a control system so that the control system may attempt to perform maneuvers or operate in a manner which is safe or minimally degrades in the presence of the failure.
Discrete Time Fault Detection Filter

The fault detection problem is similar to the problem presented in Chen[1] and the discrete time filter presented in Mutuel[2]. The discrete time fault detection problem begins with the following linear system with two possible fault modes, F₁ and F₂ as:
x(k+1)=Φ(k)x(k)+Γω(k)+F₁μ₁(k)+F₂μ₂(k)+Γ_{c}u(k) (72)
y(k)=C(k)x(k)+v(k) (73)
where x(k) is the state at time step k, ω is process noise or uncertainty in the plant model, μ₁ is the target fault and μ₂ is the nuisance fault. The measurements y are also corrupted by measurement noise v(k). All of the system matrices Φ, C, Γ, F₁, and F₂ may be considered time varying and are continuously differentiable. The term u(k) is the control command into the dynamics from an actuator and Γ_{c} is the control sensitivity matrix. These terms are ignored in this development for simplicity. Section 6 demonstrates how to incorporate known actuator commands back into the filter derived.

The following assumptions are required:
1. The system is (H, Φ) observable.
2. The matrices F₁ and F₂ are output separable.

The goal of the Discrete Time Fault Detection Filter (DTFDF) is to develop a filter structure in which is impervious to the effect of the nuisance fault while maintaining observability of the target fault. In this way, a system with multiple fault modes may be separated and each individual mode identified independently with separate filters. Note that in Chung[3], it is shown that this model may be used to represent faults in either the measurements or the dynamics through a transformation.

The objective of blocking one fault type while rejecting another is described in the following min-max problem:

$$\begin{matrix}{min}_{{μ}_{1}} {max}_{{μ}_{2}} {max}_{x ( 0 )} \frac{1}{2} {\sum }_{0}^{k} ( {‖ {μ}_{1} ( k ) ‖}_{{Q}_{1}^{- 1}}^{2} - {‖ {μ}_{2} ( k ) ‖}_{γ {Q}_{2}^{- 1}}^{2} - & ( 74 ) \\ {‖ x ( k ) - \overline{x} ( k ) ‖}_{{Q}_{s}} + {‖ y ( k ) - Cx ( k ) ‖}_{{V}^{- 1}}^{2} ) - \frac{1}{2} {‖ x ( 0 ) - \hat{x} ( k ) ‖}_{{Π}_{0}}^{2} , & \end{matrix}$$

subject to the dynamics in Eq. 72. The weighting matrices Q₁, Q₂, Qₛ, V, and Π₀ along with the scalar γ are all design parameters. Note that V is typically related to the power spectral density of the measurements. Similarly, W is chosen as the power spectral density of the dynamics, which will become part of the solution presented. All of these parameters are assumed positive definite while γ is assumed non-negative. If γ is zero, then the nuisance fault is removed from the problem.

The result of the minimization is the following filter structure for providing the best estimate of \hat{x} while permitting the target faults to affect the state and removing the effect of the nuisance fault from the state. Given a priori initial conditions \overline{x}(k) with covariance Π(k), the update of the state with the new measurements y(k) can proceed. Note that the notation of Π(k) differs from the normal P used in Kalman filtering[5] since this is not truly the error covariance.

As part of the process, a projector is created to eliminate the effects of the nuisance fault in the residual. This projector is capable of defining the space of influence of the nuisance fault as:
H(k)=I−(CΦⁿF₂)[(CΦⁿF₂)^{T}(CΦⁿF₂)]⁻¹(CΦⁿF₂)T (75)
in which n is the smallest, positive number required to make the system (C, F₂) observable. The projector will be used to modify the posteriori residual process.

Once the projector is defined, the measurements may be processed. The update equations are given in Eq. 76-Eq. 78.
R=V⁻¹−HQₛH^{T} (76)
M(k)=Π(k)−Π(k)C^{T}(R+CΠ(k)C^{T})⁻¹CΠ(k) (77)
K=Π(k)C^{T}(R+CΠ(k)C^{T})⁻¹ (78)

In this series of equations the matrix Qₛ is defined to weight the ability of the filter to track residual in the remaining space of the filter. This matrix is a design parameter allowed to exist and should be used judiciously since it can cause a violation of the positive definiteness requirement on the matrix R.

The state is updated using the calculated gain K in Eq. 79.
\hat{x}(k)=\overline{x}(k)+K(y(k)−C\overline{x}(k)) (79)

Then the state is then propagated forward in time according to Eq. 80
\overline{x}(k+1)=Φ\hat{x}(k) (80)

The covariance M(k) is propagated as in Eq. 81.

$$Π ( k + 1 ) = Φ M ( k ) {Φ}^{T} + \frac{1}{γ} {F}_{2} {Q}_{2} {F}_{2}^{T} + W - {F}_{1} {Q}_{1} {F}_{1}^{T} \qquad ( 81 )$$

It is important to note two facts. First, if no faults exist (Q₁=0 and Q₂=0) and no limit on the measurement exist (Qₛ=0), then the filter structure reduces to that of a Kalman Filter. Second, the updated state \hat{x}(k) may be reprocessed with the measurements to generate the posteriori residual:
r(k)=H(k)(y(k)−C\hat{x}(k)) (82)

Note that r(k) is zero mean if μ₁ is zero regardless of the value of μ₂. This residual is used to process the measurements through the Shiryayev Test. Note that the statistics of this test are static if no fault signal exists. Otherwise, the filter exhibits the normal statistics added to the statistics of the new fault signal which allows fault signals to be distinguished.

In this way, the generic discrete time fault detection filter is defined. The tuning parameter V is determined by the measurement uncertainty. The tuning parameter W should be determined by the uncertainty in the dynamics. The other tuning parameters Q₁, Q₂, and Qₛ are defined to provide the necessary weighting to either amplify the target fault, eliminate the effect of the nuisance fault, or bound the error in the state estimate.

Continuous to Discrete Time Conversion

Occasionally, a discrete time system must be developed from a continuous time dynamic system. Given a dynamic system of the form:
\dot{x}=Ax+Bω+f₁μ₁+f₂μ₂ (83)
then the discrete time dynamic system is calculated as:

$$\begin{matrix}x ( {t}_{k + 1} ) = {ⅇ}^{A Δ t} x ( {t}_{k} ) + {\int }_{{t}_{k}}^{{t}_{k + 1}} {ⅇ}^{At} B ω ( t ) ⅆ t + & ( 84 ) \\ {\int }_{{t}_{k}}^{{t}_{k + 1}} {ⅇ}^{At} {f}_{1} {μ}_{1} ⅆ t + {\int }_{{t}_{k}}^{{t}_{k + 1}} {ⅇ}^{At} {f}_{2} {μ}_{2} ⅆ t & \end{matrix}$$

Defining Φ=e^{AΔt}, the continuous time system may be rewritten into the continuous time system with a few assumptions. First, the process noise matrix is defined as

$$Γ = {\int }_{{t}_{k}}^{{t}_{k + 1}} {ⅇ}^{At} B ⅆ t .$$

Then the fault direction matrices are defined as

$${F}_{1} = {\int }_{{t}_{k}}^{{t}_{k + 1}} {ⅇ}^{At} {f}_{1} ⅆ t and {F}_{2} = {\int }_{{t}_{k}}^{{t}_{k + 1}} {ⅇ}^{At} {f}_{2} ⅆ t ,$$

respectively.

If f₁, f₂, and B are time invariant, and if we further approximate Φ=I+AΔt, then the fault and noise matrices may be approximated as:

$$\begin{matrix}Γ = ( I Δ t + \frac{1}{2} A Δ {t}^{2} ) B & ( 85 ) \\ {F}_{1} = ( I Δ t + \frac{1}{2} A Δ {t}^{2} ) {f}_{1} & ( 86 ) \\ {F}_{2} = ( I Δ t + \frac{1}{2} A Δ {t}^{2} ) {f}_{2} & ( 87 )\end{matrix}$$

Faults in the Measurements

The measurement model may include faults. In order to process these faults, the fault is transferred from the measurement model to the dynamic model using the following method. Once transferred, the fault detection filter processing proceeds as normal. This process works for either target or nuisance faults.

Given the Model
y(k)=C(k)x(k)+Eμₘ+v(k) (88)

The problem becomes to find a matrix fₘ such that:
E=C(k)fₘ (89)

Many solutions may be available and the designer is responsible to pick the best solution. Once fₘ is chosen, the dynamics may be updated in the following way:
x(k+1)=Φx(k)+Γω+Fₘ[μₘ;\dot{μ}ₘ] (90)
where Fₘ is defined as:
Fₘ=[fₘ;Φfₘ] (91)

In short, the matrix Fₘ takes up two fault directions. The meaning of \dot{μ}ₘ is not significant since the original fault signal is assumed unknown. A measurement fault is equivalent to two faults in the dynamics as described in Chung [95]. A similar transfer may be made in the continuous time case in which case the new fault direction is merely f=[fₘ;Afₘ].

Least Squares Filtering

If no dynamics are present or modelled, then an alternate form may be constructed in which the measurement fault is blocked in a similar manner. In this case, Eq. 75 is reduced to the following form:
H(k)=I−(E)[(E)^{T}(E)]⁻¹(E)^{T} (92)

The residual is then calculated as:
r(k)=H(k)(y(k)−C\overline{x}(k)) (93)

The residual is now assumed fault free and the state estimate is calculated using the standard weighted least squares estimation process:
\hat{x}(k)=(C^{T}(k)V⁻¹(k)C(k))⁻¹C^{T}(k)V⁻¹(k)r(k) (94)

The Shiryayev or Wald tests may then be used to operate on this residual or the posteriori residual calculated as:
r(k)=H(k)(y(k)−C\hat{x}(k)) (95)

This method is effective when a single fault influences more than one measurement. This version is referred to as the Least Squares Fault Detection Filter since dynamics are not used.

Output Separability

Given a model for the dynamic system and associated fault directions, a test must be made for output separability. This test is similar to an observability/controllability and assesses the ability of the fault detection filter to observe a fault and distinguish it from other faults in the system. The test for output separability is a rank test of the matrix CF. If the matrix is full rank, then the filter is observable.

If not the designer may chose to examine a rank test of the matrix CΦⁿF where n is any positive integer. In essence, this determines if the fault is output separable through the dynamic process which results in an indirect examination in the fault. If the matrix is full rank for a value of n, then the system is output separable. However, it must be noted that the size of n will likely relate to the amount of time necessary to begin to observe the fault.

Reduced Order Filters and Algebraic Reconstruction

Reduced order filters may be constructed in which the fault signal is not used in the filter. In essence, the direction is removed from the filter structure. Such filter structures are discussed in Mutuel. In essence, the filter operates without the use of the damaged measurement. This step is necessary in the case where the fault is sufficiently large. However, it can result in an unstable filter structure since the filter typically eliminates the space that was influenced by the fault.

An alternative to complete elimination of the measurement source is algebraic reconstruction. From the remaining measurements, a replacement estimate of the measurement may be reconstructed from the residual process. In essence, the faulty measurement or actuator motion is reconstructed based upon the healthy measurements and the dynamic model. This method can increase the performance of the filter during a fault and provide a means for estimating the stability of the filter structure in the presence of a fault. No reduction in order is necessary. In other words, the new measurement:
\overline{y}=C(k)\overline{x}(k) (96)
is used to calculate the replacement measurement. The replacement measurement is processed within the filter as if it were a real measurement.

Further the fault signal in the measurements may be reconstructed using:
H_{d}(k)E\hat{μ}(k)=H_{d}(k)(y(k)−C(k)\overline{x}(k))=H_{d}(k)(Eμₘ+v(k)) (97)
where the term H_{d}(k)=(I−C(k)(C^{T}(k)C(k))⁻¹C^{T}(k)) acts as a projector on the measurement annihilating the effect of the state estimate. A similar form may be used for constructing the fault signal in the dynamics except that the fault is of course modified by the dynamics. Using this method, the value of \hat{μ} may be estimated for a measurement failure using a least squares technique.
Inserting a Control System and Actuator Failures

In general the fault model may be any introduced signal. In the Dynamics of Eq. 72, the system modelled has process noise (ω) and actuator commands (u(k)). One possible fault direction is that F=Γ_{c} indicating that the fault signal μ is actually a failure in the actuator. While a control system may be supplying a command u, the effect of μ is to remove or distort this signal in some unknown manner. For instance, μ=−u(k)+b could indicate a stuck actuator since the fault signal exactly removes any command issued except for a constant bias b. In this way, but measurement and actuator faults are handled by this structure.

If u(k) is assumed known from a control system and not a random variable, then the only change required in the filter structure presented is the addition of the command in the propagation phase.
\overline{x}(k+1)=Φ\hat{x}(k)+Γ_{c}u(k) (98)

In this way, an external command system is introduced into the filter structure and command failures may be modelled.

Shiryayev Test for Change Detection and Isolation

A method for processing residuals given a set of hypothesized results is presented. This method may be used to determine which of a set of hypothesized events actually happened based on a residual history. This method may be applied to the problem of determining which fault, if any has occurred within a system. The Shiryayev Hypothesis testing scheme may be used to discriminate between healthy systems and fault signals using the residual processes from the fault detection filters. This section describes the Generalized Multiple Hypothesis Shiryayev Sequential Probability Ratio Test (MHSSPRT). The theoretical structure is presented along with requirements for implementation.

The algorithm is presented in Bertsekas [9] in which the author considers a problem of instruction. In this example, the instructor of a class is trying to determine the state of the student. The state is either enlightened or unenlightened. The goal of the instructor is to get the student to the enlightened state. At each time step, the instructor tests the student. Based upon the result of the test, the instructor attempts to determine the state of the student in the presence of uncertainty. If the state is ambiguous, the instructor gives more instruction followed by another test. The risk is that the student will either not achieve enlightenment or will become bored with unnecessary repetition.

The example outlines the fundamental concepts of the SSPRT. The student starts in the unenlightened state, but may transition to the enlightened state after instruction. A probability of this transition given a period of instruction is assumed. The instructor provides instruction and testing. However, the testing may not accurately reflect the state of the student, introducing uncertainty into the problem. There is a cost associated with instruction as the student and instructor may both become bored. There is a penalty for stopping the process before the student reaches the enlightened state. Finally, there is also a penalty for declaring the student enlightened when in fact the student is unenlightened. All of these factors are used to develop the SSPRT.

In White and Speyer [12], the SSPRT is applied to the problem of fault detection. In this case, a linear, stochastic dynamic system is assumed. Two systems are assumed, each with a different bias in the measurement. The bias values are assumed known a priori. The goal of the paper is to use the SSPRT to determine the transition from one bias to another in minimum time and while minimizing the false alarm rate.

White and Speyer point out that the SSPRT is limited in the fact that the algorithm only permits two hypotheses. If more hypotheses are needed to cover the possible states of a given system, then multiple SSPRT algorithms are necessary. In this case, each SSPRT starts from the same hypothesis but is tuned to detect a transition to a different hypothesis. The algorithm is computationally expensive. In addition, each SSPRT operates in a manner that does not recognize that that multiple hypotheses are possible. Malladi and Speyer [10] suggest an approach to enhancing the SSPRT to allow multiple hypotheses, termed the Multiple Hypothesis SSPRT (MHSSPRT). This algorithm is applied to fault detection as well. However, in the development of the algorithm, the transition probabilities between each time step seem to allow more than one transition while the measurement phase only assumes a single transition.

The section is outlined into three parts. The first section outlines the development of the binary SSPRT as shown in [12] with references to [9]. The second section expands these results to allow for multiple hypotheses while allowing only one transition to a specific hypothesis. The last part is an implementation page that summarizes the critical results.

The Binary SSPRT

This section outlines the SSPRT, referred to as the binary SSPRT because this algorithm chooses between two possible states given a single measurement history. Only the probability estimation algorithm is presented. The development follows White [12]. The SSPRT detects the transition from a base state to a hypothesized state. Let the base state be defined as H₀ and the possible transition hypothesis as H₁. Define a sequence of measurements up to time t_{N} as Z_{N}={z₁, z₂, . . . , z_{N}}. These measurements are sometimes the residual process from another filter such as a Kalman Filter. The SSPRT requires that the measurements zₖ are independent and identically distributed. If the system is in the H₀ state, then the measurements are independent and identically distributed with probability density function f₀(zₖ). Similarly, if the system is in the H₁ state, then the measurements have density function f₁(zₖ).

The probability that the system is in the base state at time tₖ is defined as F₀(tₖ) and the probability that the system has transitioned is F₁(tₖ). The goal of this section is to define a recursive relationship for these probabilities based on the measurement sequence Z_{N}. Define the unknown time of transition as θ. The probability that a transition has occurred given a sequence of measurements is then:
F₁(tₖ)=P(θ≦tₖ/Zₖ) (99)

This probability will be referred to as the a posteriori probability for reasons that will become clear. Similary, the a posteriori probability that the system remains in the base state given the same measurement sequence may be defined as:
F₀(tₖ)=P(θ>tₖ/Zₖ) (100)
which is the probability that the transition has not yet happened even though it may occur sometime in the future. The initial probability for F₁(t₀) is π while the initial probability for F₀(t₀) is (1−π).

Define the a priori probability of a transition and no transition as:
φ₁(tₖ₊₁)=P(θ≦tₖ₊₁/Zₖ) (101)
φ₀(tₖ₊₁)=P(θ>tₖ₊₁/Zₖ) (102)

Finally, at each time step, there is a probability of a transition occurring defined as p. In this development, p is assumed constant which implies that the time of transition is geometrically distributed. The mathematical definition states that p is the probability that the transition occurs at the current time step given that the transition occurs sometime after the previous time step.
p=P(θ=tₖ/θ>tₖ₋₁) (103)

With these definitions, it is possible to write the probability of a transition using Bayes rule. Starting from the initial conditions at t₀, the probability that a transition occurrs given the measurement z₁ is given by:

$${F}_{1} ( {t}_{1} ) = P ( θ \leq {t}_{1} / {z}_{1} ) = \frac{P ( {z}_{1} / θ \leq {t}_{1} ) P ( θ \leq {t}_{1} )}{P ( {z}_{1} )} \qquad ( 104 )$$

The probability that a transition occurs before time t₁ is:

$$\begin{matrix}P ( θ \leq {t}_{1} ) = P ( θ \leq {t}_{0} ) + P ( θ = {t}_{1} ) ( 105 ) \\ = P ( θ \leq {t}_{0} ) + P ( θ = {t}_{1} / θ > {t}_{0} ) P ( θ > {t}_{0} ) + ( 106 ) \\ P ( θ = {t}_{1} / θ \leq {t}_{0} ) P ( θ \leq {t}_{0} ) ( 107 ) \\ = π + p ( 1 - π ) + ( 0 ) π ( 108 ) \\ = π + p ( 1 - π )\end{matrix}$$

where the probability that the transition occurrs at t₁, P(θ=t₁), is expanded around the condition that the transition time happens after t₀, P(θ>t₀), or at or before time t₀, P(θ≦t₀). Of course, the probability that a transition occurrs at t₁ given that the transition already occurred is zero since only one transition is assumed. A second transition is assumed impossible. Therefore, the a priori probability of a transition at t₁ given only initial conditions is:
φ₁(t₁)=π+p(1−π) (109)
with the trivial derivation of the a priori probability that no transition has occurred.
φ₀(tᵢ)=1−φ₁(t₁)=(1−p)(1−π) (110)

Next, the probability of a given measurement P(z₁) may be rewritten to take into account the time of transition.
P(z₁)=P(z₁/θ≦t₁)P(θ≦t₁)+P(z₁/θ>t₁)P(θ>t₁) (111)

The conditional probability of z₁ taking any value in the range z₁ε(ρ₁,ρ₁+dz₁) given that a transition has already occurred is defined by the probability density function of hypothesis H₁ as:
P(z₁/θ≦t₁)=f₁(z₁)dz₁ (112)

Likewise, the probability of z₁ taking any value in the same range conditioned on the fact that the transition has not happened is given by:
P(z₁/θ>t₁)=f₀(z₁)dz₁ (113)

Substituting Eq. 112, 113, and the result of 105 into Eq. 111 gives:
P(z₁)=f₁(z₁)dz₁φ₁(t₁)+f₀(z₁)dz₁φ₀(t₁) (114)

Substituting back into the definition of F₁(1) in Eq. 104,

$${F}_{1} ( {t}_{1} ) = \frac{{ϕ}_{1} ( {t}_{1} ) {f}_{1} ( {z}_{1} )}{{ϕ}_{1} ( {t}_{1} ) {f}_{1} ( {z}_{1} ) + {ϕ}_{0} ( {t}_{1} ) {f}_{0} ( {z}_{1} )} \qquad ( 115 )$$

The differential increment, dz₁, cancels out of Eq. 115.

A similar expression for F₀(t₁) may be formulated using Bayes rule, or else a simpler expression may be used. Realizing that either the base hypothesis H₀ is true or the transition hypothesis H₁ is true, the sum of both probabilities must equal 1. Therefore,
F₀(t₁)=1−F₁(t₁) (116)

While this result seems trivial at this point, the result seems less clear in light of the multiple hypothesis development presented in [10] and the following sections. Moving forward one time step to time t₂, F₁(t₂) may be defined using Bayes rule again:

$${F}_{1} ( {t}_{2} ) = P ( θ \leq {t}_{2} / {Z}_{2} ) = \frac{P ( {Z}_{2} / θ \leq {t}_{2} ) P ( θ \leq {t}_{2} )}{P ( {Z}_{2} )} \qquad ( 117 )$$

Since the measurement sequence Z₂=[z₁, z₂] is conditionally independent by assumption then

$${F}_{1} ( {t}_{2} ) = \frac{P ( {z}_{2} / θ \leq {t}_{2} ) P ( {z}_{1} / θ \leq {t}_{2} ) P ( θ \leq {t}_{2} )}{P ( {z}_{2} / {z}_{1} ) P ( {z}_{1} )} \qquad ( 118 )$$

Since the measurements are independent, P(z₂/z₁)=P(z₂). In addition, P(z₂/θ≦t₂)=f₁(z₂)dz₂, just as in Eq. 112 in the previous time step. Finally, applying Bayes rule again,

$$P ( {z}_{1} / θ \leq {t}_{2} ) = \frac{P ( θ \leq {t}_{2} / {z}_{1} ) P ( {z}_{1} )}{P ( θ \leq {t}_{2} )} \qquad ( 119 )$$

Substituting back into 118, gives

$${F}_{1} ( {t}_{2} ) = \frac{{f}_{1} ( {z}_{2} ) {dz}_{2} P ( θ \leq {t}_{2} / {z}_{1} )}{P ( {z}_{2} )} \qquad ( 120 )$$

However,

$$\begin{matrix}P ( θ \leq {t}_{2} / {z}_{1} ) = P ( θ \leq {t}_{1} / {z}_{1} ) + P ( θ = {t}_{2} / {z}_{1} ) ( 121 ) \\ = {F}_{1} ( {t}_{1} ) + p ( 1 - {F}_{1} ( {t}_{1} ) ) ( 122 ) \\ = {ϕ}_{1} ( {t}_{2} ) ( 123 )\end{matrix}$$

This is the propagation relationship for the probability at time t₂. In addition, P(z₂) has a similar form to Eq. 114 shown as:
P(z₂)=f₁(z₂)dz₂φ₁(t₂)+f₀(z₂)dz₂φ₀(t₂) (124)

Substituting back into Eq. 120 gives a recursive relationship for F₁(t₂) in terms of φ₁(t₁), φ₀(t₁), and the respective density functions.

$${F}_{1} ( {t}_{2} ) = \frac{{ϕ}_{1} ( {t}_{2} ) {f}_{1} ( {z}_{2} )}{{ϕ}_{1} ( {t}_{2} ) {f}_{1} ( {z}_{2} ) + {ϕ}_{0} ( {t}_{2} ) {f}_{0} ( {z}_{2} )} \qquad ( 125 )$$

By induction, it is possible to rewrite the relationship into a recursive algorithm as:

$${F}_{1} ( {t}_{k + 1} ) = \frac{{ϕ}_{1} ( {t}_{k + 1} ) {f}_{1} ( {z}_{k + 1} )}{{ϕ}_{1} ( {t}_{k + 1} ) {f}_{1} ( {z}_{k + 1} ) + {ϕ}_{0} ( {t}_{k + 1} ) {f}_{0} ( {z}_{k + 1} )} \qquad ( 126 )$$

The propagation of the probabilities is given as:
φ₁(tₖ₊₁)=F₁(tₖ)+p(1−F₁(tₖ)) (127)

The base hypothesis probability is calculated in each case using the assumption that both probabilities must sum to one. Therefore:
F₀(tₖ₊₁)=1−F₁(tₖ₊₁) (128)
and
φ₀(tₖ₊₁)=1−φ₁(tₖ₊₁) (129)

This is the conclusion of the results presented in [12]. A recursive algorithm is established for determining the probability that a transition has occurred from H₀ to H₁ given the independent measurement sequence Zₖ. The algorithm assumes that only one transition is possible. In addition, the algorithm assumes that the probability of a transition is constant for each time step. Finally, the algorithm assumes that the measurements form an independent measurement sequence with constant distribution.

The Multiple Hypothesis SSPRT

The previous section developed an algorithm for estimating the probability that a given system was either in the base state or had transitioned to another hypothesized state given a sequence of measurements. Because there are only two possible states, this test is referred to as the binary SSPRT.

This section seeks to expand the results of the previous section to take into account the possibility that the system in question may transition from one base state to one of several different hypothesized states. However, it is assumed that only one transition occurs and that the system transitions to only one of the hypothesized states. It is assumed that the system cannot transition to a combination of hypothesized states or transition multiple times.

To begin, assume that a total of M hypothesis exist in addition to the initial hypothesis. The probability that each hypothesis jε{1, 2, . . . , M} is correct given a sequence of measurements up to time tₖ is defined as Fⱼ(tₖ). The associated base probability is F₀(tₖ). Since only one transition is possible from the base state, then the total probability of a transition must remain unchanged, regardless of the state to which the system transitions. The time of transition is still defined as θ. As a means of notation, the time of transition to hypothesis Hⱼ is defined as θⱼ. Mathematically, the total probability of a transition is the sum of the probability of a transition to each of the probabilities:

$$P ( θ \leq {t}_{k} ) = {\sum }_{j = 1}^{M} P ( {θ}_{j} \leq {t}_{k} ) \qquad ( 130 )$$

With this realization, the development of multiple hypothesis SSPRT is now straightforward. For the j^{th} hypothesis, the appropriate definition for the probability of a transition to this hypothesis is:
Fⱼ(tₖ)=P(θⱼ≦tₖ/Zₖ) (131)

The probability that no transition has occurred is simply:

$${F}_{0} ( {t}_{k} ) = P ( θ > {t}_{k} / {Z}_{k} ) = 1 - {\sum }_{j = 1}^{M} {F}_{j} ( {t}_{k} ) \qquad ( 132 )$$

Again, these are the a posteriori probabilities. The initial conditions for each hypothesis are defined as πⱼ=Fⱼ(t₀), j=1, 2, . . . , M, with the obvious restriction that the initial conditions sum to one. The a priori probabilities are defined again as:
φⱼ(tₖ₊₁)=P(θⱼ≦tₖ₊₁/Zₖ) (133)

$${ϕ}_{0} ( {t}_{k + 1} ) = P ( {θ}_{0} > {t}_{k + 1} / {Z}_{k} ) = 1 - {\sum }_{j = 1}^{M} {ϕ}_{j} ( {t}_{k + 1} ) \qquad ( 134 )$$

The probability of a transition may be developed using Bayes rule as before.

$${F}_{j} ( {t}_{1} ) = P ( {θ}_{j} \leq {t}_{1} / {z}_{1} ) = \frac{P ( {z}_{1} / {θ}_{j} \leq {t}_{1} ) P ( {θ}_{j} \leq {t}_{1} )}{P ( {z}_{1} )} \qquad ( 135 )$$

This time, the goal is to find the value for the probability of a transition to one particular hypothesis while still accounting for the fact that a transition may occur to another hypothesis. The probability that the transition has occurred before the current time step is given as:
P(θⱼ≦t₁)=P(θⱼ≦t₀)+P(θⱼ=t₁) (136)

This step is similar in form to the binary hypothesis SSPRT derivation in Eq. 105. The term P(θⱼ≦t₀) is given as an initial condition Dry before the algorithm begins. The term P(θⱼ=t₁) is now expanded as before around the conditional probability that the transition has occurred before or after the previous time step.

$$\begin{matrix}P ( {θ}_{j} = {t}_{1} ) = P ( {θ}_{j} = {t}_{1} / {θ}_{j} > {t}_{0} ) P ( {θ}_{j} > {t}_{0} ) + ( 137 ) \\ P ( {θ}_{j} = {t}_{1} / {θ}_{j} \leq {t}_{0} ) P ( {θ}_{j} \leq {t}_{0} ) ( 138 ) \\ = P ( {θ}_{j} = {t}_{1} / {θ}_{j} > {t}_{0} ) P ( {θ}_{j} > {t}_{0} ) + ( 0 ) P ( {θ}_{j} \leq {t}_{0} ) ( 139 )\end{matrix}$$

The probability that a transition occurs at each time step, regardless of which transition occurs is p as in the binary hypothesis. This need not be true, but it is assumed in this case for simplicity. It is left to the designer to determine whether a transition to one hypothesis at a given time is more likely than to another. For this development, P(θⱼ=t₁/θⱼ>t₀)=p.

The probability associated with a transition to the j^{th} hypothesis at some time after to is P(θⱼ>t₀). This probability cannot be calculated without taking into account the probability that the transition θ may have occurred or will occur in the future and may or may not transition to the j^{th} hypothesis. This probability is now expanded as before around the conditional probability that θ occurs before or after the current time step.

$$\begin{matrix}P ( {θ}_{j} > {t}_{0} ) = P ( {θ}_{j} > {t}_{0} / θ > {t}_{0} ) P ( θ > {t}_{0} ) + ( 140 ) \\ P ( {θ}_{j} > {t}_{0} / θ \leq {t}_{0} ) P ( θ \leq {t}_{0} ) ( 141 ) \\ = P ( {θ}_{j} > {t}_{0} / θ > {t}_{0} ) P ( θ > {t}_{0} ) + ( 142 ) \\ ( 0 ) P ( θ \leq {t}_{0} ) ( 143 )\end{matrix}$$

Given the defintion of Eq. 130, the probability that the transition time occurs after to is simply one minus the sum of all the probabilities that the transition has already occurred, or:

$$P ( θ > {t}_{0} ) = 1 - {\sum }_{i = 1}^{M} P ( {θ}_{j} \leq {t}_{0} ) \qquad ( 144 )$$

A question remains of how to define the probability that given the transition occurs after t₀, the transition goes to the j^{th} hypothesis. Assuming that a transition to any one of the M hypotheses is equally likely, this probability is defined as:
P(θⱼ>t₀/θ>t₀)=1/M (145)

Eq. 145 states that given a transition occurs in the future, the probabilities of transition to an hypothesis are the same. This assumption does not necessarily need to be true and may be adjusted to suit the paritcular application so long as the sum of all of these probabilities is one.

Substituting Eq. 145, 144, 140, and 137 into Eq. 136 gives:

$$P ( {θ}_{j} \leq {t}_{1} ) = P ( {θ}_{j} \leq {t}_{0} ) + ( 146 ) \\ P ( {θ}_{j} = {t}_{1} / {θ}_{j} > {t}_{0} ) P ( {θ}_{j} > {t}_{0} / θ > {t}_{0} ) P ( θ > {t}_{0} ) = ( 147 ) \\ P ( {θ}_{j} \leq {t}_{0} ) + ( 148 ) \\ p ( 1 / M ) ( 1 - {\sum }_{i = 1}^{M} P ( {θ}_{j} \leq {t}_{0} ) ) ( 149 )$$

Applying initial conditions in Eq. 146, and defining it as the a priori probability, gives the following:

$${ϕ}_{j} ( {t}_{1} ) = P ( {θ}_{j} \leq {t}_{0} ) + ( p / M ) ( 1 - {\sum }_{i = 1}^{M} P ( {θ}_{j} \leq {t}_{0} ) ) = ( 150 ) \\ {π}_{j} + ( p / M ) ( 1 - {\sum }_{i = 1}^{M} {π}_{j} ) ( 151 )$$

The base hypothesis is still defined simply as:

$${ϕ}_{0} ( {t}_{1} ) = 1 - {\sum }_{j = 1}^{M} {ϕ}_{j} ( {t}_{1} ) \qquad ( 152 )$$

The rest of the derivation proceeds in a straightforward manner similar to that of the binary SSPRT. The probability of a given measurement P(z₁) is re-written to take into account both the time of transmission and the particular hypothesis:

$$P ( {z}_{1} ) = {\sum }_{j = 1}^{M} P ( {z}_{1} / {θ}_{j} \leq {t}_{1} ) P ( {θ}_{j} \leq {t}_{1} ) + ( 153 ) \\ P ( {z}_{1} / θ > {t}_{1} ) P ( θ > {t}_{1} ) ( 154 )$$

As before in Eq. 112, the conditional probability of z₁ taking any value in the range z₁ε(ρ₁,ρ₁+dz₁) given that a transition has already occurred is defined by the probability density function of hypothesis Hⱼ as:
P(z₁/θⱼ≦t₁)=fⱼ(z₁)dz₁ (155)

Substituting Eq. 155, 113, and the result of 150 into Eq. 153 gives:

$$P ( {z}_{1} ) = {\sum }_{j = 1}^{M} {f}_{j} ( {z}_{1} ) ⅆ {z}_{1} {ϕ}_{j} ( {t}_{1} ) + {f}_{0} ( {z}_{1} ) ⅆ {z}_{1} {ϕ}_{0} ( {t}_{1} ) \qquad ( 156 )$$

Then substituting back into the definition of Fⱼ(1) in Eq. 135 yields:

$${F}_{j} ( {t}_{1} ) = \frac{{ϕ}_{j} ( {t}_{1} ) {f}_{j} ( {z}_{1} )}{{\sum }_{j = 1}^{M} {ϕ}_{j} ( {t}_{1} ) {f}_{j} ( {z}_{1} ) + {ϕ}_{0} ( {t}_{1} ) {f}_{0} ( {z}_{1} )} \qquad ( 157 )$$

The differential increment, dz₁, cancels out of Eq. 157. The same equation could be used to calculate F₀(t₁), or use the simplified form:

$${F}_{0} ( {t}_{1} ) = 1 - {\sum }_{j = 1}^{M} {F}_{j} ( {t}_{1} ) \qquad ( 158 )$$

Moving forward one time step to time t₂, Fⱼ(t₂) may be defined using Bayes rule again:

$${F}_{j} ( {t}_{2} ) = P ( {θ}_{j} \leq {t}_{2} / {Z}_{2} ) = \frac{P ( {Z}_{2} / {θ}_{z} \leq {t}_{2} ) P ( {θ}_{j} \leq {t}_{2} )}{P ( {Z}_{2} )} \qquad ( 159 )$$

Since the measurement sequence Z₂=[z₁,z₂] is conditionally independent by assumption, then

$${F}_{j} ( {t}_{2} ) = \frac{P ( {z}_{2} / {θ}_{j} \leq {t}_{2} ) P ( {z}_{1} / {θ}_{j} \leq {t}_{2} ) P ( {θ}_{j} \leq {t}_{2} )}{P ( {z}_{2} / {z}_{1} ) P ( {z}_{1} )} \qquad ( 160 )$$

Since the measurements are independent, P(z₂/z₁)=P(z₂). In addition, P(z₂/θⱼ≦t₂)=fⱼ(z₂)dz₂, just as in Eq. 155 in the previous time step. Finally, applying Bayes rule again,

$$P ( {z}_{1} / {θ}_{j} \leq {t}_{2} ) = \frac{P ( {θ}_{j} \leq {t}_{2} / {z}_{1} ) P ( {z}_{1} )}{P ( {θ}_{j} \leq {t}_{2} )} \qquad ( 161 )$$

Substituting back into 160, gives

$${F}_{j} ( {t}_{2} ) = \frac{{f}_{j} ( {z}_{2} ) {dz}_{2} P ( {θ}_{j} \leq {t}_{2} / {z}_{1} )}{P ( {z}_{1} )} \qquad ( 162 )$$

Applying the definition Eq. 150, yields

$$\begin{matrix}P ( {θ}_{j} \leq {t}_{2} / {z}_{1} ) = P ( {θ}_{j} \leq / {z}_{1} ) + P ( {θ}_{j} = {t}_{2} / {z}_{1} ) & ( 163 ) \\ = {F}_{j} ( {t}_{1} ) + ( p / M ) ( 1 - {\sum }_{i = 1}^{M} {F}_{i} ( {t}_{1} ) ) & ( 164 ) \\ = {ϕ}_{j} ( {t}_{2} ) & ( 165 )\end{matrix}$$

In addition, P(z₂) has the form shown as:

$$P ( {z}_{2} ) = {\sum }_{j = 1}^{M} {f}_{j} ( {z}_{2} ) {dz}_{2} {ϕ}_{2} ( {t}_{2} ) + {f}_{0} ( {z}_{2} ) {dz}_{2} {ϕ}_{0} ( {t}_{2} ) \qquad ( 166 )$$

Substituting back into Eq. 162 gives a recursive relationship for Fⱼ(t₂) in terms of φⱼ(t₁) and the respective density functions.

$${F}_{j} ( {t}_{2} ) = \frac{{ϕ}_{j} ( {t}_{2} ) {f}_{j} ( {z}_{2} )}{{\sum }_{j = 1}^{M} {ϕ}_{j} ( {t}_{2} ) {f}_{j} ( {z}_{2} ) + {ϕ}_{0} ( {t}_{2} ) {f}_{0} ( {z}_{2} )} \qquad ( 167 )$$

By induction, it is possible to rewrite the relationship into a recursive algorithm as:

$${F}_{j} ( {t}_{k} ) = \frac{{ϕ}_{j} ( {t}_{k} ) {f}_{j} ( {z}_{k} )}{{\sum }_{j = 1}^{M} {ϕ}_{j} ( {t}_{k} ) {f}_{j} ( {z}_{k} ) + {ϕ}_{0} ( {t}_{k} ) {f}_{0} ( {z}_{k} )} \qquad ( 168 )$$

So at each time step, a measurement zₖ is taken. The probability of Fⱼ is calculated according to Eq. 168. Between measurements the probability of each hypothesis is propogated forward according to

$${ϕ}_{j} ( {t}_{k + 1} ) = {F}_{j} ( {t}_{k} ) + ( p / M ) ( 1 - {\sum }_{i = 1}^{M} {F}_{j} ( {t}_{k} ) ) \qquad ( 169 )$$

At each stage the posteriori base hypothesis F₀(tₖ) is updated using the same formula as Eq. 168 or equivalently as

$${F}_{0} ( {t}_{k} ) = 1 - {\sum }_{j = 1}^{M} {F}_{j} ( {t}_{k} ) \qquad ( 170 )$$

Likewise, the a priori base hypothesis probability is calculated at each time step as:

$${ϕ}_{0} ( {t}_{k + 1} ) = 1 - {\sum }_{j = 1}^{M} {ϕ}_{j} ( {t}_{k + 1} ) \qquad ( 171 )$$

In both cases, the base state is calculated such that the sum of all hypothesized probabilities is one. In other words, the system is in one of the states covered by the hypothesis. Allowing the sum of probabilities to exceed one might indicate that some overlap exists between the hypotheses. This case does not allow for any overlap between hypotheses.

A brief word about the difference between the algorithm presented here and the algorithm derived by Malladi [10]. The algorithm presented in this section made several assumptions that differ from the algorithm in the Malladi. First, all hypotheses are mutually exclusive and the system must be in one of the hypothesized states. This requirement is enforced by Eq. 171 and 170. Second, this algorithm insists that only one transition occur, although which transition occurs is not known initially. This requirement is enforced by Eq. 130. The algorithm in [10] violates both of these assumptions.

The next section summarizes the algorithm for implementation.

Implementing the MHSSPRT

This section describes a method for implementation of the MHSSPRT for both the binary and multiple hypothesis versions of the SSPRT. Only implementation considerations are covered and some parts of the material are repeated from previous sections for ease of understanding.

Implementing the Binary SSPRT

The binary SSPRT assumes that the system is in one state and at some time θ will transition to another state. The problem is to detect the transition in minimum time using the residual process z(tₖ).

At time t₀, there exists a probability that the transition has not occurred and the system is in the base state. This probability is defined as F₀(t₀). The other possibility is that the system has already transitioned. The probability that this is the case is defined as F₁. During each time step, there is a probability that a transition occurred defined as p. This value is a design criteria and might indicate the mean time between failures (MTBF) for a given instrument over one time step.

The probability of a transition over a particular time step is defined as:
φ₁(tₖ₊₁)=F₁(tₖ)+p(1−F₁(tₖ)) (172)

Note that the probability of no transition is given by:
φ₀(tₖ₊₁)=1−φ₁(tₖ₊₁) (173)

Given a new set of measurements y(tₖ), a residual must be constructed z(tₖ). The construction of this residuals depends upon the particular models used for each system. The residual process must be constructed to be independent and identically distributed and have a known probability density function for each hypothesized dynamic system. For the base state the density function is defined as f₀(z(tₖ)) while the density assuming the transition is defined as f₁(z(tₖ)). These must be recalculated at each time step. With the densities defined, the probabilities are updated as:

$${F}_{1} ( {t}_{k} ) = \frac{{ϕ}_{1} ( {t}_{k} ) {f}_{1} ( z ( {t}_{k} ) )}{{ϕ}_{1} ( {t}_{k} ) {f}_{1} ( z ( {t}_{k} ) ) + {ϕ}_{0} ( {t}_{k} ) {f}_{0} ( z ( {t}_{k} ) )} \qquad ( 174 )$$

with the base probability calculated as:
F₀(tₖ)=1−F₁(tₖ) (175)

This process is repeated until either the experiment is completed or until F₁(tₖ) reaches a probability limit at which time the transition is declared. The choice of the limit is up to the designer and the application. Several suggestions are made in White [12] in which a dynamic programming approach is employed.

Note that the assumptions do not assume that the system may transition back to the original state. If such a transition is required, the designer should wait until this test converges to the limit and then reset the algorithm with the transition system as the base hypothesis and the previous base as the transition system.

Implementing the Multiple Hypothesis SSPRT

The Multiple Hypothesis SSPRT differs from the binary version in that a transition may occur to any one of many possible states. Each state is hypothesized and represented as Hⱼ for the j^{th} hypothesis. The hypothesis H₀ is the baseline hypothesis. This test assumes that at some time in the past the system started in the H₀ state. The goal is to estimate the time of transition θ from the base state to some hypothesis Hⱼ. The test assumes that only one transition will occur and the system will transition to another hypothesis within the total hypothesis set. Results are ambiguous if either of these assumptions are violated.

Given an initial set of probabilities Fⱼ for each hypothesis at time tₖ, the probability that a transition has occurred for each hypothesis between tₖ and tₖ₊₁ is given as:

$${θ}_{j} ( {t}_{k + 1} = {F}_{j} ( {t}_{k} ) + ( p / M ) ( 1 - {\sum }_{i = 1}^{M} {F}_{i} ( {t}_{k} ) ) \qquad ( 176 )$$

where M is the total number of hypotheses in the set (not including the base hypothesis) and p is the probability of a transition away from the base hypothesis between times tₖ and tₖ₊₁. As in the binary test, the value of p is The probability that the system is still in the base state is simply:

$${ϕ}_{0} ( {t}_{k + 1} = 1 - {\sum }_{j = 1}^{M} {ϕ}_{j} ( {t}_{k + 1} \qquad ( 177 )$$

The probabilities are updated with a new residual r(tₖ). Each hypothesis is updated using:

$${F}_{j} ( {t}_{k} ) = \frac{{ϕ}_{j} ( {t}_{k} ) {f}_{j} ( z ( {t}_{k} ) ) )}{{\sum }_{i = 1}^{M} {ϕ}_{i} ( {t}_{k} ) {f}_{i} ( z ( {t}_{k} ) ) + {ϕ}_{0} ( {t}_{k} ) {f}_{0} ( {t}_{k} )} \qquad ( 178 )$$

with the base hypothesis updated using:

$${F}_{0} ( {t}_{k} ) = 1 - {\sum }_{i = 1}^{M} {F}_{i} ( {t}_{k} ) \qquad ( 179 )$$

Using these methods, the probability of a transition from the base hypothesis H₀ to another hypothesis Hⱼ based upon the residual process r(tₖ) is estimated. The process continues until one probability Fⱼ exceeds a certain bound. The bound is determined by the designer.

Note that the values of p/M is arbitrary in one sense, a design variable in another, and an estimate of instrument performance as a third interpretation. This value represents the probability of failure between any two measurements. Manufacturers typically report mean time between failures (MTBF) which is the time, usually in hours, between failures of the instrument. Therefore, the probability of a failure between measurements is defines as

$$p = \frac{Δ t}{MTBF * 3600}$$

if the MTBF is defined in hours.
Multiple Hypothesis Wald SPRT

The previous sections discussed the implementation of the Shiryayev Test for change detection. The Wald Test is a simpler version focused on determining an initial state. The problem of the Wald Test is to determine in minimum time the dynamics system which corresponds to the residual process z(tₖ).

As before, a set of M hypothesized systems Hⱼ are defined. The goal of the Wald Test is to use the residual process to calculate the probability that each hypothesis represents the true state of the system. This test was used for integer ambiguity resolution in [13].

The implementation of the Wald Test is a simpler form of the Shiryayev Test. In this case, the a priori probabilities Fⱼ(tₖ) are defined for each hypothesized system Hⱼ. At tₖ₊₁ the probabilities are updated using the hypothesized density function fᵢ as:

$${F}_{j} ( {t}_{k + 1} ) = \frac{{F}_{j} ( {t}_{k} ) {f}_{j} ( z ( {t}_{k + 1} ) )}{{\sum }_{i = 0}^{M} {F}_{i} ( {t}_{k} ) {f}_{i} ( z ( {t}_{k + 1} ) )} \qquad ( 180 )$$

Since no base state exists, all of the probabilities are updated simultaneously. Since no transition exists, the effect is as if p=0 in Eq. 176.

Adaptive Estimation

This section summarizes the mathematical algorithm that may be used for adaptive measurement noise estimation. Two possible algorithms are shown, the Limited-Memory Noise Estimator and the Weighted Limited Memory Noise Estimator. The algorithms are applied to the problem of estimating measurement noise levels on-line and adapting the filtering process of an Extended Kalman Filter. The work presented here follows closely Hull and Speyer[6].

Extended Kalman Filter

The extended Kalman filter (EKF)[5] is a nonlinear filter that was introduced after the successful results obtained from the Kalman filter for linear systems. The essential feature of the EKF is that the linearization is performed about the present estimate of the state. Therefore, the associated approximate error variance must be calculated on line to compute the EKF gains.

For the system described as:
x(k+1)=φ(k)x(k)+Γω(k) (181)
y(k)=C(k)x(k)+v(k) (182)
where x(k) is the state at time step k and ω is process noise or uncertainty in the plant model assumed zero mean and with power spectral density W. The measurements y are also corrupted by measurement noise v(k) assumed zero mean with measurement power spectral density of V. Each of the noise processes are defined as independent noise processes such that:

$$\begin{matrix}E [ ω ( j ) {ω}^{T} ( i ) ] = 0 i \neq j & ( 183 ) \\ = W ( i ) i = j & \\ E [ v ( j ) {v}^{T} ( i ) ] = 0 i \neq j & ( 184 ) \\ = V ( i ) i = j & \end{matrix}$$

For the filter, we define the a priori state estimate as \overline{x}(k) and the posteriori estimate of the state as \hat{x}(k). The system matrices Φ, Γ C are linearized versions of the true nonlinear functions. Both matrices may be time varying. If the true system is described as nonlinear functions such as:
x(k+1)=f(x(k),ω(k)) (185)
y(k)=g(x(k),v(k)) (186)
then the linearized dynamics are defined as:

$$Φ ( k ) = {[ \frac{\partial f ( x ( k ) , ω ( k ) )}{\partial x ( k )} ]}_{x ( k ) = \overline{x} ( k )} \qquad ( 187 )$$

The relationship between the process noise may be defined empirically or through analysis as:

$$Γ ( k ) = {[ \frac{\partial f ( x ( k ) , ω ( k ) )}{\partial ω ( k )} ]}_{x ( k ) = \overline{x} ( k )} \qquad ( 188 )$$

The measurement sensitivity matrix is calculated as:

$$C ( k ) = {[ \frac{\partial g ( x ( k ) , v ( k ) )}{\partial x ( k )} ]}_{x ( k ) = \overline{x} ( k )} \qquad ( 189 )$$

Let \hat{x}(k) be defined as the best estimate given by the measurement history Y(k)=[y(1), y(2), . . . , y(k)] with approximate a posteriori error variance P(k). The approximate a priori error variance is defined as M(k). Then the following system defines the Extended Kalman Filter (EKF) relationships:

The propagation from one time step to the next is given as:
\overline{x}(k+1)=Φ(k)\hat{x}(k) (190)
M(k+1)=Φ(k)P(k)Φ^{T}(k)+W(k) (191)

The update given a new measurement y(k) is defined as:
\hat{x}(k)=\overline{x}(k)+K[y(k)−g(\overline{x}(k))] (192)
P(k)=M(k)−K(k)C(k)M(k) (193)
where the gain K(k) is calculated as:
K(k)=M(k)C^{T}(k)[C(k)M(k)C^{T}(k)+V(k)]⁻¹ (194)

The residual process is defined as
r(k)=y(k)−g(\overline{x}(k))] (195)

It is assumed that
E[r(j)r^{T}(i)]≅0i≠j
≅C(i)M(i)C^{T}(i)+V(i)i=j (196)
so that the statistical small sampling theory used for adaptive noise estimation as described in the next section is applicable.
Adaptive Noise Estimation

Two algorithms are described for adaptive noise estimation, the first is the Limited Memory Noise Estimator (LMNE), and the second is the Weighted Limited Memory Noise Estimator (WLMNE).

Limited Memory Noise Estimator

By using statistical sampling theory, the population mean and covariance of the residuals r(k) formed in the EKF can be estimated by using a sample mean and a sample covariance. Suppose a sample size of N is chosen, then the unbiased sample variance of the residuals is given by

$$\overline{R} = \frac{1}{N - 1} {\sum }_{k = 2}^{N} ( r ( k ) - \overline{v} ) {( r ( k ) - \overline{v} )}^{T} \qquad ( 197 )$$

where \overline{v} is the sample mean of the residuals given by:

$$\overline{ν} = \frac{1}{N} {\sum }_{k = 1}^{N} r ( k ) \qquad ( 198 )$$

Given the average value of C(k)M(k)C^{T}(k) over the sample window given by:

$$\frac{1}{N} {\sum }_{k = 1}^{N} C ( k ) M ( k ) {C}^{T} ( k ) \qquad ( 199 )$$

Then the estimated measurement covariance matrix at time k is given by:

$$\overline{V} = \frac{1}{N - 1} {\sum }_{k = 1}^{N} [ ( r ( k ) - \overline{ν} ) {( r ( k ) - \overline{ν} )}^{T} - \frac{N - 1}{N} C ( k ) M ( k ) {C}^{T} ( k ) ] \qquad ( 200 )$$

The above relations are used at time step k for estimating the measurement noise mean and variance at that time instant. Before that, the EKF operates in the classical way using a zero mean and a pre-defined variance for measurement statistics. Recursion relations for the sample mean and sample covariance for k>N can be formed as:

$$\begin{matrix}\overline{ν} ( k + 1 ) = \overline{ν} ( k ) + \frac{1}{N} ( r ( k + 1 ) - r ( k + 1 - N ) ) & ( 201 ) \\ \overline{V} ( k + 1 ) = \overline{V} ( k ) + \frac{1}{N - 1} [ ( r ( k + 1 ) - \overline{ν} ( k + 1 ) ) ( r ( k + 1 ) - & ( 202 ) \\ { \overline{ν} ( k + 1 ) )}^{T} - ( r ( k + 1 - N ) - & \\ \overline{ν} ( k + 1 - N ) {( r ( k + 1 ) - \overline{ν} ( k + 1 - N ) )}^{T} + & \\ \frac{1}{N} ( r ( k + 1 ) - r ( k + 1 - N ) ) ( r ( k + 1 ) - & \\ { r ( k + 1 - N ) )}^{T} - & \\ \frac{N - 1}{N} ( C ( k + 1 ) M ( k + 1 ) {C}^{T} ( k + 1 ) - & \\ C ( k + 1 - N ) M ( k + 1 - N ) {C}^{T} ( k + {1}_{N} ) ) ) ] & \end{matrix}$$

Respectively. The sample mean computed in the first equation above is a bias that has to be accounted for in the EKF algorithm. Thus, the EKF state estimate update is modified as:
\hat{x}(k)=\overline{x}(k)+K(k)[y(k)−g(\overline{x}(k))−\overline{v}(k)] (203)

The above relations estimate the measurement noise mean and covariance based on a sliding window of state covariance and measurements. This window maintains the same size by throwing old data and saving current obtained data. This method keeps the measurement mean and variance estimates representative of the current noise statistics. The optimal window size can be determined only using numerical simulations. Next, the Weighted Limited Memory Noise Estimator is described.

The Weighted Limited Memory Noise Estimator

This method is used to weigh current state covariance and measurements more than older ones. This is done by multiplying the individual noise samples used in the adaptive filter by a growing weight factor \overline{ω}. This weight factor is generated as
\overline{ω}(k)=(k−1)(k−2) . . . (k−β)k^{β} (204)
where β is an integer parameter that serves to delay the use of the noise samples. The value of β is to be determined through numerical experimentation. Notice that \overline{ω}(k) approaches 1 as k approaches ∞.

The Weighted Limited Memory Noise Estimator is similar in form to the un-weighted version presented in the previous section. The sample mean at time k is given by

$$\overline{ν} ( N ) = \frac{1}{N} {\sum }_{k = 1}^{N} ϖ ( k ) r ( k ) \qquad ( 205 )$$

The sample mean computed in this way is biased, but it approaches an unbiased estimate as \overline{ω}(k) approaches unity. The measurement noise variance is computed for the first N samples in the following way

$$\begin{matrix}\overline{V} ( N ) = \frac{1}{N - 1} {\sum }_{k = 1}^{N} [ ( ϖ ( k ) r ( k ) - \overline{ν} ( k ) ) {( ϖ ( k ) r ( k ) - \overline{ν} ( k ) )}^{T} - & ( 206 ) \\ \frac{N - 1}{N} {ϖ}^{2} C ( k ) M ( k ) {C}^{T} ( k ) - & \\ {( ϖ ( k ) - \frac{Ω}{N} )}^{2} ( r ( k ) {r}^{T} ( k ) - C ( k ) M ( k ) {C}^{T} ( k ) ) ] & \\ where & \\ Ω = {\sum }_{k = 1}^{N} ϖ ( k ) & ( 207 )\end{matrix}$$

Again, the above noise estimate mean and variance equations are used at the initial time when the window size N is reached in time. After that, the following recursion relation is used to estimation the noise mean:

$$\overline{ν} ( k ) = \overline{ν} ( k - 1 ) + \frac{1}{N} [ ϖ ( k ) r ( k ) - ϖ ( k - N ) r ( k - N ) \qquad ( 208 )$$

And the noise variance is estimated using the following recursion:

$$\begin{matrix}\overline{V} ( k ) = \overline{V} ( k - 1 ) + \frac{1}{N - 1} [ ( ϖ ( k ) r ( k ) - \overline{ν} ( k ) ) ( ϖ ( k ) r ( k ) - \\ { \overline{ν} ( k ) )}^{T} - ( ϖ ( k - N ) r ( k - N ) - \\ \overline{ν} ( k - N ) ) {( ϖ ( k - N ) r ( k - N ) - \overline{ν} ( k - N ) )}^{T} + \\ \frac{1}{N} ( ϖ ( k ) r ( k ) - ϖ ( k - N ) r ( k - N ) ) ( ϖ ( k ) r ( k ) - \\ { ϖ ( k - N ) r ( k - N ) )}^{T} + \\ \frac{N - 1}{N} [ {ϖ}^{2} ( k - N ) C ( k - N ) M ( k - N ) {C}^{T} ( k - N ) - \\ {ϖ}^{2} ( k ) C ( k ) M ( k ) {C}^{T} ( k ) ] - {( ϖ ( k ) - \frac{Ω ( k )}{N} )}^{2} [ r ( k ) {r}^{T} ( k ) - \\ C ( k ) M ( k ) {C}^{T} ( k ) ] + {( ϖ ( k - N ) - \frac{Ω ( k - N )}{N} )}^{2} \\ [ r ( k ) {r}^{T} ( k ) - C ( k - N ) M ( k - N ) {C}^{T} ( k - N ) ] ]\end{matrix} \qquad ( 209 )$$

where
Ω(k)=Ω(k−1)+(\overline{ω}(k)−\overline{ω}(k−N)) (210)

This Weighted Limited-Memory Adaptive Noise Estimator requires more storage space than the previous Limited-Memory Adaptive Noise Estimator. The \overline{ω}(k), \overline{ω}(k)r(k), and \overline{ω}²(k)C(k)M(k)C^{T}(k) terms need to be stored and shifted in time over the window size length N in addition to r(k) and C(k)M(k)C^{T}(k). This adds considerable computational cost to this algorithm in comparison to un-weighted algorithm of the previous section.

GPS/INS EKF

A GPS/INS Extended Kalman Filter (EKF) is presented. The filter structure integrates Inertial Measurement Unit (IMU) acceleration and angular velocity to estimate the position, velocity, and attitude of a vehicle. Then the GPS pseudo range and Doppler measurements are used to correct the state and estimate bias errors in the IMU measurement model.

In this methodology, the IMU acceleration measurements and angular velocity measurements are integrated using an Earth gravity model and an Earth oblate spheroid model using the strap down equations of motion. The output of the integration is passed to a tightly coupled EKF. This filter uses the GPS measurements to estimate the error in the state estimate. The error is then used to correct the state and the process continues. The term tightly coupled refers to the process of using code and Doppler measurements as opposed to using GPS estimated position and velocity. The update rates shown are typical, but may vary. The important point is that the IMU sample rate may be as high as required while the GPS receiver updates may be at a lower rate.

The next sections outline the details of the GPS/INS EKF. Measurement models are laid out for both the GPS and the IMU. The error state and dynamics are defined. Then the measurement model is defined which includes the distance between the GPS antenna and the IMU. The section concludes with a discussion of processing techniques.

IMU Measurement Model

The outputs of an Inertial Measurement Unit (IMU) are acceleration and angular rates, or, in the case of a digital output, the output is ΔV and Δθ. The measurements can be modelled as a simple slope with a bias. These models are represented by equations 211 and 213.
ã_{B}=mₐa_{B}+bₐ+vₐ (211)
\dot{b}ₐ=v_{b}_{ₐ} (212)
\tilde{ω}_{IB}^{B}=m_{g}ω_{IB}^{B}+b_{g}+v_{g} (213)
b_{g}=v_{b}_{_{g}} (214)

The term ω_{IB}^{B} represents the angular velocity of the body frame relative to the inertial frame represented in the body frame. In these models, the m term is the scale factor of the instrument, vₐ and v_{g} represent white noise, and bₐ and b_{g} are the instrument biases to be calibrated or estimated out of the measurements. For modelling purposes, these biases are assumed to be driven by the white noise process, v_{b}_{ₐ} and v_{b}_{_{g}}.

Other error sources than bias could be considered. Mechanical errors such as misalignment between the components and scale factor error are not considered here, although they could be included. Higher order models with specialized noise models may be used.

Strap Down Navigation

The strap down IMU measurements may be integrated in time to produce the navigation state estimate. The strap down equations of motion state vector is given by:

$$[ \begin{matrix}{P}_{T} \\ {V}_{T} \\ {Q}_{T}^{E} \\ {Q}_{B}^{T}\end{matrix} ] \qquad ( 215 )$$

The velocity vector is measured in the Tangent Plane (East, North, Up). The position vector is measured in the same plane relative to the initial condition. The initial condition must be supplied to the system for the integration to be meaningful. The terms Q_{T}^{E} and Q_{B}^{T} are quaternion terms. Q_{T}^{E} represents the quaternion rotation from the Tangent Plane to the Earth-Centered-Earth-Fixed (ECEF) coordinate frame. Using an oblate-spheroid Earth model, defined in Ref [61] the Q_{T}^{E} defines the latitude and longitude. Altitude is separated to complete the position vector. Q_{B}^{T} represents the quaternion rotation from the Body Frame to the Tangent Plane.

These states are estimated through the integration of the strap down equations of motion.

$$[ \begin{matrix}{\dot{P}}_{T} \\ {\dot{V}}_{T} \\ {Q}_{T}^{E} \\ {Q}_{B}^{T}\end{matrix} ] = [ \begin{matrix}{V}_{T} \\ {a}_{T} \\ \frac{1}{2} {Ω}_{ET}^{T} {Q}_{T}^{E} \\ \frac{1}{2} {Ω}_{TB}^{B} {Q}_{B}^{T}\end{matrix} ] \qquad ( 216 )$$

where a_{T} is the acceleration in the tangent frame. The acceleration vector in the body frame, measured by the IMU, is rotated into the tangent frame and integrated to find velocity with some modifications as shown below.

The 4×4 matrix, Ω, is defined from an angular velocity vector, ω, as shown in Eq. 217.

$$\begin{matrix}Ω = [ \begin{matrix}0 & - {ω}_{x} & - {ω}_{y} & - {ω}_{z} \\ {ω}_{x} & 0 & {ω}_{z} & - {ω}_{y} \\ {ω}_{y} & - {ω}_{z} & 0 & {ω}_{x} \\ {ω}_{z} & {ω}_{y} & - {ω}_{x} & 0\end{matrix} ] & ( 217 ) \\ ω = [ \begin{matrix}\begin{matrix}{ω}_{x} \\ {ω}_{y}\end{matrix} \\ {ω}_{z}\end{matrix} ] & \end{matrix}$$

The Ω_{ET}^{T} term is a nonlinear term representing the change in Latitude and Longitude of the vehicle as it passes over the surface of the Earth.

The Ω_{TB}^{B} term represents the angular velocity of the vehicle relative to the tangent frame and is determined from the gyro measurements. To compute ω_{TB}^{B}, the rotation of the Earth and slow rotation of the vehicle around the Tangent plane of the Earth must be removed from the gyro measurements as in Eq. 218.
ω_{TB}^{B}=\tilde{ω}_{IB}^{B}−C_{T}^{B}(ω_{ET}^{T}+C_{E}^{T}ω_{IE}^{E}) (218)

In this equation, C_{E}^{T} is a cosine rotation matrix representing Q_{E}^{T}. Similarly, C_{T}^{B} represents the cosine rotation matrix version of the quaternion Q_{T}^{B}. The ω_{IE}^{E} term is the angular velocity of the Earth in the ECEF coordinate frame.
a_{T}=C_{B}^{T}ã_{B}−C_{E}^{T}(ω_{IE}^{E}×ω_{IE}^{E}×P_{E}−−(ω_{ET}^{T}+2C_{E}^{T}ω_{IE}^{E})×V_{T}+g_{T} (219)

The position in the ECEF coordinate frame, P_{ECEF} is computed from Altitude and the Q_{T}^{E} vector as shown in [57]. The J2 gravity model used to determine the gravity vector g_{T} at any given position on or above the Earth is given in [50].

A new state may be estimated over a specified time step using a Runge-Kutta Method [58] from the previous state and the new IMU measurements.

3. Error Dynamics

The dynamics of this filter closely follow those presented in [64], although similar variations are presented in [50], and [55] in the tangent plane coordinates.

The navigation state is estimated in the ECEF coordinate frame. The basic, continuous time, kinematic relationships are:
\dot{P}=V (220)
\dot{V}=C_{B}^{E}a_{b}−2ω_{IE}^{E}×V+g_{E}
C_{B}^{E}=C_{B}^{E}Ω_{EB}^{B} (222)

where each of the terms is defined in Table 1.

TABLE 1
Description of State

| Symbol | Description |
|---|---|
| P | Position Vector in ECEF |
| | Coordinate Frame |
| V | Velocity Vector in ECEF |
| | Coordinate Frame |
| C_{B}^{E} | Rotation Matrix from |
| | Body Frame to ECEF |
| | Frame |
| a_{b} | Specific Force Vector |
| | (acceleration) in the Body |
| | Frame |
| ω_{IE}^{E} | Angular velocity vector of |
| | the ECEF Frame |
| | relative to the Inertial |
| | Frame decomposed in the |
| | ECEF Frame. |
| g_{E} | Gravitational Acceleration |
| | in the ECEF Frame |
| Ω_{EB}^{B} | Angular Rotation matrix |
| | of the Body Frame |
| | relative to the ECEF frame |
| | in the Body Frame. |

The estimated value of the position, velocity, and attitude are assumed perturbed from the true states. The relationship of the error with the estimated values and the true values are given as:
\hat{P}_{E}=P_{E}+δP (223)
\hat{V}_{E}=V_{E}+δV (224)
C_{\overline{B}}^{E}=C_{B}^{E}(I−2[δq×]) (225)

The ( ) nomenclature signifies an estimate of the value. The term C_{\overline{B}}^{E} is the estimated rotation matrix derived from the estimate of the quaternion, Q_{\overline{B}}^{E}. The δP and δV terms represent the error in the position and velocity estimates respectively. The term δq represents an error in the quaternion Q_{\overline{B}}^{E} and is only a 3×1 vector, a linear approximation. The [( )×] notation is used to represent the matrix representation of a cross product with the given vector.

The specific force and inertial angular velocity are also estimated values. The error models were defined previously and repeated here without the scale factor:
ã_{B}=a_{B}+bₐ+vₐ (226)
\tilde{ω}_{I\overline{B}}^{\overline{B}}=ω_{IB}^{B}+b_{g}+v_{g} (227)

An important distinction must be made about \tilde{ω}_{I\overline{B}}^{\overline{B}} in that since the measurements are taken assuming an attitude of Q_{\overline{B}}^{E}, the actual reference frame for the measured angular velocity is in the \overline{B} frame while the true angular velocity is in the true B reference frame.

The angular velocity \hat{ω}_{E\overline{B}}^{\overline{B}} is estimated from the gyro measurements: as
\hat{ω}_{E\overline{B}}^{\overline{B}}=\tilde{ω}_{I\overline{B}}^{\overline{B}}−C_{E}^{\overline{B}}ω_{IE}^{E} (228)

From these relationships, the dynamics of the error in the state as well as the estimate of the biases may be defined as:
δ\dot{P}=δV (229)
δ\dot{V}=(G−(Ω_{IE}^{E})²)δP−2Ω_{IE}^{E}δV−2C_{\overline{B}}^{E}Fδq+C_{\overline{B}}^{E}δbₐ+C_{\overline{B}}^{E}vₐ (230)
δq=−Ω_{I\overline{B}}^{\overline{B}}δq−δb_{g}−v_{g} (231)
δb_{g}=V_{b}_{_{g}} (232)
δ\dot{b}ₐ=v_{b}_{ₐ} (233)

Note that higher order terms of δq have been neglected from this analysis. The matrix G is defined as

$$G = \frac{\partial g}{\partial P}$$

and F=[ã_{B}×].

Two clock terms are added to the dynamic system, but are completely separated from the kinematics. These clock terms represent the clock bias and clock drift error estimates of the GPS receiver. The clock dynamics are given as:

$$\begin{matrix}\frac{ⅆ}{ⅆ t} δ τ = δ \dot{τ} + {v}_{τ} & ( 234 ) \\ \frac{ⅆ}{ⅆ t} δ \dot{τ} = {v}_{\dot{τ}} & ( 235 )\end{matrix}$$

E[v_{\dot{τ}}v_{τ}]≠0 (236)
where τ is the clock bias, \dot{τ} is the clock drift, and v_{τ} is process noise in the clock bias while v_{\dot{τ}} is the model of the clock drift.

The dynamic systems may be represented in matrix form for the purposes of the EKF. The EKF uses a seventeen error states presented. The dynamics are presented in Eq. 236. The noise vector, v, includes all of the noise terms previously described, and is assumed to be white, zero mean Gaussian noise with statistics v˜(0, W), where W is the covariance of the noise.

$$\begin{matrix}[ \begin{matrix}δ {\dot{P}}_{E} \\ δ {\dot{V}}_{E} \\ δ \dot{q} \\ δ {\dot{b}}_{g} \\ δ {\dot{b}}_{g} \\ δ c \dot{τ} \\ δ c \ddot{τ}\end{matrix} ] = [ \begin{matrix}{0}_{3 \times 3} & {I}_{3 \times 3} & {0}_{3 \times 3} & {0}_{3 \times 3} & {0}_{3 \times 3} & 0 & 0 \\ G - {( {Ω}_{IE}^{E} )}^{2} & - 2 {Ω}_{IE}^{E} & - 2 {C}_{\overline{B}}^{E} F & {0}_{3 \times 3} & {C}_{\overline{B}}^{E} & 0 & 0 \\ {0}_{3 \times 3} & {0}_{3 \times 3} & - {Ω}_{I \overline{B}}^{\overline{B}} & \frac{1}{2} {I}_{3 \times 3} & {0}_{3 \times 3} & 0 & 0 \\ {0}_{3 \times 3} & {0}_{3 \times 3} & {0}_{3 \times 3} & {0}_{3 \times 3} & {0}_{3 \times 3} & 0 & 0 \\ {0}_{3 \times 3} & {0}_{3 \times 3} & {0}_{3 \times 3} & {0}_{3 \times 3} & {0}_{3 \times 3} & 0 & 0 \\ {0}_{1 \times 3} & {0}_{1 \times 3} & {0}_{1 \times 3} & {0}_{1 \times 3} & {0}_{1 \times 3} & 0 & 1 \\ {0}_{1 \times 3} & {0}_{1 \times 3} & {0}_{1 \times 3} & {0}_{1 \times 3} & {0}_{1 \times 3} & 0 & 0\end{matrix} ] & ( 237 ) \\ [ \begin{matrix}δ P \\ δ V \\ δ q \\ δ {b}_{g} \\ δ {b}_{a} \\ c δ τ \\ c δ \dot{τ}\end{matrix} ] + [ \begin{matrix}0 \\ {C}_{\overline{B}}^{E} {v}_{a} \\ {v}_{g} \\ {v}_{{b}_{g}} \\ {v}_{{b}_{a}} \\ {v}_{τ} \\ {v}_{\dot{τ}}\end{matrix} ] & \end{matrix}$$

This defines the dynamic state of the GPS/INS EKF. The next section describes the GPS measurement model.

GPS Measurement Model

The Global Positioning System (GPS) consists the space segment, the control segment and the user segment. The space segment consists of a set of at least 24 satellites operating in orbit transmitting a signal to users. The control segment monitors the satellites to provide update on satellite health, orbit information, and clock synchronization. The user segment consists of a single user with a GPS receiver which translates the R/F signals from each satellite into position and velocity information.

The GPS Interface Control Document (ICD) [20] describes the waveform generated from each satellite in the GPS constellation. The GPS satellites broadcast the ephemeris and code ranges on two different carrier frequencies, known as L1 and L2. Two types of code ranges are broadcast, the Course Acquisition (C/A) code, and the P code. The C/A code is only available on the L1 frequency and is available for civilian use at all times. The P code is generated on both L1 and L2 frequencies. However, the military restricts access to the P code through encryption. The encrypted P code signal is referred to as the Y code. The ephemeris data, containing satellite orbit trajectories, is transmitted on both frequencies and is available for civilian use.

TABLE 2
GPS Signal Components

| | Frequency |
|---|---|
| Signal | (MHz) |
| C/A | 1.023 |
| P(Y) | 10.23 |
| Carrier L1 | 1575.42 |
| Carrier L2 | 1227.60 |
| Ephemeris | 50 · 10⁻⁶ |
| Data | |

As shown in [21], the L1 and L2 signals may be represented as:
L1(t)=P(t)D(t)cos(2πf_{L1}t)+C/A(t)D(t)sin(2πf_{L1}t) (238)
L2(t)=P(t)D(t)cos(2πf_{L2}t) (239)

In this model, P(t), C/A(t), and D(t) represent the P code, the C/A code, and the ephemeris data, respectively. The terms f_{L1} ^{and f}_{L2} are the frequencies of the L1 and L2 carriers.

The P code and C/A code are a digital clock signal, incremented with each digital word. Details of the coding process are discussed in the ICD [20]. All of the P and C/A codes transmitted from each satellite are generated from the satellite atomic clock. All of the satellite clocks are synchronized to a single atomic clock located on the Earth and controlled by the U.S. Military [24]. Newer versions will soon incorporate both the L5 Frequency and the M code.

A GPS receiver converts either code into a range measurement of the distance between the receiver and the satellite. The range measurement includes different errors induced through atmospheric effects, multi-path, satellite clock errors and receiver clock errors. This range with the appropriate error terms is referred to as a pseudo-range.
\tilde{p}ⁱ=[(Xⁱ−x)²+(Yⁱ−y)²+(Zⁱ−z)²]^{1/2}++cτⁱ_{SV}+cτ+Iⁱ+Eⁱ+MPⁱ+η₁ (240)

In 240, the subscript i indexes the particular satellite sending this signal. The letter c represents the speed of light. The symbols (Xⁱ, Yⁱ, Zⁱ, τ_{SV}ⁱ) denote the satellite position in the ECEF coordinate frame and the satellite clock bias relative to the GPS atomic clock. Orbital models and a clock bias model are provided in the ephemeris data set which are used to calculate the satellite position, velocity, and clock bias at a given time. The symbols (x, y, z, τ) represent the receiver position in the ECEF coordinate frame and the receiver clock bias, respectively. The other terms represent noise parameters, which are listed in Table 3.

TABLE 3
Code Sources of Error (From [27] and [28])

| | |
|---|---|
| Error1σ (meters) | Description |

| | | |
|---|---|---|
| Iⁱ | 7.7 | Ionospheric and |
| | | tropospheric delay. |
| Eⁱ | 3.6 | Transmitted ephemeris |
| | | set error. |
| MPⁱ | Geometry | Multi-path, caused by |
| | Dependent | reflection of signal |
| | | before entering receiver. |
| ηⁱ | 0.1-0.7 | Receiver noise due to |
| | | thermal noise, |
| | | inter-channel bias, and |
| | | internal clock accuracy. |

The code measurements have noise with over a 10 meter standard deviation. This table is compiled from information found in [27] and [28]. Models may be used to significantly reduce the ionosphere error or troposphere error such as those suggested in [37].

In addition to the C/A and P code measurements, the actual carrier wave may be measured to provide another source of range data. If the receiver is equipped with a phase lock loop (PLL), the actual carrier phase is tracked and this information may be used for ranging. While not really relevant to a single vehicle situation, carrier phase is very important for relative filtering.

The carrier phase model includes the integrated carrier added to an unknown integer. Since the true range to the satellite is unknown, a fixed integer is used to represent the unknown number of initial carrier wavelengths between the receiver and the satellite. The measurement model is given as:
λ(\tilde{φ}ⁱ+Nⁱ)=[(Xⁱ−x)²+(Yⁱ−y)²+(Zⁱ−z)²]^{1/2}++cτⁱ_{SV}+cτ−Iⁱ+Eⁱ+mpⁱ+βⁱ (241)

The symbol λ represents the carrier wavelength while the symbol \tilde{φ} is measured phase. The letter N represents the initial integer number of wavelengths between the satellite and the receiver, which is a constant and unknown, but may be estimated. It is referred to as the integer ambiguity in the carrier phase range. The other terms are noise terms, which are listed in Table 3.

TABLE 3
Phase Sources of Error (From [27] and [28])

| | |
|---|---|
| Error1σ (meters) | Description |

| | | |
|---|---|---|
| Iⁱ | 7.7 | Ionospheric and tropospheric |
| | | delay. |
| Eⁱ | 3.6 | Transmitted ephemeris set |
| | | error. |
| MPⁱ | Geometry | Multi-path, caused by |
| | Dependent | reflection of signal |
| | | before entering receiver. |
| | | Modern processing |
| | | limits to less than ¼ cycle if |
| | | line of site |
| | | to the satellite is |
| | | available. [32] |
| βⁱ | 0.002 | Receiver noise due to thermal |
| | | noise, |
| | | inter-channel bias, and internal |
| | | clock accuracy. |

The noise sources in the carrier phase measurements are similar to the noise in the code measurement model and are derived from the same sources [27][28]. The carrier phase ionospheric error operates in the reverse direction from code ionosphere error due to the varying refractive properties of the atmosphere to different frequencies [33]. In addition to the errors shown in Equation 241, the phase-lock-loops are susceptible to cycle slips, which can result in a phase error equal to one wavelength. These types of errors are rare and occur in high dynamic environments where the tracking loops are unable to track the high rate of change in the carrier [34].

The error variance of the receiver noise is the size of the tracking loop error on each receiver. Typical estimates for tracking loop errors are about 1/100th of a cycle, or about 2 mm (1σ) for L1 carrier measurements [35].

GPS receives can also measure the doppler shift in the carrier or code. If a PLL is used, then doppler may be estimated from one of the lower states within the PLL. Other receivers use a frequency lock loop (FLL) which measures Doppler directly.
\tilde{\dot{ρ}}ᵢ=μ\tilde{φ}ᵢ+cτ_{SVi}+c\dot{τ}+vᵢ (242)

Note that in this representation, the measurement still includes the effect of the rate of change in the clock bias, referred to as the clock drift. The satellite rate of change is removed with information from the ephemeris set. The noise term vᵢ is assumed white noise, which may or may not be the case based upon receiver design.

The GPS measurement model is now defined for the purposes of this project. Only the code and Doppler measurements are used. For more complex, relative navigation schemes, the carrier phase measurements would also be employed as in [14]. However, typically carrier phase measurements are employed for differential GPS techniques in which measurements from two different GPS receivers are subtracted from each other.

For instance, single difference measurements are defined as the difference between the range to satellite i from two different receivers a and b. For code measurements, the single difference measurement is defined as:
Δ\tilde{ρ}ⁱ=\tilde{ρ}ₐⁱ−\tilde{ρ}_{b}ⁱ==[(Xⁱ−xₐ)²+(Yⁱ−yₐ)²+Zⁱ−zₐ)²]^{1/2}−[(Xⁱ−x_{b})²+(Yⁱ−y_{b})²+Zⁱ−z_{b})²]^{1/2}++Δcτ+ΔMPⁱ+Δηⁱ (243)

The common mode errors are eliminated, but the relative clock bias between the two receivers remains. Also note that the multi-path and receiver noise are not eliminated. Double differencing is the process of subtracting two single differenced measurements from two different satellites i and j defined for code measurements as:
∇Δ\tilde{ρ}_{ab}^{ij}=Δ\tilde{ρ}_{ab}ⁱ−Δ\tilde{ρ}_{ab}^{j} (244)

The advantage of using double difference measurements is the elimination of the relative clock bias term in Eq. 243 since the relative clock is common to all of the single difference measurements. Elimination of the clock bias effectively reduces the order of the filter necessary to estimate relative distance as well as eliminating the need for clock bias modelling. The double difference carrier phase measurement is defined similarly. Double difference carrier measurements do not eliminate the integer ambiguity. The double difference ambiguity, ∇ΔN_{ab}^{ij} still persists. A means of estimating this parameter is defined in the section titled Wald Test for Integer Ambiguity Resolution.

EKF Measurement Model

This section describes the linearized measurement model. The process is derived into two steps. First, a method for linearizing the GPS measurements at the antenna is defined. Then a method for transferring the error in the EKF error state to the GPS location and back to the IMU is defined. This method allows the effect of the lever arm to be demonstrated and used in the processing of the EKF.

The basic linearization proceeds from a Taylor's series expansion.

$$\begin{matrix}f ( x ) = f ( \overline{x} ) + \frac{1}{1 !} {f}^{′} ( \overline{x} ) ( x - \overline{x} ) + & ( 245 ) \\ \frac{1}{2} {f}^{″} ( \overline{x} ) {( x - \overline{x} )}^{2} + … + \frac{1}{N !} {f}^{N} ( \overline{x} ) {( x - \overline{x} )}^{N} & \end{matrix}$$

In the above equation, f′(\overline{x}) represents the partial derivative of the function f with respect to x evaluated at the nominal point \overline{x}.

The true range between the satellite and the receiver is defined as:
ρᵢ=∥Pₛₐₜ_{ᵢ}−P_{E}∥ (246)

In Eq. 240, the code measurement is a nonlinear function of the antenna position and the satellite position. Given an initial estimate \overline{P}_{E} of the receiver position and assuming that the satellite position is known perfectly from the ephemeris, an a priori estimate of the range is formed as:
ρᵢ=[(Xᵢ−\overline{x})²+(Yᵢ−\overline{y})²+(Zᵢ−\overline{z})²]^{1/2} (247)
where
\overline{P}_{E}=[\overline{x}, \overline{y}, \overline{z}] (248)

The least squares filter derived here neglects all but the first order differential term. The new measurement model for each satellite is given in Eq. 249

$$\begin{matrix}{ρ}_{i} = {ρ}_{i} + & ( 249 ) \\ [ \begin{matrix}\frac{- ( {X}_{i} - \overline{x} )}{{\overline{ρ}}_{i}} & \frac{- ( {Y}_{i} - \overline{y} )}{{\overline{ρ}}_{i}} & \frac{- ( {Z}_{i} - \overline{z} )}{{\overline{ρ}}_{i}} & 1 & 0 & 0 & 0 & 0\end{matrix} ] & \\ [ \begin{matrix}δ x \\ δ y \\ δ z \\ c δ τ \\ δ \dot{x} \\ δ \dot{y} \\ δ \dot{z} \\ c ( δ \dot{τ} )\end{matrix} ] + c \overline{τ} & \end{matrix}$$

where c\overline{τ} is the a priori estimate of the receiver clock bias.

The doppler measurement of Eq. 242 may be linearized as in Eq. 250

$$\begin{matrix}{ρ}_{i} = {ρ}_{i} + [ \begin{matrix}\frac{δ \dot{ρ}}{δ x} & \frac{δ \dot{ρ}}{δ y} & \frac{δ \dot{ρ}}{δ z} & 0 & \frac{- ( {X}_{i} - \overline{x} )}{{\overline{ρ}}_{i}} & \frac{- ( {Y}_{i} - \overline{z} )}{{\overline{ρ}}_{i}} & \frac{- ( {Z}_{i} - \overline{z} )}{{\overline{ρ}}_{i}} & 1\end{matrix} ] & ( 250 ) \\ [ \begin{matrix}δ x \\ δ y \\ δ z \\ c δ τ \\ δ \dot{x} \\ δ \dot{y} \\ δ \dot{z} \\ c ( δ \dot{τ} )\end{matrix} ] + c \dot{\overline{τ}} & \end{matrix}$$

where

$$\frac{δ \dot{ρ}}{δ \overline{x}} ,$$

representing the partial of the range rate with respect to the position vector, is given by:

$$\frac{δ \dot{ρ}}{δ \vec{x}} = {ρ}^{\overline{\to }} ( \frac{{ρ}^{\overline{\to }} \cdot {ρ}^{{\to }^{\dot{\_}}}}{{\overline{ρ}}^{3}} ) - \frac{{ρ}^{{\to }^{\dot{\_}}}}{\overline{ρ}} \qquad ( 251 )$$

where • is the vector dot product and the terms \vec{ρ} and \vec{ρ} are the a priori range and range rate vectors computed as:

$${ρ}^{\overline{\to }} = [ \begin{matrix}\begin{matrix}{X}_{i} - \overline{x} \\ {Y}_{i} - \overline{y}\end{matrix} \\ {Z}_{i} - \overline{z}\end{matrix} ] \qquad ( 252 )$$

$${ρ}^{{\to }^{\dot{\_}}} = [ \begin{matrix}\begin{matrix}{X}_{i} - {x}^{\dot{\_}} \\ {Y}_{i} - {y}^{\dot{\_}}\end{matrix} \\ {Z}_{i} - {z}^{\dot{\_}}\end{matrix} ] \qquad ( 253 )$$

The code and doppler linearization from a particular satellite i may combined into a single matrix, Hᵢ as shown in Eq. 254.

$${H}_{i} = [ \begin{matrix}\frac{- ( {X}_{i} - \overline{x} )}{{\overline{ρ}}_{i}} & \frac{- ( {Y}_{i} - \overline{y} )}{{\overline{ρ}}_{i}} & \frac{- ( {Z}_{i} - \overline{z} )}{{\overline{ρ}}_{i}} & 1 & 0 & 0 & 0 & 0 \\ \frac{δ \dot{ρ}}{δ x} & \frac{δ \dot{ρ}}{δ y} & \frac{δ \dot{ρ}}{δ z} & 0 & \frac{- ( {X}_{i} - \overline{x} )}{{\overline{ρ}}_{i}} & \frac{- ( {Y}_{i} - \overline{z} )}{{\overline{ρ}}_{i}} & \frac{- ( {Z}_{i} - \overline{z} )}{{\overline{ρ}}_{i}} & 1\end{matrix} ] \qquad ( 254 )$$

Combining the measurements from multiple satellites, Eq. 254 may be used to simplify the measurement equation for both code and doppler as in Eq. 255.
ρ=\overline{ρ}+Hδx+c\overline{τ}+v (255)
where ρ is the set of range and range rate measurements, δx is the state vector, \overline{x} is the a priori state estimate vector, and H is the set of linearized measurement equations for each measurement given in 254.

Translating the problem into the state space of the EKF requires the addition of the gyro and accelerometer bias terms. Eq. 256 defines the measurement model for use of code and Doppler measurements in the EKF.

$$\begin{matrix}[ \begin{matrix}\tilde{ρ} ( 256 ) \\ {ρ}^{\dot{\sim}}\end{matrix} ] = [ \begin{matrix}\overline{ρ} ( 257 ) \\ {ρ}^{\dot{\_}}\end{matrix} ] + \\ [ \begin{matrix}\frac{( {X}_{i} - {x}^{\vec{\_}} )}{{ρ}_{i}} & {0}_{3 \times 3} & {0}_{3 \times 3} & {0}_{3 \times 3} & {0}_{3 \times 3} & 1 & 0 ( 258 ) \\ \frac{δ \dot{ρ}}{δ \vec{x}} & \frac{( {X}_{i} - {x}^{\vec{\_}} )}{{ρ}_{i}} & {0}_{3 \times 3} & {0}_{3 \times 3} & {0}_{3 \times 3} & 0 & 1\end{matrix} ] \\ [ \begin{matrix}δ {P}_{E} ( 259 ) \\ δ {V}_{E} ( 260 ) \\ δ q ( 261 ) \\ δ {b}_{g} ( 262 ) \\ δ {b}_{a} ( 263 ) \\ c δτ ( 264 ) \\ δ c \dot{τ}\end{matrix} ] + [ \begin{matrix}c \overline{τ} ( 265 ) \\ c {τ}^{\dot{\_}}\end{matrix} ] + [ \begin{matrix}{v}_{ρ} ( 266 ) \\ {v}_{\dot{ρ}}\end{matrix} ]\end{matrix} \qquad ( 267 )$$

The noise vector, v, is assumed to be a zero-mean, white noise process with Gaussian statistics v˜(0, V) where V is the covariance. The individual parameters, v_{ρ} and v_{\dot{ρ}} are assumed uncorrelated (E[v_{ρ}v_{\dot{ρ}}^{T}]=0).

The model described applies to the case in which the GPS antenna and IMU are co-located. Generally, an IMU is placed some physical distance from the GPS antenna. In this case, the measurement models must be modified to account for the moment arm generated by the distance between the two sensors.

Several methods may be chosen for the implementation of this effect. One method is presented in [97]. That method incorporates the translation of error as part of the measurement matrix H. An equivalent method is followed here in which a separate translation matrix is calculated. The two methods are equivalent, but this method is more computationally efficient. The problem is to determine the proper way to use GPS measurements taken at the GPS antenna location to compute the correction to the INS, which is located at the IMU. Assuming a constant, rigid lever arm L from the IMU to the GPS antenna, the position transformation is defined as:
P_{GPS}_{_{E}}=P_{INS}_{_{E}}+C_{B}^{E}L (268)

The velocity transformation requires deriving the time derivative of Eq 268. The time derivative of a rotation matrix is given as:

$$\frac{ⅆ}{ⅆ t} {C}_{B}^{E} = {C}_{B}^{E} [ {ω}_{BE}^{B} x ] \qquad ( 269 )$$

where ω_{BE}^{B} is the angular velocity of the body frame relative to the ECEF frame represented in the body frame. This angular velocity relates to inertial velocity as:
ω_{BE}^{B}=ω_{BI}^{B}+ω_{IE}^{E} (270)
where ω_{IB}^{B} is the angular velocity of the vehicle body in the inertial frame represented in the body frame and ω_{IE}^{E} is the rotation of the ECEF frame with respect to the inertial frame represented in the ECEF frame.

Using Eq. 269 to calculate the time derivative of Eq. 268 to get the velocity relationship between the GPS and the INS utilizing the definition of the angular velocities in Eq. 270.
V_{GPS}_{_{E}}=V_{INS}_{_{E}}+C_{B}^{E}(ω_{IB}^{B}×L)−ωIE^{E}×C_{B}^{E}L (271)

The error in the position at the GPS antenna is defined as:
δP_{GPS}_{_{E}}=P_{GPS}_{_{E}}−\overline{P}_{GPS}_{_{E}}=δP_{INS}_{_{E}}+C_{B}^{E}L−C_{\overline{B}}^{E}L (272)

Substituting the linearized quaternion error results in:
δP_{GPS}_{_{E}}=P_{INS}_{_{E}}−2C_{\overline{B}}^{E}[L×]δq (273)

Likewise the velocity error may be defined as:

$$\begin{matrix}δ {V}_{{GPS}_{E}} = {V}_{{GPS}_{E}} - {\overline{V}}_{GPS} \\ = δ {V}_{{INS}_{E}} - C \frac{E}{B} ( {\tilde{ω}}_{I \overline{B}}^{\overline{B}} \times L ) + {ω}_{I , E}^{E} \times C \frac{E}{B} L\end{matrix} \qquad ( 274 )$$

Note that the \tilde{ω}_{I\overline{B}}^{\overline{B}} term is the a priori angular velocity corrected for gyro bias error. Using this definition, Eq. 274 becomes

$$\begin{matrix}δ {V}_{GPS} = δ {V}_{INS} + {C}_{\overline{B}}^{E} ( I + 2 [ δ q \times ] ) ( {\tilde{ω}}_{I \overline{B}}^{\overline{B}} + δ {b}_{g} ) \times L - {ω}_{IE}^{E} \times \\ {C}_{\overline{B}}^{E} ( I + 2 [ δ q \times ] ) L - {C}_{\overline{B}}^{E} ( {\tilde{ω}}_{I \overline{B}}^{\overline{B}} \times L ) + {ω}_{IE}^{E} \times {C}_{\overline{B}}^{E} L \\ = δ {V}_{INS} + {V}_{vq} δ q - {C}_{\overline{B}}^{E} [ L \times ] δ {b}_{g} + H . O . T\end{matrix} \qquad ( 275 )$$

where V_{vq} is defined as:

$${V}_{vq} = - 2 [ {C}_{\overline{B}}^{E} ( {\tilde{ω}}_{I \overline{B}}^{\overline{B}} \times L ) \times ] - {ω}_{IE}^{E} \times [ {C}_{\overline{B}}^{E} L \times ] \qquad ( 276 )$$

and where cross terms between δb_{g} and δq are neglected.

A linear transformation T that translates the error in the INS state to an associated error at the GPS antenna location, may now be defined as:

$${T}_{INS}^{GPS} = [ \begin{matrix}I & 0 & - 2 {C}_{\overline{B}}^{E} [ L x ] & 0 & 0 & 0 & 0 \\ 0 & I & {V}_{vq} & 0 & - {C}_{B}^{E} [ L x ] & 0 & 0 \\ 0 & 0 & I & 0 & 0 & 0 & 0 \\ 0 & 0 & 0 & I & 0 & 0 & 0 \\ 0 & 0 & 0 & 0 & I & 0 & 0 \\ 0 & 0 & 0 & 0 & 0 & 1 & 0 \\ 0 & 0 & 0 & 0 & 0 & 0 & 1\end{matrix} ] \qquad ( 277 )$$

where all submatricesi have appropriate dimensions. Using this rotation the error in the INS state may be translated to the GPS antenna using Eq. 278.

$$δ {x}_{GPS} = {T}_{INS}^{GPS} δ {x}_{INS} \qquad ( 278 )$$

In addition to the state, the error covariance must be translated as well. The new error covariance is calculated as:
M_{GPS}=T_{INS}^{GPS}M_{INS}T_{INS}^{GPS}^{^{T}} (279)

A more simple solution is to simply multiply the transfer matrix with the measurement matrix to form a new measurement model of the form:
\tilde{ρ}=\overline{ρ}+C_{new}δx+v (280)
where C_{new} is defined for n satellites in view as:

$$\begin{matrix}{C}_{new} = {[ \begin{matrix}\frac{( {X}_{i} - \vec{\overline{x}} )}{{ρ}_{i}} & {0}_{n \times 3} & 1 & 0 \\ \frac{δ \dot{ρ}}{δ \vec{x}} & \frac{( {X}_{i} - \vec{\overline{x}} )}{{ρ}_{i}} & 0 & 1\end{matrix} ]}_{2 n \times 8} \\ {[ \begin{matrix}{I}_{3 \times 3} & {0}_{3 \times 3} & - 2 {C}_{\overline{B}}^{E} [ L x ] & {0}_{3 \times 3} & {0}_{3 \times 3} & 0 & 0 \\ {0}_{3 \times 3} & {I}_{3 \times 3} & {V}_{vq} & - {C}_{\overline{B}}^{E} [ L x ] & {0}_{3 \times 3} & 0 & 0 \\ {0}_{1 \times 3} & {0}_{1 \times 3} & {0}_{1 \times 3} & {0}_{1 \times 3} & {0}_{1 \times 3} & 1 & 0 \\ {0}_{1 \times 3} & {0}_{1 \times 3} & {0}_{1 \times 3} & {0}_{1 \times 3} & {0}_{1 \times 3} & 0 & 1\end{matrix} ]}_{8 \times 17}\end{matrix} \qquad ( 281 )$$

The use of the transfer matrix

$${T}_{IMU}^{GPS}$$

or the more simple version of simply defining C_{new} is a design choice for implementation. Both are equivalent. The derivation of the transfer matrix is provided to show insight into the transfer of the error state from the IMU to the GPS and back. It is more useful for differential GPS/IMU applications in which high accuracy position measurements are available at the GPS receivers and need to be processed in those frames.
EKF Processing

Processing of the EKF now proceeds as normal. The navigation processor integrates the IMU at the desired rate to get the a priori state estimates. When GPS measurements are available, the measurements are processed using the translation matrices prescribed. The discrete time dynamics may be approximated from the continuous dynamics. The state transition matrix is approximated as:
Φ(tₖ₊₁,tₖ)=I+AΔt (282)
where Δt=tₖ₊₁−tₖ. Likewise, the process noise in discrete time must be integrated. If the continuous noise model in Eq. 236 is represented as simply v and is zero mean Gaussian with power spectral density of N, then the discrete time process noise may be approximated as:

$$W = ( I Δ t + \frac{1}{2} {A ( Δ t )}^{2} ) {N ( I Δ t + \frac{1}{2} {A ( Δ t )}^{2} )}^{T} \qquad ( 283 )$$

Other approximations are possible.

The measurement matrix is calculated at the GPS antenna. The measurement is processed and the covariance updated according to Eq. 284-286 in which the covariance used is now the covariance at the GPS antenna. Once the correction is calculated, the state at the GPS antenna is updated and then translated back to the INS location using the updated state information and reversing the direction of Eq. 268 and 271. Finally the error covariance is translated back to the INS using

$${T}_{GPS}^{INS}$$

which may be derived using similar methods as

$${T}_{INS}^{GPS}$$

but has a reversed sign on all of the off diagonal terms. The covariance is then calculated as

$${P}_{INS} = {T}_{GPS}^{INS} {P}_{GPS} {T}_{GPS}^{{INS}^{T}} .$$

The EKF equations in discrete time used are as follows:
δ\hat{x}ₜ_{ₖ}=δ\overline{x}ₜ_{ₖ}+Kₜ_{ₖ}(\overline{ρ}ₜ_{ₖ}−\overline{ρ}ₜ_{ₖ}−Hₜ_{ₖ}δ\overline{x}ₜ_{ₖ}) (284)
Kₜ_{ₖ}=Mₜ_{ₖ}Hₜ_{ₖ}^{T}(Hₜ_{ₖ}Mₜ_{ₖ}Hₜ_{ₖ}^{T}+V)⁻¹ (285)
Pₜ_{ₖ}=(I−Kₜ_{ₖ}Hₜ_{ₖ}Hₜ_{ₖ})Mₜ_{ₖ} (286)
Φₜ_{ₖ₊₁}_{,t}_{ₖ}=exp(Aₜ_{ₖ}Δt)≈I+Aₜ_{ₖ}Δt (287)
Mₜ_{ₖ₊₁}=Φₜ_{ₖ₊₁}_{,t}_{ₖ}Pₜ_{ₖ}Φₜ_{ₖ}^{T}+ΓWΓ^{T} (288)
δ\overline{x}ₜ_{ₖ₊₁}=Φₜ_{ₖ₊₁}_{,t}_{ₖ}δ\hat{x}ₜ_{ₖ} (289)

The terms V and W are variances associated with measurement noise and process noise respectively. This system defines the basic model for estimation of the base vehicle system.

The state correction δ\hat{x}ₜ_{ₖ} is actually used to calculate the update to the navigation state. Once the correction is applied, this state is set to zero and the process repeated.

Navigation State Correction

Given the navigation state at the INS, this section covers how to use the correction δ\hat{x}(tₖ) to correct the navigation state. The correction is defined as:

$$δ \hat{x} = [ \begin{matrix}{{δ}_{\hat{P}}}_{{GPS}_{E}} \\ {{δ}_{\hat{V}}}_{{GPS}_{E}} \\ δ \hat{q} \\ {δ}_{{\hat{b}}_{g}} \\ {δ}_{{\hat{b}}_{a}} \\ δ c \hat{τ} \\ δ c {τ}^{\dot{\hat{}}}\end{matrix} ] \qquad ( 290 )$$

Therefore, the updated state estimates at the GPS antenna are:
\hat{P}_{GPS}_{_{E}}=\overline{P}_{GPS}_{_{E}}+δ\hat{P}_{GPS}_{_{E}} (291)
\hat{V}_{GPS}_{_{E}}=\overline{V}_{GPS}_{_{E}}+δ\hat{V}_{GPS}_{_{E}} (292)
\hat{b}_{g}=\overline{b}_{g}+δ\hat{b}_{g} (293)
\hat{b}ₐ=\overline{b}ₐ+δ\hat{b}ₐ (294)
c\hat{τ}=c\overline{τ}+δc\hat{τ} (295)
c\hat{\dot{τ}}=c\overline{τ}+δc\hat{\dot{τ}} (296)

Note that the gyro bias, accelerometer bias, and clock bias are not affected by the reference frame change. Neither is the attitude of the vehicle since the lever arm L between the GPS antenna and the IMU is considered rigid.

The attitude term requires special processing to update. As previously stated, the correction term δ\hat{q} is a 3×1 vector which is an approximation to a full quatermion. The correction represents the rotation from the a priori reference frame to the posteriori reference frame. The first step is creating a full quaternion from the approximation. The corrected quaternion is defined as:

$$Q = {[ {\begin{matrix}1 \\ δ \hat{q}\end{matrix}}_{3 \times 1} ]}_{4 \times 1} \qquad ( 297 )$$

The rotation is then normalized so that the norm of the rotation is equal to one:

$${Q}_{\hat{B}}^{\overline{B}} = \frac{Q}{{‖ Q ‖}_{2}} \qquad ( 298 )$$

The updated attitude is determined through the use of a quatemion rotation as:
Q_{\hat{B}}^{E}=Q_{\hat{B}}^{\overline{B}}\mathring{×}Q_{\overline{B}}^{E} (299)
where the quatemion rotation operator \mathring{×} is defined for any two quaternions Q_{A}^{B} and Q_{B}^{C} as:

$${Q}_{A}^{C} = {Q}_{A}^{B} ⊗ {Q}_{B}^{C} = [ \begin{matrix}{q}_{1}^{AB} & - {q}_{2}^{AB} & - {q}_{3}^{AB} & - {q}_{4}^{AB} \\ {q}_{2}^{AB} & {q}_{1}^{AB} & {q}_{4}^{AB} & - {q}_{3}^{AB} \\ {q}_{3}^{AB} & - {q}_{4}^{AB} & {q}_{1}^{AB} & {q}_{2}^{AB} \\ {q}_{4}^{AB} & {q}_{3}^{AB} & - {q}_{2}^{AB} & {q}_{1}^{AB}\end{matrix} ] [ \begin{matrix}{q}_{1}^{BC} \\ {q}_{2}^{BC} \\ {q}_{3}^{BC} \\ {q}_{4}^{BC}\end{matrix} ] \qquad ( 300 )$$

where Q_{A}^{B}=[q₁^{AB},q₂^{AB},q₃^{AB},q₄^{AB}]^{T} and Q_{B}^{C}=[q₁^{BC},q₂^{BC},q₃^{BC},q₄^{BC}]^{T} respectively.

In this way, the updated rotation quatemion Q_{\hat{B}}^{E} is defined. With this definition, it is possible to rotate the GPS position and velocity back to the IMU using the following relationships:
\hat{P}_{INS}_{_{E}}=\hat{P}_{GPS}_{_{E}}−C_{\hat{B}}^{E}L (301)
\hat{V}_{INS}_{_{E}}=\hat{V}_{GPS}_{_{E}}−C_{\hat{B}}^{E}(ω_{I\hat{B}}^{\hat{B}}×L)+ω_{IE}^{E}×C_{\hat{B}}^{E}L (302)
where C_{\hat{B}}^{E} was determined using Q_{\hat{B}}^{E}. The angular velocity is also updated using the updated gyro bias estimates.

The state is now completely converted back from the GPS position to the IMU. The navigation filter may now continue with an updated state estimate.

Differential GPS/INS EKF

An EKF structure for performing differential GPS/INS EKF is proposed and examined in Williamson [96]. This structure builds off of the model presented in this section. In this structure, each vehicle operates a navigation processor integrating the local IMU to form the local navigation state. Then, when available, GPS measurements are used to correct the local state. One method for performing this task is to use two completely separate GPS/INS EKF filters and difference the output. A second method, which provides more accuracy using differential GPS measurements is presented here. The techniques applied here can be used on more than one vehicle.

For the relative navigation problem, a global state space is constructed in which both vehicle states are considered. One vehicle is denoted the base vehicle while the second vehicle is referred to as the rover vehicle. The state space model can be represented as the following:

$$[ \begin{matrix}δ {x}_{1} \\ δ {x}_{2}\end{matrix} ] = [ \begin{matrix}{A}_{1} & 0 \\ 0 & {A}_{2}\end{matrix} ] [ \begin{matrix}δ {x}_{1} \\ δ {x}_{2}\end{matrix} ] + [ \begin{matrix}{v}_{1} \\ {v}_{2}\end{matrix} ] \qquad ( 303 )$$

where δx₁ and δx₂ denote the error in the state of the base and rover vehicles, respectively. A₁ and A₂ are the state transition matrices corresponding to the linearized dynamics, and v₁ and ω₂ are the process noise of the primary and follower vehicles. Note that the dynamics are calculated based upon the trajectory of the local vehicle and are completely independent of each other. No aerodynamic coupling is modelled. The dynamics are based solely on kinematic relationships for this case, although other interactions could be modelled as necessary. The process noise for the dynamics is modelled as
v₁˜N(0,W₁)
v₂˜N(0,W₂)
E[v₁v₂^{T}]=0 (304)

The total state size is now 34 as this state equation combines the error in both the base and rover vehicles.

The measurement model for the GPS code and doppler measurements are presented as:

$$[ \begin{matrix}{ρ}_{1} \\ {ρ}_{2}\end{matrix} ] = [ \begin{matrix}{H}_{1} & 0 \\ 0 & {H}_{2}\end{matrix} ] [ \begin{matrix}δ {x}_{1} \\ δ {x}_{2}\end{matrix} ] + [ \begin{matrix}{v}_{1} + {b}_{c} \\ {v}_{2} + {b}_{c}\end{matrix} ] \qquad ( 305 )$$

where ρ₁ and ρ₂ represent the GPS code and doppler available to each vehicle, and the measurement noise v₁ and v₂ are modelled as independent, zero mean white Gaussian processes. The a priori estimates of range are not included in this formulation for convenience and ease of notation. The GPS common mode errors are included in the term b_{c}.

The common mode errors b_{c} enter into both measurements ρ₁ and ρ₂, which results in a large correlation between the two independent systems. The common mode errors are also known to be much larger than either of the local GPS receiver errors, v₁ or v₂. An EKF constructed from this model will have a covariance correlated through the measurements. This error source prevents decentralized formulations such as the one in
[86], although this could be employed as a less optimal implementation. While the EKF will compensate for this correlation, the noise still colors both vehicle states. Therefore, the relative state defined as Δδx=δx₁−δx₂ has reduced relative accuracy.

A rotation of the current state may be made so that the common mode measurement noise is removed. The rotation changes the states from δx₁ and δx₂ to x₁ and Δδx.

This rotation is represented by the following equation.

$$[ \begin{matrix}δ {x}_{1} \\ Δδ x\end{matrix} ] = [ \begin{matrix}I & 0 \\ I & - I\end{matrix} ] [ \begin{matrix}δ {x}_{1} \\ δ {x}_{2}\end{matrix} ] \qquad ( 306 )$$

A similar rotation can be applied to the measurement states ρ₁ and ρ₂ to form the measurement states ρ₁ and Δρ, where Δρ represents the single differenced C/A code range and Doppler measurements.

Applying this rotation systematically to the state space and measurement models of Eq. 303 and 305, we obtain:

$$\begin{matrix}[ \begin{matrix}δ {x}_{1} \\ Δδ x\end{matrix} ] = [ \begin{matrix}I & 0 \\ I & - I\end{matrix} ] [ \begin{matrix}δ {x}_{1} \\ Δδ x\end{matrix} ] + [ \begin{matrix}{ω}_{1} \\ {ω}_{1} - {ω}_{2}\end{matrix} ] & ( 306 ) \\ [ \begin{matrix}{ρ}_{1} \\ Δρ\end{matrix} ] = [ \begin{matrix}{H}_{1} & 0 \\ {H}_{1} - {H}_{2} & {H}_{2}\end{matrix} ] [ \begin{matrix}δ {x}_{1} \\ Δδ x\end{matrix} ] + [ \begin{matrix}{v}_{1} + {b}_{c} \\ {v}_{1} - {v}_{2}\end{matrix} ] & ( 308 )\end{matrix}$$

The measurement Δρ now represents the single differenced C/A code range and doppler measurements. The common mode errors have been eliminated in the relative measurement. In doing so, correlations between the states have been introduced in the dynamics, the measurement matrix, the process noise, and the measurement noise. These correlations may require centralized processing with a filter state twice the size of single vehicle filter. Assuming that the two vehicles are operating along a similar trajectory, the coupling terms may be neglected. If the vehicles are close to each other (<1 km) and traveling along a similar path, the dynamics of the two vehicles are equivalent to first order. The coupling term A₁-A₂ may be assumed to be zero in this circumstance. The measurement coupling H₁-H₂ may also be assumed zero through a similar argument; especially, if the transfer matrix

$${T}_{IMU}^{GPS}$$

defined in the previous section is employed. This transfer matrix eliminates the effect of the location of the IMU's relative to the GPS antenna so that the more accurate differential GPS measurements may be employed without correlations.

If correlations in the process and measurement noises are neglected, the system described in Eq. 307 and 308 may be completely decoupled into two filters. In this case, the global filter may now be separated into two separate EKFs, as described in the decentralized approach. The base vehicle and the rover operates an EKF using δ\dot{x}₁=A₁δx₁+ω₁ as the dynamics and ρ₁=H₁δx₁+v₁+b_{c} as the measurements.

Similarly, the rover vehicle now operates an EKF using Δδ\dot{x}=A₂Δδx+ω₁−ω₂ as the dynamics and Δρ=H₂Δδx+v₁−v₂ as the measurements.

The final piece in the relative navigation filter is the use of single differenced or double differenced carrier phase measurements to provide precise relative positioning. These measurements are processed on the rover vehicle in addition to range and doppler. The measurements may only be processed if the integer ambiguity algorithm has converged. That algorithm is discussed in [96].

Double differenced measurements are formed by first creating single difference measurements. A primary satellite is chosen and then the single differenced measurement from that satellite is subtracted from the single differenced satellite measurements from all of the other available measurements. Other double difference measurement combinations are also possible. For two satellite measurements, one from the prime and the other from satellite i, the new carrier phase measurement model is defined as:

$$\begin{matrix}λ ( ∇ Δ ϕ + ∇ Δ N ) = Δ {ρ}_{prime} - Δ {ρ}_{i} + \\ ( {H}_{prime} - {H}_{i} ) Δ δ x + Δ {v}_{{car}_{prime}} - Δ {v}_{{car}_{i}}\end{matrix} \qquad ( 309 )$$

where ∇Δφ is the double differenced carrier phase measurement, ∇ΔN is the estimated integer ambiguity calculated in the Wald Test, and λ is the wavelength of the carrier.

In order to process these measurements sequentially, the EKF uses a method in Maybeck [5] to first uncorrelate the measurements and then process sequentially using the Potter scalar update.

Note that this method requires the base vehicle to transmit GPS measurements as well as a priori and posteriori state estiamtes to the rover vehicle as discussed in [96]. The state of the rover vehicle is estimated relative to the base vehicle. In this way the rover vehicle state is recovered at the antenna location and then integrated at the IMU location similar to the single vehicle solution. The equations for generating the rover vehicle updated state at the antenna are:

$$\begin{matrix}{\hat{P}}_{{2}_{{GPS}_{E}}} = {\hat{P}}_{{1}_{{GPS}_{E}}} - {\overline{P}}_{{1}_{{GPS}_{E}}} - Δδ {\hat{P}}_{{GPS}_{E}} & ( 310 ) \\ {\hat{V}}_{{2}_{{GPS}_{E}}} = {\hat{V}}_{{1}_{{GPS}_{E}}} - {\overline{V}}_{{1}_{{GPS}_{E}}} - Δδ {\hat{V}}_{{GPS}_{E}} & ( 311 ) \\ {\hat{b}}_{{2}_{g}} = {\hat{b}}_{{1}_{g}} - {\overline{b}}_{{1}_{g}} - Δδ {\hat{b}}_{g} & ( 312 ) \\ {\hat{b}}_{{2}_{a}} = {\hat{b}}_{{1}_{a}} - {\overline{b}}_{{1}_{a}} - Δδ {\hat{b}}_{a} & ( 313 ) \\ c {\hat{τ}}_{2} = c {\hat{τ}}_{1} - c {\overline{τ}}_{1} - Δδc \hat{τ} & ( 314 ) \\ c {{τ}^{\dot{\hat{}}}}_{2} = c {{τ}^{\dot{\hat{}}}}_{1} - c {{τ}^{\dot{\_}}}_{1} - Δδc {τ}^{\dot{\hat{}}} & ( 315 )\end{matrix}$$

Care must be taken when correcting the relative attitude estimation. Remembering the definition for the quaternion error δq, the following two relationships define the quaternion error for each vehicle relative to the Earth.

$$\begin{matrix}{C}_{{\overline{B}}_{1}}^{E} = {C}_{{\hat{B}}_{1}}^{E} ( I - 2 [ δ {\hat{ q}}_{1} \times ] ) \to [ δ {\hat{q}}_{1} \times ] = \frac{1}{2} ( I - {C}_{E}^{{\hat{B}}_{1}} {C}_{{\overline{B}}_{1}}^{E} ) & ( 316 ) \\ {C}_{{\overline{B}}_{2}}^{E} = {C}_{{\hat{B}}_{2}}^{E} ( I - 2 [ δ {\hat{q}}_{2} \times ] ) \to [ δ {\hat{q}}_{2} \times ] = \frac{1}{2} ( I - {C}_{E}^{{\hat{B}}_{2}} {C}_{{\overline{B}}_{2}}^{E} ) & ( 317 )\end{matrix}$$

We note the following definition for Δδq=δq₁−δq₂, the quatemion state in the differential EKF. This definition implies the following relationship:

$$[ δ {\hat{q}}_{2} \times ] = [ δ {\hat{q}}_{1} \times ] - [ Δδ \hat{q} \times ] = \frac{1}{2} ( I - {C}_{E}^{{B}_{1}} {C}_{{B}_{1}}^{E} ) - [ Δδ \hat{ q} \times ] \qquad ( 318 )$$

The relationship between the relative attitude error estimate Δδ\hat{q} in the differential EKF and the rover attitude error δ\hat{q}₂ is now defined in terms of estimated relative attitude error and the a priori

$$( {C}_{{\overline{B}}_{1}}^{E} )$$

and posterior (C_{E}^{\hat{B}}^{₁}) rotation matrices which may be constructed from the base vehicle state matrices transmitted to the rover. Once the error is calculated, the rover attitude error is applied in the same manner as the base vehicle error using Eq. 297 through Eq. 300.

Using this method, the differential EKF is now defined. The code, Doppler, and carrier phase measurements may be used to estimate the relative state between the base and rover vehicle. Accuracy relative to the Earth remains the same. However, relative accuracy is greatly improved. Flight test experiments demonstrated centimeter level performance in Williamson [96].

Alternate Relative Navigation GPS/INS EKF

An alternate version to the filter presented is presented. In this method the two filters for the base and rover remain somewhat independent operating as if in separate, single vehicle mode. However, the measurements of the rover are changed such that the rover EKF processes the state estimate relative to the base EKF.

In the first version, the rover range and range rate measurements are constructed using:
\tilde{ρ}₂=\overline{ρ}₁+Δ\overline{ρ} (319)
where \overline{ρ}₁ is the a priori range estimate and range rate estimate of the base GPS antenna to satellite for each available pseudo range, and Δ\tilde{ρ}ᵢ is the single differenced measurement of the actual pseudoranges and range rates. The advantage of this method is that it only requires the a priori state estimate from the base vehicle rather than both the a priori and posteriori estimates required in the previous section. Note that \overline{ρ}₁ can be constructed on the rover vehicle using the a priori base estimate, common satellite ephemeris, and knowledge of the lever arm vector L, if any. Alternatively, the base may merely transmit the state of the vehicle at the GPS antenna. The disadvantage of this solution is that the filter structure does not properly take into account correlations between the estimation process on the base and the rover due to using the same measurement history.

An alternate version uses only the posteriori state estimate defined as:
\tilde{ρ}₂=\hat{ρ}₁+Δ\tilde{ρ} (320)
where \tilde{ρ}₁ is the posteriori range and range rate estimate to the satellites.

A third option is to incorporate the carrier phase measurements in the same manner using either single differenced or double differenced measurements to provide precise relative range measurements. Note that all of the measurements may be processed using single or double differenced measurments. If double differenced measurements are used, then the clock model may be removed from the rover vehicle EKF, although this is not recommended.

Finally, a fourth option is to utilize a least squares or weighted least squares solution on the measurements to determine an actual position and velocity measurement for processing within the EKF in a Loosely Coupled manner. In essence, the relative measurements are used to calculate Δ\tilde{x} using a least squares process.
Δ\tilde{x}=(H^{T}H)¹H^{T}Δ\tilde{ρ} (321)

Note that several variations are possible using a weighted least squares or a second EKF processing GPS only measurements as well as using the code, carrier, and/or Doppler measurements in single differneced or double differenced combinations.

Then the new state measurement for the vehicle is defined as \tilde{x}₂=\hat{x}₁−Δ\tilde{x}. Then the \tilde{x}₂ is processed within the EKF using the appropriate measurement matrix. Note that \overline{x}₁ may be used as well. This method is less expensive computationally, but severely corrupts the measurements by blending the estimates together in the state space so that the measurements in the state space do not have independent noise terms. Processing proceeds as in the single vehicle case with appropriate noise variances calculated from the particular process employed.

Multiple GPS Receivers and One IMU

In Hong [97], the observation is made that multiple GPS receivers may be used in this formulation. The same dynamics would be present. However each set of measurements would have a different lever arm separation between the IMU and the GPS antennae. Each value of L would need to be calibrated and known a priori. However, the processing of each of the measurements would proceed as with only one GPS antenna except that the different GPS receivers would have a different L vector.

Multiple receivers can increase observability. If the receivers are not synchronized to the same clock and oscillator, then each added receiver increases the state space of the filter since two new clock terms must be added for each receiver added. This approach can add a computational burden. Further, due to the introduction of common mode errors, only a common set of satellites should be employed in the filter to reduce error. Using a common satellite set suggests an alternate method than the one proposed in Hong [97]. Using double differenced measurements, the clock bias terms and common mode errors may be eliminated between any two receivers. However, absolute position information relative to the Earth is lost in the process. This suggests that the GPS/INS system employ one receiver as the primary receiver to provide the primary position and velocity information. The remaining receivers are then used to provide measurements which are differenced with the primary GPS measurements.

The primary GPS measurements are processed normally. Double differenced measurements between receivers a and b using measurements from common satellites i and j are defined as:
∇Δ\tilde{ρ}_{ab}^{ij}=\tilde{ρ}ₐⁱ−\tilde{ρ}_{b}ⁱ−\tilde{ρ}ₐ^{j}+\tilde{ρ}_{b}^{j} (322)
where \tilde{ρ}ₐⁱ is the code measurement from satellite i at receiver a. The Doppler measurement is defined similarly. The new, double differenced code and Doppler measurement model for each satellite i and j is given as:

$$[ \begin{matrix}∇ Δ \tilde{ρ} \\ ∇ Δ \dot{\tilde{ρ}}\end{matrix} ] = [ \begin{matrix}∇ Δ \overline{ρ} \\ ∇ Δ \dot{\overline{ρ}}\end{matrix} ] + ( {C}_{a}^{i} - {C}_{b}^{i} - {C}_{a}^{j} + {C}_{b}^{j} ) δ x + [ \begin{matrix}∇ Δ {v}_{ρ} \\ ∇ Δ {v}_{\dot{ρ}} \end{matrix} ] \qquad ( 323 )$$

Note that even though the range and Doppler are measured at two different receiver antennae, the error state ix is defined at the IMU. For each GPS receiver antennae location a and b measuring common satellites i and j, the measurement matrix Cₐⁱ is defined as:

$${C}_{a}^{i} = {{[ \begin{matrix}\frac{\text{(} {X}^{i} - {\vec{\overline{x}}}_{a} \text{)}}{{ρ}_{ia}^{i}} & {0}_{n \times 3} & 1 & 0 \\ \frac{δ {\dot{ρ}}_{a}^{i}}{δ {\overline{x}}_{a}^{i}} & \frac{\text{(} {X}^{i} - {\vec{\overline{x}}}_{a} \text{)}}{{ρ}_{ia}^{i}} & 0 & 1\end{matrix} ]}_{2 n \times 8} [ \begin{matrix}{I}_{3 \times 3} & {0}_{3 \times 3} & - 2 {C}_{\vec{B}}^{E} [ {L}_{a} \times ] & {0}_{3 \times 3} & {0}_{3 \times 3} & 0 & 0 \\ {0}_{3 \times 3} & {I}_{3 \times 3} & {V}_{3 \times 3} & - {C}_{\vec{B}}^{E} [ {L}_{a} \times ] & {0}_{3 \times 3} & 0 & 0 \\ {0}_{1 \times 3} & {0}_{1 \times 3} & {0}_{1 \times 3} & {0}_{1 \times 3} & {0}_{1 \times 3} & 1 & 0 \\ {0}_{1 \times 3} & {0}_{1 \times 3} & {0}_{1 \times 3} & {0}_{1 \times 3} & {0}_{1 \times 3} & 0 & 1\end{matrix} ]}_{6 \times 17} \qquad ( 324 )$$

and the other measurement matrices are defined similarly. The lever arm for each receiver Lₐ and L_{b} are body axis vector lengths from the IMU to receiver antennae a and b respectively. Then V_{vq} is redefined for the specific receiver antenna location as

$${V}_{vq} = - 2 [ {C}_{\overline{B}}^{E} ( {\tilde{ω}}_{I \overline{B}}^{\overline{B}} \times {L}_{a} ) \times ] - {ω}_{IE}^{E} \times [ {C}_{\overline{B}}^{E} {L}_{a} \times ] \qquad ( 325 )$$

The new measurement model for using multiple GPS receivers on a single IMU is now defined. The double difference measurement noise is correlated between measurements. Carrier phase measurements could be used in place of (or in addition to) the double difference code measurements if the integer ambiguity ∇ΔN is estimated. An alternative method is to augment the EKF state with the ambiguities ∇ΔN and process using code and carrier measurements. The use of the Wald test is superior since the Wald test always assumes the integer nature of the carrier phase measurements. Once the ambiguity is resolved, carrier phase measurements can be included in the EKF process using the following measurement model.
λ(∇Δ\tilde{φ}+∇ΔN)=∇Δ\overline{ρ}+(Cₐⁱ−C_{b}ⁱCₐ^{j}+C_{b}^{j})δx+c\overline{τ}+∇Δv_{φ} (326)
where the measurement matrices are only defined for range, and not range rate as:

$${C}_{a}^{i} = {{[ \frac{( {X}^{i} - {\vec{\overline{x}}}_{a} )}{{ρ}_{i a}^{i}} 1 ]}_{n \times 4} [ \begin{matrix}{I}_{3 \times 3} & {0}_{3 \times 3} & - 2 {C}_{B}^{E} [ {L}_{a} \times ] & {0}_{3 \times 3} & {0}_{3 \times 3} & 0 & 0 \\ {0}_{1 \times 3} & {0}_{1 \times 3} & {0}_{1 \times 3} & {0}_{1 \times 3} & {0}_{1 \times 3} & 1 & 0\end{matrix} ]}_{4 \times 17} \qquad ( 327 )$$

In Eq. 326, the term ∇Δ\overline{N} represents the current estimate of the integer ambiguity.

A simplification may be made using the transfer matrix T_{INS}^{GPS}. If this methodology is used, then the differential GPS techniques defined in the previous section apply. In this strategy, one receiver acts as the base station and all of the other receivers measurements are subtracted from the base receiver. The result is that the absolute accuracy of the IMU position is not enhanced. However, the absolute attitude and angular rate are significantly stabilized and directly measured.

Magnetometers

An additional measurement type is a magnetometer. The magnetometer measures the Earth's magnetic field. Since the Earth has a constant magnetic field with fixed polarity, a set of three magnetometers may be used to aid the navigation equation. Magnetometers may come in packages of one, two, three or more for redundancy. It is now possible to buy a 3-axis magnetometer instrument in which the Earth's magnetic field is measured relative to the body axis coordinate frame.

Standard Earth magnetic field models exist which provide magnitude and direction of the magnetic field in the tangent frame as a function of vehicle position and time of year since the magnetic field varies as a function of time. The measurement equation for a three axis magnetometer is given by:
\tilde{B}_{B}=C_{T}^{\overline{B}}B_{T}+b_{b}+v_{b} (328)
where B_{T} is the true magnetic field (B field) strength vector in the local tangent frame, b_{b} is the bias in magnetometer, and v_{b} is noise which is assumed zero mean with covariance V_{b}. An a priori estimate of the B field, \overline{B} is subject to errors in the navigation state. The linearized error equation using a perturbation method similar to those used previously and subtracting off the is given by:
\tilde{B}=(I+[δq×])C_{T}^{\overline{B}}\overline{B}_{T}+\overline{b}_{b}+δb_{b}+v_{b} (329)
where \overline{b}_{b} is the a priori estimate of the magnetometer bias and δb_{b} is the error term similar to an accelerometer bias error. This form may be converted to a measurement equation similar to the GPS measurement and processed in the EKF. Note that errors associated with the vehicle position may also be included similar to the gravity term. Finally, the state of the EKF may be augmented to included the magnetometer bias. The magnetometers are used as measurements and processed as often as the measurements are available. Additional errors such as scale factor and misalignment error may also be included.
Alternative Clock Modelling

Previously, only two clock terms are added to the dynamic system. However, a third clock term may be added with describes the oscillator effects as a function of acceleration. Each oscillator is sensitive to acceleration in all three axes. The frequency will shift as acceleration is applied. The sensitivity matrix Γ_{τ} is a matrix which relates the frequency shift as a function of acceleration as:
ΔF=FΓ_{τ}a_{b} (330)
where F is the nominal oscillator frequency, and a_{b} is the three axis acceleration experienced by the oscillator.

Substituting in the acceleration measurement error model, Eq. 330 becomes:
ΔF=FΓ_{τ}(ã_{b}+bₐ+vₐ) (331)
which may be used to calculate the increase in frequency due to acceleration and employed in the navigation processor as an integration step. However, bias error in the accelerometers will cause unnatural frequency shift which will need to be corrected in the EKF. The new measurement model is:

$$\begin{matrix}\frac{ⅆ}{ⅆ t} δτ = δ \dot{τ} + {v}_{τ} + F {Γ}_{τ} {b}_{a} + F {Γ}_{τ} {v}_{a} & ( 332 ) \\ \frac{ⅆ}{ⅆ t} δ \dot{τ} = δ \ddot{τ} + {v}_{\dot{τ}} & ( 333 ) \\ \frac{ⅆ}{ⅆ t} δ \ddot{τ} = {v}_{\ddot{τ}} & ( 334 )\end{matrix}$$

where τ is the clock bias, \dot{τ} is the clock drift, and vr is process noise in the clock bias while v_{\dot{τ}} is the model of the clock drift as before. Note the third order term is used to aid in clock modelling. This model may be substituted into the EKF. Note the dependence on clock bias to accelerometer bias and the correlation of the process noise terms. Of course, this error model assumes that the navigation filter has been updated with acceleration data dependence at each time step.
Atmospheric Modelling

The EKF state may be augmented to include the GPS measurement dependence upon troposphere error. Radio navigation techniques have been used by Saastamoinen[84] and Niell[85] to measure the refraction of the GPS wave caused by the stratosphere and troposphere.

Niell computes the delay as a function of both the wet and dry components of the atmosphere. The delay is computed as:
δs=δs_{d}M_{d}+δs_{w}M_{w} (335)
where δs is the total delta, δs_{d} is the component due to the dry atmosphere at zenith, δs_{w} is the component due to wet part of the atmosphere. M_{d} and M_{w} are mapping functions for each component and computed empirically.

Saastemoinen[84] gives a estimate of the zenith delay for a satellite outside of the atmosphere based upon the following equation:
δs=0.002277 sec z[p+(1255/T+0.05)e−1.16 tan²(z)] (336)
where z is the angle of the satellite relative to receiver zenith, p is the total barometric pressure, e is the partial pressure of water vapor both in millibars and T is the absolute temperature in degrees Kelvin. The results are expressed in meters of delay.

The purpose of the mapping functions is to more precisely match the zenith delay to lower elevation angles. Many empirical models exists as noted by Niell[85]. Further, Niell provides an analytical expression for the change in delay as a function of receiver altitude.

The delay associated with the troposphere and stratosphere for each satellite is only dependent upon a single parameter, the calculation of the zenith delay. The mapping functions provide a relationship between this delay and the receiver relative satellite elevation angle and the receiver altitude. Using this fact it is possible to calculate the zenith delay and the estimate the error in the zenith delay within the EKF as an added state. The zenith delay is a function of temperature, pressure, and humidity, although other less accurate versions do not require these instruments. The error is associated with user altitude.

An appropriate dynamic model could be:
δ\dot{z}=v_{z} (337)
where the error in the zenith delay is a slowly varying function of time. Higher order terms are possible.

The measurement for each GPS satellite would be modified to include the perturbation effects the user altitude. Note that only one parameter would need to be added to the EKF since all of the satellites would have the same zenith delay error.

Vehicle Dynamics

The dynamics presented are kinematic in nature. It is possible to add in aircraft or other types of vehicle models. Aircraft and missile models are similar and could be used to enhance the filter. The dynamic model would need to be modified to incorporate the rotational inertias as well as actuator models for the control surfaces. While the EKF would not need to know the control algorithm used, it would need access to the commands sent from the control algorithm to the actuators. The advantage of such a method would be enhanced observability within the GPS/INS EKF states and improved “coast” time of the IMU when GPS measurements were not available. Using the dynamic model, the error in the INS is bounded since velocity and attitude are directly related through the inertias.

An additional possibility is the incorporation of the aerodynamic coefficients. A separate level would allow further enhancement and more precise prediction of the navigation state. This method would also increase IMU coast time. However, the method would likely require the addition of air data instruments such as alpha, beta, and airspeed as well as temperature and pressure. These add complexity to the system, but would improve the accuracy of the prediction and help bound the IMU error buildup during a GPS loss of lock scenario.

A third option could be to add in a boat or ground vehicle model. Both of these are somewhat simpler versions in which the vehicle under normal circumstances is only allowed to move in certain manners. Again, access is needed to the commands sent to the control system. For a car, these include steering angle, throttle, and gear ratio. For a boat these would include rudder position and revolutions. The improved performance is caused by the bounding of the IMU bias errors within the dynamic range of the vehicle. Other vehicles models could be used as well.

Additional Instruments

More instruments may be added to the system such as magnetometers, air speed, pressure, and temperature. A magnetometer would enter into the system as a measurement on the direction of magnetic Earth and would be combined with an Earth model. The processing would proceed in the filter as if it were another instrument.

An air data suite of instruments could be added to enhance the vehicle modeling. Instruments such as air speed, alpha, and beta could be combined with a wind model and/or the aerodynamic coefficients of the vehicle to provide additional information on the vehicle motion. These instruments would likely enter as a measurement of the vehicle air speed. Temperature and pressure measurements as well as humidity could also be employed to enhance performance.

The addition of redundant GPS and GPS/INS configurations could also be considered. As previously stated, multiple GPS receivers could be employed to provide attitude as well as position measurements. In the same manner, multiple IMU's with multiple locations could all be used to aid in the estimation of gravity and attitude. The lever arm from each GPS receiver to each IMU would be necessary.

Reduced systems may also be envisioned in which the GPS and a subset of an IMU are used for navigation and possibly combined with vehicle dynamics. For instance, combining a GPS and a roll rate gyro with a magnetometer and the vehicle model should provide sufficient observability of the entire vehicle state. Other alternatives include mixing multiple accelerometers at known distances to produce angular acceleration or angular rate data.

Finally, GPS alone is possible to navigation under certain circumstances with the vehicle model. Since the vehicle model bounds the aircraft motion and defines the attitude relative to velocity, GPS alone is a possible complete navigation system using the given equations and the lever arm between the GPS and a set point on the aircraft around which all of the inertias are centered.

Wald Test for Integer Ambiguity Resolution

This section briefly describes the method used in the FFIS to resolve the integer ambiguity so that carrier phase measurements may be used in the EKF described in the previous section. This method has been presented previously in [13] and will only be summarized here. The algorithm only uses GPS measurements and is completely independent from the GPS/INS EKF derived in the previous section, although those measurements could be used to enhance the filter. The major achievement of this algorithm is the ability to converge consistently on the correct integer ambiguity between two moving vehicles without any ground based instrumentation.

The algorithm used is based upon the Multiple Hypothesis Wald Sequential Probability Ratio Test. This algorithm calculates the probability that a given hypothesis is true out of a set of assumed hypotheses in minimum time. The algorithm operates recursively on a residual process with a given probability distribution. In this case, the algorithm is applied to the problem of picking out the correct integer ambiguity from a set of hypothesized integers.

The residual process used combines both carrier and code measurements:

$$r = [ \begin{matrix}λ ( ∇ Δ \tilde{ϕ} + ∇ Δ N ) - ∇ Δ \tilde{ρ} ( 338 ) \\ E λ ( ∇ Δ \tilde{ϕ} + ∇ Δ N )\end{matrix} ] = [ \begin{matrix}∇ Δ {v}_{car} - ∇ Δ {v}_{code} ( 339 ) \\ E ∇ Δ {v}_{car}\end{matrix} ] \qquad ( 340 )$$

where \tilde{φ} and \tilde{ρ} are the carrier and code measurements, ∇ΔN is the hypothesized integer ambiguity and E is the left annihilator of the measurement matrix H, as in [13][16].

The residual process r is a zero mean, Brownian motion process with variance given in Eq. 341.

$$[ \begin{matrix}4 ( {V}_{carrier} + {V}_{code} ) & 16 {V}_{carrier} {E}^{T} \\ 16 {EV}_{carrier} & 4 {EV}_{carrier} {E}^{T}\end{matrix} ] \qquad ( 341 )$$

A separate residual process is generated for each hypothesized integer. Knowing the statistics, the probability density function fᵢ(k+1) for hypothesis i at time k+1 may be calculated. Using this density, the probability that hypothesis i, Fᵢ(k+1), is true is generated recursively using the following relationship. Refer to [10] and [13] for development of the algorithm.

$${F}_{i} ( k + 1 ) = \frac{{F}_{i} ( k ) {f}_{i} ( k + 1 )}{{\sum }_{i = 0}^{L} {F}_{i} ( k ) {f}_{i} ( k + 1 )} \qquad ( 342 )$$

Note that the sum of all probabilities must equal 1.0 since the algorithm assumes only one hypothesis can be true. Once a particular hypothesis reaches this value (or a threshold value), the filter declares convergence and the hypothesis meeting the value is the correct integer ambiguity.

After the Wald Test converges, the integer ambiguity is maintained in a separate algorithm. Only when lock on the integer ambiguity is lost does the algorithm reset and begin to operate again. A least squares method may be used to determine integer biases for the remaining satellites in view using a Kalman filter that employs the high accuracy relative position resulting from the carrier phase signal. This low cost method converges quickly to the correct integers.

Alternatively and for health monitoring, the system may be reset to use the Shiryayev Test as a means of detecting cycle skips or slips in the integer ambiguity. The baseline case is defined as the set of integers that the Wald test chose. The Shiryayev test then estimates the probability that the integer ambiguity has shifted from the current integer set to one of the other hypotheses of integers around the baseline case. If the probability of one of the other hypotheses increases, then the results show that the integers have changed indicating a cycle skip. The user may then chose to use the integer selected by the Shiryayev test and then restart the test around this new set, or may chose to simply re-initialize the Wald Test to search around a new set of points.

The satellite with the highest elevation angle is used as the primary satellite to insure that it will be in view for a long time. Then, up to five satellites are selected from the rest of the available satellites based on elevation angle and differenced from the primary satellite to get double differenced carrier phase residual. During the maintenance portion of the algorithm, the satellite with the highest elevation angle (excluding the primary satellite) is used to determine and backup a secondary integer bias set differenced against it (called the secondary satellite). This secondary integer set is put into service in case the primary satellite is lost.

In summary, the Wald Test estimates the correct integer ambiguity using GPS code and carrier measurements. The algorithm operates recursively and does not place any assumptions on the dynamics of the vehicles. Once the integer ambiguity is resolved for a set of satellites, maintenance algorithms monitor the carrier lock on the satellites and add new satellites to the set as needed. The carrier measurements with the integer ambiguity are then processed in the differential EKF described in the previous section.

Vision Instrumentation

Vision based instrumentation provides a means of adding direct line of sight range, range rate, and angle measurements. This section details how to utilize range, range rate, and angle measurements into the filter structure. Note, that these do not necessarily have to be vision based measurements. Instead, the actual measurements may comprise pseudo-lites, wireless communication ranging, or infra-read beacons.

Generalized Relative Range Measurement

There are a number of different instruments that provide a direct range measurement between vehicles. Instruments such as using a vision system to provide a relative range and bearing measurement or a radio navigation system to provide a simple range measurement may provide additional information on formations of vehicles. One method for integrating such measurements in a differential method within the existing architecture is presented.

The main difference between the relative range measurement from a vehicle and the relative range measurement from a GPS satellite (or other common beacon system), is that the linearization process is measured relative to a vehicle in the formation and has errors associated with that vehicle motion. Previously, satellite errors are neglected. In this case, the line of sight vector, or the H matrix for the relative range measurement contains errors from both the base and the rover.

The relative range measurement r_{1,2} between vehicle 1 and 2 is defined as norm of the difference between to positions:
r_{1,2}=∥P₁−P₂∥₂ (343)
where P₁ is the position vector of vehicle 1 and P₂ is the position vector of vehicle 2.

Each position has three components:
P₁=[x₁, y₁, z₁] (344)

The range is re-defined as:
r_{1,2}=[(x₁−x₂)²+(y₁−y₂)²+(z₁−z₂)²]^{1/2} (345)

Proceeding as with the GPS measurements, a first order perturbation may be taken with respect to the estimated error in both the positions. The a priori estimate of range \overline{r}_{1,2} is defined as:
\overline{r}_{1,2}=∥\overline{P}₁−\overline{P}₂∥² (346)

The first order perturbation of the relative range with respect to the first vehicle position is:

$$\frac{δ {r}_{1 , 2}}{δ {P}_{1}} = [ \frac{{\overline{x}}_{1} - {\overline{x}}_{2}}{{r}_{1 , 2}} \frac{{\overline{y}}_{1} - {\overline{y}}_{2}}{{r}_{1 , 2}} \frac{{\overline{z}}_{1} - {\overline{z}}_{2}}{{r}_{1 , 2}} ] [ \begin{matrix}δ {x}_{1} \\ δ {y}_{1} \\ δ {z}_{1}\end{matrix} ] \qquad ( 347 )$$

In this case, δx₁, δy₁, and δz₁, are the error in the x₁, y₁, and z₁ states respectively.

Likewise, the perturbation of the relative range with respect to the second vehicle position is:

$$\frac{δ {r}_{1 , 2}}{δ {P}_{2}} = [ \begin{matrix}\frac{{\overline{x}}_{1} - {\overline{x}}_{2}}{{r}_{1 , 2}} & \frac{{\overline{y}}_{1} - {\overline{y}}_{2}}{{r}_{1 , 2}} & \frac{{\overline{z}}_{1} - {\overline{z}}_{2}}{{r}_{1 , 2}}\end{matrix} ] [ \begin{matrix}δ {x}_{2} \\ δ {y}_{2} \\ δ {z}_{2}\end{matrix} ] \qquad ( 348 )$$

A relative range measurement equation may be written in terms of a first order perturbation of the errors in each vehicle location with additive noise as:

$${\tilde{r}}_{1 , 2} = {\overline{r}}_{1 , 2} + [ {H}_{1 , 2} - {H}_{1 , 2} ] [ \begin{matrix}δ {P}_{1} \\ δ {P}_{2}\end{matrix} ] + {υ}_{{r}_{1 , 2}} \qquad ( 349 )$$

where H_{1,2} is the line of site matrix defined as

$${H}_{1 , 2} = [ \begin{matrix}\frac{{\overline{x}}_{1} - {\overline{x}}_{2}}{{r}_{1 , 2}} & \frac{{\overline{y}}_{1} - {\overline{y}}_{2}}{{r}_{1 , 2}} & \frac{{\overline{z}}_{1} - {\overline{z}}_{2}}{{r}_{1 , 2}}\end{matrix} ] \qquad ( 350 )$$

The associated error states are of course:

$$\begin{matrix}δ {P}_{1} = [ \begin{matrix}δ {x}_{1} \\ δ {y}_{1} \\ δ {z}_{1}\end{matrix} ] \\ and & ( 351 ) \\ δ {P}_{2} = [ \begin{matrix}δ {x}_{2} \\ δ {y}_{2} \\ δ {z}_{2}\end{matrix} ] & ( 352 )\end{matrix}$$

Finally, νᵣ_{_{1,2}} represents noise. Note that in the terminology defined previously in this chapter (using ΔδP=δP₁−δP₂), that Eq. 349 may be written equivalently as:
\tilde{r}_{1,2}=\overline{r}_{1,2}+H_{1,2}ΔδP+νᵣ_{_{1,2}} (353)

In this way, the generalized relative range measurement is defined. The error states ΔδP correspond to the position vectors in the standard EKF. If the IMU and the relative range measurement points are co-located on each vehicle, then these measurements may be included in the EKF structure defined in previous sections as an additional measurement. The appropriate error equation is:
\tilde{r}_{1,2}=\overline{r}_{1,2}+[H_{1,2} 0_{1×3} 0_{1×3} 0_{1×3} 0_{1×3} 0_{1×2}]Δδx+νᵣ_{_{1,2}} (354)
where Δδx is the 17×1 state of the EKF as defined.
Generalized Relative Range with Lever Arm

Suppose that the relative range is measured at some distance from the local inertial system. A method is desired for transforming the relative range measurement from the point of measurement to the local INS so that the measurement may be included in the GPS/INS EKF previously defined for relative navigation. The measurement will be used as an enhancement to the relative navigation filter defined using differential GPS with the generalized relative range measurement supplying direct information about the separation between both vehicles.

Each vehicle measures the relative range r_{1,2} at a distance relative to the local INS, P_{INS,1}_{_{E}} and P_{INS,2}_{_{E}}, where each INS measures the position of the local vehicle in the ECEF. The distance between the relative range measurement point on each vehicle and the INS is denoted as L_{INS,1} and L_{INS,2}. These vectors are assumed measured in the body frame. The relative position between the vehicles is defined as:
P₁_{_{E}}−P₂_{_{E}}=P_{INS,1}_{_{E}}+C_{B}_{₁}^{E}L_{INS,1}−P_{INS,2}_{_{E}}−C_{B}_{₂}^{E}L_{INS,2} (355)
where C_{B}_{₁} is the cosine rotation matrix from the body frame of vehicle 1 to the ECEF coordinate frame. The term C_{B}_{₂} has similar meaning for vehicle 2. The cosine rotation matrices were defined previously and are consistent with previous development in this chapter.

The error in the position at the relative range measurement antenna is defined as:
ΔδP_{1,2}=δP₁_{_{E}}−δP₂_{_{E}}=P₁_{_{E}}−\overline{P}₁_{_{E}}−P₂_{_{E}}+\overline{P}₂_{_{E}} (356)
and therefore:

$$Δδ {P}_{1 , 2} = δ {P}_{INS , {1}_{E}} - 2 {C}_{{\overline{B}}_{1}}^{E} [ {L}_{INS , 1} \times ] δ {q}_{1} + δ {P}_{INS , {2}_{E}} + 2 {C}_{{\overline{B}}_{2}}^{E} [ {L}_{INS , 2} \times ] δ {q}_{2} \qquad ( 357 )$$

where q₁ and q₂ are the errors in quaternion attitude for each vehicle, as defined previously. Substituting Eq. 357 with the relative range measurement of Eq. 353 gives the relative range measurement at the INS location which is:

$$\begin{matrix}{\tilde{r}}_{1 , 2} = {\overline{r}}_{1 , 2} + {H}_{1 , 2} Δδ {P}_{1 , 2} + {υ}_{{r}_{1 , 2}} & ( 358 ) \\ {\tilde{r}}_{1 , 2} = {\overline{r}}_{1 , 2} + {H}_{1 , 2} ( δ {P}_{INS , {1}_{E}} - 2 {C}_{{\overline{B}}_{1}}^{E} [ {L}_{INS , 1} \times ] δ {q}_{1} + δ {P}_{INS , {2}_{E}} + 2 {C}_{{\overline{B}}_{2}}^{E} [ {L}_{INS , 2} \times ] δ {q}_{2} ) + {υ}_{{r}_{1 , 2}} & ( 359 )\end{matrix}$$

Placing Eq. 359 into the terms of the EKF defined gives the following measurement equation for relative range for a non-co-located relative range measurement point and an INS:

$$\begin{matrix}{\tilde{r}}_{1 , 2} = {\overline{r}}_{1 , 2} + {H}_{1 , 2} [ {I}_{3 \times 3} {0}_{3 \times 3} - 2 {C}_{{\overline{B}}_{1}}^{E} [ {L}_{INS , 1} \times ] {0}_{3 \times 3} {0}_{3 \times 3} {0}_{3 \times 2} ] δ {x}_{1} & ( 360 ) \\ - {H}_{1 , 2} [ {I}_{3 \times 3} {0}_{3 \times 3} - 2 {C}_{{\overline{B}}_{2}}^{E} [ {L}_{INS , 2} \times ] {0}_{3 \times 3} {0}_{3 \times 3} {0}_{3 \times 2} ] δ {x}_{2} + {υ}_{{r}_{1 , 2}} & ( 361 )\end{matrix}$$

Note that H_{1,2} is a 1×3 vector containing the line of sight direction between vehicle one and vehicle two. If it is assumed that the vehicles are in relatively close formation such that the attitudes are similar implying that

$${C}_{{\overline{B}}_{1}}^{E} = {C}_{{\overline{B}}_{2}}^{E} ,$$

and have similar configurations such that L_{INS,1}=L_{INS,2}, then Eq. 354 may be re-written in the familiar form using Δδx=δx₁−δx₂:

$${\tilde{r}}_{1 , 2} = {\overline{r}}_{1 , 2} + {H}_{1 , 2} [ {I}_{3 \times 3} {0}_{3 \times 3} - 2 {C}_{{\overline{B}}_{1}}^{E} [ {L}_{INS , 1} \times ] {0}_{3 \times 3} {0}_{3 \times 3} {0}_{3 \times 2} ] Δδ x + {υ}_{{r}_{1 , 2}} \qquad ( 362 )$$

Using this method, one ore more measurements of relative range may be applied to the relative EKF previously defined. A single measurement of relative range gives some measurement of the relative position and relative attitude. However, more than one measurement is necessary to achieve observability. The number of independent relative range measurements required for complete state observability is the similar to the number of GPS satellites required for observability. Proof of observability is similar to GPS observability[97].

Generalized Relative Range with Clock Bias

Often relative ranging systems are dependent upon an estimate of time or relative time between the vehicles. For instance, a range system that is part of a wireless communication system relies on the assumed time of return: the assumed time it takes for one vehicle to receive a message, process it, and send it back to the transmitter. The total time of transmission is then multiplied by the speed of light to get the relative range. Each vehicle measures time with a local clock that may be operating at different frequencies from the other vehicle. Both clocks have errors with respect to true inertial time.

These errors introduce a range bias that is possibly time varying. This bias is similar to the GPS clock bias except that it contains components of both vehicle clock errors. In GPS, the satellite clock errors are transmitted with the satellite ephemerides and explicitly subtracted out as part of calculating satellite position [22].

Two methods are suggested for processing these errors. First, if the relative range system has a separate clock from the GPS system, then a separate clock bias state is introduced into the dynamics presented in Eq. 236. This bias term is in addition to the GPS receiver clock bias estimate, but would have similar first, second, or even third order dynamics. The clock bias is added to the relative range measurement in Eq. 354 as a separate state for each vehicle or in 362 as a single relative clock error. Using this method, the relative range measurement would include the effects of the clock bias error on the measurement equations and estimate the bias through the clock model dynamics.

This method has the advantage of system simplicity since no interconnection is required between the GPS/INS and the relative range system. However, the computational complexity increases since additional states should be included in the EKF dynamics. These may be neglected, but result in reduced performance.

Further, the synchronization of measurements between the relative range system and the GPS/INS system would require a modification to the processing of the EKF algorithm. The EKF would need to be propagated to the time of the relative range measurements, then the measurements processed. The process would be repeated with respect to the GPS measurements. If the measurements are synchronized, the only penalty is additional computation time. If the measurements are not synchronized, then the filter becomes asynchronous and exact computational time becomes somewhat unpredictable. If the measurement time between the relative range system and GPS receiver are unknown, then the system is not only asynchronous but the system performance is degraded since no common time reference exists to relate relative range measurements to the GPS time and this time uncertainty results in the introduction of additional errors into the state estimation process.

An alternate method is suggested that eliminates these problems. The relative range and GPS measurements should be measured relative to the same clock. The advantage of this method is that the measurements of both systems are synchronized relative to each other eliminating time uncertainty. Further, only one set of clock bias errors must be estimated. If this method is employed on both vehicles, then the clock bias error in the relative range measurements is the same clock bias in the GPS measurements. Using this assumption the measurement of relative range in Eq. 362 may be modified to include an estimate of the relative clock bias as:

$${\tilde{r}}_{1 , 2} = {\overline{r}}_{1 , 2} + {H}_{1 , 2} [ {I}_{3 \times 3} {0}_{3 \times 3} - 2 {C}_{{\overline{B}}_{1}}^{E} [ {L}_{INS , 1} \times ] {0}_{3 \times 3} {0}_{3 \times 3 } {1}_{3 \times 1 } {0}_{3 \times 1} ] Δδ x + \overline{τ} + {υ}_{{r}_{1 , 2}} \qquad ( 363 )$$

where the representation 1_{3×1} is used to denote a column vector of three rows all containing the value of 1. The term \overline{τ} is the a priori estimate of the clock bias. In this way, the relative range measurement may be used to help estimate the relative clock error as well as relative range. No additional states are required in the EKF. Some additional processing is required if the relative range measurements arrive at different rates than the GPS. However, the system is synchronous since measurement time is predictable relative to a common clock.
Generalized Relative Range Rate

The preceding section discussed relative range measurements. This section expands these results to include relative range rate in which the relative velocities along a particular line of sight vector are measured. These measurements may be made in a number of ways such as tracking Doppler shift in a wireless communication system or radar system or using the equivalent of a police “radar gun” to track relative speed.

Relative range rate measurements are similar to differential GPS Doppler measurements and may be processed in a similar manner. Relative range rate is defined as:

$$\begin{matrix}{\dot{r}}_{1 , 2} = \frac{\partial }{\partial t} {‖ {P}_{1} - {P}_{2} ‖}_{2} & ( 364 ) \\ = \frac{( {V}_{1} - {V}_{2} ) ∘ ( {P}_{1} - {P}_{2} )}{{‖ {P}_{1} - {P}_{2} ‖}_{2}} & ( 365 )\end{matrix}$$

where \dot{r}_{1,2} is the time derivative of the relative range, referred to as range rate, and P₁, P₂, V₁, and V₂ are the position and velocity vectors of vehicle 1 and 2 respectively. The symbol ∘ represents the vector dot product. Defining the vectors ΔP=P₁−P₂ and ΔV=V₁−V₂, the partial derivative of the range rate with respect to the relative position vector ΔP is:

$$\frac{\partial {\dot{r}}_{1 , 2}}{\partial Δ P} = \frac{Δ V}{{‖ Δ P ‖}_{2}} - [ \frac{( Δ V ) ∘ ( Δ P )}{{‖ Δ P ‖}_{2}^{3}} ] ( Δ P ) \qquad ( 366 )$$

Likewise, the patrial derivative of the range rate with respect to the relative velocity vector ΔV is:

$$\frac{\partial {\dot{r}}_{1 , 2}}{\partial Δ P} = \frac{Δ P}{{‖ Δ P ‖}_{2}} \qquad ( 367 )$$

Note that these derivations are similar to those derived for the GPS range rate between the GPS receiver and the GPS satellite. In this sense, the relative range measurement may be derived from Eq. 250 using the first order partial derivatives defined here except that perturbations must now be taken with respect to both vehicles since both vehicles are assumed to have stochastic errors in the state estimates. Using Eq. 250 as a basis, using the partial derivatives defined here, and using the a priori state estimates \overline{P}₁, \overline{P}₂, \overline{V}₃, and \overline{V}₂ noting that Δ\overline{P}=\overline{P}₁−\overline{P}₂ and Δ\overline{V}=\overline{V}₁−\overline{V}₂, a new relative range rate measurement is defined as:

$$\begin{matrix}{{r}^{\dot{\sim}}}_{1 , 2} = {{r}^{\dot{\_}}}_{1 , 2} + [ \begin{matrix}\frac{\partial {\dot{r}}_{1 , 2}}{\partial Δ P} & \frac{\partial {\dot{r}}_{1 , 2}}{\partial Δ V} ] [ \begin{matrix}Δδ P ( 368 ) \\ Δδ V\end{matrix} ] + {υ}_{{\dot{r}}_{1 , 2}}\end{matrix} = & ( 369 ) \\ {{r}^{\dot{\_}}}_{1 , 2} + [ \frac{Δ \overline{V}}{{‖ Δ \overline{P} ‖}_{2}} - [ \frac{( Δ \overline{V} ) ∘ ( Δ \overline{P} )}{{‖ Δ \overline{P} ‖}_{2}^{3}} ] ( Δ \overline{P} ) \frac{Δ \overline{P}}{{‖ Δ \overline{P} ‖}_{2}} ] [ \begin{matrix}Δδ P ( 370 ) \\ Δδ V\end{matrix} ] + {υ}_{{\dot{r}}_{1 , 2}} & ( 371 )\end{matrix}$$

defining ν_{\dot{r}}_{_{1,2}} as the noise in the measurement with the following additional definitions:

$$\begin{matrix}{{r}^{\dot{\_}}}_{1 , 2} = \frac{( {\overline{V}}_{1} - {\overline{V}}_{2} ) ∘ ( {\overline{P}}_{1} - {\overline{P}}_{2} )}{{‖ {\overline{P}}_{1} - {\overline{P}}_{2} ‖}_{2}} & ( 372 ) \\ Δδ P = δ {P}_{1} - δ {P}_{2} & ( 373 ) \\ Δδ V = δ {V}_{1} - δ {V}_{2} & ( 374 )\end{matrix}$$

For simplification, the measurement matrix H_{\dot{r}}_{_{1,2}} is defined as:

$${H}_{{\dot{r}}_{1 , 2}} = [ \frac{Δ \overline{V}}{{‖ Δ \overline{P} ‖}_{2}} - [ \frac{( Δ \overline{V} ) ∘ ( Δ \overline{P} )}{{‖ Δ \overline{P} ‖}_{2}^{3}} ] ( Δ \overline{P} ) \frac{Δ \overline{P}}{{‖ Δ \overline{P} ‖}_{2}} ] \qquad ( 375 )$$

This measurement matrix is a row vector with 6 columns. One measurement matrix is used for each available range rate measurement, if more than one are available.

Generalized Relative Range Rate with Lever Arm

Following the previous derivation for relative range, it is now desired to translate the relative range measurement from the point where the relative range is measured on each vehicle to the location of the INS on each vehicle. The derivation follows closely the derivation of the translation from the GPS antenna to the INS.

For the first vehicle, the velocity of the relative ranging point on the vehicle may be translated to the INS velocity using the following kinematic relationships. As with the GPS range rate, the relationship is defined in the ECEF coordinate frame, common to both vehicles.

$${V}_{{1}_{E}} = {V}_{INS , {1}_{E}} + {C}_{{B}_{1}}^{E} ( {ω}_{{IB}_{1}}^{{B}_{1}} \times {L}_{INS , 1} ) - {ω}_{IE}^{E} \times {C}_{{B}_{1}}^{E} {L}_{INS , 1} \qquad ( 376 )$$

The

$${ω}_{{IB}_{1}}^{{B}_{1}}$$

term is the true angular velocity at the INS in the body frame of vehicle 1 while the ω_{IE}^{E} is the rotation of the inertial frame with respect to the Earth.

Likewise, a similar definition holds for vehicle 2:

$${V}_{{2}_{E}} = {V}_{INS , {2}_{E}} + {C}_{{B}_{2}}^{E} ( {ω}_{{IB}_{2}}^{{B}_{2}} \times {L}_{INS , 1} ) - {ω}_{IE}^{E} \times {C}_{{B}_{2}}^{E} {L}_{INS , 2} \qquad ( 377 )$$

As before, the

$${ω}_{{IB}_{2}}^{{B}_{2}}$$

term is the true angular velocity at the second vehicle INS location in the body frame of vehicle 2 while the

$${ω}_{IE}^{E}$$

is the rotation of the inertial with respect to the Earth.

The lever arms representing the distance between the INS and the range rate measurement point are defined for each vehicle as: L_{INS,1} and L_{INS,2} respectively. Both are assumed rigid with respect to time.

The relative velocity ΔV_{E} is then calculated using Eq 376 and Eq. 377 as:

$$\begin{matrix}Δ {V}_{E} = {V}_{{1}_{E}} - {V}_{{2}_{E}} & ( 378 ) \\ = {V}_{INS , {1}_{E}} + {C}_{{B}_{1}}^{E} ( {ω}_{{IB}_{1}}^{{B}_{1}} \times {L}_{INS , 1} ) - {ω}_{IE}^{E} \times {C}_{{B}_{1}}^{E} {L}_{INS , 1} - & ( 379 ) \\ ( {V}_{{2}_{E}} = {V}_{INS , {2}_{E}} + {C}_{{B}_{2}}^{E} ( {ω}_{{IB}_{2}}^{{B}_{2}} \times {L}_{INS , 2} ) - {ω}_{IE}^{E} \times {C}_{{B}_{2}}^{E} {L}_{INS , 2} ) & ( 380 )\end{matrix}$$

The velocity error in the estimate at the range rate measurement point is derived using perturbation analysis similar to the GPS derivation in Eq. 274. The error is defined as:

$$\begin{matrix}δ {V}_{{1}_{E}} = {V}_{{1}_{E}} - {\overline{V}}_{{1}_{E}} & ( 381 ) \\ = δ {V}_{INS , {1}_{E}} - {C}_{{B}_{1}}^{E} ( {\tilde{ω}}_{I {\overline{B}}_{1}}^{{\overline{B}}_{1}} \times {L}_{INS , 1} ) + {ω}_{I , E}^{E} \times {C}_{{\overline{B}}_{1}}^{E} {L}_{INS , 1} & \end{matrix}$$

Note that the

$${\tilde{ω}}_{I {\overline{B}}_{1}}^{{\overline{B}}_{1}}$$

term is the a priori angular velocity corrected for gyro bias error. The ability to translate from the range rate point to the INS requires estimates of the angular velocity which should be supplied by the INS. The bias errors of the INS are then explicitly a part of the relative range rate measurement. The error in the gyro bias is defined as δb_{g,1} and is additive with the INS angular velocity. Using this definition, Eq. 381 becomes

$$\begin{matrix}δ {V}_{1} = δ {V}_{INS , {1}_{E}} + {C}_{{\overline{B}}_{1}}^{E} ( I + 2 [ δ {q}_{1} \times ] ) ( {\tilde{ω}}_{I {\overline{B}}_{1}}^{{\overline{B}}_{1}} + δ {b}_{g , 1} ) \times {L}_{INS , 1} - & ( 382 ) \\ {ω}_{IE}^{E} \times {C}_{{\overline{B}}_{1}}^{E} ( I + 2 [ δ {q}_{1} \times ] ) {L}_{INS , 1} - {C}_{{\overline{B}}_{1}}^{E} ( {\tilde{ω}}_{I {\overline{B}}_{1}}^{{\overline{B}}_{1}} \times L ) + & \\ {ω}_{IE}^{E} \times {C}_{{\overline{B}}_{1}}^{E} {L}_{INS , 1} & \\ = δ {V}_{INS , {1}_{E}} + {V}_{vq , 1} δ {q}_{1} - {C}_{{\overline{B}}_{1}}^{E} [ {L}_{INS , 1} \times ] δ {b}_{g , 1} + H . O . T & \end{matrix}$$

where V_{vq,1} is defined as:

$${V}_{vq , 1} = - 2 [ {C}_{{\overline{B}}_{1}}^{E} ( {\tilde{ω}}_{I {\overline{B}}_{1}}^{{\overline{B}}_{1}} \times {L}_{INS , 1} ) \times ] - {ω}_{IE}^{E} \times [ {C}_{{\overline{B}}_{1}}^{E} {L}_{INS , 1} \times ] \qquad ( 383 )$$

and where cross terms between δb_{g,1} and δq₁ are neglected.

The error in the second vehicle velocity is calculated using the same assumptions:

$$δ {V}_{2} = δ {V}_{INS , {2}_{g}} + {V}_{vq , 2} δ {q}_{2} - {C}_{{\overline{B}}_{2}}^{E} [ {L}_{INS , 2} \times ] δ {b}_{g , 2} \qquad ( 384 )$$

with V_{vq,2} defined as:

$${V}_{vq , 2} = - 2 [ {C}_{{\overline{B}}_{2}}^{E} ( {\tilde{ω}}_{I {\overline{B}}_{2}}^{{\overline{B}}_{2}} \times {L}_{INS , 2} ) \times ] - {ω}_{IE}^{E} \times [ {C}_{{\overline{B}}_{2}}^{E} {L}_{INS , 2} \times ] \qquad ( 385 )$$

Combining these results with Eq. 368 and the relative range equations Eq. 357 allows for the derivation of the relative range measurement in terms of the error states in the INS for each vehicle.

$$\begin{matrix}{\dot{\tilde{r}}}_{1 , 2} = {\dot{\overline{r}}}_{1 , 2} + \frac{\partial {\dot{r}}_{1 , 2}}{\partial Δ P} ( δ {P}_{INS , {1}_{E}} - 2 {C}_{{\overline{B}}_{1}}^{E} [ {L}_{INS , 1} \times ] δ {q}_{1} - δ {P}_{INS , {2}_{E}} + 2 {C}_{{\overline{B}}_{2}}^{E} [ {L}_{INS , 2} \times ] δ {q}_{2} ) + \frac{\partial {\dot{r}}_{1 , 2}}{\partial Δ V} ( δ {V}_{INS , {1}_{E}} + {V}_{vq , 1} δ {q}_{1} - {C}_{{\overline{B}}_{1}}^{E} [ {L}_{INS , 1} \times ] δ {b}_{g , 1} - δ {V}_{INS , {2}_{E}} - {V}_{vq , 2} δ {q}_{2} + {C}_{{\overline{B}}_{2}}^{E} [ {L}_{INS , 2} \times ] δ {b}_{g , 2} ) + {v}_{\dot{r} 1 , 2} = {\dot{\overline{r}}}_{1 , 2} + & ( 386 ) \\ [ \frac{\partial {r}_{1 , 2}}{\partial Δ P} \frac{\partial {r}_{1 , 2}}{\partial Δ V} ] [ \begin{matrix}{I}_{3 \times 3} & {0}_{3 \times 3} & - 2 {C}_{{\overline{B}}_{1}}^{E} [ {L}_{INS , 1} \times ] & {0}_{3 \times 3} & {0}_{3 \times 3} & {0}_{3 \times 2} \\ {0}_{3 \times 3} & {I}_{3 \times 3} & {V}_{vq , 1} & - {C}_{{\overline{B}}_{1}}^{E} [ {L}_{INS , 2} \times ] & {0}_{3 \times 3} & {0}_{3 \times 2}\end{matrix} ] [ \begin{matrix}δ {P}_{{1}_{E}} \\ δ {V}_{{1}_{E}} \\ δ {q}_{1} \\ δ {b}_{{g}_{1}} \\ δ {b}_{{a}_{1}} \\ c {δτ}_{1}\end{matrix} ] - [ \frac{\partial {r}_{1 , 2}}{\partial Δ P} \frac{\partial {r}_{1 , 2}}{\partial Δ V} ] [ \begin{matrix}{I}_{3 \times 3} & {0}_{3 \times 3} & - 2 {C}_{{\overline{B}}_{2}}^{E} [ {L}_{INS , 2} \times ] & {0}_{3 \times 3} & {0}_{3 \times 3} & {0}_{3 \times 2} ( 394 ) \\ {0}_{3 \times 3} & {I}_{3 \times 3} & {V}_{vq , 2} & - {C}_{{\overline{B}}_{2}}^{E} [ {L}_{INS , 2} \times ] & {0}_{3 \times 3} & {0}_{3 \times 2}\end{matrix} ] [ \begin{matrix}δ {P}_{{2}_{E}} \\ δ {V}_{{2}_{E}} \\ δ {q}_{2} \\ δ {b}_{{g}_{2}} \\ c {δτ}_{2}\end{matrix} ] + {v}_{{\dot{r}}_{1 , 2}} & ( 387 )\end{matrix}$$

δP₁_{_{E}}=Position1 (388)
δV₁_{_{E}}=Velocity1 (389)
δq₁=QuaternionError1 (390)
δb_{g}_{₁}=Gyrobias1 (391)
δbₐ_{₁}=Accelbias1 (392)
cδτ₁=ClockBias1 (393)
L_{INS,1}=LeverArm1 (394)
δP₂_{_{E}}=Position2 (395)
δV₂_{_{E}}=Velocity2 (396)
δq₂=QuaternionError2 (397)
δb_{g}_{₂}=Gyrobias2 (398)
δbₐ_{₂}=Accelbias2 (399)
cδτ₂=ClockBias2 (400)
L_{INS,2}=LeverArm2 (401)

If we assume that the vehicles are in formation and that the configurations are the same such that

$${C}_{{\overline{B}}_{1}}^{E} \approx {C}_{{\overline{B}}_{2}}^{E} , {L}_{INS , 1} \approx {L}_{INS , 2} , and {\tilde{ω}}_{I {\overline{B}}_{1}}^{{\overline{B}}_{1}} \approx {\tilde{ω}}_{I {\overline{B}}_{2}}^{{\overline{B}}_{2}}$$

then Eq. 386 reduces to:

$$\begin{matrix}{\dot{\tilde{r}}}_{1 , 2} = {\dot{\overline{r}}}_{1 , 2} + \frac{\partial {\dot{r}}_{1 , 2}}{\partial Δ P} ( Δδ {P}_{INS , E} - 2 {C}_{{\overline{B}}_{1}}^{E} [ {L}_{INS , 1} \times ] Δδ q + \frac{\partial {\dot{r}}_{1 , 2}}{\partial Δ V} ( Δδ {V}_{INS , E} + {V}_{vq , 1} Δδ q - {C}_{{\overline{B}}_{1}}^{E} [ {L}_{INS , 1} \times ] Δδ {b}_{g} ) + {v}_{\dot{r} 1 , 2} = {\dot{\overline{r}}}_{1 , 2} + & ( 402 ) \\ [ \frac{\partial {\dot{r}}_{1 , 2}}{\partial Δ P} \frac{\partial {\dot{r}}_{1 , 2}}{\partial Δ V} ] [ \begin{matrix}{I}_{3 \times 3} & {0}_{3 \times 3} & - 2 {C}_{{\overline{B}}_{1}}^{E} [ {L}_{INS , 1} \times ] & {0}_{3 \times 3} & {0}_{3 \times 3} & {0}_{3 \times 2} \\ {0}_{3 \times 3} & {I}_{3 \times 3} & {V}_{vq , 1} & - {C}_{{\overline{B}}_{1}}^{E} [ {L}_{INS , 1} \times ] & {0}_{3 \times 3} & {0}_{3 \times 2}\end{matrix} ] [ \begin{matrix}Δδ {P}_{E} \\ Δδ {V}_{E} \\ Δδ q \\ Δδ {b}_{g} \\ Δ c δ τ\end{matrix} ] + {v}_{\dot{r} 1 , 2} & ( 403 )\end{matrix}$$

L_{INS,1}=LeverArm (404)
ΔδP₁_{_{E}}=RelPosition (405)
ΔδV₁_{_{E}}=RelVelocity (406)
Δδq₁=RelQuaternionError (407)
Δδb_{g}_{₁}=RelGyrobias (408)
Δδbₐ_{₁}=RelAccelbias (409)
Δcδτ₁=RelClockBias (410)
which may be processed using the relative EKF reduction.
Generalized Relative Range Rate with Clock Drift

The clock of the relative range rate measuring system will add errors onto the measurement. The same issues presented with relative range apply to relative range rate, except that instead of clock bias errors, the clock drift rate affects the relative range rate system. The designer is left with the same set of options for configuring the system as defined in the Section titled Generalized Relative Range with Clock Bias. Either a separate clock model is introduced into the EKF for the relative range rate clock or the system is synchronized and driven off of the GPS clock so that a common time reference is used between all instruments. This method is presented here.

In the case of a common time reference, only an additional range rate term c\dot{τ} must be introduced into the error. The result is similar to that presented for GPS and is not presented here. The effect of this error on the relative range rate measurement model in Eq. 386 is:

$${\dot{\tilde{r}}}_{1 , 2} = {\dot{\overline{r}}}_{1 , 2} + [ \frac{\partial {\dot{r}}_{1 , 2}}{\partial Δ P} \frac{\partial {\dot{r}}_{1 , 2}}{\partial Δ V} ] [ \begin{matrix}{I}_{3 \times 3} & {0}_{3 \times 3} & - 2 {C}_{{B}_{1}}^{E} [ {L}_{INS , 1} \times ] & {0}_{3 \times 3} & {0}_{3 \times 3} & {0}_{3 \times 1} & {0}_{3 \times 1} \\ {0}_{3 \times 3} & {I}_{3 \times 3} & {V}_{vq , 1} & - {C}_{{B}_{1}}^{E} [ {L}_{INS , 1} \times ] & {0}_{3 \times 3} & {0}_{3 \times 1} & {1}_{3 \times 1}\end{matrix} ] [ \begin{matrix}δ {P}_{{1}_{E}} \\ δ {V}_{{1}_{E}} \\ δ {q}_{1} \\ δ {b}_{{q}_{1}} \\ δ {b}_{{a}_{1}} \\ c {δτ}_{1} \\ c δ {\dot{τ}}_{1}\end{matrix} ] - [ \frac{\partial {r}_{1 , 2}}{\partial Δ P} \frac{\partial {r}_{1 , 2}}{\partial Δ V} ] [ \begin{matrix}{I}_{3 \times 3} & {0}_{3 \times 3} & - 2 {C}_{{\overline{B}}_{2}}^{E} [ {L}_{INS , 2} \times ] & {0}_{3 \times 3} & {0}_{3 \times 3} & {0}_{3 \times 1} & {0}_{3 \times 1} \\ {0}_{3 \times 3} & {I}_{3 \times 3} & {V}_{vq , 2} & - {C}_{{\overline{B}}_{2}}^{E} [ {L}_{INS , 2} \times ] & {0}_{3 \times 3} & {0}_{3 \times 1} & {1}_{3 \times 1}\end{matrix} ] [ \begin{matrix}δ {P}_{{2}_{E}} \\ δ {V}_{{2}_{E}} \\ δ {q}_{2} \\ δ {b}_{{g}_{2}} \\ δ {b}_{{a}_{2}} \\ c {δτ}_{2} \\ c δ {\dot{τ}}_{2}\end{matrix} ] \qquad ( 411 )$$

δP₁_{_{E}}=Position1 (412)
δV₁_{_{E}}=Velocity1 (413)
δq₁=QuaternionError1 (414)
δb_{g}_{₁}=Gyrobias1 (415)
δbₐ_{₁}=Accelbias1 (416)
cδτ₁=ClockBias1 (417)
cδ\dot{τ}₁=ClockDrift1 (418)
L_{INS,1}=LeverArm1 (419)
δP₂_{_{E}}=Position2 (420)
δV₂_{_{E}}=Velocity2 (421)
δq₂=QuaternionError2 (422)
δb_{g}_{₂}=Gyrobias2 (423)
δbₐ_{₂}=Accelbias2 (424)
cδτ₂=ClockBias2 (425)
cδ\dot{τ}₂=ClockDrift2 (426)
L_{INS,2}=LeverArm2 (427)
where the error in the clock drift has been explicitly defined as

$$c δ {\dot{τ}}_{1}$$

and cδ\dot{τ}₂ for each vehicle and the a priori estimates of clock drift are c\overline{τ}₁ and cδ\overline{τ}₂, respectively.

If the configurations simplifications described previously for similar aircraft in formation flight are met, then the modification to Eq 411 is:

$${\dot{\tilde{r}}}_{1 , 2} = {\dot{\overline{r}}}_{1 , 2} + [ \frac{\partial {\dot{r}}_{1 , 2}}{\partial Δ P} \frac{\partial {\dot{r}}_{1 , 2}}{\partial Δ V} ] [ \begin{matrix}{I}_{3 \times 3} & {0}_{3 \times 3} & - 2 {C}_{{B}_{1}}^{E} [ {L}_{INS , 1} \times ] & {0}_{3 \times 3} & {0}_{3 \times 3} & {0}_{3 \times 1} & {0}_{3 \times 1} \\ {0}_{3 \times 3} & {I}_{3 \times 3} & {V}_{vq , 1} & - {C}_{{B}_{1}}^{E} [ {L}_{INS , 1} \times ] & {0}_{3 \times 3} & {0}_{3 \times 1} & {1}_{3 \times 1}\end{matrix} ] [ \begin{matrix}Δδ {P}_{E} \\ Δδ {V}_{E} \\ Δδ q \\ Δδ {b}_{g} \\ Δδ {b}_{a} \\ Δ c δτ \\ Δ c δ \dot{τ}\end{matrix} ] + Δ \dot{\overline{τ}} + {v}_{{\dot{r}}_{1 , 2}} \qquad ( 428 )$$

L_{INS,1}=LeverArm (429)
ΔδP₁_{_{E}}=RelPosition (430)
ΔδV₁_{_{E}}=RelVelocity (431)
Δδq₁=RelQuaternionError (432)
Δδb_{g}_{₁}=RelGyrobias (433)
Δδbₐ_{₁}=RelAccelbias (434)
Δcδτ₁=RelClockBias (435)
Δcδτ₂=RelClockDrift (436)
In this way, the clock error is introduced into the relative range measurement without having to introduce additional error states in the EKF.
Non-Common Configuration Relative Range and Range Rate Processing

If the relative range and range rate measurements are processed, but the aircraft do not share common configurations, then propagated errors from the INS must be estimated at the range and range rate antenna locations on each aircraft. Then these measurements will be processed within the EKF using measurements, error states, and covariances calculated at the antenna locations. In this case, we assume that vehicle 1, the base vehicle, is the emitter of information and vehicle 2, the rover, is measuring range rate information relative to the base.

A linear transformation T that translates the error in the INS state to an associated error at the range and range rate antenna location for vehicle 1, is now be defined as:

$${T}_{INS , 1}^{{r}_{1 , 2}} = {[ \begin{matrix}I & 0 & - 2 {C}_{{B}_{1}}^{E} [ {L}_{INS , 1} \times ] & 0 & 0 & 0 & 0 \\ 0 & I & {V}_{{vq}_{1}} & - {C}_{{B}_{1}}^{E} [ {L}_{INS , 1} \times ] & 0 & 0 & 0 \\ 0 & 0 & I & 0 & 0 & 0 & 0 \\ 0 & 0 & 0 & I & 0 & 0 & 0 \\ 0 & 0 & 0 & 0 & I & 0 & 0 \\ 0 & 0 & 0 & 0 & 0 & 0 & 1\end{matrix} ]}_{17 \times 17} \qquad ( 437 )$$

where all submatrices have appropriate dimensions. Likewise, the transformation matrix for the second vehicle is:

$${T}_{INS , 2}^{{r}_{1 , 2}} = {[ \begin{matrix}I & 0 & - 2 {C}_{{B}_{2}}^{E} [ {L}_{INS , 2} \times ] & 0 & 0 & 0 & 0 \\ 0 & I & {V}_{{vq}_{2}} & - {C}_{{B}_{2}}^{E} [ {L}_{INS , 2} \times ] & 0 & 0 & 0 \\ 0 & 0 & I & 0 & 0 & 0 & 0 \\ 0 & 0 & 0 & I & 0 & 0 & 0 \\ 0 & 0 & 0 & 0 & I & 0 & 0 \\ 0 & 0 & 0 & 0 & 0 & 0 & 1\end{matrix} ]}_{17 \times 17} \qquad ( 438 )$$

Using this rotation the error in the INS state may be translated to the range and range rate measurement antenna.
δx₁^{r}^{_{1,2}}=T_{INS,1}^{r}^{_{1,2}}δx_{INS,1} (439)
δx₂^{r}^{_{1,2}}=T_{INS,2}^{r}^{_{1,2}}δx_{INS,2} (440)

These relationships imply that the error in the relative state estimate at the location of the base and rover is defined as Δδx^{r}^{_{1,2}}=δx₁^{r}^{_{1,2}}−δx₂^{r}^{_{1,2}}.

The measurement model for the range measurement received at the rover is simply:
\tilde{r}_{1,2}=\overline{r}_{1,2}

$$+ [ \frac{\partial {r}_{1 , 2}}{\partial Δ P} {0}_{1 \times 3} {0}_{1 \times 3} {0}_{1 \times 3} {0}_{1 \times 3} {0}_{1 \times 1} {0}_{1 \times 1} ] Δδ {x}^{{r}_{1 , 2}} + Δ \dot{\overline{τ}} + {v}_{{\dot{r}}_{1 , 2}} = {\dot{\overline{r}}}_{1 , 2} + {H}_{Δ {\dot{r}}_{1 , 2}} Δδ {x}^{{r}_{1 , 2}} + Δ \dot{\overline{τ}} + {v}_{{r}_{1 , 2}} \qquad ( 441 )$$

The measurement model for the range rate measurement received at the rover is also simply:

$${\dot{\tilde{r}}}_{1 , 2} = {\dot{\overline{r}}}_{1 , 2} + [ \frac{\partial {\dot{r}}_{1 , 2}}{\partial Δ P} \frac{\partial {\dot{r}}_{1 , 2}}{\partial Δ V} {0}_{1 \times 3} {0}_{1 \times 3} {0}_{1 \times 3} {0}_{1 \times 1} {0}_{1 \times 1} ] Δδ {x}^{{r}_{1 , 2}} = {\dot{\overline{r}}}_{1 , 2} + {H}_{Δ {\dot{r}}_{1 , 2}} Δδ {x}^{{r}_{1 , 2}} + Δ \dot{\overline{τ}} + {v}_{{r}_{1 , 2}} \qquad ( 442 )$$

In addition to the state, the error covariance can be translated as well. The new error covariance is calculated as:
M₁=T_{INS,1}^{r}^{_{1,2}}M_{INS,1}T_{INS,1}^{r}^{_{1,2}}^{^{T}} (443)
M₂=T_{INS,2}^{r}^{_{1,2}}M_{INS,2}T_{INS,2}^{r}^{_{1,2}}^{^{T}} (444)

In order to process these measurement equations, a methodology similar to the one presented for differential GPS is utilized. In this case the rover is operating an EKF similar to the differential GPS with dynamics:
Δδ\dot{x}=A₂Δδx+ω₁−ω2 (445)
where the dynamics matrix A₂ is kinematic dynamics previously defined and ω₁ and ω₂ are the process noise of each vehicle.

Using the dynamics in Eq. 445, and the measurements in equations 441 and 442, it is possible to construct an EKF that processes this data to form the relative state estimate. The base vehicle transmits the a priori state estimate x, to the rover. The location vectors L_{INS,1} and L_{INS,2} are assumed known at the rover. When the relative range or range rate measurement is available, the EKF update equations are used to estimate the error Δδ\hat{x}^{r}^{_{1,2}} as:

$$Δ {δ}_{{\hat{x}}^{{r}_{1 , 2}}} = Δ {δ}_{{\overline{x}}^{{r}_{1 , 2}}} + K ( [ \begin{matrix}{\tilde{r}}_{1 , 2} \\ {\dot{\tilde{r}}}_{1 , 2}\end{matrix} ] - [ \begin{matrix}{H}_{Δ {r}_{1 , 2}} \\ {H}_{{Δ}_{{\dot{r}}_{1 , 2}}}\end{matrix} ] Δ {δ}_{{\overline{x}}^{{r}_{1 , 2}}} ) \qquad ( 466 )$$

where we now define generically

$${H}_{r} [ \begin{matrix}{H}_{{Δr}_{1 , 2}} \\ {H}_{{Δ}_{{\dot{r}}_{1 , 2}}}\end{matrix} ] \qquad ( 447 )$$

and
K=M₂−M₂Hᵣ^{T}(HᵣM₂Hᵣ^{T}+Vᵣ)⁻¹HᵣM₂ (448)

The measurement matrix Vᵣ is defined as the covariance of the range and range rate noise or:

$${V}_{r} E [ [ \begin{matrix}{υ}_{{r}_{1 , 2}} \\ {υ}_{{\dot{r}}_{1 , 2}}\end{matrix} ] [ \begin{matrix}{υ}_{{r}_{1 , 2}} & {υ}_{{\dot{r}}_{1 , 2}}\end{matrix} ] ] \qquad ( 449 )$$

where νᵣ_{_{1,2}} and ν_{\dot{r}}_{_{1,2}} are assumed to be scalars. Note that more than one range or range rate measurement may be incorporated through this same process for different range and range rate locations and measurements.

At this point, if the GPS algorithm is used, the relative state error Δδ\hat{x}^{r}^{_{1,2}} would be combined with the absolute state estimate error δ\hat{x}₁ of the base vehicle to form the estimated local error δ\hat{x}₂.

Generalized Angle Measurements

The generalized angle to a particular point on the vehicle may be filtered using a standard, Modified Gain Extended Kalman Filter (MGEKF) [15] on the receiver observing angles. Note that the receiver must tie the angle information to the local inertial measurements for these measurements to have meaning.

Using the method, generalized angle measurements may be applied to the EKF filtering structure presented.

GPS Fault Detection

This section outlines some methods and processes for performing fault tolerant navigation with specific instruments using the methods described. Several methods and variations are presented using a combination of GPS, GPS/INS, and other instruments blended through various dynamic systems.

GPS Range Only

The methodology presented in Section 2 is applied to a GPS receiver operating with range measurements. The process is defined in the following steps.

GPS Dynamics and State

For this problem, the state consists of the 3 positions and one clock bias. The positions are in the Earth-Centered Earth Fixed coordinate frame. However, the state could also be in the East-North Up (ENU) frame with no significant modification. No state dynamics are assumed yet. The state vector to be estimated is the error in the position and clock bias denoted in general as δx=[δPₓδP_{y}δP_{z}cδτ] where c is the speed of light and τ is the clock bias in seconds, and Pₓ, P_{y}, P_{z} are the three components of the position vector. The δ( ) notation is used to signify error in the parameter defined as δx=x−\overline{x} where x is the true quantity and \overline{x} is the a priori estimate.

The number of states created is equal to the number of GPS satellite measurements plus one. This is because each state will effectively be calculated with a subset of all of the measurements except for one satellite. This one satellite will be excluded and assumed to be faulty within each state. In addition, there will be a final baseline state which processes all measurements.

GPS Measurement

The GPS measurement model for a range measurement ρᵢ for satellite i is given as:

$$[ \begin{matrix}δ {P}_{x} = ECEFXPosition \\ δ {P}_{y} = ECEFYPosition \\ δ {P}_{z} = ECEFZPosition \\ c δ τ = ClockBias\end{matrix} ] \begin{matrix} ( 450 ) \\ ( 451 ) \\ ( 452 ) \\ ( 453 )\end{matrix}$$

$$\begin{matrix}{\tilde{ρ}}_{i} = {ρ}_{i} + [ \begin{matrix}\frac{- ( {X}_{i} - {P}_{x} )}{{\overline{ρ}}_{i}} & \frac{- ( {Y}_{i} - {P}_{y} )}{{\overline{ρ}}_{i}} & \frac{- ( {Z}_{i} - {P}_{z} )}{{\overline{ρ}}_{i}} & 1\end{matrix} ] & ( 454 ) \\ [ \begin{matrix}δ {P}_{x} \\ δ {P}_{y} \\ δ {P}_{z} \\ c δ τ\end{matrix} ] + c \overline{τ} + {μ}_{i} + {v}_{i} & \\ = {ρ}_{i} + {C}_{i} δ x + {μ}_{i} {v}_{i} & ( 455 )\end{matrix}$$

where [XᵢYᵢZᵢ] is the position vector of satellite i in the ECEF coordinate frame, [\overline{xyz}] is the a priori state estimate of the receiver, and the initial estimate of range is defined as:
ρᵢ=[(Xᵢ−Pₓ)²+(Yᵢ−P_{y})²+(Zᵢ−P_{z})²]^{1/2}+c\overline{τ} (456)

Note that c\overline{τ} is the clock bias in meters and c represents the speed of light. The linearized measurement matrix Cᵢ is used for shorthand notation and the state to be estimated is the error in the position or δx. For each measurement, we will construct a separate state estimate δxᵢ and associated a priori values for Pₓᵢ, Pₓᵢ, Pₓᵢ, and c\overline{τ}ᵢ. The matrix C will represent the total set of measurement matrices for all available measurements such that
\tilde{ρ}=\overline{ρ}+Cδx+μᵢ+vᵢ (457)
where \tilde{ρ} is a column vector of all of the available measurements. Finally, the matrix C_{j≠i} will represent all measurements except the measurement for satellite i.

The term μᵢ represents a fault in the satellite. The term vᵢ is the measurement noise and is assumed zero mean with variance V. This model assumes that several models.

GPS Fault Modelling

Since no dynamics are present, the fault does not need to be converted to an actuator fault. Instead, the projector used for a particular model simply eliminates one measurement from the set of all measurements. A reduced set of measurements remains. Therefore for each satellite failure, no projection process is required.

Residual Process

As stated, the effect of the projector simply eliminates one measurement for that satellite. The residual process for this case is given as:
\overline{r}ᵢ=\tilde{ρ}_{j≠i}−\tilde{ρ}_{j≠i}−C_{j≠i}δ\overline{x}ᵢ (458)
where δxᵢ is the state assumed to be free of a fault from satellite i.
Gain Calculation

The gain is calculated using a weighted least squares algorithm:
Kᵢ=(C_{j≠i}^{T}V_{j≠i}⁻¹C_{j≠i})⁻¹C_{j≠i}^{T}V_{j≠i}⁻¹ (459)
State Correction Process

The state correction process is simply:
δ\hat{x}ᵢ(k)=δ\overline{x}ᵢ(k)+Kᵢrᵢ (460)
Updated Residual Process

The updated residual process is defined as:
\hat{r}ᵢ=\tilde{ρ}_{j≠i}−\overline{ρ}_{j≠i}−C_{j≠i}δ\hat{x}ᵢ (461)
Residual Testing

In this case, the Shiryayev Test is invoked, although other methods may be used. The Shiryayev Test may be used to process the updated residual to determine the probability of a failure.

Each state xᵢ assumes the existence of a failure in one satellite except the baseline, healthy case. Each hypothesized failure has a an associated probability of being true defined as φᵢ(k) before updating with the residual \hat{r}_{Fi}(k). The probability that the system is healthy is likewise

$${ϕ}_{0} ( k ) = 1 - {\sum }_{i = 1}^{N} {ϕ}_{i} ( k ) .$$

A probability density function f₀(\hat{r}₀,k) and fᵢ(\hat{r}ᵢ,k) is assumed for each hypothesis. In this case, if we assume that the process noise and measurement noise are Gaussian, then the probability density function for the residual process is the Gaussian using

$${f}_{i} ( {\hat{r}}_{i} , k ) = \frac{1}{{( 2 π )}^{n / 2} ‖ {P}_{Fi} ‖} exp \{ - \frac{1}{2} {\hat{r}}_{i} ( k ) {P}_{Fi}^{- 1} {\hat{r}}_{i} ( k ) \} \qquad ( 462 )$$

where P_{Fi} is the covariance of the residual \hat{r}_{F}(k) and ∥.∥ defines the matrix 2-norm. The covariance P_{Fi} is defined as:
P_{Fi}=C_{j≠i}V_{j≠i}C_{j≠i}^{T} (463)

From this point, it is possible to update the probability that a fault has occurred for all hypotheses. The following relationship calculates the probability that the fault has occurred.

$${G}_{i} ( k ) = \frac{{ϕ}_{i} ( k ) {f}_{i} ( {\hat{r}}_{i} , k )}{{\sum }_{i = 1}^{N} {ϕ}_{i} ( k ) {f}_{i} ( {\hat{r}}_{i} , k ) + {ϕ}_{0} ( k ) {f}_{0} ( {\hat{r}}_{0} , k )} \qquad ( 464 )$$

From time step to time step, the probability must be propagated using the probability p that a fault may occur between any time steps k and k+1. The propagation of the probabilities is given as:

$${ϕ}_{i} ( k + 1 ) = {G}_{i} ( k ) + \frac{p}{N} ( 1 - {\sum }_{i = 1}^{N} {G}_{i} ( k ) ) \qquad ( 465 )$$

Note that for any time step, the healthy hypothesis may be updated as:

$$\begin{matrix}{G}_{0} ( k ) = 1 - {\sum }_{i = 1}^{N} {G}_{i} ( k ) and & ( 466 ) \\ {ϕ}_{0} ( k + 1 ) = 1 - {\sum }_{i = 1}^{N} {ϕ}_{1} ( k + 1 ) & ( 467 )\end{matrix}$$

In this way the probability that a failure has occurred in any satellite may be defined and calculated.

Declaration

Declaration occurs when one of the probabilities of a failure takes on a value above a threshold. Other metrics are possible, but a probability of 99.999% is a reasonable value.

Propagation

Since there are no dynamics, no propagation is performed. The next section considers both range and range rate measurements.

GPS Range and Range Rate

The methodology described is applied to a GPS receiver operating with range and range rate measurements. The process is defined in the following steps.

GPS Dynamics and State

For this problem, the state consists of the 3 positions, 3 velocities and one clock bias and one clock drift. The positions are in the Earth-Centered Earth Fixed coordinate frame. However, the state could also be in the East-North Up (ENU) frame with no significant modification.

The state dynamics are a simple integration driven by a white noise process. However, no dynamics are necessary. Dynamics are mentioned to add contrast to the previous version of this filter. The dynamics are defined as:
δx(k+1)=Φδx(k)+δω(k) (468)

The state vector to be estimated is the error in the position and clock bias are now defined as:

$$δ x = [ \begin{matrix}δ {P}_{x} \\ δ {P}_{y} \\ δ {P}_{z} \\ δ {V}_{x} \\ δ {V}_{y} \\ δ {V}_{z} \\ c δ τ \\ c δ \dot{τ}\end{matrix} ] \qquad ( 469 )$$

where c is the speed of light and τ is the clock bias in seconds, tau is the clock drift, Pₓ,P_{y},P_{z}, are the three components of the position vector, and Vₓ,V_{y},V_{z} are the three components of the velocity. The dynamics matrix Φ is approximated as Φ=I+AΔt where Δt is the time step between step k and k+1 and A defines us as:

$$A = [ \begin{matrix}0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 1 & 0 \\ 0 & 0 & 0 & 0 & 0 & 0 & 0 & 0\end{matrix} ] \qquad ( 470 )$$

In this case Γ and ω are an appropriate process noise system. One possible combination is defined as:

$$Γ = [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 0 \\ 0 & 0 & 0 & 1\end{matrix} ] \qquad ( 471 )$$

and ω=[ω_{V}_{ₓ}ω_{V}_{_{y}}ω_{V}_{_{z}}ω_{\dot{τ}}]^{T} where each component represents a zero mean, white noise process and E[ωω^{T}]=W.

Again, the number of states created is equal to the number of GPS satellite measurements plus one. This is because each state will effectively be calculated with a subset of all of the measurements except for one satellite. This one satellite will be excluded and assumed to be faulty within each state. In addition, there will be a final baseline state which processes all measurements.

GPS Measurement

The GPS measurement model for a range measurement ρᵢ for satellite i is the same as defined previously. The GPS measurement for \dot{ρ}ᵢ, the range rate measurement is given as:
\tilde{\dot{ρ}}ᵢ=\overline{ρ}+C_{\dot{ρ}i}δx+c\overline{τ}+μᵢ+v_{\dot{ρ}i} (472)

Note that in this case, μᵢ may be modelled as a separate fault mode than for the code. However, in the current problem, the range and range rate measurements are assumed to suffer from the same satellite failure. The matrix C_{\dot{ρ}i} is defined as in Eq. 254 as:

$${C}_{i} = [ \begin{matrix}\frac{- ( {X}_{i} - {\overline{P}}_{x} )}{{\overline{ρ}}_{i}} & \frac{- ( {Y}_{i} - {\overline{P}}_{y} )}{{\overline{ρ}}_{i}} & \frac{- ( {Z}_{i} - {\overline{P}}_{z} )}{{\overline{ρ}}_{i}} & 0 & 0 & 0 & 1 & 0 \\ \frac{δ \dot{ρ}}{δ {P}_{x}} & \frac{δ \dot{ρ}}{δ {P}_{y}} & \frac{δ \dot{ρ}}{δ {P}_{z}} & \frac{- ( {X}_{i} - {\overline{P}}_{x} )}{{\overline{ρ}}_{i}} & \frac{- ( {Y}_{i} - {\overline{P}}_{y} )}{{\overline{ρ}}_{i}} & \frac{- ( {Z}_{i} - {\overline{P}}_{z} )}{{\overline{ρ}}_{i}} & 0 & 1\end{matrix} ] \qquad ( 473 )$$

The matrix C will now represent the total set of measurement matrices for all available measurements of range and range rate such that

$$[ \begin{matrix}\tilde{ρ} \\ \dot{\tilde{ρ}}\end{matrix} ] = [ \begin{matrix}\overline{ρ} \\ \dot{\overline{ρ}}\end{matrix} ] + C δ x + {μ}_{i} + [ \begin{matrix}{v}_{i} \\ {v}_{\dot{ρ} i}\end{matrix} ] \qquad ( 474 )$$

where \tilde{ρ} is a column vector of all of the available measurements. Finally, the matrix C_{j≠i} will represent all measurements except the range and range rate measurements for satellite i.

The term μᵢ represents a fault in the satellite. The term vᵢ is the measurement noise and is assumed zero mean with variance V. This model assumes that several models.

GPS Fault Modelling

Again, the projector used for a particular model simply eliminates one measurement from the set of all measurements. A reduced set of measurements remains. Therefore for each satellite failure, no projection process is required.

Residual Process

As stated, the effect of the projector simply eliminates one measurement for that satellite. The residual process for this case is given as:
\overline{r}ᵢ=\tilde{ρ}_{j≠i}−\overline{ρ}_{j≠i}−C_{j≠i}δ\overline{x}ᵢ (475)
where δxᵢ is the state assumed to be free of a fault from satellite i. Similarly, the notation \tilde{ρ}_{j≠i} is taken to mean the total vector of measurements including range and range rate except those associated with satellite i. The notation is condensed for convenience.
Gain Calculation

The gain and covariance are updated as:
Mᵢ(k)=Pᵢ(k)−Pᵢ(k)C_{j≠i}^{T}(V_{j≠i}+C_{j≠i}Pᵢ(k)C_{j≠i}^{T})⁻¹C_{j≠i}Pᵢ(k) (476)
Kᵢ=Pᵢ(k)C_{j≠i}^{T}V_{j≠i}⁻¹ (477)
where Kᵢ is the Kalman Filter Gain.
State Correction Process

The state correction process is simply:
δ\hat{x}ᵢ(k)=δ\overline{x}ᵢ(k)+Kᵢrᵢ (478)
Updated Residual Process

The updated residual process is defined as:
\hat{r}ᵢ=\tilde{ρ}_{j≠i}−\overline{ρ}_{j≠i}−C_{j≠i}δ\hat{x}ᵢ (479)
Residual Testing

In this case, the Shiryayev Test is invoked, although other methods may be used. The Shiryayev Test may be used to process the updated residual to determine the probability of a failure.

As before, each state xᵢ assumes the existence of a failure in one satellite except the baseline, healthy case. Each hypothesized failure has a an associated probability of being true defined as φᵢ(k) before updating with the residual \hat{r}_{Fi}(k). The probability that the system is healthy is likewise

$${ϕ}_{0} ( k ) = 1 - {\sum }_{i = 1}^{N} {ϕ}_{i} ( k ) .$$

A probability density function f₀(\hat{r}₀,k) and fᵢ(\hat{r}ᵢ,k) is assumed for each hypothesis. In this case, if we assume that the process noise and measurement noise are Gaussian, then the probability density function for the residual process is the Gaussian using

$${f}_{i} ( {\hat{r}}_{i} , k ) = \frac{1}{{( 2 π )}^{n / 2} ‖ {P}_{Fi} ‖} exp \{ - \frac{1}{2} {\hat{r}}_{i} ( k ) {P}_{Fi}^{- 1} {\hat{r}}_{i} ( k ) \} \qquad ( 480 )$$

where P_{Fi} is the covariance of the residual \hat{r}_{F}(k) and ∥.∥ defines the matrix 2-norm. The covariance P_{Fi} is defined as:
P_{Fi}=C_{j≠i}MᵢC_{j≠i}_{T}+V_{j≠i} (481)

From this point, it is possible to update the probability that a fault has occurred for all hypotheses. The following relationship calculates the probability that the fault has occurred.

$${G}_{i} ( k ) = \frac{{ϕ}_{i} ( k ) {f}_{i} ( {\hat{r}}_{i} , k )}{{\sum }_{i = 1}^{N} {ϕ}_{i} ( k ) {f}_{i} ( {\hat{r}}_{i} , k ) + {ϕ}_{0} ( k ) {f}_{0} ( {\hat{r}}_{0} , k )} \qquad ( 482 )$$

From time step to time step, the probability must be propagated using the probability p that a fault may occur between any time steps k and k+1. The propagation of the probabilities is given as:

$${ϕ}_{i} ( k + 1 ) = {G}_{i} ( k ) + \frac{p}{N} ( 1 - {\sum }_{i = 1}^{N} {G}_{i} ( k ) ) \qquad ( 483 )$$

Note that for any time step, the healthy hypothesis may be updated as:

$$\begin{matrix}{G}_{0} ( k ) = 1 - {\sum }_{i = 1}^{N} {G}_{i} ( k ) and & ( 484 ) \\ {ϕ}_{0} ( k + 1 ) = 1 - {\sum }_{i = 1}^{N} {ϕ}_{1} ( k + 1 ) & ( 485 )\end{matrix}$$

In this way the probability that a failure has occurred in any satellite is defined and calculated.

Declaration

Declaration occurs when one of the probabilities of a failure takes on a value above a threshold.

Propagation

Propagation of both the state and the covariance are completed as follows:
\overline{x}ᵢ(k+1)=Φ\hat{x}ᵢ(k) (486)
P₀(k+1)=Φ(k)M₀(k)Φ^{T}(k)+W (487)
Adding Vehicle Dynamics

If vehicle dynamics are present using a control system, then the GPS receiver system may be used to detect failures within the control system. Actuator faults may be detected using the GPS measurements. In this case the dynamics are;
x(k+1)=Φx(k)+Γω+Fμ+Γ_{c}u(k) (488)

In this case the the matrix Γ_{c} represents the control matrix and the command u(k) is provided by a control system. The failure mode F=−Γ_{c} for one or more of the commands u(k) so that the fault directly affects the actual command input.

Using this methodology, a fault detection filter would be constructed for each actuator failure modeled.

GPS/INS Fault Tolerant Navigation

Previous sections disclosed by example some of the components for GPS/INS Fault Tolerant Navigation System embodiments of the present invention. The following discloses a new method for integrating these components into a system for detecting, isolating, and reconfiguring the navigation system using for example IMU failure modes.

If all of the GPS and IMU measurements are working properly, then it is possible to operate using the GPS/INS EKF previously presented. However, in the presence of a single axis failure in the IMU, a different methodology is necessary. The Fault Tolerant Navigator is typically comprised of three parts. First, a bank of Fault Detection Filters, each tuned to block the fault from one of the IMU axes, are formed. Given a single axis IMU failure, one of these filters remains impervious to the fault. Then the output of the residuals are input to a Multiple Hypothesis Shiryayev SPRT. The MHSSPRT calculates the probability that a fault has occurred. Finally, decision logic reconfigures the system to operate in a degraded mode in order to continue navigating even in the presence of the fault. The output of the filter is the preferred estimate of the state using GPS and an IMU with a fault in one axis. The output may be used for aircraft carrier landing, aerial refueling, or may be used as a feedback into an ultra-tight GPS receiver.

Further description of the GPS/INS Fault Tolerant Navigation is explained in three portions: (a) the structure for detecting accelerometer faults is discussed; (b) the gyro faults; and (c) the Shiryayev Test is explained as steps for detecting and isolating the fault.

Gyro Fault Detection Filter

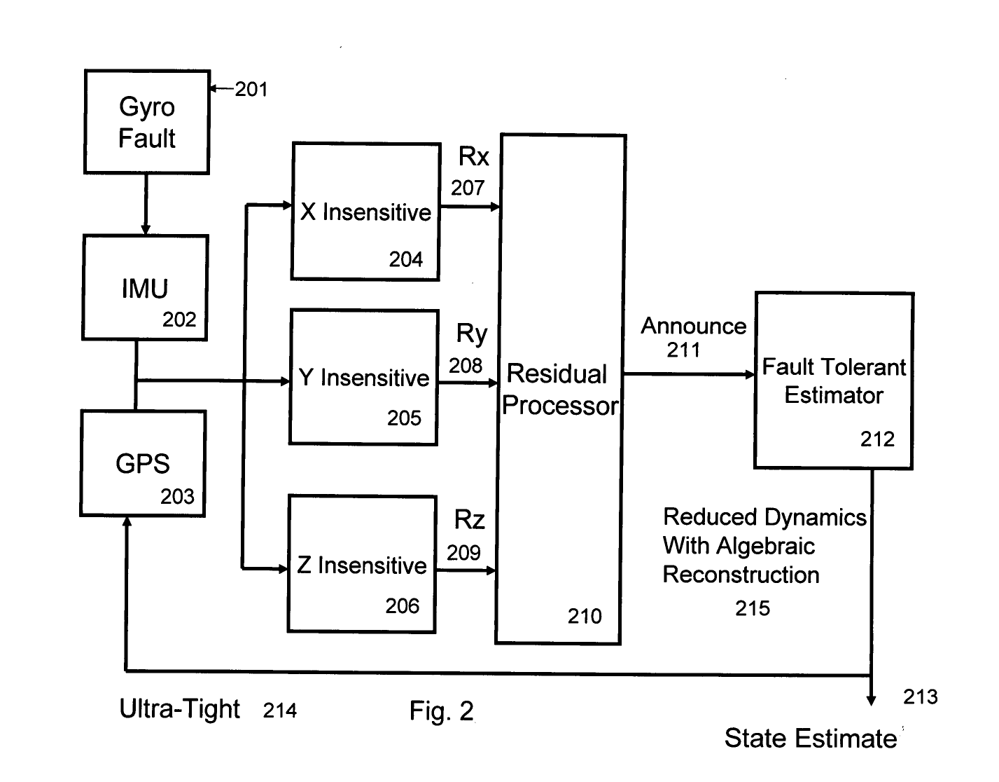

FIG. 2 displays a realization of the gyro fault detection filter using a GPS 203 and an IMU 202 designed to detect the gyro failure 201. In order to detect gyro faults, three or more fault detection filters 204, 205, 206 operate on the measurements generated by the GPS and the IMU, where each filter is adapted to reject one of the gyro axis faults in one direction while amplifying faults from the other two directions. Each filter produces a residual 207, 208, 209 respectively. These residuals are tested in the residual processor 210 and based on the tests, and announcement 211 is made. Using this announcement, the fault tolerant estimator 212 chooses the filter 204, 205, or 206 which is not affected by the fault and outputs the state estimate 213 from this filter. Additional reduction of order or algebraic reconstruction of the state or measurements 215 is possible. If the system is an ultra-tight GPS/INS then the state estimate is fed back to the GPS receiver 214. In this way, if a single axis failure occurs, the filter designed to eliminate the effect of this fault is used in the reconfiguration process and is never corrupted by the fault.

The gyro fault detection filter design of the fault detection filters for gyro faults in the GPS/IMU filter structure is disclosed, particularly the method of their design, output separability and processing.

Gyro Fault Modeling

The gyro fault model is derived from the basic GPS/INS EKF. The measurement model is augmented with fault states, one for each axis. The new measurement model is defined as:
\tilde{ω}_{IB}^{B}=m_{g}ω_{IB}^{B}+b_{g}+v_{g} (489)
and
b_{g}=V_{b}_{_{g}}+μ_{g}, (490)
where the values have the same definition as in Eq. 213 and μ_{g} is a vector of three fault directions, one for each gyro axis. The value of μ is unknown. Only the direction is specified. Using this new measurement model, the continuous time dynamic system for the GPS/INS EKF given in Eq. 236 is modified to include the fault directions. The dynamic model is given as:
δ\dot{x}=Aδx+Bω+f_{g}μ_{g}, (491)
where the fault direction f_{g} is defined as:

$${f}_{g} = [ \begin{matrix}{0}_{3 \times 3} \\ {0}_{3 \times 3} \\ {0}_{3 \times 3} \\ {I}_{3 \times 3} \\ {0}_{3 \times 3} \\ {0}_{2 \times 3}\end{matrix} ] . \qquad ( 492 )$$

However, one consequence of this choice is that the gyro fault enters into the Doppler GPS measurements. The Doppler error model in Eq. 274 becomes the following with the addition of the fault in the gyro.
δV_{GPS}=δV_{INS}+V_{vq}δq−C_{\overline{B}}^{E}[L×]δb_{g}+−C_{\overline{B}}^{E}[L×]μ_{g} (493)

The new measurement model is similar to the baseline model in Eq. 88 with the value of E=−C_{\overline{B}}^{E}[L×]. An equivalent fault direction in the dynamics is selected such that Cf_{new}=E. In the present example, preferably the fault direction is selected to be time invariant, i.e.,

$${f}_{new} = [ \begin{matrix}{0}_{3 \times 3} \\ {0}_{3 \times 3} \\ {0}_{3 \times 3} \\ {I}_{3 \times 3} \\ {0}_{3 \times 3} \\ {0}_{2 \times 3}\end{matrix} ] , \qquad ( 494 )$$

which was the original design choice. However, the process of transferring a measurement fault into the dynamics costs an extra set of fault directions. The new fault direction matrix f_{g}=[fₙew,Afₙew] which conveniently turns out to be the following time invariant matrix:

$${f}_{g} = [ \begin{matrix}{0}_{3 \times 3} & {0}_{3 \times 3} \\ {0}_{3 \times 3} & {0}_{3 \times 3} \\ {0}_{3 \times 3} & \frac{1}{2} {I}_{3 \times 3} \\ {I}_{3 \times 3} & {0}_{3 \times 3} \\ {0}_{3 \times 3} & {0}_{3 \times 3} \\ {0}_{2 \times 3} & {0}_{2 \times 3}\end{matrix} ] \qquad ( 495 )$$

Note that the fault now enters through the gyro bias and the attitude of the vehicle.

One or ordinary skill in the are will recognize that a different choice of the original gyro model results in a different fault matrix as does the selection of a set of different values for the matrix f_{new}.

The discrete time filter is preferably derived as:
δx(tₖ₊₁)=Φδx(tₖ)+Γvₚ+Fμ_{g} (496)
with the transformations detailed above.

With examples of the dynamics and fault directions are defined, the preferred next stage is to designate the faults are to be treated as target faults and those faults that are to be treated as nuisance faults. This treatment of faults are typically based upon the type of detection process employed. For the instant example, three filters are designed. Each filter is designed to make two of the gyro axis directions target faults while the third is designated as the nuisance fault. In this way, if one of the gyro instruments fails in any way, one of the filters will be immune to the effects while the other two filters are affected. This configuration makes detection and reconfiguration very easy since the detection problem includes the step of finding the filter operating normally and the reconfiguration problem includes the step of transferring from the normal filter structure to one filter that was immune to the fault.

To separate the filter, preferably the matrix f_{g} is dissected. Those columns that are in the target fault space are separated into target faults. Those in the nuisance fault space are in the nuisance fault. For example, if the gyro in the x direction is designated the nuisance fault, then f₁ and f₂ are defined as follows:

$$\begin{matrix}{f}_{{2}_{x}} = [ \begin{matrix}{0}_{3 \times 1} & {0}_{3 \times 1} \\ {0}_{3 \times 1} & {0}_{3 \times 1} \\ 0 & \frac{1}{2} \\ 0 & 0 \\ 0 & 0 \\ 1 & 0 \\ 0 & 0 \\ 0 & 0 \\ {0}_{3 \times 1} & {0}_{3 \times 1} \\ {0}_{2 \times 1} & {0}_{2 \times 1}\end{matrix} ] and & ( 497 ) \\ {f}_{{1}_{yz}} = [ \begin{matrix}{0}_{3 \times 1} & {0}_{3 \times 1} & {0}_{3 \times 1} & {0}_{3 \times 1} \\ {0}_{3 \times 1} & {0}_{3 \times 1} & {0}_{3 \times 1} & {0}_{3 \times 1} \\ 0 & 0 & 0 & 0 \\ 0 & \frac{1}{2} & 0 & 0 \\ 0 & 0 & 0 & \frac{1}{2} \\ 0 & 0 & 0 & 0 \\ 1 & 0 & 0 & 0 \\ 0 & 0 & 1 & 0 \\ {0}_{3 \times 1} & {0}_{3 \times 1} & {0}_{3 \times 1} & {0}_{3 \times 1} \\ {0}_{2 \times 1} & {0}_{2 \times 1} & {0}_{2 \times 1} & {0}_{2 \times 1}\end{matrix} ] . & ( 498 )\end{matrix}$$

The discrete time system becomes:
δx(tₖ₊₁)=Φδx(tₖ)+Γvₚ+F₁μ_{g}_{_{yz}}+F₂μ_{g}_{ₓ} (499)
where μ_{g}_{ₓ} are the fault signals associated with the x axis gyro fault, i.e., the nuisance fault, and μ_{g}_{_{yz}} are the fault signals associated with the y and z axis gyro faults, i.e., the target faults. In this way, three filter models are constructed, each with a different dynamic model. Filter 1, designed to be impervious to the x axis gyro fault is expressed in Eq. 499. For the second filter of the present example, a design is chosen to be impervious to a y axis fault, the dynamic model is
δx(tₖ₊₁)=Φδx(tₖ)+Γvₚ+F₁μ_{g}_{_{zz}}+F₂μ_{g}_{_{y}} (500)
where F₁ and F₂ are now defined from f₁ and f₂ which are:

$$\begin{matrix}{f}_{{2}_{y}} = [ \begin{matrix}{0}_{3 \times 1} & {0}_{3 \times 1} \\ {0}_{3 \times 1} & {0}_{3 \times 1} \\ 0 & 0 \\ 0 & \frac{1}{2} \\ 0 & 0 \\ 0 & 0 \\ 1 & 0 \\ 0 & 0 \\ {0}_{3 \times 1} & {0}_{3 \times 1} \\ {0}_{2 \times 1} & {0}_{2 \times 1}\end{matrix} ] and & ( 501 ) \\ {f}_{{1}_{xz}} = [ \begin{matrix}{0}_{3 \times 1} & {0}_{3 \times 1} & {0}_{3 \times 1} & {0}_{3 \times 1} \\ {0}_{3 \times 1} & {0}_{3 \times 1} & {0}_{3 \times 1} & {0}_{3 \times 1} \\ 0 & \frac{1}{2} & 0 & 0 \\ 0 & 0 & 0 & 0 \\ 0 & 0 & 0 & \frac{1}{2} \\ 0 & 0 & 0 & 0 \\ 1 & 0 & 0 & 0 \\ 0 & 0 & 1 & 0 \\ {0}_{3 \times 1} & {0}_{3 \times 1} & {0}_{3 \times 1} & {0}_{3 \times 1} \\ {0}_{2 \times 1} & {0}_{2 \times 1} & {0}_{2 \times 1} & {0}_{2 \times 1}\end{matrix} ] . & ( 502 )\end{matrix}$$

For the third filter, designed to be impervious to a Z axis fault, the dynamic model is
δx(tₖ₊₁)=Φδx(tₖ)+Γvₚ+F₁μ_{g}_{_{xy}}+F₂μ_{g}_{_{z}} (503)
where F₁ and F₂ are now defined from f₁ and f₂ which are:

$$\begin{matrix}{f}_{{2}_{z}} = [ \begin{matrix}{0}_{3 \times 1} & {0}_{3 \times 1} \\ {0}_{3 \times 1} & {0}_{3 \times 1} \\ 0 & 0 \\ 0 & 0 \\ 0 & \frac{1}{2} \\ 0 & 0 \\ 0 & 0 \\ 1 & 0 \\ {0}_{3 \times 1} & {0}_{3 \times 1} \\ {0}_{2 \times 1} & {0}_{2 \times 1}\end{matrix} ] and & ( 504 ) \\ {f}_{{1}_{xz}} = [ \begin{matrix}{0}_{3 \times 1} & {0}_{3 \times 1} & {0}_{3 \times 1} & {0}_{3 \times 1} \\ {0}_{3 \times 1} & {0}_{3 \times 1} & {0}_{3 \times 1} & {0}_{3 \times 1} \\ 0 & \frac{1}{2} & 0 & 0 \\ 0 & 0 & 0 & \frac{1}{2} \\ 0 & 0 & 0 & 0 \\ 1 & 0 & 0 & 0 \\ 0 & 0 & 1 & 0 \\ 0 & 0 & 0 & 0 \\ {0}_{3 \times 1} & {0}_{3 \times 1} & {0}_{3 \times 1} & {0}_{3 \times 1} \\ {0}_{2 \times 1} & {0}_{2 \times 1} & {0}_{2 \times 1} & {0}_{2 \times 1}\end{matrix} ] . & ( 505 )\end{matrix}$$

This defines the three fault detection filter structures required for use to detect faults in either of the three gyros.

Gyro Fault Detection Filter Processing

The processing now proceeds as a combination between the EKF and the fault detection filter where the steps of the process is preferably followed for each filter structure. There are three separate structures, each designed to be immune to a different fault. Preferably, the only commonality between the filters are the inputs and the acceleration and angular rate as well as GPS measurements are the same for each filter. The processing is the same, but each filter uses the different fault direction matrices described above.

Collecting the measurements: At time tₖ, the IMU measurements ã(tₖ) and \tilde{ω}_{I\overline{B}}_{\overline{B}}(tₖ) are collected. Each filter receives a copy of these unprocessed measurements. Then the copied measurements are corrected with for bias errors that have been estimated in each filter.

Propagating the dynamics: Propagating the dynamics with the IMU measurements at tₖ and the state estimate at tₖ₋₁. With each new set of IMU measurements, generate the dynamics, and form the state transition matrix. The dynamics matrix A is defined as:

$$A ( {t}_{k } ) = [ \begin{matrix}{0}_{3 \times 3} & {I}_{3 \times 3} & {0}_{3 \times 3} & {0}_{3 \times 3} & {0}_{3 \times 3} & 0 & 0 \\ G - {( {Ω}_{IE}^{E} )}^{2} & - 2 {Ω}_{IE}^{E} & - 2 {C}_{\frac{E}{B}} F & {0}_{3 \times 3} & {C}_{\frac{E}{B}} & 0 & 0 \\ {0}_{3 \times 3} & {0}_{3 \times 3} & - {Ω}_{I \overline{B}}^{\overline{B}} & \frac{1}{2} {I}_{3 \times 3} & {0}_{3 \times 3} & 0 & 0 \\ {0}_{3 \times 3} & {0}_{3 \times 3} & {0}_{3 \times 3} & {0}_{3 \times 3} & {0}_{3 \times 3} & 0 & 0 \\ {0}_{3 \times 3} & {0}_{3 \times 3} & {0}_{3 \times 3} & {0}_{3 \times 3} & {0}_{3 \times 3} & 0 & 0 \\ {0}_{1 \times 3} & {0}_{1 \times 3} & {0}_{1 \times 3} & {0}_{1 \times 3} & {0}_{1 \times 3} & 0 & 1 \\ {0}_{1 \times 3} & {0}_{1 \times 3} & {0}_{1 \times 3} & {0}_{1 \times 3} & {0}_{1 \times 3} & 0 & 0\end{matrix} ] \qquad ( 506 )$$

with definitions associated with Eq. 236. The state transition matrix is formed using A(tₖ). A simple approximation may be made using Φ(tₖ,tₖ₋₁)=I+AΔt, although other approximations or even direct calculations are possible. This may be done at the IMU rate or at a slower rate as required by the designer.

Propagating the fault direction and process noise: The discrete time process noise and fault directions are calculated in the following way.

For each fault direction matrix f₁ or f₂, the discrete time matrix is approximated as:

$$F = ( I Δ t + \frac{1}{2} A ( {t}_{k} ) Δ {t}^{2} ) f \qquad ( 507 )$$

However, direct calculation could be possible. Other approximations may be chosen for reduced computation time. The process noise from the continuous time model must be converted to the discrete time version. If the process noise v is zero mean Gaussian with power spectral density of N, then:

$$W = ( I Δ t + \frac{1}{2} A ( {t}_{k} ) {( Δ t )}^{2} ) {N ( I Δ t + \frac{1}{2} A ( {t}_{k} ) {( Δ t )}^{2} )}^{T} \qquad ( 508 )$$

Propagating the Covariance matrix: Given the updated covariance M(tₖ₋₁), the updated covariance is calculated as:

$$\begin{matrix}Π ( {t}_{k} ) = Φ ( {t}_{k} , {t}_{k - 1} ) M ( {t}_{k - 1} ) {Φ}^{T} ( {t}_{k} , {t}_{k - 1} ) + \frac{1}{γ} {F}_{2} {Q}_{2} {F}_{2}^{T} + W - & ( 509 ) \\ {F}_{1} {Q}_{1} {F}_{1}^{T} & \end{matrix}$$

where γ, Q₁ and Q₂ are design variables. Note that if GPS measurements are not available at the next time step, the propagation is performed setting M(tₖ)=Π(tₖ).

Integrating the IMU measurements: Integrating the IMU measurements preferably using the navigation processor described above. Each filter integrates the same measurements separately so that there are three different navigation states, one for each fault detection filter. These may be integrated at any desirable rate. When GPS measurements are available, the fault detection filter processing begins in the next step.

Testing: If GPS measurements are available, the next steps are performed to correct the state and examine the IMU for faults. If not, then the process is repeated at the next time step.

Calculating the GPS measurement residual: The first step is to transfer the navigation state from the INS to the antenna to form a priori measurements of the range and range rate. The position and velocity of the state at the GPS antenna are given by:
\overline{P}_{GPS}_{_{E}}=\overline{P}_{INS}_{_{E}}+C_{\overline{B}}^{E}L (510)
and
\overline{V}_{GPS}_{_{E}}=\overline{V}_{INS}_{_{E}}+C_{\overline{B}}^{E}(\tilde{ω}_{I\overline{B}}^{\overline{B}}×L)−ω_{IE}^{E}×C_{\overline{B}}^{E}L. (511)

Then, using the position and velocity, determining the a priori range measurement for each satellite. For satellite i, the range is represented as:
\overline{ρ}ᵢ=∥P_{Sat}_{ᵢ}−P_{GPS}_{_{E}}∥+c\overline{τ} (512)
where c\overline{τ} is the a priori estimate of the clock bias multiplied by the speed of light. Likewise the range rate measurement for each satellite is represented as:

$${\dot{\overline{ρ}}}_{i} = \frac{( {P}_{{Sat}_{i}} - {\overline{P}}_{{GPS}_{E}} ) ( {V}_{{Sat}_{i}} - {\overline{V}}_{{GPS}_{E}} )}{‖ {P}_{{Sat}_{i}} - {\overline{P}}_{{GPS}_{E}} ‖} + c \dot{\overline{τ}} . \qquad ( 513 )$$

Then the a priori residual vector r is formed for all of the measurements. The measured range \tilde{ρ} and range rate \tilde{\dot{ρ}} are subtracted from the a priori estimates to form the residual.

$$\overline{r} ( {t}_{k} ) = [ \begin{matrix}\tilde{ρ} ( {t}_{k} ) - \overline{ρ} ( {t}_{k} ) \\ \dot{\tilde{ρ}} ( {t}_{k} ) - \dot{\overline{ρ}} ( {t}_{k} )\end{matrix} ] . \qquad ( 514 )$$

The notation \overline{r} is used to denote the a priori residual since the residual is formed with a priori state information.

Calculating the measurement matrix: Calculating the measurement matrix for the n GPS measurements:

$$\begin{matrix}C = {[ \begin{matrix}\frac{( {X}_{i} - \vec{\overline{x}} )}{{ρ}_{i}} & {0}_{n \times 3} \\ \frac{δ \dot{ρ}}{δ \vec{x}} & \frac{( {X}_{i} - \vec{\overline{x}} )}{{ρ}_{i}}\end{matrix} ]}_{2 n \times 6} & ( 515 ) \\ {[ \begin{matrix}{I}_{3 \times 3} & {0}_{3 \times 3} & - 2 {C}_{\frac{E}{B}} [ L \times ] & {0}_{3 \times 3} & {0}_{3 \times 3} & 1 & 0 \\ {0}_{3 \times 3} & {I}_{3 \times 3} & {V}_{vq} & - {C}_{\frac{E}{B}} [ L \times ] & {0}_{3 \times 3} & 0 & 1\end{matrix} ]}_{6 \times 17} & \end{matrix}$$

The alternative use of the transfer matrix T_{INS}^{GPS} described above is preferred for differential GPS embodiments. It is not used here for ease of notation and convenience in explaining by example.

Determining the projector H for the nuisance fault:
H=I−(CF₂)[(CF₂)^{T}(CF₂)]⁻¹(CF₂)^{T} (516)

Determining the gain K and update the covariance M(tₖ) using the associated measurement covariance V:
R=V⁻¹−HQₛH^{T}; (517)
M(tₖ)=Π(tₖ)−Π(tₖ)C^{T}(R+CΠ(tₖ)C^{T})⁻¹CΠ(tₖ); (518)
and
K=Π(tₖ)C^{T}(R+CΠ(tₖ)C^{T})⁻¹ (519)

Correcting the state estimate: Multiplying the gain times the residual to get the correction to the state estimate:
c=K\overline{r}. (520)

The navigation state is then corrected with the state information at the GPS receiver to form the state \hat{x}(tₖ). The state may then be transferred back to the IMU using the relationships described above. The state is now ready to be propagated again and the process restarts.

Determining the a posteriori residual for analysis: The residual \hat{r} is calculated using the updated state and the measurements previously processed as:

$$\hat{r} ( {t}_{k} ) = [ \begin{matrix}{ρ}^{\dot{\sim}} ( {t}_{k} ) - \hat{ρ} ( {t}_{k} ) \\ \dot{\tilde{ρ}} ( {t}_{k} ) - \dot{\hat{ρ}} ( {t}_{k} )\end{matrix} ] , \qquad ( 521 )$$

where the values of \hat{ρ}(tₖ) and \hat{\dot{ρ}}(tₖ) are calculated using \hat{x}(tₖ).

Examining the residual \hat{r}(tₖ) for faults. Using detection methodology, i.e., detection steps, such as the Shiryayev Test, Least Squares, or Chi-Square methodologies, target faults in the system should be visible if they exist while nuisance faults should not influence the statistical properties of the residual.

Accelerometer Fault Detection Filter

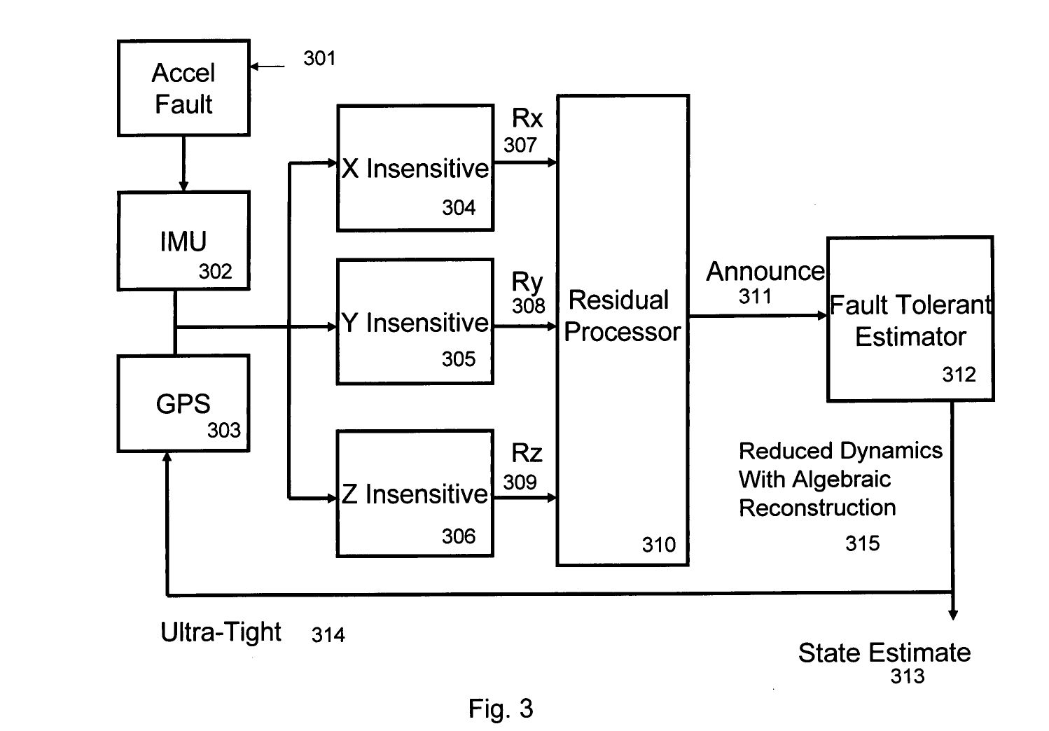

Accelerometer fault detection filters may also be constructed for the case of using GPS/INS. FIG. 3 shows one possible configuration. The GPS receiver 303 and IMU 302 both produce measurements. The IMU has a failure in an accelerometer 301 that must be detected. As with the gyro faults, three separate filter structures 304, 305, 306 are constructed. Each one with a different accelerometer axis isolated as the nuisance fault. Each filter produces a residual 307, 308, 309 respectively. These residuals are tested in the residual processor 310 and based on the tests, and announcement 311 is made. Using this announcement, the fault tolerant estimator 312 chooses the filter 304, 305, or 306 which is not affected by the fault and outputs the state estimate 313 from this filter. Additional reduction of order or algebraic reconstruction of the state or measurements 315 is possible. If the system is an ultra-tight GPS/INS then the state estimate is fed back to the GPS receiver 314.

The processing proceeds with similar steps to the gyro case except for the following modifications. In some embodiments, both the gyro filter and accelerometer filters may operate in parallel for a total of six fault detection filters.

Accelerometer Fault Modeling

The accelerometer fault model is derived from the IMU error model. The measurement model is augmented with fault states, one for each axis. The new measurement model is defined as:
ã_{B}=mₐa_{B}+bₐ+vₐ+μₐ (522)
\dot{b}ₐ=v_{b}_{ₐ} (523)
where the values have the same definition as in Eq. 211 and μₐ is a vector of three fault directions, one for each accelerometer axis. The value of μ is unknown. Only the direction is specified. This filter structure may be embodied variously where the present example is described because the acceleration faults are directly observable with the Doppler measurements. In this embodiment, the filter structure anticipates three possible faults, one in each accelerometer axis. Three filters are constructed as with the gyro faults. The first of three fault detection filters is designed preferably to be substantially impervious to the x accelerometer fault. The x axis is the nuisance fault and the y and z axes are the target faults. The nuisance fault direction for the x accelerometer as:

$${f}_{{2}_{x}} = [ \begin{matrix}{0}_{3 \times 1} \\ 1 \\ 0 \\ 0 \\ {0}_{3 \times 1} \\ {0}_{3 \times 1} \\ {0}_{3 \times 1} \\ {0}_{2 \times 1}\end{matrix} ] \qquad ( 524 )$$

The target faults are defined as:

$${f}_{{1}_{yz}} = [ \begin{matrix}{0}_{3 \times 1} & {0}_{3 \times 1} \\ 0 & 0 \\ 1 & 0 \\ 0 & 1 \\ {0}_{3 \times 1} & {0}_{3 \times 1} \\ {0}_{3 \times 1} & {0}_{3 \times 1} \\ {0}_{3 \times 1} & {0}_{3 \times 1} \\ {0}_{2 \times 1} & {0}_{2 \times 1}\end{matrix} ] \qquad ( 525 )$$

The second filter is designed to be impervious to the y axis accelerometer fault. The nuisance fault is defined as:

$${f}_{{2}_{y}} = [ \begin{matrix}{0}_{3 \times 1} \\ 0 \\ 1 \\ 0 \\ {0}_{3 \times 1} \\ {0}_{3 \times 1} \\ {0}_{3 \times 1} \\ {0}_{2 \times 1}\end{matrix} ] , \qquad ( 526 )$$

with the target faults defined as:

$${f}_{{1}_{xz}} = [ \begin{matrix}{0}_{3 \times 1} & {0}_{3 \times 1} \\ 1 & 0 \\ 0 & 0 \\ 0 & 1 \\ {0}_{3 \times 1} & {0}_{3 \times 1} \\ {0}_{3 \times 1} & {0}_{3 \times 1} \\ {0}_{3 \times 1} & {0}_{3 \times 1} \\ {0}_{2 \times 1} & {0}_{2 \times 1}\end{matrix} ] . \qquad ( 527 )$$

Finally the third filter is designed to be impervious to the z accelerometer fault. The nuisance fault is defined as:

$${f}_{{2}_{x}} = [ \begin{matrix}{0}_{3 \times 1} \\ 0 \\ 0 \\ 1 \\ {0}_{3 \times 1} \\ {0}_{3 \times 1} \\ {0}_{3 \times 1} \\ {0}_{2 \times 1}\end{matrix} ] , \qquad ( 528 )$$

with the target faults defined as:

$${f}_{{1}_{xy}} = [ \begin{matrix}{0}_{3 \times 1} & {0}_{3 \times 1} \\ 1 & 0 \\ 0 & 1 \\ 0 & 0 \\ {0}_{3 \times 1} & {0}_{3 \times 1} \\ {0}_{3 \times 1} & {0}_{3 \times 1} \\ {0}_{3 \times 1} & {0}_{3 \times 1} \\ {0}_{2 \times 1} & {0}_{2 \times 1}\end{matrix} ] . \qquad ( 529 )$$

The processing now proceeds with steps analogous to those described above with the gyro example with each filter operating independently on the same set of inputs with the differences defined previously.

Detection, Isolation, and Reconfiguration

The previous sections dealt with the design of a Fault Tolerant GPS/INS system that could be used for blocking certain types of faults while amplifying others. This section relates those results to the problems of detection, isolation, and reconfiguration. The discussion is more general. However, for the purposes of implementation, the general procedures described in the integrity machine portion are preferably used. Detection may be treated in a statistical form in which the predicted statistics of the posteriori residual r are compared with the expected statistics. The comparison may be made in one of many ways. A Chi-Square statistic is typical of RAIM types of algorithms. A least squares approach is a simpler method also employed by RAIM types of algorithms.

Finally, the preferred embodiment executes the Shiryayev test described above. This filter structure uses the residual \hat{r} as an input along with the expected statistics of the residual. The Shiryayev test hypothesizes the effect of each fault type on the residual and tests against those results. For the present example, the detection step is reduced to determining which filter structure is no longer zero mean and which filter remains zero mean. The detection and isolation procdures are combined into one. When the Shiryayev Test is employed in a fault situation, one of the fault detection filters will remain zero mean while the others drift away. The MHSSPRT estimates the probability that the fault has occurred based upon these residual processes.

One embodiment forms seven hypotheses. The first hypothesis assumes no faults are present. In this case, the GPS/INS EKF would have a residual with zero mean and known noise statistics based upon the IMU and GPS noise models. This is the base hypothesis. The other six hypotheses each assume that a fault has occurred in one of the axis. The residual process from each of the six filters is processed. Since each filter is tuned to block a particular fault, the residual which remains the zero mean process is the filter that has successfully blocked the fault, if the fault has occurred. Since the base filter has more information, this filter should outperform the other six if no fault exists. However, if one fault occurs, one filter residual will remain zero mean while all others will exhibit a change in performance. The detection process is solved whenever the MHSSPRT estimates a probability of a fault over a prescribed threshold. The isolation process is also solved since the MHSSPRT detects the probability that a particular fault has occurred given the residual processes. Once the fault is detected and isolated, reconfiguration is possible in one of three ways. First, if sufficient, the filter immune to the fault may continue to operate. Second, the filter that is immune could be used to restart a reduced order filter that would not use the measurements from the faulted instrument. Since the fault detector is immune, the initial condition used in the reduced order filter could be assumed uncorrupted. Another embodiment enhances the fault detection filter with algebraic reconstruction of the measurement using the existing measurements and the dynamic model.

Integrity and Continuity

The issue of integrity and continuity are integral to the design of the GPS/INS EKF Fault Detection Filters. The goal is to provide the highest level of integrity and continuity given a particular measurement rate, probability of false alarm, failure rate, time to alarm, and instrument performance.

In fact, the fault detection methodology combined with the Shiryayev Test define the trade space for the integrity of a given navigation system. Integrity is defined as the probability of a fault that would interrupt operation and still remain undetected. In other words, the problem of integrity is the problem of providing an estimate of the number of times a failure within the system will occur and not be detected by the fault detection system.

The trade space is defined by five variables. The first is the instrument failure rate. If a particular instrument is more prone to failure than another, the effect should be seen in the calculation of integrity. It should also be used in the integrity algorithms. The MHSSPRT takes this into account with the p/M value, which represents the effect of the mean time between failures (MTBF) of the instrument. The MHSSPRT takes this into account by design.

The second variable is the instrument performance. Integrity requires a minimum performance level which must be provided by the instruments. The GPS/INS EKF presented must use instruments that, while healthy, meet the minimum operational requirements for the application. For automated carrier landing, the issue is the ability to measure the relative distance to the carrier at the point of touchdown to within a specified limit. The GPS/INS must be capable of performing this task. The error model in the GPS/INS defines the limit of the ability of the navigation system to operate in a healthy manner.

The measurement rate is also an important factor. The higher the measurement rate, the greater the chance of detection at higher cost. Combining this variable with the fourth variable, time to alarm, helps define the required performance. Given a desired time to alarm and instrument performance, the update rate is specified by the MHSSPRT and fault detection filters. Since the MHSSPRT detects the change in minimum time [11], the measurement rate must be high enough to allow the MHSSPRT to detect the fault to meet the time to alarm requirement, which is application specific.

Finally, the MHSSPRT also defines the probability of a missed alarm. The MHSSPRT structure combines the effects of the MTBF and the desired alarm limit to provide a filter that detects the faults within minimum time. Care must be taken to design the process so that the minimum time to alarm is met while still providing the desired integrity and without generating too many false alarms. Again, the ability to quantitatively determine the probability defines the trade space for missed alarms as well as true alarms.

Continuity is also defined. Continuity is defines as the probability that, once started, a given system will continue to operate regardless of the fault condition. For the aircraft carrier landing problem, once an approach is started, continuity is the probability that the approach will complete successfully. The continuity probability is usually less than integrity, but still large enough that the system should complete successfully even under faulted conditions.

The GPS/INS EKF would be designed to meet minimum performance requirements for continuity. However, under a fault the GPS/INS EKF no longer functions properly. The Fault Detection filters immune to the fault, the reduced order filters, or the filters employing algebraic reconstruction may all be used in the presence of the fault. Each of these has a minimum accuracy attainable given the instruments. In this way, these methods define the minimum performance requirements for the system to maintain a level of continuity. If the continuity requirements for a fault require high precision, then the precision must be provided by one of the fault detection filter structures or variants.

This process applies the the ideas of integrity and continuity in general. For formation flight, a minimum safe operating distance would be defined and the integrity of the system would be limited to detecting a fault which would cause the navigation estimation error to grow beyond the threshold. Continuity would be the ability of the reduced order filter to continue operating within the prescribed error budget. Similar systems may be defined for platoons of trucks, farming equipment or boats.

Additional Instruments

Additional instruments may be employed at the cost of higher complexity. All of the variations described in Sections 4 through 2 are applicable to this system. Adding instruments requires the addition of more filters to detect faults in those instruments. Adding vehicle models would allow the creation of additional filters to detect and isolate actuator faults, but would also allow the vehicle dynamics to stabilize estimates of attitude and velocity making fault detection easier. Pseudo-lites could be added, but these would act in a similar manner to GPS measurements.

Vision based instruments could be added into the system to enhance relative navigation. If known reference points are identified on the target, then the angle information from the vision system along with knowledge of the geometry could be used to generate range and orientation information for mixing into the EKF. Each one of these reference points could be subject to a faulted condition in which a hypothesis testing scheme such as the Shiryayev Test would need to be employed. The next section discusses GPS fault detection which is a similar problem.

Magnetometer

Magnetometers are suggested as measurements to the GPS/INS EKF system enhancing attitude performance. A failure in the magnetometer is a measurement error. The error would be converted to a state space error using the measurement model in Eq. 329 and the process as described in Section 3. Each axis of the magnetometer would have a separate fault. Once converted to the state space model, the same fault detection methodologies would be employed to detect and isolate the magnetometer fault using the GPS and IMU measurements.

The magnetometer measurements are given in Eq. 5. The model utilizes these inputs as measurements. A new filter model could be implemented using position, velocity, and attitude. The system may be calculated using the dynamics defined in Eq. 236 with bias terms may be introduced for each magnetometer model.

The measurement model becomes
\tilde{B}_{B}=(I+[δq×])C_{T}^{\overline{B}}\overline{B}_{T}+\overline{b}_{b}+δb_{b}+v_{b}+μ_{b} (530)

The new state dynamics are

$$δ x = {[ \begin{matrix}δ P \\ δ V \\ δ q \\ δ {b}_{g} \\ δ {b}_{a} \\ δ {b}_{b} \\ c δ τ \\ c δ \dot{τ}\end{matrix} ]}_{20 \times 1} \qquad ( 531 )$$

and new dynamics defined as:

$$A = [ \begin{matrix}{0}_{3 \times 3} & {I}_{3 \times 3} & {0}_{3 \times 3} & {0}_{3 \times 3} & {0}_{3 \times 3} & {0}_{3 \times 3} & 0 & 0 \\ G - {( {Ω}_{IE}^{E} )}^{2} & - 2 {Ω}_{IE}^{E} & - 2 {C}_{\frac{E}{B}} F & {0}_{3 \times 3} & {C}_{\frac{E}{B}} & {0}_{3 \times 3} & 0 & 0 \\ {0}_{3 \times 3} & {0}_{3 \times 3} & - {Ω}_{I \overline{B}}^{\overline{B}} & \frac{1}{2} {I}_{3 \times 3} & {0}_{3 \times 3} & {0}_{3 \times 3} & 0 & 0 \\ {0}_{3 \times 3} & {0}_{3 \times 3} & {0}_{3 \times 3} & {0}_{3 \times 3} & {0}_{3 \times 3} & {0}_{3 \times 3} & 0 & 0 \\ {0}_{3 \times 3} & {0}_{3 \times 3} & {0}_{3 \times 3} & {0}_{3 \times 3} & {0}_{3 \times 3} & {0}_{3 \times 3} & 0 & 0 \\ {0}_{3 \times 3} & {0}_{3 \times 3} & {0}_{3 \times 3} & {0}_{3 \times 3} & {0}_{3 \times 3} & {0}_{3 \times 3} & 0 & 0 \\ {0}_{1 \times 3} & {0}_{1 \times 3} & {0}_{1 \times 3} & {0}_{1 \times 3} & {0}_{1 \times 3} & {0}_{1 \times 3} & 0 & 1 \\ {0}_{1 \times 3} & {0}_{1 \times 3} & {0}_{1 \times 3} & {0}_{1 \times 3} & {0}_{1 \times 3} & {0}_{1 \times 3} & 0 & 0\end{matrix} ] \qquad ( 532 )$$

The measurement fault can be calculated solving the problem of E=CFₘ in which C contains the measurements for either the magnetometer and/or the GPS measurements. In this case, an obvious choice becomes to place the fault in the magnetometer bias as:

$${F}_{m} = [ \begin{matrix}{0}_{3 \times 3} \\ {0}_{3 \times 3} \\ {0}_{3 \times 3} \\ {0}_{3 \times 3} \\ {0}_{3 \times 3} \\ {I}_{3 \times 3} \\ {0}_{1 \times 3} \\ {0}_{1 \times 3}\end{matrix} ] \qquad ( 533 )$$

The process then proceeds as before.

Multiple GPS Receivers

Similarly, the use of multiple GPS receivers to gain attitude information may be used to detect a failure in the satellite.

GPS Fault Detection

The information from the GPS/INS filter may be used to detect faults in the GPS measurements. A separate filter structure is constructed for each GPS measurement and the Shiryayev Test is again employed to detect the fault.

An alternative is to simply use GPS measurements alone in either an Extended Kalman Filter or in a Least Squares filter structure. The residuals may then be processed using a Chi-Square method, such as in [98], or using the Shiryayev Test as before. Again, the hypotheses would consist finding the residual that is the healthiest in order to eliminate the effect of the faulty GPS signal.

This process is especially important for GPS ultra-tight schemes in which a GPS/INS EKF is used to feed back on the correlation process of the GPS receiver. To the extent that the filter is protected from faults from either the GPS or IMU, the filter protects the ultra-tight GPS/INS scheme from degrading radically. Such schemes require this type of filtering in order to operate properly.

Further, the introduction of vehicle dynamics in either GPS fault detection or ultra-tight GPS/INS will also enhance performance through bounding of the estimation growth.

For the differential GPS case for relative navigation, almost no change is needed in the filter structure. The differential carrier phase measurements may be applied in a similar manner to that shown in Section 2. However, carrier phase measurements are subject to cycle skips and slips. In Wolfe [13], a method of using the Shiryayev Test for detecting carrier phase cycle slips should also be employed as a pre-filter before using the carrier phase measurements in the fault detection filters. However, the method of tuning and development would remain the same as for the single vehicle fault detection filter.

Relative Navigation Fault Detection

Note that the dynamics used to process the navigation solution for the fault detection filters described in this section are the same for the relative navigation filter described in Section 2. As such the fault detection filters defined in this section with the associated fault models will also work with the relative navigation EKF in order to detect failures in the IMU in both the base or the rover. The fault direction matrices F remain the same for the relative navigation EKF. If the process in Section 2 is used, it is possible that the relative navigation filter will detect a fault in the base vehicle using the transmitted base data. In order to distinguish between a rover fault and a base fault, the rover vehicle should switch back to a single vehicle mode or else wait for the base vehicle to declare a fault. In either case, the system is in degraded mode and the operation may be halted or modified accordingly.

If the method presented in Section 3, the rover vehicle will still see faults in the base EKF. However, these faults will now enter through the GPS measurements further obscuring the fault. A new fault model must be developed for this type of operation and then the fault matrix converted from the measurement fault to a state space fault. An obvious choice for the fault matrix is to incorporate the base fault into a failure in the clock bias. If the clock bias states are not used due to the fact that the measurements are double differenced, then a more complex fault model is required to solve E=CF.

Ultra-Tight GPS/INS

Ultra-tight GPS/INS has been suggested as a means of enhancing GPS performance during high dynamics or high jamming scenarios. This section describes a method of blending the GPS with the INS within the GPS receiver and providing feedback to satellite tracking.

GPS Tracking

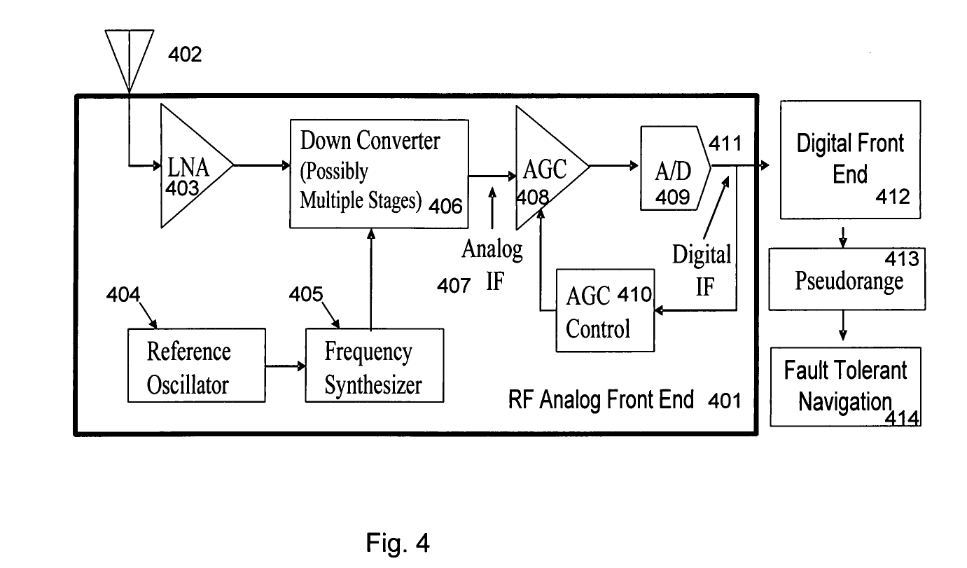

Ultra-tight technology is based upon a modification to traditional GPS tracking. This section describes a standard tracking loop scenario for GPS receivers. The typical GPS receiver architecture 401 is depicted in FIG. 4. In this figure, an antenna 402 passes a received GPS signal through a low noise amplifier (LNA) 403 in order to both filter and amplify the desired signal. In the down conversion stage 406, the signal is then converted from the received GPS frequency to a lower intermediate frequency 407 through multiplication with a reference frequency generated by the local oscillator. This process may be repeated multiple times in order to achieve the desired final intermediate frequency. The signal is then amplified with an automatic gain control (AGC) 408 and sampled through the analog to digital converter (ADC) 409. The AGC 410 is designed to maintain a certain power level input to the ADC. The digital output 411 is processed through the digital front end 412 to generate pseudorange, range rate, and possibly carrier phase measurements 413 which would then be processed in the GPS filter structures 414 using the fault tolerant methods described.

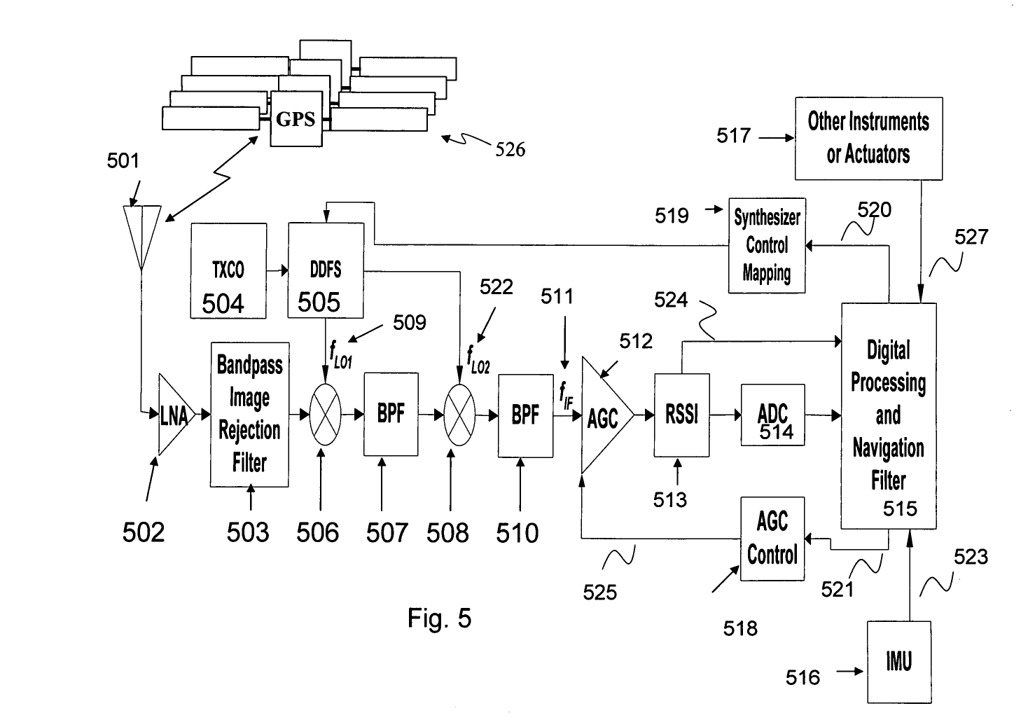

Several types of RF down conversion stages are used in GPS receiver tracking. The first and most common is a two stage superhetrodyne receiver depicted in FIG. 5. In this case the GPS satellites 526 broadcast a signal through an antenna 501, passes through an LNA 502, then a band pass filter (BPF) 503, is mixed with a signal 506 generated by the direct digial frequency synthesizer 505 driven by an oscillator 504 which may be a temperature controlled oscillator or some other type of clock device. In this case, an oscillator is used to convert the input frequency to a lower frequency through a mixer. A second mixer performs reduces the carrier frequency further. The signal is then passed through another BPF 507, mixed again 508, filtered again 510 and amplified 512. The signal power could be measured through the RSSI 513 and then sampled in the ADC 514. The sampled data is processed through the fault tolerant navigation system and digital processor 515. This processor may make use of other instruments and actuators (from a vehicle model) 517 and in particular an IMU 516 using methods described to provide a command 521 to the AGC which changes the amplification level. A second command 520 drives a control system 519 to adjust the frequency within the DDFS 505 in order to compensate for oscillator errors.

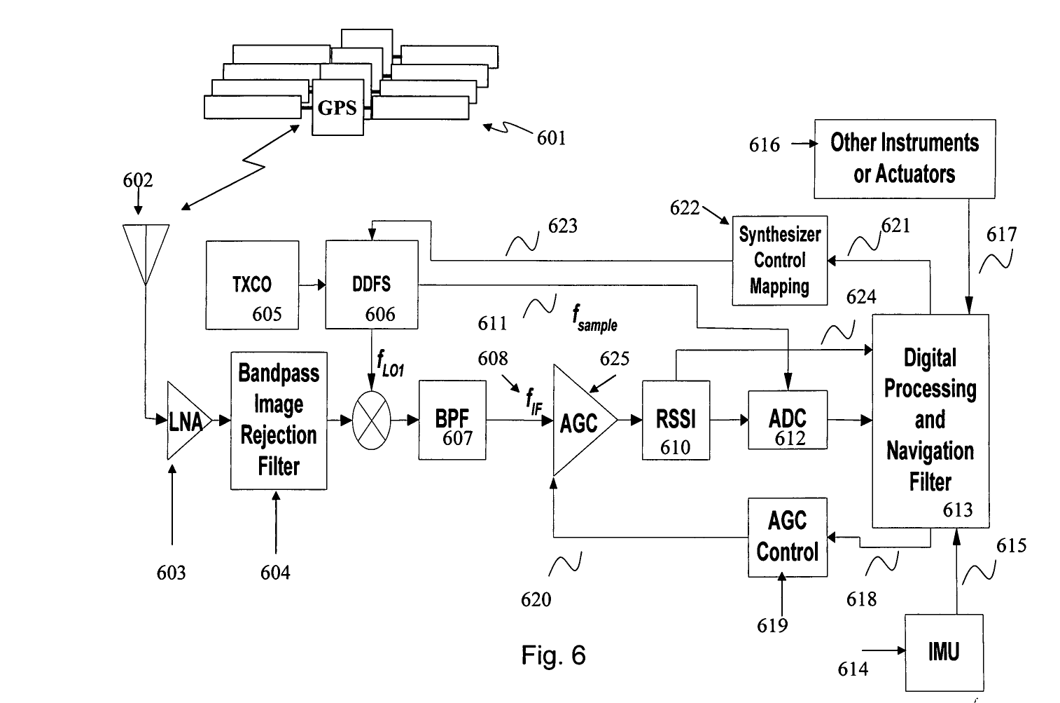

A second type of RF front end uses only one stage and is depicted in FIG. 6. In this case the GPS satellites 601 broadcast a signal through an antenna 602, passes through an LNA 603, then a band pass filter (BPF) 604 is mixed with a signal generated by the direct digial frequency synthesizer 606 driven by an oscillator 605 which may be a temperature controlled oscillator or some other type of clock device. In this case, an oscillator is used to convert the input frequency to a lower frequency through a mixer. The signal is then passed through another BPF 607, and amplified 625. The signal power could be measured through the RSSI 610 and then sampled in the ADC 612. The sampled data is processed through the fault tolerant navigation system and digital processor 613. This processor may make use of other instruments and actuators (from a vehicle model) 616 and in particular an IMU 614 using methods described to provide a command 618 to the AGC 619 which changes the amplification level 620. A second command 621 drives a control system 622 to adjust the frequency within the DDFS 606 in order to compensate for oscillator errors.

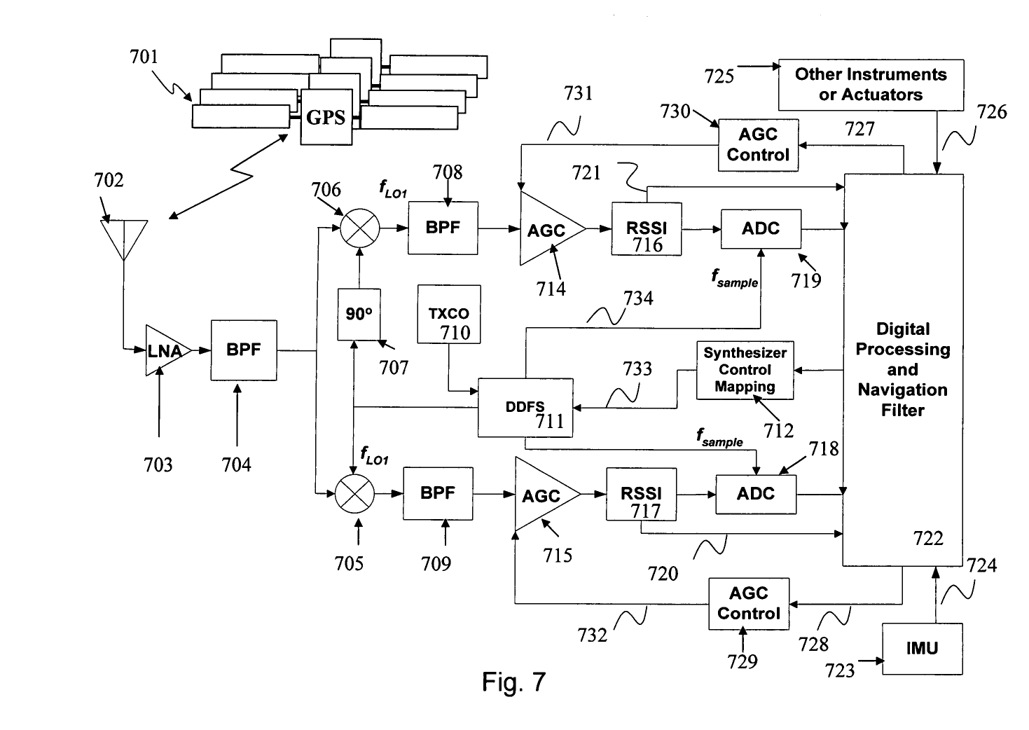

An alternate architecture which is gaining popularity is referred to as the direct to baseband radio architecture. This analog structure is depicted in FIG. 7. The main difference between FIG. 6 and FIG. 7 is that in FIG. 7, the signal at the antenna is mixed with the in-phase and quadrature down conversion signal 705 and 706, as opposed to just the in-phase signal of FIG. 6. The result is the generation of two signals, each of which may be filtered 709, 708, amplified, 715, 714, the power may be measured 716 and 717, and digitized with a separate ADC 719 and 718. The sampled data is processed through the fault tolerant navigation system and digital processor 722. This processor may make use of other instruments and actuators (from a vehicle model) 725 and in particular an IMU 723 using methods described to provide a command 728 727 to the AGC 729 730 which changes the amplification level 732 714. A second command 712 drives a control system 733 to adjust the frequency within the DDFS 711 in order to compensate for oscillator errors. The results presented here may be modified to take advantage of this architecture using a separate tracking loop structure for both the in phase and quadrature signals, or else the both the analog I's and Q's may be recombined in the digital domain before processing through the tracking loops.

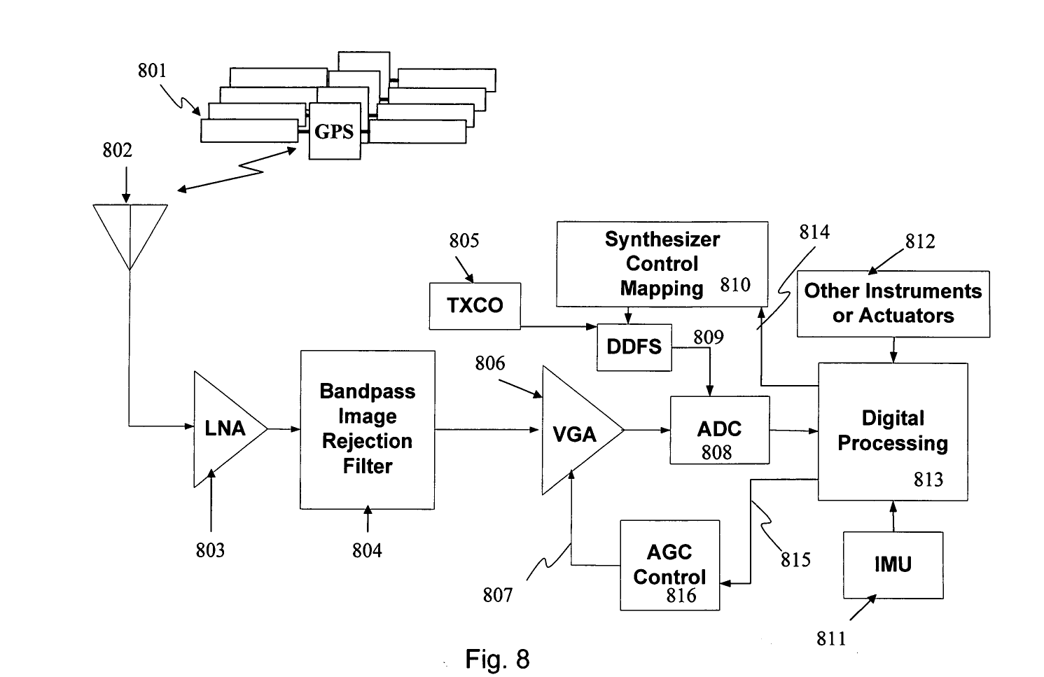

The ideal solution with the minimum parts is the direct sampling method depicted in FIG. 8. In this case, no down conversion stage is used and the receiver operates on the principle of Nyquist undersampling [110]. This method may require additional filtering before the digital tracking loops, but provides the minimum number of components. In this case the GPS satellites 801 broadcast a signal through an antenna 802, passes through an LNA 803, then a band pass filter (BPF) 804. The signal is amplified 806 and sampled 808. The sampled data is processed through the fault tolerant navigation system and digital processor 813. This processor may make use of other instruments and actuators (from a vehicle model) 812 and in particular an IMU 811 using methods described to provide a command 815 to the AGC 816 which changes the amplification level 806. A second command 814 drives a control system 810 to adjust the frequency within the DDFS 809 in order to compensate for oscillator errors.

Once in the digital domain, GPS digital processing is used to process the signal into suitable measurements of pseudorange, range rate, and carrier phase for use in navigation filter. The method for performing digital processing is usually referred to as the tracking loop. A separate tracking loop is required to track each separate GPS satellite signal.

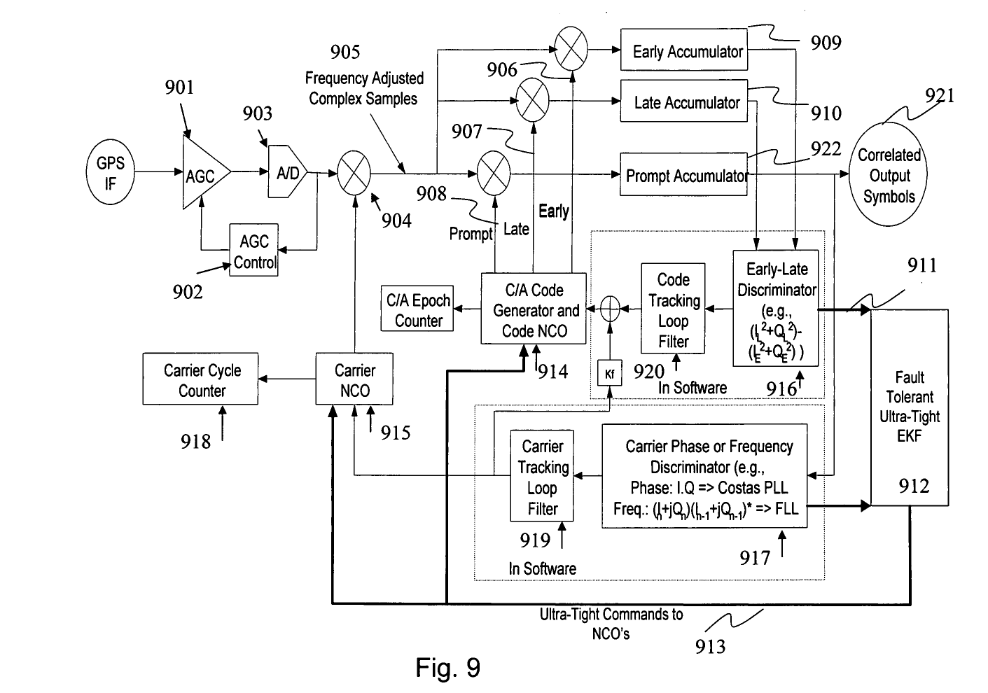

FIG. 9 describes a standard GPS early minus late tracking loop system[110]. The figure represents the processing associated with a single channel, and only the in-phase portion. In this system, the digital samples generated by the analog to digital converter 903 are first multiplied 904 by the carrier wave generated by the carrier numerically controlled oscillator (NCO) 915. Then the output is multiplied by three different representations of the coded signal: early 906, late 907, and prompt 908. All of these signals are generated relative to the code NCO 914. The prompt signal is designed to be synchronized precisely with incoming coded signal. The late signal is delayed by an amount of time Δ, typically half of the chipping rate of the GPS code signal. Other chip spacings and the use of additional code offset signals in addition to the three mentioned may be used to generate more outputs used in the discriminator functions and filtering algorithms. The early signal is advanced forward in time by the same amount Δ. All three signals are accumulated (integrated) over the entire code length N 909, 910, 922, which is 1024 chips for the course-acquisition (C/A) code in GPS. The outputs of the accumulation are processed through the code discriminator 916 and the carrier discriminator 917. The output of each are passed through a respective filter 920, 919 to generate commands to each NCO 914 and 915. The outputs of the discriminator may also be fed to the ultra-tight fault tolerant filter 912 which may generate commands 913 to each of the NCO's.

Not depicted in FIG. 9 are a second set of three signals generated similarly to the first set with one exception. Instead of multiplying by the carrier NCO, these signals are multiplied with the phase quadrature of the NCO signal (90° phase shifted). In this way six symbols are generated at the output of the accumulation process. One set of early, late, and prompt signals is in phase with the carrier signal referred to as I_{E},I_{L}, and I_{P} respectively. The other set of early, late, and prompt signals is in phase quadrature, each referred to as Q_{E}, Q_{L}, and Q_{P} respectively.

The process may be described analytically. The signal input after the analog-to-digital converter (ADC) may be described as the measurement \dot{z}(t):

$${\dot{z}}_{I} ( t ) = {\sum }_{i = 1}^{m} {c}_{i} ( t ) {d}_{i} ( t ) \sqrt{2 {A}_{i}} sin {ϕ}_{i} ( t ) + {\dot{n}}_{I} ( t ) \qquad ( 534 )$$

where i is an index on the number of satellite signals currently visible at the antenna. The total number of satellite signals currently available is m. The term cᵢ(t) is the spread spectrum coding sequence for the iₜₕ satellite and dᵢ(t) is the data bit. The spreading sequence is assumed known a priori while the data bit must be estimated in the receiver. Note that in Eq. 534 each satellite signal i has an independent amplitude Aᵢ and carrier phase φᵢ which both are time varying although the amplitude usually varies slowly with time. The term \dot{n}(t) is assumed to be zero mean, additive white Gaussian noise (AWGN) with power spectral density V. A quadrature measurement may be available if created in the analog domain. In this case, the signal has been processed through a separate ADC converter through the architecture depicted in FIG. 7.

$${\dot{z}}_{Q} ( t ) = {\sum }_{i = 1}^{m} {c}_{i} ( t ) {d}_{i} ( t ) \sqrt{2 {A}_{i}} cos {ϕ}_{i} ( t ) + {\dot{n}}_{Q} ( t ) \qquad ( 535 )$$

The GPS signal is a bi-phase shift key[112] encoded sequence consisting of a series of N=1024 chips, each chip is of length Δ in time. The code sequence is designed such that mean value calculated over N chips is zero and the autocorrelation function meets the following criteria:
E[cᵢ(t)cᵢ(t+τ)]=1 if τ=t (536)
=1−|τ−t| if |τ−t|≦Δ/2 (537)
=0 otherwise (538)

The carrier phase φᵢ has components defined in terms of the Doppler shift and phase jitter associated with the receiver local clock. The model used is defined as:
φᵢ(t)=ωᵢt+θᵢ(t) (539)
where ω_{c} is the carrier frequency after the ADC and θ(t) is the phase offset. The term θ(t) is assumed to be a Wiener process with the following statistics:

$$θ ( 0 ) = 0 , E [ θ ( t ) ] = 0 , E [ d {θ ( t )}^{2} ] = \frac{dt}{{τ}_{d}} \qquad ( 540 )$$

The received carrier frequency ω(t) is defined in terms of a deterministic carrier frequency ωc at the ADC and a frequency drift ω_{d}(t) as:
ωᵢ(t)=ω_{ci}+ω_{di}(t) (541)

The process described in FIG. 9 mixes the signal in Eq. 534 with a GPS receiver generated replica signal. The replica is calculated using the output of the Numerically Controlled Oscillators (NCO's). The general replica signal for each satellite i is defined as:
\overline{z}ᵢ=cᵢ(\overline{t})≈\sqrt{2A}ᵢ sin \overline{φ}ᵢ(t) (542)
where \overline{t} is the current estimate of the current location within the code sequence, \overline{A} is the estimate of the amplitude, and \overline{φ} is the estimated carrier phase.

However, six versions of the replica signal are actually generated and mixed with the input. Three are generated using an “in-phase” replica of the carrier and three are in phase quadrature. Within the set of three in-phase or quadrature replicas, three different code replicas are generated. These are typically referred to as the Early, Prompt, and Late functions. The early and late replicas are offset from the prompt signal by a spacing of Δ/2. Therefore, a total of six outputs are generated, an early/prompt/late combination for the in-phase symbol and an early/prompt/late combination for the quadrature symbol. These new symbols are represented as:

$$\begin{matrix}δ {\dot{z}}_{IE} ( t ) = {\dot{z}}_{I} ( t ) c ( \overline{t} + \frac{Δ}{2} ) & ( 543 ) \\ = c ( t ) c ( \overline{t} + \frac{Δ}{2} ) d ( t ) 2 \sqrt{A \overline{A}} sin ( ϕ ( t ) - \overline{ϕ} ( t ) ) + & ( 544 ) \\ c ( \overline{t} + \frac{Δ}{2} ) \sqrt{2 \overline{A}} sin ( \overline{ϕ} ( t ) ) \dot{n} ( t ) & ( 545 ) \\ δ {\dot{z}}_{IP} ( t ) = {\dot{z}}_{I} ( t ) c ( \overline{t} ) & ( 546 ) \\ = c ( t ) c ( \overline{t} ) d ( t ) 2 \sqrt{A \overline{A}} sin ( ϕ ( t ) - \overline{ϕ} ( t ) ) + & ( 547 ) \\ c ( \overline{t} ) \sqrt{2 \overline{A}} sin ( \overline{ϕ} ( t ) ) \dot{n} ( t ) & ( 548 ) \\ δ {\dot{z}}_{IL} ( t ) = {\dot{z}}_{I} ( t ) c ( \overline{t} - \frac{Δ}{2} ) & ( 549 ) \\ = c ( t ) c ( \overline{t} - \frac{Δ}{2} ) d ( t ) 2 \sqrt{A \overline{A}} sin ( ϕ ( t ) - \overline{ϕ} ( t ) ) + & ( 550 ) \\ c ( \overline{t} - \frac{Δ}{2} ) \sqrt{2 \overline{A}} sin ( \overline{ϕ} ( t ) ) \dot{n} ( t ) & ( 551 ) \\ δ {\dot{z}}_{QE} ( t ) = {\dot{z}}_{Q} ( t ) c ( \overline{t} + \frac{Δ}{2} ) & ( 552 ) \\ = c ( t ) c ( \overline{t} + \frac{Δ}{2} ) d ( t ) 2 \sqrt{A \overline{A}} cos ( ϕ ( t ) - \overline{ϕ} ( t ) ) + & ( 553 ) \\ c ( \overline{t} + \frac{Δ}{2} ) \sqrt{2 \overline{A}} cos ( \overline{ϕ} ( t ) ) \dot{n} ( t ) & ( 554 ) \\ δ {\dot{z}}_{QP} ( t ) = {\dot{z}}_{Q} ( t ) c ( \overline{t} ) & ( 555 ) \\ = c ( t ) c ( \overline{t} ) d ( t ) 2 \sqrt{A \overline{A}} cos ( ϕ ( t ) - \overline{ϕ} ( t ) ) + & ( 556 ) \\ c ( \overline{t} ) \sqrt{2 \overline{A}} cos ( \overline{ϕ} ( t ) ) \dot{n} ( t ) & ( 557 ) \\ δ {\dot{z}}_{QL} ( t ) = {\dot{z}}_{QL} ( t ) c ( \overline{t} + \frac{Δ}{2} ) & ( 558 ) \\ = c ( t ) c ( \overline{t} + \frac{Δ}{2} ) d ( t ) 2 \sqrt{A \overline{A}} cos ( ϕ ( t ) - \overline{ϕ} ( t ) ) + & ( 559 ) \\ c ( \overline{t} + \frac{Δ}{2} ) \sqrt{2 \overline{A}} cos ( \overline{ϕ} ( t ) ) \dot{n} ( t ) & ( 560 )\end{matrix}$$

where only one satellite signal is assumed and high frequency terms are neglected. Each of these symbols is then integrated over the code period N. This integration effectively removes the high frequency terms. In addition, the integration also attenuates the presence of additional GPS satellite signals so that only the particular satellite signal comes through. Note that other variations of code spacings and additional replicas may be generated with larger chip spacings. In fact, it is possible to generate multiple code replicas each offset from the previous by Δ or some fraction thereof in order to evaluate the entire coding sequence simultaneously. The scheme presented here is the standard method of tracking, however other methods are available using a large number of correlations and steering the replica generation process through the NCO according to the location of the peak value in all of the correlation functions.

Once the input signals and replicas are integrated over N chips to form the early, late, and prompt symbols, the integrators are emptied and the process restarts with the next set of samples. The output of the integrators, the symbols, are used as inputs to the tracking loop through a discrimination function and a filter in order to provide feedback to the carrier NCO and the code NCO. A typical discriminator function for determining the error in the code measurement for the early and late symbols is:

$$h ( δ {x}_{i} ) = ( {z}_{IE}^{2} + {z}_{QE}^{2} ) - ( {z}_{IL}^{2} + {z}_{QL}^{2} ) \qquad ( 561 )$$

where δxᵢ is the error in the state estimate of the vehicle with respect to the line of sight to the i^{th} satellite. The particular discriminator function h( ) is designed to calculate the error in the code tracking loop. This particular discriminator is referred to as the power discriminator for a delay lock loop. Other discriminators are possible such as:

$$\begin{matrix}Envelope h ( δ {x}_{i} ) = \sqrt{{z}_{IE}^{2} + {z}_{QE}^{2}} - \sqrt{{z}_{IL}^{2} + {z}_{QL}^{2}} & ( 562 ) \\ Dot h ( δ {x}_{i} ) = ( {z}_{IE} - {z}_{IL} ) {z}_{IP} + ( {z}_{QE} - {z}_{QL} ) {z}_{QP} & ( 563 ) \\ NormalizeEnvelope h ( δ {x}_{i} ) = ( \sqrt{{z}_{IE}^{2} + {z}_{QE}^{2}} - \sqrt{{z}_{IL}^{2} + {z}_{QL}^{2}} ) / & ( 564 ) \\ ( \sqrt{{z}_{IE}^{2} + {z}_{QE}^{2}} + \sqrt{{z}_{IL}^{2} + {z}_{QL}^{2}} ) & \end{matrix}$$

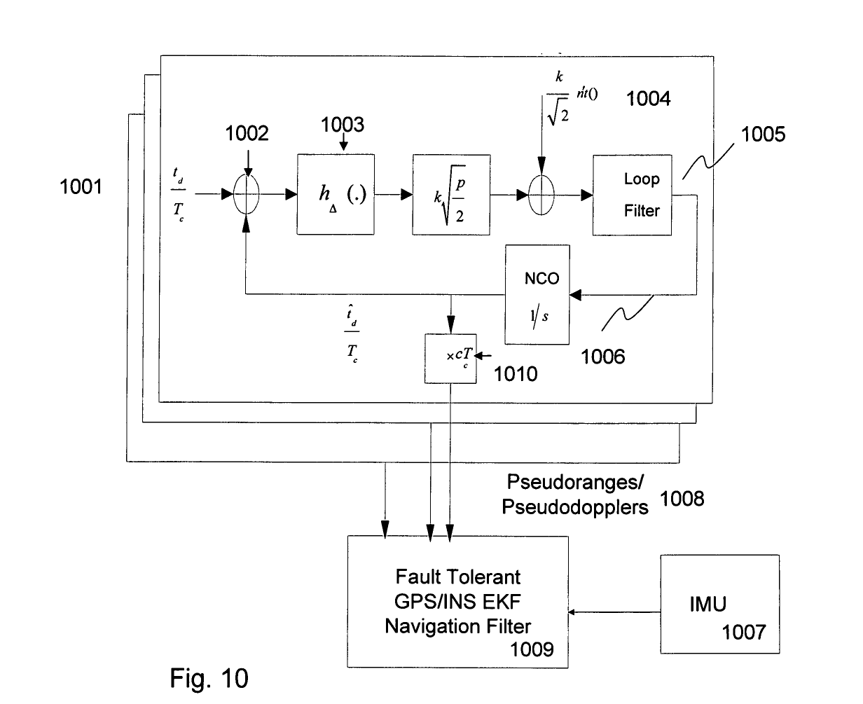

A comparison of the discriminator functions is given in FIG. 10. For a complete treatment of the derivation of this particular discriminator function, refer to[110] or [25]. For the purposes here, the discriminator function is generic and other versions which supply an error in the code tracking may be used.

The carrier phase may be tracked in either a frequency lock loop or phase lock loop. The type of discriminator used depends on the type of tracking required. The following discriminators are commonly used with carrier or frequency tracking. Those discriminators used for phase locked loops are denoted with a PLL while frequency locked loops have are listed with the FLL notation. Note that only the prompt symbols are used for carrier tracking.
Sign sign(z_{IP})z_{QP} PLL (565)
Dot z_{IP}z_{QP} PLL (566)

$$\begin{matrix}Angle arctan ( \frac{{z}_{IP}}{{z}_{QP}} ) PLL & ( 567 ) \\ Approx . Angle \frac{{z}_{IP}}{{z}_{QP}} PLL & ( 568 ) \\ Cross {z ( {t}_{0} )}_{IP} {z ( {t}_{1} )}_{QP} - {z ( {t}_{1} )}_{IP} {z ( {t}_{0} )}_{QP} FLL & ( 569 ) \\ FLLSign ( {z ( {t}_{0} )}_{IP} {z ( {t}_{1} )}_{QP} - {z ( {t}_{1} )}_{IP} {z ( {t}_{0} )}_{QP} ) sign ( {z ( {t}_{1} )}_{IP} {z ( {t}_{0} )}_{IP} + & ( 570 ) \\ {z ( {t}_{1} )}_{QP} {z ( {t}_{0} )}_{QP} ) FLL & \\ MaxLikelihood arctan ( \frac{{z ( {t}_{1} )}_{IP} {z ( {t}_{0} )}_{IP} + {z ( {t}_{1} )}_{QP} {z ( {t}_{0} )}_{QP}}{{z ( {t}_{0} )}_{IP} {z ( {t}_{1} )}_{QP} - {z ( {t}_{1} )}_{IP} {z ( {t}_{0} )}_{QP}} ) FLL & ( 571 )\end{matrix}$$

The symbols z(t₀) and z(t₁) are assumed to be from successive integration steps so that the FLL discriminators essentially perform a differentiation in time to determine the frequency shift between integration periods. The output of the function sign( ) is a positive or negative one depending upon the sign of the term within the parenthesis.

The discriminator outputs are used as inputs into the tracking loops. The tracking loop estimates the phase error for both the code and carrier and then adjust the NCO. A separate loop filter is used for code and carrier tracking. Each loop filter is typically a first or second order tracking loop [112].

The output of the NCO is used to generate inputs to the navigation filter. The navigation system does not provide information back to the tracking loops in a standard GPS receiver.

A more general and abstracted representation of the tracking process for a GPS receiver is depicted in FIG. 10. This figure depicts multiple GPS channels each operating a tracking loop and providing output to a GPS/INS EKF. The model depicted is a simplified baseband model of a tracking loop which is typically used in communications analysis[110]. Only the code tracking loop is depicted. A separate but similar process is used to track the carrier in order to estimate pseudodopplers.

In this filter structure, the signal is abstracted as a time of arrival

$$\frac{{t}_{d}}{{T}_{c}}$$

where t_{d} is the time of arrival and T_{c} is the chipping rate. The signal is differenced with the estimated time \hat{t}_{d} determined from the code NCO. The discriminator function h_{Δ} represents the process of correlating the code in phase and in quadrature as well as the accumulation of early, late, prompt, or other combinations of the measured signal with the estimated signal in order to produce a measurement of the error. The error is amplified and additive white Gaussian noise (AWGN) is added to represent the noise inherent in the GPS tracking process. The noise is represented by \dot{n}(t). The error signal plus noise is passed through a loop filter, typically a second order loop, the output of the filter is used to drive the NCO, which acts as an integrator.

The output of the NCO is then compared with the input signal. The NCO output is also used as the estimate of time which is converted to a range measurement for use in a navigation algorithm such as the GPS/INS EKF.

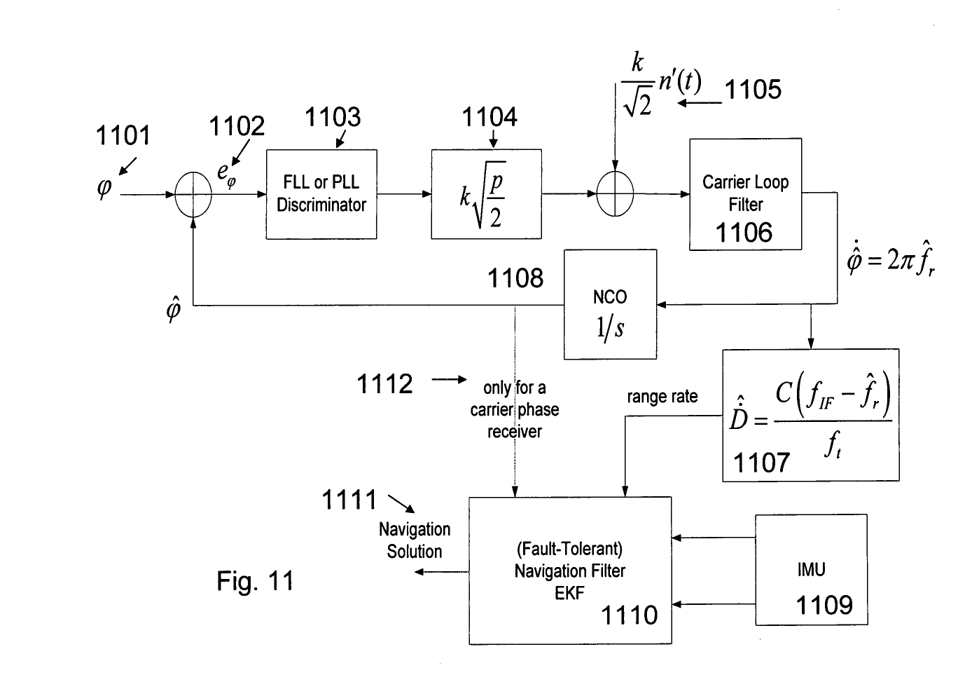

A similar tracking loop presented in FIG. 11 is used to track carrier and generate the pseudo-Doppler measurements processed within the GPS/INS EKF. The carrier tracking loop will have a different discriminator function, and a different loop filter. The output will be a Doppler estimate for use in navigation. The output may include an accumulated carrier phase for the purposes of performing differential carrier phase tracking.

The basic GPS tracking functionality is now defined. A separate algorithm is used to track the code and carrier for each satellite signal received at the antenna. The tracking loop consists of a discrimination function designed to compare the received signal with an internally generated replica and provide a measure of error between the signal and the replica. The error is processed through a loop filter structure which generates a command to steer the local replica generator. The output of the generator is used to provide pseudo-measurements to a navigation process. No navigation information is used within the tracking loop structures.

Ultra-Tight Methodology

The essence of ultra-tight GPS technology is the enhancement of the tracking loops with the use of navigation information gleaned through the processing of all available GPS satellite data as well as other instruments such as an IMU. The navigation state of the estimator drives the GPS signal replica in order to minimize the error between the actual signal and the replica. Other instruments or information signals are used to the extent that they enhance the navigation state in order to enable better tracking.

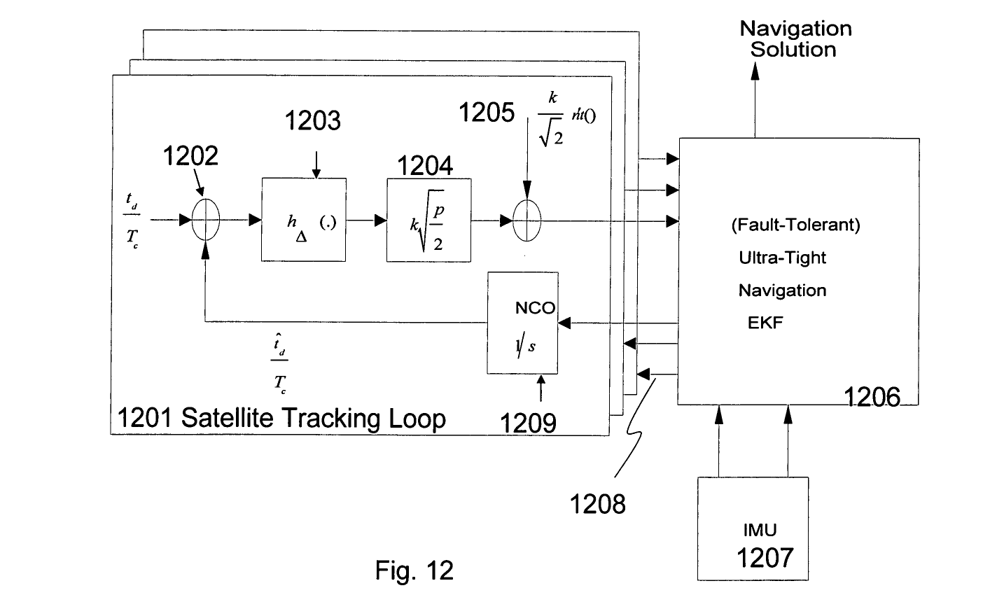

FIG. 12 demonstrates the fundamental difference between standard tracking and ultra-tight GPS/INS using the baseband model. In this comparison with the structure described in FIG. 10, three basic changes have been made. First the loop filter structure has been removed. The output of the discriminator modified by a gain and with associated noise is input directly into the navigation filter. In this case the navigation filter is the GPS/INS EKF designed in Section 6 with a few modifications described below. The second change is that all of the independent tracking loop structures are simultaneously processed within the navigation filter so that information from all tracking loops are processed together to form the best estimate of the navigation state. Finally, the navigation filter is used to drive the NCO and generate the replica signal.

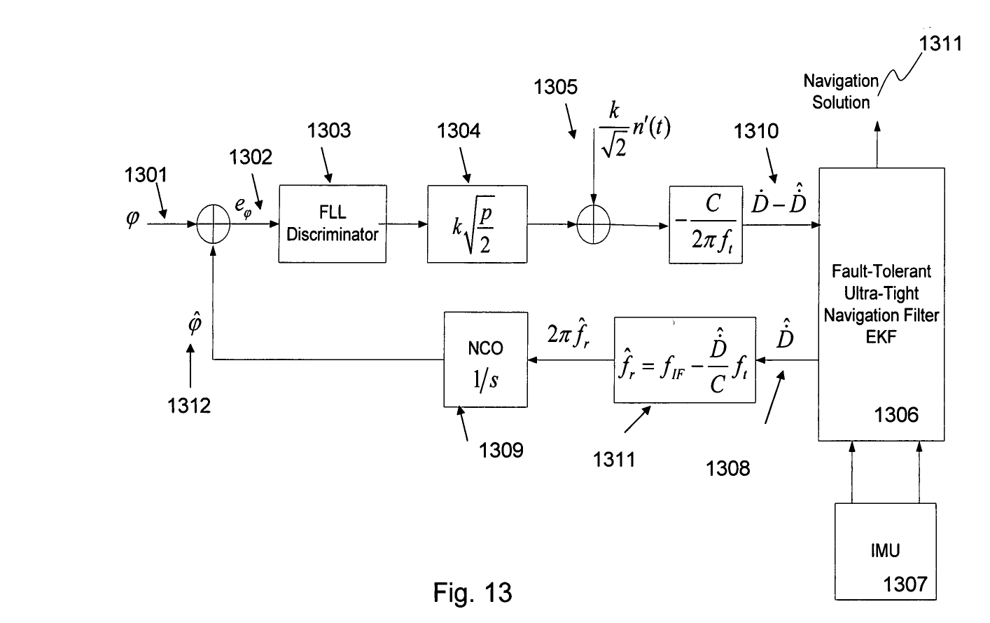

FIG. 13 describes a similar structure in which the output of the carrier tracking loops are input to the GPS/INS EKF. These measurements take the place of the Doppler measurements and provide rate information to the EKF.

Using these two types of inputs, the carrier tracking and the code tracking discriminator functions, the ultra-tight GPS/INS EKF may be created. The next sections discuss implementation more explicitly.

Measurement Generation

The main difference between the inputs to the standard EKF and the ultra-tight EKF is the measurement inputs. The standard EKF uses range and range rate as inputs. The ultra-tight uses the output of the discriminator functions.

In order to determine range information, the relationship between range and the code tracking is established. For this analysis, a purely digital receiver is assumed. The block diagram of the RF front end is depicted in FIG. 8. In this case, the antenna receives the signal from the GPS satellites, amplifies it and possibly filters it before the signal is sampled in the Analog-to-Digital Converter (ADC). This architecture is simple to model as well as a fully implement able receiver design.

The signal for a single GPS satellite is re-defined for this analysis in order to relate the signal to the receiver motion. This process is completed by taking the simple code model defined in Eq. 534 and modifying it with the appropriate error sources defined previously. This signal is defined as:
sᵢ(t)=\sqrt{Aᵢ}cᵢ(t−Δt₁−Δt_{T}−tₜᵣₐₙₛ)sin(ω_{L1}tω_{D}+θ(t))+n(t) (572)

In this case, the signal amplitude is defined as A which is a slowly varying process, the spread spectrum code is defined as c(t), the data bit is

In essence:

$$1 - c ( t ) c ( \overline{t} ) \frac{{c}_{light}}{{t}_{chip}} = \vert ρ - \overline{ρ} \vert = \vert {H}_{ρ} δ x \vert \qquad ( 573 )$$

where \overline{t} is again the predicted code time, ρ is the true satellite range as defined in Section 4, \overline{ρ} is the a priori estimate of range, c_{light} is the speed of light and t_{chip} is size of one chip in seconds. The term δx is the EKF state vector defined in Section 4 and H_{ρ} is the linearized perturbation matrix defined explicitly as the first row of the H matrix in Eq. 256 in the same section. From this definition, it is clear that when t=\overline{t} then E[c(t)c(\overline{t})]=1 and Eq. 573 indicates then that ρ=\overline{ρ} indicating that the system tracks perfectly. Note that no noise has been introduced.

The absolute values enable the estimation of the error but not the estimation of the direction required to correct the error. As stated previously, the discriminator functions such as the early minus late tracking will be used to determine both magnitude and direction. Note that any of the discriminators in Eq. 562 may be employed. Each provides a linear measure of the error in the current code NCO used to drive the replica. This linear error is related to the error in range.

A similar definition may be applied for carrier phase errors.
λ(φ−\overline{φ})=ρ−\overline{ρ}=H_{ρ}δx (574)

Note that the carrier phase error φ−\overline{φ} is in cycles and λ is the wavelength of the carrier. In this case the error directly translates to a range error.

An alternative form uses the time derivative of the carrier phase or frequency to measure relative range rate as:
λ(\dot{φ}−\overline{φ})=\dot{ρ}−\overline{ρ}=H_{\dot{ρ}}δx (575)
where H_{\dot{ρ}} is the linearized range rate perturbation matrix defined explicitly as the second row of the H matrix in Eq. 256. The designer has the choice of representations depending upon particular receiver design.

Using these relationships, the outputs of the incoming signal mixed with the replica may be processed using the discriminator functions defined at the output rate of the integrate and dump or even at the sample level. Alternate forms may be created as well.

EKF Processing

The EKF is now processed. Note that the variations in this form may be presented to use the fault tolerant estimation techniques presented in Section 9 or the simple EKF presented in section 6. The simple version is presented here.

In this case, the measurements and a priori estimates are replaced. Instead the residual is generated directly from the output of the discriminator function. For range generated from the code discriminator using the early and late symbols:

$${\overline{r}}_{{ρ}_{i}} ( {t}_{k} ) = \sqrt{{z}_{IE}^{2} + {z}_{QE}^{2}} - \sqrt{{z}_{IL}^{2} + {z}_{QL}^{2}} \qquad ( 576 )$$

where the envelope discriminator is chosen. Other discriminators may also be used. The measurement matrix H_{ρ} is calculated as before for range measurements.

Similarly, for the range rate measurements:

$${r}_{{\dot{ρ}}_{i}} ( {t}_{k} ) = arctan ( \frac{{z ( {t}_{1} )}_{IP} {z ( {t}_{0} )}_{IP} + {z ( {t}_{1} )}_{QP} {z ( {t}_{0} )}_{QP}}{{z ( {t}_{0} )}_{IP} {z ( {t}_{1} )}_{QP} - {z ( {t}_{1} )}_{IP} {z ( {t}_{0} )}_{QP}} ) \qquad ( 577 )$$

This version uses a frequency lock loop discriminator to produce the measurement residual using measurement matrix H_{\dot{ρ}}. As before, other discriminators may be chosen.

If a PLL discriminator is chosen, then the H_{ρ} measurement matrix is used when processing the carrier phase residual. However, to compensate for the bias between the code and carrier range as well as drive the phase error to zero, an additional state for each GPS measurement must be introduced into the EKF. This state consists of a bias driven by a white noise process, \dot{b}_{GPS}=ω_{GPS}. The bias is linear and only appears in the carrier phase measurements. The process noise is small and is only used to keep the filter open.

The EKF processing proceeds as before, generating corrections to the IMU measurements using the residual processes defined in Eq. 576 and Eq. 577. The process is defined in Section 6.

Receiver Feedback

Receiver feedback is generated from the corrected navigation state velocity estimates. The output of the velocity estimate is combined with the satellite velocity estimate provided by the ephemeris set to produce a relative speed between the receiver and the satellite. The frequency command update to each NCO for the code or carrier is given by:

$${\hat{f}}_{r} = {f}_{IF} - \frac{1}{c} {\dot{\hat{ρ}}}_{i} {f}_{t} \qquad ( 578 )$$

where f_{IF} is the intermediate frequency of the GPS signal assuming no relative motion and \hat{\dot{ρ}}ᵢ is the relative range rate between the satellite and the receiver.
Federated Architectures

The ultra-tight navigation filter may be too computationally intense to be performed in real time on current processors. To allow computational efficiencies a decomposition of the ultra-tight navigation filter using a federated architecture similar to the one proposed in Abbott[94], and Psiaki[109].

The structure is a federated architecture which consists of four stages. First, the incoming digitized signal is mixed with a replica signal constructed from the output of the navigation filter for each satellite. The replica signal is constructed from the navigation filter using high rate IMU data. The output of the mixer is then processed through a low pass filter to form nonlinear functions of the errors in the estimates of pseudorange and phase. These errors are the difference between the actual pseudorange and phase and the estimated (replicated) pseudorange and phase calculated by the navigation filter. This error function associated is with the Is and Qs from the correlation process for each satellite and is processed at high frequency through a reduced order Extended Kalman Filter (EKF) which estimates the error in the replica signal. At a lower rate, the output of these filters which are themselves estimates of the error in the replica signal are processed within a global navigation filter designed to estimate the navigation state and perform an online calibration of the local IMU and receiver oscillator. Finally, the output of this filter is converted to commands for the replica signal generation and receiver clock correction which are input into the mixers.

This federated architecture provides an acceptable trade off between computational requirements, tracking bandwidth requirements, and instrument performance. The ideal performance is achieved when vehicle motion is known perfectly such as in a static condition at a surveyed location. The IMU provides user motion data with errors.

One significant problem with the blending of GPS and IMU measurements in jamming is the fact that jamming signals, increase the error variance on code measurements. Since the code is noisier than during normal operation, the classical extended Kalman filter assumes the a priori knowledge of the measurement noise distribution. Therefore, its performance degrades when the measurement noise distribution is uncertain, or when it changes in time or under certain hostile environments. In order to improve the performance and ensure stability, SySense has implemented an adaptive estimation process within the EKF to estimate the noise in the pseudorange measurements online.

The adaptive approach utilizes the global filter residual and covariance matrix history over a moving time window. From this stored window of information, the measurement noise covariance and residual mean are estimated using small sample theory. The estimates are sequentially updated in time as the measurement window is shifted in time to account for new measurements and neglect old ones. The adaptive scheme has the option of weighting new measurements more than old ones to account for highly dynamic noise environments. Therefore, this adaptive estimation scheme is capable of detecting changing measurement noise distributions in high dynamics environments which is very important for high performance GPS/INS systems. For details, refer to[6]. Using this scheme, degraded filter performance in the presence of jamming is attenuated. This scheme may then be used along with the RSSI in hardware to estimate jamming levels and adjust the ultra-tight feedback gain as well as correlation chip spacing on the fly to maintain acceptable levels of filter performance.

Oscillator Feedback

The EKF provides an estimate of the local oscillator error, τ. This estimate may be used to provide feedback to the local oscillator performing the RF down conversion, driving the sample rate and system timing. The method would be to adjust the frequency of the oscillator through the oscillator electronics in order to force the oscillator to maintain a desired frequency.

Note that if the acceleration sensitivity matrix is used in the EKF as defined in Section 6, then the oscillator may be compensated for predicted changes in frequency as a function of acceleration. The clock model will predict the frequency shift and may correct accordingly.

LMV Tracking Loop Modification

The LMV filter for tracking spread spectrum signals is presented in Section 12. Using this method of tracking, it is possible to more directly estimate the phase error, frequency shift, and amplitude error. This method provides significant advantages over standard tracking loops described previously for this application.

For ultra-tight methodologies using the LMV PLL, the overall loop structure significantly changes. The result is a new measurement for the calculation of relative range rate. Instead of using Eq. 577, the system now uses:
\overline{r}_{\dot{ρ}}_{ᵢ}(tₖ)=δ\hat{ω}_{d} (579)
where δ\hat{ω}_{d} is defined in Eq. 637.

In this way, a new method of generating the ultra-tight GPS/INS filter is generated. The EKF may now be processed as before using either the standard model or the fault tolerant navigation algorithms presented previously.

Adaptive Noise Estimation

The adaptive noise estimation algorithms may be employed to estimate the online noise level of each satellite separately or as a group.

The classical extended Kalman filter assumes the a priori knowledge of the measurement noise distribution. Therefore, its performance degrades when the measurement noise distribution is uncertain, or when it changes in time or under certain hostile environments. Therefore, a noise estimation approach is used to enhance the extended Kalman filter performance in the presence of added jamming noise on the satellites pseudo-range measurements. This is, in general, very important in an environment of unknown or varying measurement uncertainty. The approach estimates the unknown measurement noise and the residual mean using an adaptive estimation scheme.

The approach utilizes the extended Kalman filter residual and covariance matrix history over a moving time window. From this bank of information, the measurement noise covariance and residual mean are estimate. The estimates are updated in time as the measurement window is shifted in time to account for new measurements and neglect old ones. The adaptive scheme have the option of weighting new measurements more than old ones to account for highly dynamic noise environments. Therefore, this adaptive estimation scheme is capable of detecting changing measurement noise distribution which is very important for high performance GPS/INS systems.

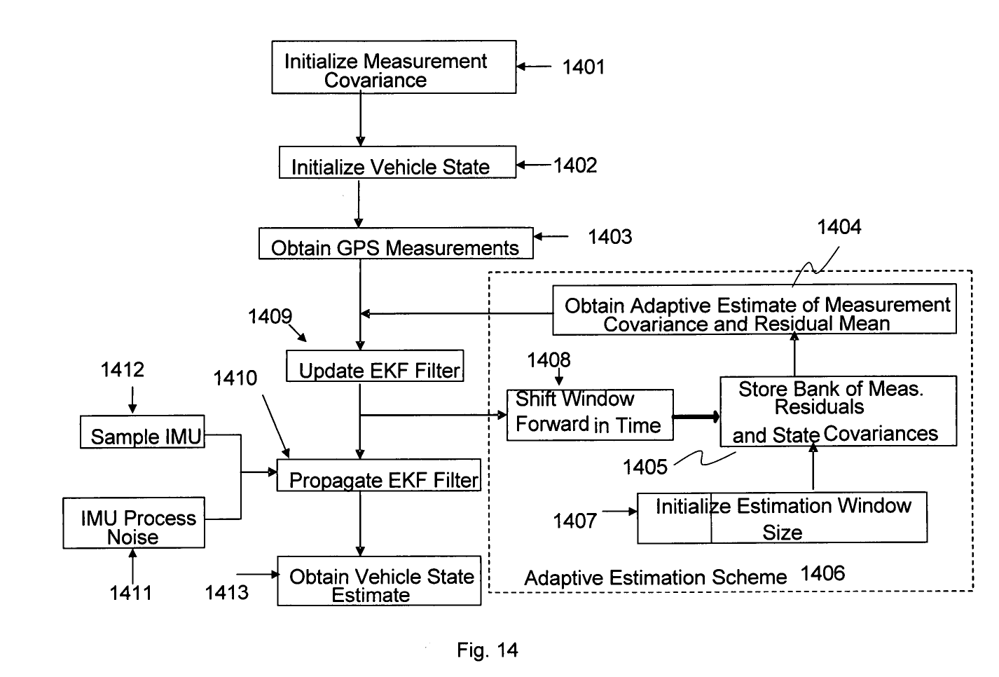

The adaptive scheme is illustrated in FIG. 14. The left part of the figure show the regular extended Kalman filter which operates using a constant pre-determined measurement noise covariance matrix. The dashed box on the right illustrates SySense adaptive measurement noise covariance and residual estimation added feature to account for unknown measurement noise distribution. As seen in the figure, the measurement covariance and residual mean are estimated adaptively and used in the update step of the extended Kalman filter to enhance the its performance.

The output of the adaptive noise estimation would be used to modify the gain control on the GPS receiver. As the noise increases, the gain would be amplified to ensure that the GPS signal is still present. Proportional control would be used.

SySense Ultra-Tight Methodology

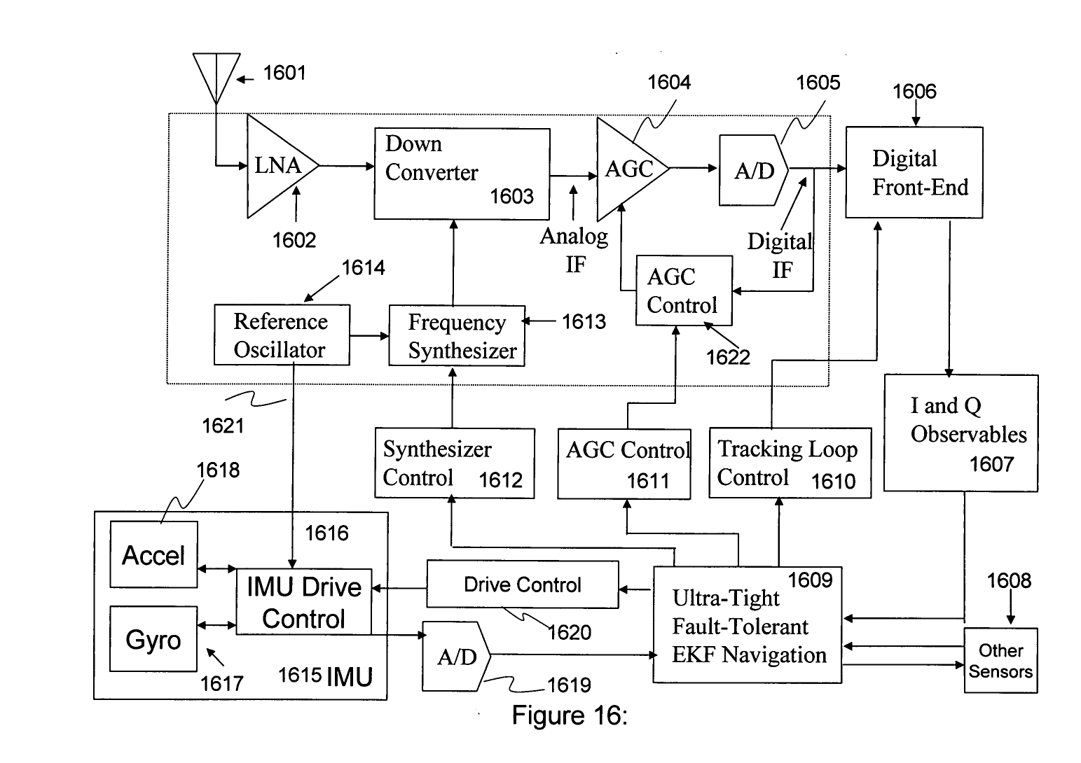

FIG. 16 represents the SySense version of ultra-tight GPS/INS. In this case, the filter uses the feedback from the EKF to direct four aspects of the architecture. First, the oscillator 1614 error is compensated 1612 for clock bias and drift in order to maintain the oscillator at the nominal frequency 1613 despite high acceleration. Second, the feedback 1611 from the EKF 1609 and/or adaptive EKF is used to provide feedback on the gain control 1622 of the receiver before the analog to digital converter 1604. In this way, the receiver sensitivity is adjusted to maintain lock on the signal. Third, the feedback 1610 is used to modify the individual tracking loops and acquisition process 1606 in order to compensate for user motion and to maintain lock on the signal. Finally, for use with MEM's accelerometers 1618 and rate gyros 1617, SySense ultra-tight 1609 provides feedback 1620 to the actual rate gyros and accelerometers 1616 in order to maintain the instrument bandwidth as well as assuring that the measurements remain within the linear range of the accelerometers and rate gyros. This is accomplished by adjusting the inner loop control law voltages 1616 within each device which are designed to maintain linearity. Other instruments 1608 are included and may be used to help stabilize the filter in the event of a total loss of GPS signal. Vehicle models, magnetometers and other instruments already mentioned may be used to improve performance.

Linear Minimum Variance Estimator Structure

The goal of the linear minimum variance (LMV) problem is to provide the best estimate of the state in the presence of state dependent noise. This section follows closely the work of Gustafson and Speyer[111] and is meant to provide a background for the formulation in subsequent sections. No new work is developed in this section and the reader is directed to [111] for more information. Subsequent sections discuss how to apply this filter to a spread spectrum communication problem.

Problem Modelling

The LMV filter minimizes the estimation error in the following dynamic system:
\dot{x}(t)=F(t)x(t)+\dot{G}(t)x(t)+\dot{w}(t) (580)

In this case, x(t) is the n-dimensional state vector, and F(t) is the n×n deterministic dynamics matrix. The \dot{w}(t) term represents additive noise. In this problem, the matrix \dot{G}(t) represents an n×n matrix of stochastic processes and is used to model wide-band variations of F(t) and inducing state dependent uncertainty into the dynamics.

In this document, both \dot{w}(t) and \dot{G}(t) are modelled as zero mean white noise processes with
E[\dot{w}(t)\dot{w}^{T}(τ)]=Wδ(t−τ) (581)
and
E[\dot{G}ᵢⱼ(t)\dot{G}ₖₗ(τ)]=Vᵢⱼₖₗδ(t−τ) (582)
where δ( ) represents the Dirac delta function and Vᵢⱼₖₗ is a four dimensional matrix.

To properly define the problem, the dynamics are converted into an equivalent Ito stochastic integral:
dx(t)=F′(t)x(t)dt+dG(t)x(t)+dw(t) (583)
where dG(t) and dw(t) are zero mean independent increments. The matrix F′(t) is modified by a stochastic correction term, as demonstrated in[111]. The correction term is defined by F′(t)=F(t)+ΔF(t). It is shown in Gustafson and Speyer[111] that

$$Δ {F}_{ij} ( t ) = \frac{1}{2} {\sum }_{k = 1}^{n} {V}_{ikkj} ( t ) \qquad ( 584 )$$

where the multi dimensional matrix V(t) is the second moment of the state dependent noise defined in Eq. 582.

A continuous time measurement model is is given by:
\dot{z}(t)=H(t)x(t)+\dot{r}(t) (585)
where \dot{r}(t) is a continuous zero-mean Gaussian white noise process with E[\dot{r}(t)\dot{r}(τ)]=R(t)δ(t−τ). The measurement matrix is assumed deterministic. The Ito form of the measurement is given by:
dz(t)=H(t)x(t)dt+dr(t) (586)
LMV Optimal Estimation

The LMV filter is designed to minimize the cost of the error in the state x(t) in the mean square sense given a particular update structure. The optimal estimate d\hat{x}(t) is computed using the following structure in Ito form:
dx(t)=F′(t)\hat{x}(t)dt+K(t)[dz(t)−H(t){circumflex over (()}x)dt] (587)

Given the linear structure of the update, the goal is to determine the value of the gain matrix K(t) which minimizes the following cost criteria:
J(K_{f},t_{f})=E[e(t_{f})^{T}W(t_{f})e(t_{f})+∫ₜ_{₀}^{t}^{_{f}}e(t)^{T}W(t)e(t)dt] (588)
in which W(t) is assumed positive semi-definite. The solution is presented in Gustafson and Speyer[111] using the following definitions:
P(t)=E[e(t)e(t)^{T}] (589)
X(t)=E[x(t)x(t)^{T}] (590)
e(t)=\hat{x}(t)−x(t) (591)

The state covariance is propagated as:
\dot{X}(t)=F′(t)X(t)+X(t)F′^{T}+Δ(X,t)+W(t) (592)
where
Δ(X,t)dt=E[dG(t)X(t)dG(t)^{T}] (593)

The components of Δ(X,t) are calculated as:

$${Δ ( X , t )}_{ij} = {\sum }_{k = 1}^{n} {\sum }_{l = 1}^{n} {V}_{ijkl} ( t ) {X}_{kl} ( t ) \qquad ( 594 )$$

The covariance P(t) is propagated as:
\dot{P}(t)=F′P(t)+P(t)F′^{T}+Δ(X,t)+W(t)−P(t)H(t)^{T}R(t)⁻¹H(t)P(t) (595)

Using this covariance, the optimal gain is calculated similarly to the Kalman Filter as:
K(t)=P(t)H(t)^{T}R(t)⁻¹ (596)

Using these methods, the state estimate x(t) may be calculated in time using the filter structure defined in Eq. 587 based upon the dynamics defined in Eq. 580, the measurement defined in Eq. 585, the state covariance defined in Eq. 592, the error covariance of Eq. 595, and finally the optimal gain calculated as in Eq. 596.

LMV Phase Lock Loop

This section defines the problem of implementing a phase lock loop using the LMV filter described in Section 11. Several versions of the filter are described, each one in increasing complexity. The first order LMV PLL is described which corresponds to work completed in Gustafson and Speyer[111]. The following section addresses a second order version of the filter in which the goal is to maintain both phase and frequency lock. Finally, additional modifications for amplitude modification are also implemented. Using this filter, a nonlinear PLL may be constructed using a linear discriminator and implemented in real time.

First Order LMV PLL

The work of Gustafson and Speyer presented a PLL that will be referred to as the first order LMV PLL. The term first order is used since the filter only considers first order variations in the phase.

It is desired to track an incoming carrier wave of the form:
\dot{z}(t)=\sqrt{2A} sin φ(t)+\dot{n}(t). (597)

The measurement has additive white noise \dot{n}(t) with zero mean and variance N(t). The signal has unknown amplitude \sqrt{2A} with mean m₀ and variance σₘ². The signal phase φ for this incoming carrier wave is defined as:
φ(t)=ω_{c}t+θ(t) (598)
where ω_{c} is the carrier frequency and θ(t) is the phase offset. The term θ(t) is assumed to be a Wiener process with the following statistics:

$$θ ( 0 ) = 0 , E [ θ ( t ) ] = 0 , E [ d {θ ( t )}^{2} ] = \frac{dt}{{τ}_{d}} \qquad ( 599 )$$

The term τ_{d} is defined as the coherence time of the oscillator, which is the time for the standard deviation of the phase to reach one radian which is roughly where phase lock is lost using classical PLL's.

The states of the filter are chosen to estimate the in-phase and quadrature versions of the incoming signal. These are defined as:

$$[ \begin{matrix}{x}_{1} ( t ) \\ {x}_{2} ( t )\end{matrix} ] = [ \begin{matrix}\sqrt{2 A} sin ϕ ( t ) \\ \sqrt{2 A} cos ϕ ( t )\end{matrix} ] \qquad ( 600 )$$

Since θ(t) is a Weiner process, the stochastic differential of Eq. 600 in Ito form is given by:

$$\begin{matrix}[ \begin{matrix}{dx}_{1} ( t ) \\ {dx}_{2} ( t )\end{matrix} ] = [ \begin{matrix}- \frac{1}{2 {τ}_{d}} & {ω}_{c} \\ - {ω}_{c} & - \frac{1}{2 {τ}_{d}}\end{matrix} ] [ \begin{matrix}{x}_{1} ( t ) \\ {x}_{2} ( t )\end{matrix} ] dt + & ( 601 ) \\ d θ ( t ) [ \begin{matrix}0 & 1 \\ - 1 & 0\end{matrix} ] [ \begin{matrix}{x}_{1} ( t ) \\ {x}_{2} ( t )\end{matrix} ] & \end{matrix}$$

Note that Eq. 601 contains no process noise term W(t) and that the state dependent noise dθ(t) is a scalar multiplied by a deterministic matrix. The

$$\frac{1}{2 {τ}_{d}}$$

are dissipative terms required to maintain diffusion on a circle. The dynamics may be written in vector form as:
dx(t)=F′(t)x(t)dt+dG(t)x(t) (602)

The measurement in the defined state space is now linear:
dz(t)=Hx(t)dt+dn, H=[1, 0] (603)

Given the dynamic model in Eq. 601 and the measurement in Eq. 603, the problem becomes to determine the gain K(t) which minimizes the cost defined in Eq. 588 using the estimator structure defined in Eq. 587 and repeated here:
d\hat{x}(t)=F′(t)\hat{x}(t)dt+K(t)[dz(t)−H(t){circumflex over (()}x)dt] (604)

In this case a steady state gain is calculated using the steady state solutions to the state variance (Eq. 592) and the error covariance (Eq. 595). The first step is to calculate the matrix Δ(X,t) for use in the calculation of the state variance using Eq. 594. For the present case, Δ(X,t) is calculated as:

$$Δ ( X , t ) = \frac{1}{{τ}_{d}} [ \begin{matrix}{X}_{22} ( t ) & - {X}_{21} \\ - {X}_{12} ( t ) & {X}_{11} ( t )\end{matrix} ] \qquad ( 605 )$$

Then, using the steady state conditions in the state covariance, Gustafson and Speyer[111] calculate the state covariance as:

$$X ( t ) = \tilde{A} [ \begin{matrix}1 - exp \frac{- 2 t}{{τ}_{d}} cos 2 {ω}_{c } t & exp \frac{- 2 t}{{τ}_{d}} sin 2 {ω}_{c } t \\ exp \frac{- 2 t}{{τ}_{d}} cos 2 {ω}_{c } t & 1 + exp \frac{- 2 t}{{τ}_{d}} sin 2 {ω}_{c } t\end{matrix} ] \qquad ( 606 )$$

with \overline{A}=(mₒ²+σₘ²)/2. Note that as t→∞, X(t)→\overline{A}I where I is the identity matrix.

Gustafson and Speyer calculate the steady state error covariance as:

$$[ \begin{matrix}{P}_{11} ( ∞ ) & {P}_{12} ( ∞ ) \\ {P}_{21} ( ∞ ) & {P}_{22} ( ∞ )\end{matrix} ] = [ \begin{matrix}\tilde{A} {\tilde{P}}_{θ1} ( \sqrt{{\tilde{P}}_{θ1}^{2} + 2} - {\tilde{P}}_{θ1} ) & [ \tilde{A} - {P}_{11} ( ∞ ) ] / 2 {ω}_{c} {τ}_{d} \\ [ \tilde{A} - {P}_{11} ( ∞ ) ] / 2 {ω}_{c} {τ}_{d} & {P}_{11} ( ∞ ) + [ {P}_{11} ( ∞ ) ( 1 + \frac{1}{{P}_{θ 1}} ) - A ] / 2 {ω}_{c}^{2} {τ}_{d}\end{matrix} ] \qquad ( 607 )$$

The steady state solution is achieved assuming the following:
(ω_{c}τ_{d})²>>1, (ω_{c}τ_{d})²>>Ãτ_{d}/N₀ (608)

Note that the inverse of the signal to noise ratio is defined as:
\tilde{P}_{θI}=\sqrt{N₀/2Ã}τ_{d} (609)

Note also that as ω_{c}τ_{d}→∞, P₁₂(∞)→0, and P₂₂(∞)→P₁₁(∞).

Finally, if it is assumed that the filter operates above threshold, the P₁₁(∞)≅\sqrt{2}Ã\tilde{P}_{θI}, and P₁₂(∞)≅Ã/2ω_{c}τ_{d}. Using these simplifications it is possible to calculate the gains for the steady state case as:
K(∞)=[2\sqrt{Ã}/N₀τ_{d} Ã/ω_{c}τ_{d}N₀] (610)

Using the gain calculated in Eq. 610 in the update of Eq. 604, it is possible to calculate the state estimate which minimizes the cost function defined. Gustafson and Speyer[111] show that this filter performs nearly 1 dB better than the classical PLL below threshold.

Second Order LMV PLL

The previous development described the LMV PLL designed to track variations in the phase and estimate the amplitude. A more complex form is now determined which takes into account variations in frequency. These variations may arise from Doppler shift due to receiver motion or oscillator frequency changes due to variations in temperature. Further, the filter is enhanced to include an explicit model for variations in signal amplitude. This change in signal amplitude may arise from processing techniques in the radio front-end design to ensure that the signal is passed through the digitization step in the presence of variable additive noise.

As before, it is desired to track an incoming carrier wave of the form:
\dot{z}(t)=\sqrt{2A} sin φ(t)+\dot{n}(t). (611)

The measurement has additive white noise \dot{n}(t) with zero mean and variance N(t). The signal has unknown amplitude \sqrt{2A} with mean m₀ and variance σₘ². The signal phase φ for this incoming carrier wave is now defined as:
φ(t)=ω(t)t+θ(t) (612)
where θ(t) is the phase offset defied with statistics in Eq. 599. The received carrier frequency ω(t) is defined in terms of a deterministic carrier frequency ω_{c} and a frequency drift ω_{d}(t) as:
ω(t)=ω_{c}+ω_{d}(t) (613)

The term ω_{d}(t) represents Doppler shift due to user motion or oscillator drift and is assumed to be a Wiener process with the following statistics:
ω_{d}(0)=0, E[ω_{d}(t)]=0, E[dω_{d}(t)²]=αdt (614)
where α is the expected variation in user motion acceleration.

With these definitions, the definition of φ(t) is:
φ(t)=ω_{c}t+ω_{d}(t)t+θ(t) (615)

Previously, the states of the filter are chosen to estimate the in-phase and quadrature versions of the incoming signal. However, this choice does not lend itself to a linear structure. These are defined as:

$$[ \begin{matrix}{x}_{1} ( t ) \\ {x}_{2} ( t )\end{matrix} ] = [ \begin{matrix}\sqrt{2 A} sin ϕ ( t ) \\ \sqrt{2 A} cos ϕ ( t )\end{matrix} ] \qquad ( 616 )$$

This state space results in the following filter dynamics derived using the same steps used previously:

$$\begin{matrix}[ \begin{matrix}{dx}_{1} ( t ) \\ {dx}_{2} ( t )\end{matrix} ] = [ \begin{matrix}- \frac{1}{2 {τ}_{d}} - \frac{α {t}^{2}}{2} & {ω}_{c} + {ω}_{d} \\ - {ω}_{c} - {ω}_{d} & - \frac{1}{2 {τ}_{d}} - \frac{α {t}^{2}}{2}\end{matrix} ] [ \begin{matrix}{x}_{1} ( t ) \\ {x}_{2} ( t )\end{matrix} ] dt + & ( 617 ) \\ [ \begin{matrix}0 & d θ ( t ) + d {ω}_{d} t \\ - d θ ( t ) - d {ω}_{d} t & 0\end{matrix} ] [ \begin{matrix}{x}_{1} ( t ) \\ {x}_{2} ( t )\end{matrix} ] & \end{matrix}$$

Note the time dependence in the process noise. This time dependence enables the observability of the Doppler shift rate separated from the phase error.

This version of the filter requires the ability to estimate the Doppler shift ω_{d} (t). The continuous time version requires the following derivative to be calculated:

$${\hat{ω}}_{d} = \frac{ⅆ}{ⅆ t} arctan \frac{{x}_{1}}{{x}_{2}} \qquad ( 618 )$$

It is assumed that in the discrete time version of the filter that the dynamics would operate based upon the previous value of the Doppler shift, \overline{ω}_{d}. After the filter updates, the Doppler term would be updated at each time step Δt as:

$${\hat{ω}}_{d} = ( arctan \frac{{x}_{1}}{{x}_{2}} - {\overline{ω}}_{d} ) / Δ t \qquad ( 619 )$$

Note that Eq. 619 eliminates the effect of variations in amplitude. Alternately, the navigation system may provide an estimate of the Doppler shift directly from the navigation estimator. For GPS ultra-tight applications, the estimated value of satellite range rate would be used instead of \overline{ω}_{d}.

Similarly, the amplitude is estimated based upon the sum of the squares of the states as:
Â=x₁²+x₂² (620)

In this way, both the Doppler bias and amplitude are estimated explicitly by the filter.

It is noted that the calculation of steady state gains for this model are particularly difficult to calculate either analytically or numerically since the state dependent noise terms have time dependency. Therefore a simplification is sought.

Simplification of the Second-Order Filter

The preceding section discussed a second-order filter derived in a somewhat ad-hoc manner using the first order LMV PLL, derived previously, combined with estimates of the amplitude and frequency shift based upon the estimates. The previous section modelled the change in frequency as a Brownian Motion process. A simpler choice, which reduces the mathematical complexity, is to assume that the change in frequency acts as a bias with no dynamics and is not time varying. The definition of φ(t) becomes:
φ(t)=ω_{c}t+ω_{d}t+θ(t) (621)

While this is clearly not the case for moving vehicles receiving radio waves, the simplification eliminates the time dependence of the state dependent noise terms. The new dynamics are described as:

$$\begin{matrix}[ \begin{matrix}{dx}_{1} ( t ) \\ {dx}_{2} ( t )\end{matrix} ] = [ \begin{matrix}- \frac{1}{2 {τ}_{d}} & {ω}_{c} + {\overline{ω}}_{d} \\ - {ω}_{c} - {\overline{ω}}_{d} & - \frac{1}{2 {τ}_{d}}\end{matrix} ] [ \begin{matrix}{x}_{1} ( t ) \\ {x}_{2} ( t )\end{matrix} ] dt + & ( 622 ) \\ [ \begin{matrix}0 & d θ ( t ) \\ - d θ ( t ) & 0\end{matrix} ] [ \begin{matrix}{x}_{1} ( t ) \\ {x}_{2} ( t )\end{matrix} ] & \end{matrix}$$

where \overline{ω}_{d} is the a priori estimate of the frequency shift from the true carrier frequency. The dynamics are now based upon estimates of the state requiring an Extended Kalman Filter structure.

The dynamics and filter model now reduce to a form similar to the first-order LMV PLL as presented previously, so long as ω_{d} is known. Since ω_{d} is unknown, it must be estimated and used in the processing of the filter, resulting in an Extended Kalman Filter structure. Further, the steady state gains may no longer be used since these gains change with the value of ω_{d}.

However, the dynamics of Eq. 622 are similar in basic form to the dynamics of Eq. 601. In fact, the assumptions used to calculate the steady state values for the error covariance and filter gains are still maintained. For instance, the steady state variance of the state still tends towards the identity matrix. The new steady state variance is calculated as:

$$X ( t ) = \tilde{A} [ \begin{matrix}1 - {ⅇ}^{- 2 t / {τ}_{d}} cos ( 2 ( {ω}_{c} + {ω}_{d} ) t ) & {ⅇ}^{- 2 t / {τ}_{d}} sin ( 2 ( {ω}_{c} + {ω}_{d} ) t ) \\ {ⅇ}^{- 2 t / {τ}_{d}} sin ( 2 ( {ω}_{c} + {ω}_{d} ) t ) & 1 - {ⅇ}^{- 2 t / {τ}_{d}} cos ( 2 ( {ω}_{c} + {ω}_{d} ) t )\end{matrix} ] \qquad ( 623 )$$

which tends towards ÃI as X(t→∞) regardless of variations in ω_{d}. The system remains observable so that a positive definite error covariance matrix exists. The derivation of the steady state covariance is the same as in the first order loop with the following modifications:

$$[ \begin{matrix}{P}_{11} ( ∞ ) & {P}_{12} ( ∞ ) \\ {P}_{21} ( ∞ ) & {P}_{22} ( ∞ )\end{matrix} ] = [ \begin{matrix}\tilde{A} {\tilde{P}}_{θ1} ( \sqrt{{\tilde{P}}_{θ1}^{2} + 2} - {\tilde{P}}_{θ1} ) & [ \tilde{A} - {P}_{11} ( ∞ ) ] / 2 ( {ω}_{c} + {ω}_{d} ) {τ}_{d} \\ [ \tilde{A} - {P}_{11} ( ∞ ) ] / 2 ( {ω}_{c} + {ω}_{d} ) {τ}_{d} & {P}_{11} ( ∞ ) + [ {P}_{11} ( ∞ ) ( 1 + \frac{1}{{\tilde{P}}_{θ 1}} ) - \tilde{A} ] / 2 {( {ω}_{c} + {ω}_{d} )}^{2} {τ}_{d}\end{matrix} ] \qquad ( 624 )$$

which again uses the following assumptions:
(ω_{c}τ_{d})²>>1, ((ω_{c}+ω_{d})τ_{d})²>>Ãτ_{d}/N₀ (625)
and the inverse of the signal to noise ratio is still defined as:
\tilde{P}_{θI}=\sqrt{N₀/2Â}τ_{d} (626)

The gain is then calculated as:

$$K ( ∞ ) = [ \begin{matrix}2 \sqrt{\tilde{A} / {N}_{0} {τ}_{d}} & \tilde{A} / ( {ω}_{c} + {ω}_{d} ) {τ}_{d} {N}_{0} \\ \tilde{A} / ( {ω}_{c} + {ω}_{d} ) {τ}_{d} {N}_{0} & 2 \sqrt{\tilde{A} / {N}_{0} {τ}_{d}}\end{matrix} ] \qquad ( 627 )$$

Using this gain set, the steady state gain can be calculated based upon the current estimate of the angular velocity. The algorithm is presented as follows at each time step
1. At the beginning of each time step, the a priori estimate \overline{x}, the a priori estimate of the Doppler shift \overline{ω}_{d}, the a priori estimate of the amplitude \overline{A}, and, optionally, the steady state covariance P is available.
2. The measurements z(t) are taken at the current time. The measurement rate is assumed to happen at a fixed interval corresponding to the period Δt. The measurements include dependence on either x₁(t), x₂(t), or both depending on whether the in-phase, quadrature, or both measurements are available.
3. calculate the a priori value of Ã as
   Ã=(\overline{A}²+σₘ²))²/2 (628)
4.
5. Calculate the a priori inverse of the signal to noise ratio:
   \tilde{P}_{θI}=\sqrt{N₀/2Ã}τ_{d} (629)
6. Calculate the residual r as
   r(t)=z(t)−H\overline{x}(t) (630)
7.
8. Optionally calculate the steady state error covariance as:

$$P ( t ) = [ \begin{matrix}\tilde{A} {\tilde{P}}_{θ1} ( \sqrt{{\tilde{P}}_{θ1}^{2} + 2} - {\tilde{P}}_{θ1} ) & [ \tilde{A} - {P}_{11} ( t ) ] / 2 ( {ω}_{c} + {\overline{ω}}_{d} ) {τ}_{d} \\ [ \tilde{A} - {P}_{11} ( t ) ] / 2 ( {ω}_{c} + {\overline{ω}}_{d} ) {τ}_{d} & {P}_{11} ( t ) + [ {P}_{11} ( t ) ( 1 + \frac{1}{{\tilde{P}}_{θ 1}} ) - \tilde{A} ] / 2 {( {ω}_{c} + {\overline{ω}}_{d} )}^{2} {τ}_{d}\end{matrix} ] \qquad ( 631 )$$
9.
10. Calculate the filter gain K(t) as:

$$K ( t ) = [ \begin{matrix}2 \sqrt{\tilde{A} / {N}_{0} {τ}_{d}} & \tilde{A} / ( {ω}_{c} + {\overline{ω}}_{d} ) {τ}_{d} {N}_{0} \\ \tilde{A} / ( {ω}_{c} + {\overline{ω}}_{d} ) {τ}_{d} {N}_{0} & 2 \sqrt{\tilde{A} / {N}_{0} {τ}_{d}}\end{matrix} ] \qquad ( 632 )$$
11.
12. Calculate the state correction as:
   δ\hat{x}(t)=K(t)r(t) (633)
13.
14. Update the state as \hat{x}(t)=\overline{x}(t)+δ\hat{x}(t).
15. Calculate the new amplitude as:
   δÂ—=(\hat{x}₁(t))²+(\hat{x}₂(t))²−Â (634)
16.
17. Calculate the new frequency correction term as:
   δ\hat{ω}_{d}=(tan⁻¹(\hat{x}₁(t)/\hat{x}₂(t))−tan⁻¹(\overline{x}₁(t)/\overline{x}₂(t)))/Δt (635)
18. Note that other discriminator functions are available as defined in Parkinson [25] for multiple GPS receiver types. This discriminator is chosen for the current discussion since it preserves the underlying mathematics most completely.
19. Optionally, the user may chose to filter both the amplitude and frequency correction through a second order filter designed similar to a PLL [112]. The corrections are used as an input and the outputs are used in the actual estimation process. Adding in filtering tends to smooth the results and improve performance. The example presented uses a filtered output for both the amplitude and phase.
20. Update the frequency and amplitude as:
   Â=\overline{A}+δÂ (636)
21.
   \hat{ω}_{d}=\overline{ω}_{d}+δ\hat{ω}_{d} (637)
22.
23. Form the dynamics over the particular sample interval Δt:

$$F = [ \begin{matrix}0 & {ω}_{c} + {\hat{ω}}_{d} \\ - {ω}_{c} - {\hat{ω}}_{d} & 0\end{matrix} ]$$
24. Then calculate the state transition matrix as:
   Φ(t+Δt)=e^{FΔt} (639)

Note that simple approximations are not valid for calculating this matrix exponential. Since second order dynamics are an important part of the filter structure, second order or higher approximations are required.
25. Propagate the states:
   \overline{x}(t+Δt)=Φ(t+Δt)\hat{x}(t) (640)

Note that the amplitude and frequency are assumed to have no dynamics and are propagated as \overline{A}(t+Δt)=Â(t) and \overline{ω}_{d}(t+Δt)=\hat{ω}_{d}(t).

At this point the filter algorithm is complete. Several variations are possible including filtering methods for the amplitude and frequency corrections. The use of the steady state gain for performing a discrete time filter update is not justified since the frequency terms must be updated at each time step. However, once the gain is updated with the most recent estimate of the frequency, the steady state calculation may be used since it is assumed that the time step Δt is small compared with the real part of the dynamics or any rate of change of Ã or ω_{d}, although not necessarily the carrier frequency ω_{c}.

Spread Spectrum LMV Filtering

Spread spectrum communications have become prevalent in modern society. One type of communication process modulates a known coded sequence onto a carrier frequency. Then different processes are used to both track the encoded sequence as well as extract the carrier phase. Typical methods are presented in [112].

The LMV PLL may be used as a method of tracking the carrier phase from a spread spectrum communication system. Typical signals are modelled as:
\dot{z}(t)=c(t)d(t)\sqrt{2A} sin ω(t)+\dot{n}(t) (641)
where c(t) is the coding sequence and d(t) is the data bit. The other variables have been defined previously. It is assumed that the coding sequence rate is much larger than the data sequence frequency. The coding sequence is known where as the data sequence must be estimated. To estimate the data sequence, the code and the carrier must be extracted. A new method is presented in which the LMV PLL is combined with the typical tracking sequence in order to track both the code and the carrier. The remaining residual must be estimated to determine the data sequence, which is not considered in this treatment.

The code sequence is a series of N chips, each chip is of length Δ in time. The code sequence is typically designed such that mean value calculated over N chips is zero and the autocorrelation function meets the following criteria:

$$\begin{matrix}E [ c ( t ) c ( t + τ ) ] = 1 if τ = t & ( 642 ) \\ = 1 - \vert τ - t \vert if \vert τ - t \vert \leq Δ / 2 & ( 643 ) \\ = 0 otherwise & ( 644 )\end{matrix}$$

Other constructions are possible, but this one is typical for bi-phase shift key types of correlation similar to GPS [112].

The data sequence is unknown. However, the rate of change of the function d(t) is slow compared to the code length N and is typically multiple integer lengths of N between bit changes enabling code tracking and bit change detection at somewhat predictable intervals.

Typical Code Tracking Loops for GPS

A typical spread spectrum communication system for GPS receivers is depicted in FIG. 9. In this diagram, a typical early minus late code tracking scheme is combined with a prompt carrier tracking. In essence, the input signal of Eq. 641 is input into the system. A replica signal is generated locally and compared with the input signal. Each step is designed to remove a portion of the signal or provide a measure of how well the system is tracking. Then a set of loop filters steer the replica signal generation to drive the error between the actual and replicated signal to zero. The following process outlines the essential aspects of the demodulation process.
1. Take the measurement of Eq. 641 at time t.
2. The measurement is multiplied by the in-phase and quadrature of the replicated carrier signal. The result is two separate outputs:

$$\begin{matrix}{\dot{z}}_{I} ( t ) = \dot{z} ( t ) sin ( \hat{ϕ} ( t ) ) & ( 645 ) \\ = c ( t ) d ( t ) \sqrt{2 A} sin ( δ ϕ ( t ) ) & ( 646 ) \\ c ( t ) d ( t ) \sqrt{2 A} sin ( ϕ ( t ) + \hat{ϕ} ( t ) ) + & ( 647 ) \\ sin ( \hat{ϕ} ( t ) ) \dot{n} ( t ) & ( 648 ) \\ & ( 649 ) \\ {\dot{z}}_{Q} ( t ) = \dot{z} ( t ) cos ( \hat{ϕ} ( t ) ) & ( 650 ) \\ = c ( t ) d ( t ) \sqrt{2 A} cos ( δ ϕ ( t ) ) & ( 651 ) \\ c ( t ) d ( t ) \sqrt{2 A} cos ( ϕ ( t ) + \hat{ϕ} ( t ) ) + & ( 652 ) \\ cos ( \hat{ϕ} ( t ) ) \dot{n} ( t ) & ( 653 ) \\ & ( 654 )\end{matrix}$$

where \hat{φ}(t) is the current estimate of the carrier phase and δφ(t)=φ(t)−\hat{φ}(t) is the error in estimate of the carrier phase. The notation z_{I} is used to denote the in-phase symbol while the z_{Q} notation denotes the quadrature symbol.

Note that there are two terms in each measurement, one low frequency and the other high frequency. The high frequency terms will be assumed to be eliminated in the integration process, which acts as a low pass filter. The high frequency term will henceforth be ignored.

The resulting signals are functions of the code, the data bit, and the error in the carrier phase estimate. Each signal z_{I} and z_{Q} is processed separately now to eliminate the code measurements.
3. Multiply the resulting signals by the code replica at three different points in time. These are typically referred to as the Early, Prompt, and Late functions. The early and late replicas are offset from the prompt signal by a spacing of Δ/2. A total of six outputs are generated, an early/prompt/late combination for the in-phase symbol and an early/prompt/late combination for the quadrature symbol. These new symbols, less the high frequency terms of Eq. 645 and 650, are represented as:

$$\begin{matrix}{\dot{z}}_{IE} ( t ) = {\dot{z}}_{I} ( t ) c ( \hat{t} + \frac{Δ}{2} ) & ( 655 ) \\ = c ( t ) c ( \hat{t} + \frac{Δ}{2} ) d ( t ) \sqrt{2 A} sin ( δ ϕ ( t ) ) + & ( 656 ) \\ c ( \hat{t} + \frac{Δ}{2} ) sin ( \hat{ϕ} ( t ) ) \dot{n} ( t ) & ( 657 ) \\ {\dot{z}}_{IP} ( t ) = {\dot{z}}_{I} ( t ) c ( \hat{t} ) & ( 658 ) \\ = c ( t ) c ( \hat{t} ) d ( t ) \sqrt{2 A} sin ( δ ϕ ( t ) ) + & ( 659 ) \\ c ( \hat{t} ) sin ( \hat{ϕ} ( t ) ) \dot{n} ( \hat{t} ) & ( 660 ) \\ {\dot{z}}_{IL} ( t ) = {\dot{z}}_{I} ( t ) c ( \hat{t} - \frac{Δ}{2} ) & ( 661 ) \\ = c ( t ) c ( \hat{t} - \frac{Δ}{2} ) d ( t ) \sqrt{2 A} sin ( δ ϕ ( t ) ) + & ( 662 ) \\ c ( \hat{t} - \frac{Δ}{2} ) sin ( \hat{ϕ} ( t ) ) \dot{n} ( t ) & ( 663 ) \\ {\dot{z}}_{QE} ( t ) = {\dot{z}}_{Q} ( t ) c ( \hat{t} + \frac{Δ}{2} ) & ( 664 ) \\ = c ( t ) c ( \hat{t} + \frac{Δ}{2} ) d ( t ) \sqrt{2 A} cos ( δ ϕ ( t ) ) + & ( 665 ) \\ c ( \hat{t} + \frac{Δ}{2} ) cos ( \hat{ϕ} ( t ) ) \dot{n} ( t ) & ( 666 ) \\ {\dot{z}}_{QP} ( t ) = {\dot{z}}_{Q} ( t ) c ( \hat{t} ) & ( 667 ) \\ = c ( t ) c ( \hat{t} ) d ( t ) \sqrt{2 A} cos ( δ ϕ ( t ) ) + & ( 668 ) \\ c ( \hat{t} ) cos ( \hat{ϕ} ( t ) ) \dot{n} ( \hat{t} ) & ( 669 ) \\ {\dot{z}}_{QL} ( t ) = {\dot{z}}_{Q} ( t ) c ( \hat{t} - \frac{Δ}{2} ) & ( 670 ) \\ = c ( t ) c ( \hat{t} - \frac{Δ}{2} ) d ( t ) \sqrt{2 A} cos ( δ ϕ ( t ) ) + & ( 671 ) \\ c ( \hat{t} - \frac{Δ}{2} ) cos ( \hat{ϕ} ( t ) ) \dot{n} ( t ) & ( 672 )\end{matrix}$$

The terminology c(\hat{t}) is used since the coding sequence is known a priori and only the actual current point in the sequence, represented by an estimate of the time \hat{t} is unknown and must be estimated.
4. Each of the six preceding symbols are now integrated over one complete sequence of N chips. This process serves two functions. First, the low pass aspect of integration eliminates the high frequency terms that were described in Eq. 645 and 650 and subsequently ignored afterwards. Second, integrating over the N chips reduces other noise segments as a function of the code length. The longer the code length N, the greater the noise is reduced [112]. Only the average value remains with other noise, including the Additive White Gaussian Noise (AWGN) attenuated. For example, the resulting in-phase and early modulated symbol is:

$$\begin{matrix}{y}_{IE} = \frac{1}{N} {\sum }_{j = 1}^{N} {\dot{z}}_{{IE}_{j}} ( t ) & ( 673 ) \\ = \frac{1}{N} {\sum }_{j = 1}^{n} c ( {t}_{i} ) c ( {\hat{t}}_{i} + \frac{Δ}{2} ) d ( t ) \sqrt{2 A} sin ( δ ϕ ( {t}_{i} ) ) + & ( 674 ) \\ \frac{1}{N} {\sum }_{j = 1}^{N} c ( \hat{t} + \frac{Δ}{2} ) sin ( \hat{ϕ} ( t ) ) \dot{n} ( t ) & ( 675 )\end{matrix}$$

The other symbols are similarly defined. Note that the AWGN term is attenuated by the integration process. The zero mean assumption on the noise term \dot{n}(t) combined with the multiplication by the code attenuates the noise level enabling the detection of signals with amplitude much less than the power of the AWGN.
5. The results of the integration are processed through the “discriminator” functions. These discriminators essentially form a residual process used to correct the replica signal for errors.

Two discriminators are formed. The first is used to provide feedback to the code tracking loop. A typical discriminator is of the form
D_{code}(t)=(y_{IL}²+y_{QL}²)−(y_{IE}²+y_{QE}²) (676)

Note that this discriminator only processes the early and late symbols.

The prompt symbols are used to process the carrier phase. For a phase lock loop, a typical discriminator function is described as:
D_{carrier}(t)=tan⁻¹(y_{QP}/y_{IP}) (677)

Again, note that only the prompt symbols are used to correct the carrier phase and the early and late symbols ignored.

The discriminator functions are highly nonlinear. The analysis of each assumes that the error in the code time t−\hat{t} and phase δφ(t) are constant over the integration time NΔt. Many other types of discriminators are used including discriminator functions designed to track frequency rather than phase. Parkinson [25] lists a wide arrangement of discriminators.
6. The output of each discriminator is passed through a filter structure in order to provide smooth commands to the steer the replica signal generator, usually a numerically controlled oscillator (NCO).
   \hat{t}=G_{code}(s)D_{code} (678)
   \hat{φ}(t)=G_{carrier}(s)D_{carrier} (679)

The transfer functions G_{code}(s) and G_{carrier}(s) are typically time invariant, second order SISO systems. Design of these filers is discussed in [112].

In this way the typical tracking loop structure is defined. Many variations exist including various chip spacings for the early and late, multiple code representations of various spacings and various filter and tracking loop components.

Using the LMV for Carrier and Code Tracking

The LMV provides an alternate means for tracking the carrier phase. The previous algorithm is modified to employ the LMV through out the code and carrier tracking process. The result is a new and novel means of performing spread spectrum communications.

The input is the same in both cases, repeated here for simplicity. As before, the measurement is a function of the carrier phase, the amplitude, the code, and the data as well as AWGN.
\dot{z}₁(t)=c(t)d(t)\sqrt{2A} sin φ(t)+\dot{n}(t) (680)

Note that for some receiver designs, it is possible to have two inputs, one in phase as in Eq. 680 and one in quadrature as in Eq. 681. This structure is created from performing a dual down conversion to an intermediate frequency from the carrier. Each down conversion multiplies the signal by a desired frequency. One frequency is 90° out of phase with the other generating two outputs. Note that the AWGN terms are correlated between Eq. 680 and Eq. 681, which only requires a modification to the LMV algorithm to have a correlated measurement noise.
\dot{z}₂(t)=c(t)d(t)\sqrt{2A} cos φ(t)+\dot{n}(t) (681)

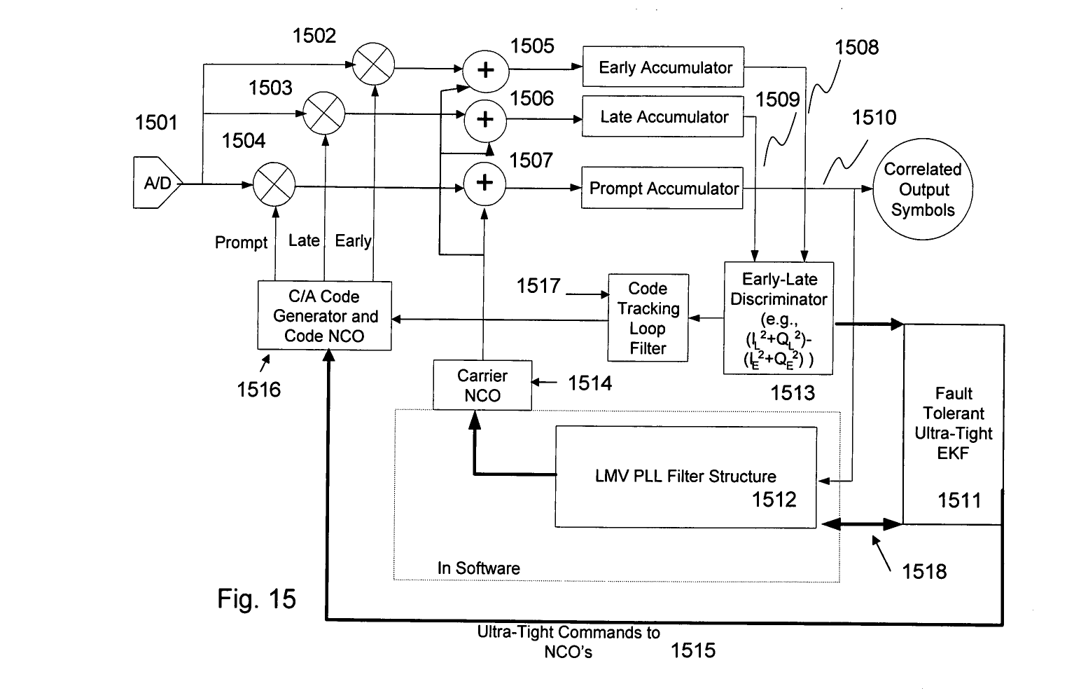

The following procedure makes use of the LMV process described in Section 3. The complete algorithm is outlined in this section. A diagram of the process is presented in FIG. 15. In this case the code generator 1516 mixes with the sampled incoming signal 1501 to generate an early 1502, late, 1503, and prompt 1504 signal. Each of these signals is differenced 1505 1506 1507 with the output of the carrier NCO 1514. The accumulated outputs 1508, 1509, 1510 are processed through the code discriminator 1513, passed through a filter 1517 and used to drive the C/A code generator 1516. Note that this process works on any generic spread spectrum system, not just the GPS C/A code. Further, the output of the prompt accumulator 1510 is processed through the LMV PLL 1512 in order to drive commands to the carrier NCO 1514. Note that the output of both the code discriminator and the LMV PLL may be used as inputs to the ultra-tight EKF 1511 which may generate commands to the LMV PLL 1518 or commands 1515 to the code NCO.

First, the carrier tracking is outlined in the presence of the spread spectrum code. The goal of this algorithm is to show how the carrier phase is calculated and assumes that the code tracking is reasonably aligned. Code tracking is discussed later. This methodology is similar to the standard loop where the code and carrier tracking loops are independent and use different discriminator functions.

The basic function of carrier tracking proceeds in four basic steps. First, the input is multiplied by the code replica which basically removes the code. Then the LMV residual is formed with the output of the previous step and the replica of the carrier. The result is integrated over the code interval N. Finally, the LMV algorithm update and propagation are performed.
1. Take the measurement of Eq. 680 and Eq. 681 and multiply by the prompt code replica.

$$\begin{matrix}{\dot{z}}_{1 P} ( t ) = {\dot{z}}_{1} ( t ) c ( \hat{t} ) & ( 682 ) \\ = c ( t ) c ( \hat{t} ) d ( t ) \sqrt{2 A} sin ( ϕ ( t ) ) + & ( 683 ) \\ c ( \hat{t} ) \dot{n} ( t ) & ( 684 ) \\ {\dot{z}}_{2 P} ( t ) = {\dot{z}}_{2} ( t ) c ( \hat{t} ) & ( 685 ) \\ = c ( t ) c ( \hat{t} ) d ( t ) \sqrt{2 A} cos ( ϕ ( t ) ) + & ( 686 ) \\ c ( \hat{t} ) \dot{n} ( t ) & ( 687 )\end{matrix}$$
2. Next, subtract the appropriate representation for the Second Order LMV PLL for each filter. The states of the LMV filter are defined in Eq. 616.

$$\begin{matrix}{\dot{z}}_{1 {PX}_{1}} ( t ) = {\dot{z}}_{1 P} ( t ) c ( t ) - {\overline{x}}_{1} ( t ) & ( 688 ) \\ = c ( t ) c ( \hat{t} ) d ( t ) \sqrt{2 A} sin ( ϕ ( t ) ) + & ( 689 ) \\ c ( \hat{t} ) \dot{n} ( t ) - & ( 690 ) \\ \sqrt{2 \overline{A}} sin ( \overline{ϕ} ( t ) ) & ( 691 ) \\ {\dot{z}}_{2 {PX}_{2}} ( t ) = {\dot{z}}_{2 P} ( t ) c ( \hat{t} ) - {\overline{x}}_{2} ( t ) & ( 692 ) \\ = c ( t ) c ( \hat{t} ) d ( t ) \sqrt{2 A} cos ( ϕ ( t ) ) + & ( 693 ) \\ c ( \hat{t} ) n ( t ) - & ( 694 ) \\ \sqrt{2 \overline{A}} cos ( \overline{ϕ} ( t ) ) & ( 695 )\end{matrix}$$

Some important differences are apparent between this filter and the standard code tracking loops. First, note that the carrier phase replica does not multiply the AWGN which will improve self-noise performance. Second, note that the carrier replica is not modified by the code error. Finally, if the code is perfectly aligned with the carrier phase, then the the average over all chips N of the function c(t)c(\hat{t}) is one, which causes the residual to reduce to the previous filter structure (disregarding the data bit, which is constant over multiple intervals N).
3. The output is now integrated over an entire set of code chips N to form the residual r as defined in Eq. 630.

$$r ( t ) = \frac{1}{N} {\sum }_{j = 1}^{N} [ \begin{matrix}{\dot{z}}_{{j1PX}_{1}} ( t ) \\ {\dot{z}}_{{j2PX}_{2}} ( t )\end{matrix} ] \qquad ( 696 )$$
4. The residual r(t) is now processed through the LMV algorithm as before using the defined steady state gains to provide an output. The amplitude and frequency are updated as before using the correction term.
5. Using the updated amplitude and frequency, the replica carrier phase generator (typically a numerically controlled oscillator) is updated to continue mixing with the input signals at the input signal rate. Note that using an NCO eliminates the need for the propagation phase of the LMV filter.

Two options exist to modify the code tracking loop. The tradition process consists of multiplying the input signal with the code and carrier replicas, but only to produce early and late samples. The prompt samples are processed as described in this section using the LMV. Since the code tracking discriminator does not use the prompt outputs, a hybrid solution is enabled which is independent of the LMV. However, a second, solution exists for processing the code with the LMV. The following process outlines the new methodology for integrating the LMV process within the code tracking portion.
1. Begin with the same input as in Eq. 680 and Eq. 681. Multiply this input by the early and late code replica.

$$\begin{matrix}{\dot{z}}_{1 E} ( t ) = {\dot{z}}_{1} ( t ) c ( \hat{t} + \frac{Δ}{2} ) & ( 697 ) \\ = c ( t ) c ( \hat{t} + \frac{Δ}{2} ) d ( t ) \sqrt{2 A} sin ( ϕ ( t ) ) + & ( 698 ) \\ c ( \hat{t} + \frac{Δ}{2} ) \dot{n} ( t ) & ( 699 ) \\ {\dot{z}}_{1 L} ( t ) = {\dot{z}}_{1} ( t ) c ( \hat{t} - \frac{Δ}{2} ) & ( 700 ) \\ = c ( t ) c ( \hat{t} - \frac{Δ}{2} ) d ( t ) \sqrt{2 A} sin ( ϕ ( t ) ) + & ( 701 ) \\ c ( \hat{t} + \frac{Δ}{2} ) \dot{n} ( t ) & ( 702 ) \\ {\dot{z}}_{2 E} ( t ) = {\dot{z}}_{2} ( t ) c ( \hat{t} + \frac{Δ}{2} ) & ( 703 ) \\ = c ( t ) c ( \hat{t} + \frac{Δ}{2} ) d ( t ) \sqrt{2 A} cos ( ϕ ( t ) ) + & ( 704 ) \\ c ( \hat{t} + \frac{Δ}{2} ) \dot{n} ( t ) & ( 705 ) \\ {\dot{z}}_{2 L} ( t ) = {\dot{z}}_{2} ( t ) c ( \hat{t} - \frac{Δ}{2} ) & ( 706 ) \\ = c ( t ) c ( \hat{t} - \frac{Δ}{2} ) d ( t ) \sqrt{2 A} cos ( ϕ ( t ) ) + & ( 707 ) \\ c ( \hat{t} + \frac{Δ}{2} ) \dot{n} ( t ) & ( 708 )\end{matrix}$$
2. As before, now subtract out the a priori estimate of the state estimates from the LMV filter modified with the expected code correlation function:

$$\begin{matrix}{\dot{z}}_{1 {EX}_{1}} ( t ) = {\dot{z}}_{1 E} ( t ) - c ( \hat{t} ) c ( \hat{t} + \frac{Δ}{2} ) {\overline{x}}_{1} ( t ) & ( 709 ) \\ = c ( t ) c ( \hat{t} + \frac{Δ}{2} ) ⅆ ( t ) \sqrt{2 A} sin ( ϕ ( t ) ) + & ( 710 ) \\ c ( \hat{t} + \frac{Δ}{2} ) \dot{n} ( t ) - & ( 711 ) \\ c ( \hat{t} ) c ( \hat{t} + \frac{Δ}{2} ) \sqrt{2 \overline{A}} sin ( \overline{ϕ} ( t ) ) & ( 712 ) \\ {\dot{z}}_{1 {LX}_{1}} ( t ) = {\dot{z}}_{1 L} ( t ) - c ( \hat{t} ) c ( \hat{t} - \frac{Δ}{2} ) {\overline{x}}_{1} ( t ) & ( 713 ) \\ = c ( t ) c ( \hat{t} - \frac{Δ}{2} ) d ( t ) \sqrt{2 A} cos ( ϕ ( t ) ) + & ( 714 ) \\ c ( \hat{t} - \frac{Δ}{2} ) \dot{n} ( t ) - & ( 715 ) \\ c ( \hat{t} ) c ( \hat{t} - \frac{Δ}{2} ) \sqrt{2 \overline{A}} cos ( \overline{ϕ} ( t ) ) & ( 716 ) \\ {\dot{z}}_{2 {EX}_{2}} ( t ) = {\dot{z}}_{2 E} ( t ) - c ( \hat{t} ) c ( \hat{t} + \frac{Δ}{2} ) {\overline{x}}_{1} ( t ) & ( 717 ) \\ = c ( t ) c ( \hat{t} + \frac{Δ}{2} ) d ( t ) \sqrt{2 A} sin ( ϕ ( t ) ) + & ( 718 ) \\ c ( \hat{t} + \frac{Δ}{2} ) \dot{n} ( t ) - & ( 719 ) \\ c ( \hat{t} ) c ( \hat{t} + \frac{Δ}{2} ) \sqrt{2 \overline{A}} sin ( \overline{ϕ} ( t ) ) & ( 720 ) \\ {\dot{z}}_{2 {LX}_{2}} ( t ) = {\dot{z}}_{2 L} ( t ) - c ( \hat{t} ) c ( \hat{t} - \frac{Δ}{2} ) {\overline{x}}_{1} ( t ) & ( 721 ) \\ = c ( t ) c ( \hat{t} - \frac{Δ}{2} ) d ( t ) \sqrt{2 A} cos ( ϕ ( t ) ) + & ( 722 ) \\ c ( \hat{t} - \frac{Δ}{2} ) \dot{n} ( t ) - & ( 723 ) \\ c ( \hat{t} ) c ( \hat{t} - \frac{Δ}{2} ) \sqrt{2 \overline{A}} cos ( \overline{ϕ} ( t ) ) & ( 724 )\end{matrix}$$

Note that in this example, the correlation function

$$c ( \hat{t} ) c ( \hat{t} - \frac{Δ}{2} )$$

is known a priori and may be calculated and used as a constant in this function.
3. Each symbol is now integrated over the number of code chips N:

$$\begin{matrix}{y}_{1 {EX}_{1}} ( t ) = \frac{1}{N} {\sum }_{j = 1}^{N} {\dot{z}}_{1 {EX}_{1}} ( t ) & ( 725 ) \\ {y}_{1 {LX}_{1}} ( t ) = \frac{1}{N} {\sum }_{j = 1}^{N} {\dot{z}}_{1 {LX}_{1}} ( t ) & ( 726 ) \\ {y}_{2 {EX}_{2}} ( t ) = \frac{1}{N} {\sum }_{j = 1}^{N} {\dot{z}}_{2 {EX}_{2}} ( t ) & ( 727 ) \\ {y}_{2 {LX}_{2}} ( t ) = \frac{1}{N} {\sum }_{j = 1}^{N} {\dot{z}}_{2 {LX}_{2}} ( t ) & ( 728 )\end{matrix}$$
4. The discriminator functions of the standard code tracking loop are now processed in the same way as in the standard spread spectrum tracking loops of Section 1. A typical discriminator is of the form:
   D_{code}(t)=(y_{1LX}_{₁}²+y_{2LX}_{₂}²)−(y_{1EX}_{₁}²+y_{2LX}_{₂}²) (729)
5.
6. The output of each discriminator is passed through a filter structure in order to update the estimated quantities.
   \hat{t}=G_{code}(s)D_{code}(t) (730)
7. The code NCO is updated with \hat{t}, the replica code time to produce the code tracking loop replica signal.
   Fourth Order LMV PLL

The difficulty with the dynamics defined in Eq. 617 is that the Doppler rate of change is additive with the phase jitter. In addition, the filter structure may be unsuitable for some applications since faults in the Doppler estimation process could drive the filter dynamics away from the nominal conditions.

An alternate version of the filter is now defined which separates the effects of the Doppler shift due to vehicle motion from phase jitter errors explicitly. This model is superior for estimating the effects of receiver clock errors as well as the actual user motion. The alternative formulation uses the following trigonometric functions:
x₁(t)=\sqrt{2A} sin(φ(t))=\sqrt{2A} sin(ω_{d}(t)t)cos(ω_{c}t+θ)+\sqrt{2A} cos(ω_{d}(t)t)sin(ω_{c}t+θ) (731)
x₂(t)=\sqrt{2A} cos(φ(t))=\sqrt{2A} cos(ω_{d}(t)t)cos(ω_{c}t+θ)−\sqrt{2A} sin(ω_{d}(t)t)sin(ω_{c}t+θ) (732)

There are now four terms. A transition of state variables is made now in the following manner:

$$[ \begin{matrix}{y}_{1} ( t ) \\ {y}_{2} ( t ) \\ {y}_{3} ( t ) \\ {y}_{4} ( t )\end{matrix} ] = [ \begin{matrix}\sqrt{2 A} sin ( {ω}_{d} ( t ) t ) cos ( {ω}_{c} t + θ ) \\ \sqrt{2 A} cos ( {ω}_{d} ( t ) t ) sin ( {ω}_{c} t + θ ) \\ \sqrt{2 A} cos ( {ω}_{d} ( t ) t ) cos ( {ω}_{c} t + θ ) \\ \sqrt{2 A} sin ( {ω}_{d} ( t ) t ) sin ( {ω}_{c} t + θ )\end{matrix} ] \qquad ( 733 )$$

From these definitions, we see clearly that:
x₁(t)=y₁(t)+y₂(t) (734)
x₂(t)=y₃(t)−y₄(t) (735)

Using these definitions, it is possible to re-write the dynamics using four states now as:

$$\begin{matrix}[ \begin{matrix}{\dot{y}}_{1} ( t ) \\ {\dot{y}}_{2} ( t ) \\ {\dot{y}}_{3} ( t ) \\ {\dot{y}}_{4} ( t )\end{matrix} ] = [ \begin{matrix}0 & 0 & {ω}_{d} & - {ω}_{c} \\ 0 & 0 & {ω}_{c} & - {ω}_{d} \\ - {ω}_{d} & - {ω}_{c} & 0 & 0 \\ {ω}_{c} & {ω}_{d} & 0 & 0\end{matrix} ] [ \begin{matrix}{y}_{1} ( t ) \\ {y}_{2} ( t ) \\ {y}_{3} ( t ) \\ {y}_{4} ( t )\end{matrix} ] + \\ [ \begin{matrix}0 & 0 & {\dot{ω}}_{d} t & - \dot{θ} ( t ) \\ 0 & 0 & \dot{θ} ( t ) & - {\dot{ω}}_{d} t \\ - {\dot{ω}}_{d} t & - \dot{θ} ( t ) & 0 & 0 \\ \dot{θ} ( t ) & {\dot{ω}}_{d} t & 0 & 0\end{matrix} ] [ \begin{matrix}{y}_{1} ( t ) \\ {y}_{2} ( t ) \\ {y}_{3} ( t ) \\ {y}_{4} ( t )\end{matrix} ]\end{matrix} \qquad ( 736 )$$

Eq. 736 is in the Langevin form. The Ito form requires the calculation of the correction term ΔF given as:

$$Δ F = \frac{1}{2 {τ}_{d}} [ \begin{matrix}- 1 & 1 & - 1 & 1 \\ 1 & - 1 & 1 & - 1 \\ - 1 & 1 & - 1 & 1 \\ 1 & - 1 & 1 & - 1\end{matrix} ] + \frac{{at}^{2}}{2} [ \begin{matrix}- 1 & 1 & 1 & - 1 \\ 1 & - 1 & - 1 & 1 \\ 1 & - 1 & - 1 & 1 \\ - 1 & 1 & 1 & - 1\end{matrix} ] \qquad ( 737 )$$

From this derivation the process of calculating the total filter structure is straightforward although tedious. A direct solution of steady state gains may be intractable.

Applications

The methodology for preserving the integrity of systems has been presented. The methodology has been presented with particular instrumentation for navigation and relative navigation. Several applications of this technology are now specifically described.

In all, the technology has been applied to multiple instrumentation types including GPS, IMU's, magnetometers, ultra-tight GPS/INS, and vision based instruments. Other instruments and models have been examined including the use of vehicle dynamics within the modelling structure.

Navigation Variations

The methodology presented applies to single vehicle applications. Any vehicle or fixed reference point that requires navigation data may make use of the specific methods presented for determining the location of the point in a fault tolerant manner. The type of vehicle is not important unless the vehicle model and control inputs are part of the navigation process. The processes work for airplanes, rockets, satellites, boats, cars, trucks, tractors, and to some extent submarines. The system may also operate on a fixed ground station or a building to provide a fault tolerant reference point for use in relative navigation.

Relative Navigation Variations

Several methods have been presented for performing fault tolerant relative navigation using GPS, GPS/INS and other instruments. The majority have in common the ability to measure relative position, velocity, and attitude. The particular vehicles used are irrelevant. Just as any combination of instruments could be used on any set of vehicles for the single vehicle filter, any combination of vehicles may be used for relative navigation. In particular, the relative navigation schemes work on two aircraft, two boats, two cars, or any other combination. Further, the relative navigation schemes may be used to determine the state relative to a fixed location, such as a runway, which also possesses a set of instruments using this same methodology.

The instrumentation techniques include GPS, INS, direct ranging, incorporation of vehicle dynamics, magnetometers, vision based angle measurements, radio beacons and pseudolites. These instruments may be incorporated in combinations and processed through the high integrity algorithms in order to form the best estimate of the relative and absolute state of each vehicle.

Multiple Vehicle Variations

Note that the procedures apply to multiple vehicles. In the two vehicle case, one vehicle operated as a base while the other operated as a rover. The base vehicle calculates the absolute state estimate of the vehicle relative to the Earth. In contrast, the rover calculates the rover state in such a way as to minimize the error in the state relative to the base vehicle.

Two basic methods are available for expanding on this methodology. The first method utilizes a single base vehicle and multiple rover vehicles all estimating the relative position to the base vehicle. This method minimizes the error in the state relative between each rover and the base. The advantage is that the communication need only proceed from the base vehicle to the rover. Each rover need not communicate with the other.

A second method is to use a sensor chain in which each vehicle acts as both base and rover vehicle. The first base vehicle provides measurements to the next vehicle in the chain. This vehicle calculates the relative state estimate and uses this to calculate the absolute state estimate for the rover vehicle. This new absolute estimate is then used to provide information to a second rover vehicle. This vehicle estimates the relative position to the first rover. Then, it calculates the local absolute position and passes this information to the next rover in the chain. This process may proceed until all vehicles are used. This method suffers from error build up from each vehicle as well as requiring more communication bandwidth. A superior method would be to utilize a single base with multiple rovers while each rover shares information with the other.

However, as a consequence of the chain method, the chain may be closed such that the last rover provides information to the base vehicle to form a final relative state. Using this methodology, it is clear that the total relative estimation error between the first base and the last rover which is converted to an absolute estimate of the base vehicle should have zero error with respect to the original base vehicle absolute estimate used to start the chain. A large deviation in the error indicates a failure within the system.

Many sub combinations using multiple base vehicles and multiple rovers may be used to suit the configuration requirements. For instance one rover may calculate the relative position to multiple base vehicles. However, all of these methods can be derived from the two basic functions derived above.

Reference Observer

A reference observer, which does not contribute to the navigation or relative navigation of any vehicle may observe the measurements, perform relative navigation algorithms, or even act as a relay of messages between vehicles. The reference observer is a third party which may or may not have instruments, but is focused on the retrieving, analyzing, and transmission of measurements and computed results from one or more dynamics systems connected through the network using the navigation or relative navigation methods presented.

Specific Applications

The next sections explicitly describe the process of using the methods presented for two types of applications. The first section describes autonomous aerial refuelling using a probe and drogue or Navy style refuelling. The second discusses the application to a tethered decoy.

Other applications such as formation flight for drag reduction, automatic docking of two vehicles, or automatic landing would use similar techniques. For instance, if one airplane wanted to physically connect with another in the air, these techniques could be applied to provide a real time, fault tolerant estimate. In the same way that the drogue provides a target for the receiver, a large aircraft attempting to recover a smaller aircraft would provide the smaller aircraft with a landing or connection point.

Similar methods could be used for cars or lifters attempting to pick up cargo or attach to trailers, boats attempting to refuel one another, boats attempting to dock. This method would even apply to a tug boat attempting to guide a tanker into port and then guide itself to the dock.

This system could be used to provide real time weapon guidance. An aircraft could utilize a vision based instrument to find a target. Then, utilizing the relative navigation schemes presented, a munition in flight would estimate its location relative to the target. The aircraft would then transmit the location of the target to the munition. The munition would use the combination of the location of the target relative to the aircraft and the aircraft relative to the munition to determine the true target location and strike the target. Finally, farming or open pit mining would also benefit from this technology. In this case, multiple ground vehicles could work together and maneuver relative to each other or a fixed reference point. Similar methods could be employed inside of a factory.

Autonomous Aerial Refueling

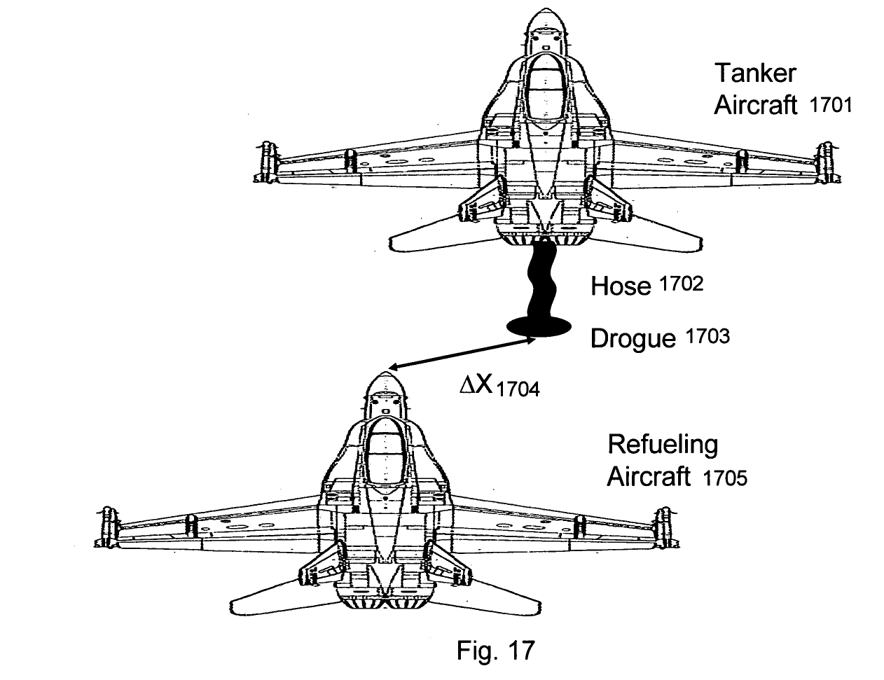

Navy style aerial refueling involves the use of a probe and drogue. The tanker aircraft reals out a hose with a drogue on the end. The receiver aircraft guides a probe into the drogue. When a solid connection is made, fuel transfer begins. FIG. 17 shows two F-18 aircraft. The lead aircraft has a hose and drogue deployed. The first aircraft 1701 contains the fuel. The second aircraft 1705 is attempting to receive fuel. The hose 1702 with a drogue 1703 at the end is deployed. The relative state vector Δx 1704 defines the relative position vector from the receiver to the drogue and is to be estimated in a fault tolerant manner.

This process is one of the more demanding and difficult tasks a pilot must complete. Pilot safety and mission success are dependent upon reliable refueling capability. An autonomous system will provide relief to pilots and increased safety of operations through all weather capability. In addition, un-piloted air vehicles (UAV's) are now entering into the airspace and attempting to complete the same tasks as piloted vehicles. An automated method is needed in order to increase the safety of piloted operations and enable UAV's to refuel.

A novel method employing GPS and GPS/INS is proposed. In this method, the drogue is equipped with one or more GPS receivers around the circumference (or in a known geometry) of the drogue. These receivers acquire satellites, process the measurements and form an estimate of the drogue location. Using a wireless transmission scheme, the drogue sensor transmits the data as either raw measurements or a position estimate to the receiver aircraft. The receiver aircraft processes the data to form a relative state vector Δx between the drogue and the aircraft. The aircraft uses the vector to guide itself into the drogue. Alternatively, for active drogue systems, the drogue and the aircraft could share information to allow feedback control on both the aircraft and the drogue.

This section provides an overview of the system architecture. First the drogue is discussed with possible variations. Then the aircraft instrumentation is discussed also with variations.

Drogue Dynamic Measuring Device (DDMD) Design

The DDMD is an instrument designed to estimate the location of the drogue and provide relative navigation information to any aicraft in the vicinity. The DDMD consists of instruments for measuring drogue dynamics on a tanker aircraft while a second aircraft attempts to link with the drogue. The instrument provides three dimensional position measurements at high output rates. The size of the instrument fits within the size restrictions of the drogue.

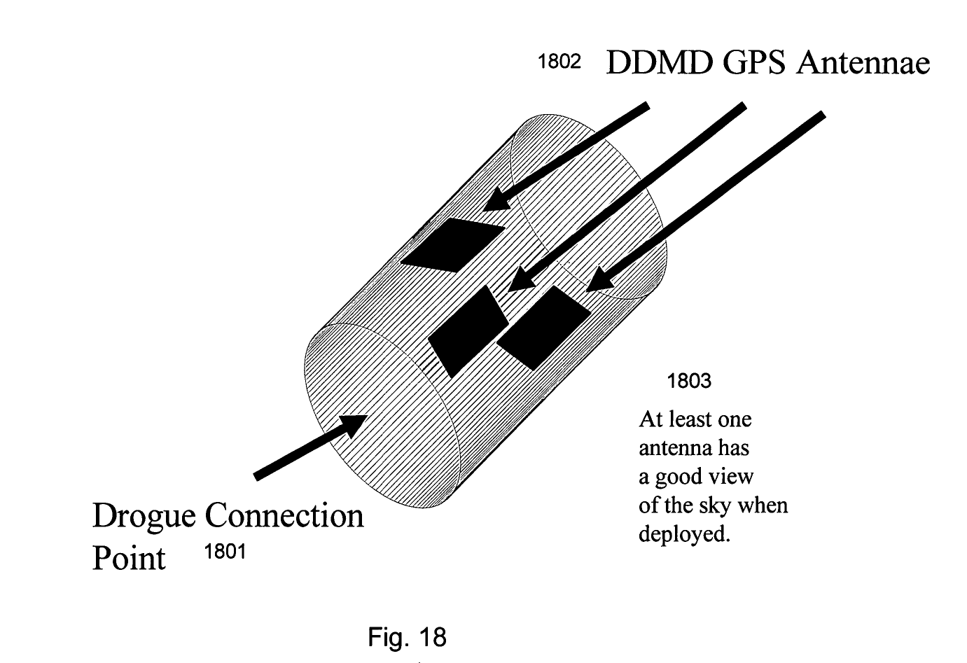

At its core, the DDMD uses multiple GPS antennae spaced at even intervals around the circumference of the drogue as the primary means of measuring drogue motion. The pattern used ensures that at least one receiver had a clear view of un-obstructed sky from which to gather information at all times. FIG. 18 shows a diagram of one proposed spacing. In that figure, multiple GPS patch antennae 1802 are spaced at intervals around the drogue 1801. Each antenna is connected to a separate GPS receiver. Multiple GPS units could be used depending upon the size of the drogue in order to assure that at least one antenna has a good view of the sky to receive satellite signals.

Separate GPS receivers are necessary in order to enable proper drogue positioning. Each receiver may or may not be synchronized to each other in order to reduce the error generated from multiple crystal oscillators. Each receiver measure the raw code, Doppler, and carrier phase shift motion between the satellites and each antenna. Using these measurements the position, velocity and attitude of the Drogue may be measured.

An IMU may be included interior to the drogue to aid in navigation. The algorithms for blending GPS and IMU's as well as using GPS for attitude determination. Magnetometers are also discussed for providing attitude estimates. These navigation aids can help provide the necessary information to translate the GPS measurements to the centerline of the drogue. They may also be used to aid in the correlation process between receivers.

Blending the DDMD with the Aircraft Navigation System

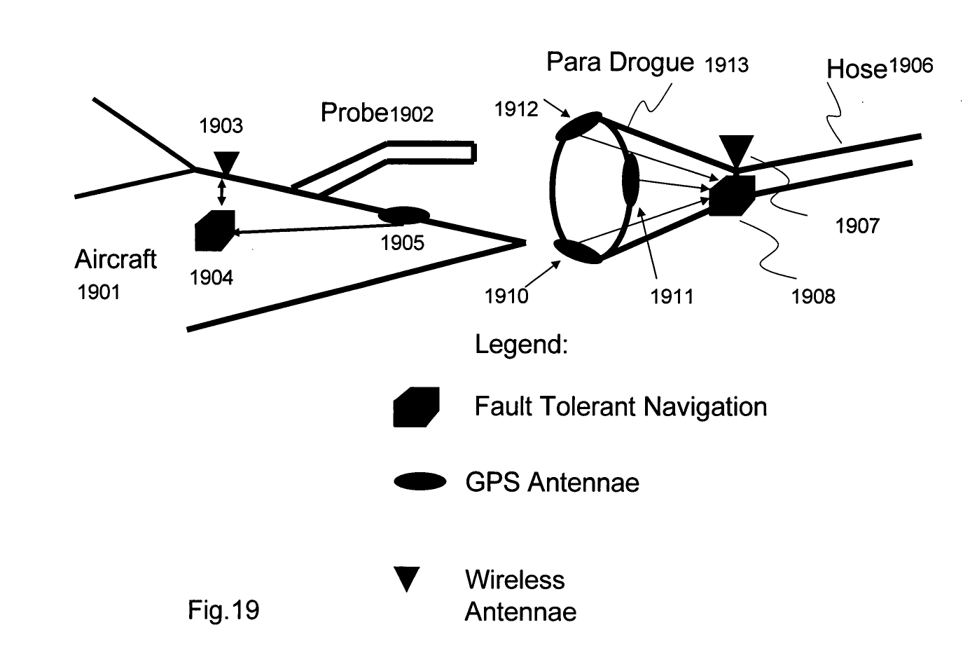

The goal of instrumenting the drogue is to estimate the position, velocity, and attitude of the drogue relative to a receiving aircraft or the tanker. FIG. 19 shows the concept. The refueling aircraft extends a probe and the pilot traditionally must fly the aircraft such that the probe enters the basket on the Drogue, connects, and allows fuel transfer. The figure also shows a Drogue instrumented with a DDMD. In this picture, the aircraft 1901 extends the probe 1902. The aircraft contains the fault tolerant navigation system 1904 which may contain a GPS receiver, an IMU, a wireless communication system and other instruments as needed. The navigation system is attached to at least one GPS antenna 19051905 located somewhere at the surface of the aircraft. The navigation system 1904 is also connected to a wireless communication system antenna 1903. The drogue 1913 attached to the hose 1906 also contains a fault tolerant navigation system 1908 which may have a GPS receiver, an IMU or other instruments. The navigation system 1908 is attached to the multiple GPS antennae 1910, 1911, 1912 located on the para drogue or on the drogue, or on the hose if necessary. Similarly the navigation nsystem 1908 is attached to a wireless communication system antenna 1907. However, the wireless antenna on the drogue may be replaced with a cable running from the navigation system 1908 to the tanker aircraft hosting the drogue (not depicted) which would act as a communication system. The tanker aircraft would then be responsible for transmitting information to and from the aircraft 1901 navigation system 1904 and the drogue 1913 navigation system 1908.

The DDMD transmits the drogue location to the receiver aircraft over a wireless data link. The link may exist on the Drogue or it may transmit through a wired connection back to the tanker which would then transmit to the receiver aircraft.

The receiver aircraft combines the data from the Drogue with data from its own GPS or GPS/INS system in order to estimate the relative state between the aircraft and the Drogue. Using this state estimate, the receiver aircraft guidance system could then navigate the probe into the Drogue since the vector relationship between the GPS receiver on the aircraft and the probe is known. Magnetometers are also discussed.

Overview

SySense has developed a new methodology for measuring the relative distance between an aircraft and an aerial refueling system. Specifically, SySense has developed instrumentation designs and navigation algorithms for performing autonomous aerial refueling. The system is composed of two components, one on the drogue, and the other on the aircraft. The system on the aircraft is composed of a GPS, or GPS/INS combination. The system on the drogue, termed a Drogue Dynamic Measurement Device (DDMD) uses GPS or GPS/INS combined with wireless communication to provide the aircraft with centimeter level relative navigation between the drogue and the aircraft. Using this instrument it is possible for a computer autopilot to locate the drogue and guide the aircraft refueling probe into the refueling system in order to refuel an aircraft.

The system is based on GPS and GPS/INS technology. The DDMD consists of multiple GPS antennae placed on the drogue surface in a known geometry. Each antenna is connected to a separate receiver or receiver architecture so that the R/F signals from each antenna are separated and processed individually. In this way, the signals from each antenna may be used to estimate the position and velocity of the individual antenna. The measurements from each may be combined to estimate drogue attitude and aid in the tracking and acquisition of GPS satellite signals from the other antennae on the drogue. Since the geometry is known, the DDMD may then estimate the location of the center of the drogue and provide this information in real time to another vehicle. Using differential GPS techniques, the drogue may then provide centimeter level positioning measurements from the center of the drogue to the aircraft.

Other instruments may be included in the estimation process on the drogue. An IMU may be used to provide inertial measurements of acceleration and angular rate. The inertial measurements may be used to aid the in the tracking loops of the receiver in an ultra-tight GPS/INS methodology. The IMU or subset of instruments could also be used to predict when satellite signals will come into view for each antenna. A magnetometer, providing 3 axis attitude could be used for the same process.

The receiver aircraft then operates a GPS or GPS/INS navigation system using the relative navigation scheme presented in [14]. This scheme combines differential GPS with an IMU to provide relative navigation between two aircraft to centimeter level. Using the outputs of the DDMD and combined with the processing techniques presented, it is possible to use the relative GPS/INS on the refueling aircraft to provide precise relative position estimates to the drogue in real time. The vehicle guidance and control system would then process these relative navigation states.

The key components of this system consist of the DDMD, the GPS/INS system on the refueling aircraft, and a wireless communication link. Simplifications are possible such as only using GPS on the receiver. Other combinations of instruments may also be integrated into the DDMD and receiver aircraft such as additional inertial instruments, multiple GPS receivers, vision instruments, magnetometers, and the integration of vehicle dynamics. These are all described as additional elements.

DDMD Relative Navigation Implementation

The previous sections described the methodology and instrument models for processing GPS and IMU measurements to form a blended solution. Issues such as distance between the GPS and the IMU, differential GPS, and integer ambiguity resolution were all considered. This section explicitly describes the processing of the DDMD and the interface to the receiver aircraft as well as the processing that is required on the receiver aircraft in order to generate the best estimate of the relative state.

Drogue Centerline Determination

The location of the drogue connection point (DCP) is of interest. Using multiple GPS receivers spaced around the circumference of the drogue, it is possible to mix the code and carrier phase measurements to form an estimate of the DCP location. This section describes the methodology for that estimation process.

Multiple GPS receivers may be used to correct a single IMU provided that the lever arm from each GPS antenna to the IMU could be defined in the body axis coordinate frame. For the drogue, two cases are possible, using GPS measurements or mixing GPS measurements with other instruments such as an IMU. The IMU case is more complex, while a GPS only solution is simpler and uses a reduced state space at the cost of robustness and redundancy.

If an IMU is placed on the drogue, then the methodology applies. All of the GPS antennae would be used to correct the INS location. Then the IMU location would be transferred to the centerline connection point of the drogue using the following relationships, similar to the equations used to transfer location from the antennae to the IMU.
P_{D}_{_{E}}=P_{INS}_{_{E}}+C_{B}^{E}L_{IMU}^{D} (738)
V_{D}_{_{E}}=V_{INS}_{_{E}}+C_{B}^{E}(ω_{IB}^{B}×L_{IMU}^{D})−ω_{IE}^{E}×C_{B}^{E}L_{IMU}^{D} (739)

In this case, P_{D}_{_{E}} and V_{D}_{_{E}} are the ECEF position and velocity of the Drogue connection point and L_{IMU}^{D} is the lever arm distance in the body axis from the IMU center to the connection point. Note that the attitude at the IMU is the same at the connection point assuming that the IMU is rigidly mounted to drogue. In this way, the GPS/INS EKF demonstrated previously could be used to determine the position, velocity, and attitude of the drogue connection point using multiple GPS antennae and an IMU. Note that all of the variations of additional instruments and differential structures presented previously could also be included.

However, the IMU is not a necessary component. If only GPS measurements are available, a reduced structure is employed. A reduced state space consisting of the DCP position, velocity and attitude is estimated. The IMU error states are removed. Using this methodology, the dynamics of the error in the DCP state are defined as:

$$\begin{matrix}[ \begin{matrix}{δ}_{{\dot{P}}_{{D}_{E}}} \\ {δ}_{{\dot{V}}_{{D}_{E}}} \\ δ \dot{q} \\ δ c \dot{τ} \\ δ c \ddot{τ}\end{matrix} ] = [ \begin{matrix}{0}_{3 \times 3} & {I}_{3 \times 3} & {0}_{3 \times 3} & 0 & 0 \\ G - {( {Ω}_{IE}^{E} )}^{2} & - 2 {Ω}_{IE}^{E} & - 2 {C}_{\overline{B}}^{E} F & 0 & 0 \\ {0}_{3 \times 3} & {0}_{3 \times 3} & - {Ω}_{I \overline{B}}^{\overline{B}} & 0 & 0 \\ {0}_{1 \times 3} & {0}_{1 \times 3} & {0}_{1 \times 3} & 0 & 1 \\ {0}_{1 \times 3} & {0}_{1 \times 3} & {0}_{1 \times 3} & 0 & 0\end{matrix} ] [ \begin{matrix}δ {P}_{{D}_{E}} \\ δ {V}_{{D}_{E}} \\ δ q \\ c δ τ \\ c δ \dot{τ}\end{matrix} ] + \\ [ \begin{matrix}0 \\ {v}_{a} \\ {v}_{g} \\ {v}_{τ} \\ {v}_{\dot{τ}}\end{matrix} ]\end{matrix} \qquad ( 740 )$$

In the new dynamics, the process noise is now used to keep the filter open and represents the dynamic range of the drogue in between GPS updates. The specific force and angular velocity matrices are generated from successive velocity and attitude estimates through differentiation. As an alternative, they may be set to zero, provided that the motion of the drogue is effectively bounded by the process noise to keep the filter open.

Likewise, the measurement model for each GPS receiver measurement set with n satellites in view at that receiver is given as:

$$\begin{matrix}[ \begin{matrix}\tilde{ρ} \\ {ρ}^{\dot{\sim}}\end{matrix} ] = [ \begin{matrix}\overline{ρ} \\ \dot{\overline{ρ}}\end{matrix} ] + {[ \begin{matrix}\frac{( {X}_{i} - {x}^{\vec{\_}} )}{{ρ}_{i}} & {0}_{n \times 3} \\ \frac{δ \dot{ρ}}{δ \vec{x}} & \frac{( {X}_{i} - {x}^{\vec{\_}} )}{{ρ}_{i}}\end{matrix} ]}_{2 n \times 6} \\ {[ \begin{matrix}{I}_{3 \times 3} & {0}_{3 \times 3} & - 2 {C}_{\overline{B}}^{E} [ {L}_{IMU}^{D} ⨯ ] & 1 & 0 \\ {0}_{3 \times 3} & {I}_{3 \times 3} & {V}_{{D}_{vq}} & 0 & 1\end{matrix} ]}_{6 \times 17} \\ [ \begin{matrix}δ {P}_{{D}_{E}} \\ δ {V}_{{D}_{E}} \\ δ q \\ c δ τ \\ δ c \dot{τ}\end{matrix} ] + [ \begin{matrix}{v}_{ρ} \\ {v}_{\dot{ρ}}\end{matrix} ]\end{matrix} \qquad ( 741 )$$

where all of the definitions given previously still valid except for V_{D}_{_{vq}} which is redefined using the new lever arm.
V_{D}_{_{vq}}=−2[C_{\overline{B}}^{E}(\tilde{ω}_{I\overline{B}}^{\overline{B}}×L_{IMU}^{D})×]−ω_{IE}^{E}×[C_{\overline{B}}^{E}L_{IMU}^{D}×] (742)

Using these measurement models and dynamics, and EKF may be constructed to determine the position, velocity and attitude in a similar fashion as described previously. Note that the above design assumes that all of the GPS receivers are synchronized to the same clock and operate using the same oscillator. If this is not the case, then a separate set of clock biases for each receiver must be added to the dynamic error state.

Due to common mode errors in the GPS measurements, the designer should limit the use of GPS satellite information to a set which is common for all GPS receivers on the drogue. Further, the multiple GPS antennae techniques are applicable. In this manner, one receiver, the one with the clearest view of the sky is chosen as the primary satellite and the other receivers are used to form double differenced measurements with the primary receiver.

Note that once the receivers lock, the attitude of the drogue will be measured precisely depending upon placement of the antennae. The greater the spread, the more accurate the attitude information.

The procedure consists of the following steps. First a GPS receiver is chosen as the base receiver. Typically, the receiver with the most visible satellites is chosen as the base. The code and Doppler measurements are processed through an EKF using the Measurement models defined in Eq. 740 and 741.

For each of the additional receivers, the following procedure is employed. The double difference code and carrier phase measurements are computed between the primary receiver and the individual receiver a are formed.

Then the Wald Test is used to compute the integer ambiguity ∇Δ\overline{N}. Using the carrier phase measurements, the relative measurement model is defined similarly to Eq. 326 as:
λ(∇Δ\tilde{φ}+∇Δ\overline{N})=∇Δ\overline{ρ}+(C_{base}ⁱ−Cₐⁱ−C_{base}^{j}+Cₐ^{j})δx+∇Δv_{φ} (743)
where the measurement matrix is defined as:

$${C}_{a}^{i} = {{[ \frac{( {X}^{i} - {{x}^{\vec{\_}}}_{a} )}{{ρ}_{i a}^{i}} {0}_{n \times 3} ]}_{n \times 3} [ {I}_{3 \times 3} {0}_{3 \times 3} - 2 {C}_{\overline{B}}^{E} [ {L}_{D}^{a} x ] {0}_{3 \times 2} ]}_{3 \times 11} \qquad ( 744 )$$

Note that the clock terms are not present in the double difference measurements.

The EKF structure now operates using the measurement model in Eq. 743 for each additional receiver on the drogue. The total state estimate correction δ\hat{x} is accumulated for all GPS receivers with available satellites. The state is propagated using the navigation processor with acceleration and gyro inputs of zero or else analytically derived. In this way, the drogue updates the local state estimate. An alternative form would be to neglect the dynamic system and process the state using a Least Squares type of algorithm.

The rotation of the drogue imposes certain constraints on the navigation system. The system must be capable of handling multiple satellite drops and re-acquisitions quickly. This suggests a methodology of linking the receivers together to coordinate time and predict loss/acquisition of satellites as the drogue rotates. With or without these modifications, the navigation software will constantly shift the receiver designated as the base receiver. The algorithm presented here is generic in those terms so long as the lever arm lengths for each GPS receiver relative to the IMU or DCP are known and a minimum number of satelltes (4) are visible on at least three different receivers.

Correlator Prediction and Ultra-Tight GPS/INS

A more advanced and substantially improved version of the drogue design would include the process of GPS correlator aiding to increase acquisition and provide anti-jam capability. Normal GPS receivers only use information from the local GPS receiver to detect, track, and process GPS signals. This section briefly discusses a methodology for linking multiple GPS receivers together to enhance performance.

A method for ultra-tight GPS/INS is discussed in [94]. Ultra-tight GPS/INS is a method in which the correlator and carrier phase tracking loops are aided with inertial informatio. This methodology essentially uses the IMU to compensate for Doppler shift and enhance tracking loop prediction. In addition the methodology may be used for improved acquisition since the ephemeris set and INS provide a means for predicting the code signal. This method could be employed only using a single GPS receiver to provide additional estimates of motion. However, the integration of other instruments or any combination of instruments that provides additional inertial measurements may be used to perform the same process. Using this method, the tracking performance of a single GPS receiver may be enhanced.

In the Drogue case previously presented, each GPS receiver operates separately. It was suggested that the clock reference for each receiver be made common so that only one clock bias and clock drift must be estimated for the entire receiver set. As an additional step towards total integration, the navigation state generated from the combination of receivers could be used to aid in prediction and tracking of satellites for all of the receivers.

There are two benefits. First, the combination of information would aid in the acquisition of signals. As the Drogue rotates, some antennae will be obscured from the sky while others move into a position to receive satellite signals. Since the position of the drogue is known and since the geometry of the antennae is known, the code and carrier tracking loops could be initialized with a prediction based upon the information and location of the tracking loop in another receiver. This would drastically improve re-acquisition time as satellites come into view.

A second enhancement is similar to the ultra-tight GPS. Since more data is available from multiple GPS receivers, these measurements may be used to aid the tracking loops and provide continuous updates for the tracking loops. In this way, the tracking loop bandwidth could be narrowed improving performance and increasing accuracy. This process would be enhanced with additional information. Again, using inertial measurements such as rate gyros, accelerometers, or adding in magnetometers and dynamic modeling will aid in tracking loop estimation. A complete IMU is not necessary but would help.

In this way, the information from all of the GPS receivers as well as from other instruments and dynamic models to provide the best possible tracking performance of the code and carrier loops. An architecture is envisioned in which one processor measures data from multiple correlator and carrier tracking loops each tied to a separate antenna. The processor receives information from other instruments, fuses the information to form the best estimate of the navigation state and then feedsback a portion of that state to the GPS tracking loops to enhance performance.

This process could be used on the drogue. A separate and similar system could be used on the receiver with the receiver aircraft's local GPS or GPS/INS combination with the same permutations previously discussed. It may also be used in differential mode in which the tracking loops on the receiver are updated using the differential GPS/INS EKF. In this scheme, information from the drogue and the receiver aircraft are used to drive the correlation process on the receiver or vice versa. The next section discusses the relative navigation implementation without the ultra-tight implementation, but the use of ultra-tight methods are applicable using the relative navigation filter.

Alternatively, the Drogue could receive information from either receiver or tanker aircraft and mix this data into the system. Information such as GPS jamming and spoofing conditions could also be applied. Additional health monitoring tasks could be added to the basic functionality. To save cost and space, the navigation system on the drogue would benefit from tracking, jamming, and spoofing data from the tanker or receiver aircraft where more expensive and larger instruments are available. In this way, the drogue estimates are protected from GPS jamming or spoofing either through the use of ultra-tight GPS or some combination of ultra-tight and information from the tanker.

Aircraft Relative Navigation

The aircraft attempting to dock with the drogue must estimate its local position. For the refuelling problem, it is assumed that the aircraft operates either a GPS or GPS/INS combination similar to the system presented in previous sections. When the aircraft enters within communication range to the Drogue, then the aircraft switches to a relative navigation scheme similar to the relative navigation scheme. In this case, the drogue acts as the base and the aircraft acts as the rover.

The drogue transmits the position, velocity and attitude of the centerline connection point to the receiver aircraft at a desired output rate. In addition, the drogue transmits raw GPS measurement data to the receiver aircraft. If the drogue only used a single GPS receiver, then the relative navigation problem proceeds as in 2. However, the measurements from multiple receivers at the drogue must be transformed to the connection point of the drogue.

To perform this transformation, one of two methods may be employed. Either the measurements are converted to equivalent measurements at the drogue center point or the raw measurements at each antenna are transmitted and the receiver must navigate relative to all of the drogues. The trade off between.

The location of the IMU, or DCP to each GPS receiver antenna is defined in Eq. 738 and 739. A similar, inverse relationship could be defined. However, since the measurements are a range, and not in vector space, only the portion of lever arm L_{D}^{a} along the line of sight vector is necessary. The conversion equation for the range to satellite i to receiver a to an equivalent range at the DCP point D is given as:

$${ρ}_{D}^{i} = {ρ}_{a}^{i} + [ \frac{( {X}_{i} - {\overline{x}}_{a} )}{{ρ}_{i}} ] ∘ {C}_{B}^{E} {L}_{D}^{a} \qquad ( 745 )$$

where the term

$$\frac{( {X}^{i} - {\overline{x}}_{a} )}{{ρ}_{a}^{i}}$$

represents the line of site row vector between receiver a and satellite i in the ECEF coordinate frame, the term L_{D}^{a} represents the moment arm from the DCP and receiver antenna a, and the operator ∘ represents the vector dot product. The carrier phase measurements would be modified in a similar manner.

$$λ ( {\tilde{ϕ}}_{D}^{i} + {N}_{a}^{i} ) = λ ( {\tilde{ϕ}}_{a}^{i} + {N}_{a}^{i} ) + [ \frac{( {X}_{i} - {{x}^{{\_}^{->}}}_{a} )}{{ρ}_{i}} ] ∘ {L}_{D}^{a} \qquad ( 746 )$$

In this scheme, the integer ambiguity is unchanged and the difference is added to the integrated carrier phase measurements.

The Doppler measurements are modified in a similar manner:

$${{ρ}^{\dot{\sim}}}_{D}^{i} = {{ρ}^{\dot{\sim}}}_{a}^{i} - [ ( \frac{{X}_{i} - {{x}^{{\_}^{->}}}_{a}}{{ρ}_{i}} ) ] ∘ ( {C}_{B}^{E} ( {ω}_{IB}^{B} \times {L}_{D}^{a} ) - {ω}_{IE}^{E} \times {C}_{B}^{E} {L}_{D}^{a} ) \qquad ( 747 )$$

Using Eq. 745 and Eq. 746, an equivalent set of code and carrier phase measurements are generated for use in the relative navigation scheme presented in 2. The code and Doppler measurements are used to initialize the filter and solve the integer ambiguity problem. Once the integer ambiguity is solved, the carrier phase measurements are employed. However, the use of these schemes introduces state estimation error into the measurements and correlates the data with the rover estimates.

An alternate method is to transmit the raw measurements from some or all of the GPS receiver on the Drogue to the receiver aircraft. The receiver would then employ a bank of Wald Test filters to determine the integer ambiguity between the aircraft GPS antenna and each antenna on the drogue. Once the integers are resolved, then all of the carrier phase measurements will be processed within the EKF. The advantage of this method is that the difference of GPS measurements occurs at the antennae locations which ensures that the amount of noise corruption from state estimates are minimized.

The disadvantage of this method is defined in terms of computational power, communication bandwidth, and receiver knowledge. Essentially, the receiver aircraft must now be aware of the drogue operation in terms of the number of GPS receivers on the drogue and the lever arm vectors between each receiver antenna and the DCP. The drogue communication bandwidth requirements increased by the number of antennae on the drogue. Then the receiver aircraft must operate a bank of Wald Test filters to estimate the integer ambiguity. Finally, the receiver aircraft must incorporate many measurements into the relative EKF in order to estimate relative attitude.

### Alternative Embodiments

Multiple variations are possible in this scheme. These may be categorized into configuration variations, navigation variations, and enhancements. Configuration variations have to do with the location and number of GPS and IMU instruments. Navigation variations are variations in the algorithm that perform the same or a subset of the same functions defined here. Enhancements include additional instruments which would add functionality and redundancy.

The configuration of the system has multiple variations. A trade space between size, power, and cost against the required accuracy is required. The number of GPS receivers and the spacing affects system accuracy. The more receivers, the more information and the better the accuracy. Fewer receivers cost less money. The same is true of the IMU. Reduced sets of instruments in which only angular rate sensors or only accelerometers are available are similar subsets of the system. The similar set of changes could be applied to the receiver aircraft using multiple GPS or GPS/INS combinations. Ultra-tightly coupled GPS/INS such as those described in [94] could also be employed. In this way, the IMU actually aids the GPS receiver tracking loops in order to reduce the effect of Doppler, tighten the bandwidth, and reject interference from either GPS jammers or spoofers.

Algorithmic variations are also possible. As noted previously, several types of navigation algorithms may be incorporated depending upon transmission requirements, accuracy requirements, and number of GPS receivers. The use of dynamics or no dynamics are also possible on the drogue.

Several enhancements could be proposed. Adding instruments such as magnetometers, air data suites, or vision based instruments could be incorporated. The magnetometer could be incorporated on the drogue or the aircraft in order to estimate the heading relative to north and stabilize the heading angle. Air data would enable the use of aerodynamic models for improved prediction. Vision instruments would place beacons on the drogue or a camera on the drogue or receiver aircraft. Each of these beacons would provide a range estimate if the geometry is known. The range estimates would be incorporated into the EKF in the same manner that a GPS measurement would be included, but would not have a clock bias term.

Finally, the issue of fault detection must be addressed. The methods presented previously provide a means of insuring integrity. The Shiryayev Test and the Fault Detection Filters define a means for extending the containment integrity and continuity of a GPS/INS (Inertial Navigation System) system. Containment integrity is specified by the maximum allowable probability for the event that the total system error is greater than the containment limit and the condition has not been detected. Continuity is the probability that the system will be available for the duration of a phase of operation, presuming that the system was available at the beginning of that phase of operation. This extension is obtained by the development of a very effective analytical redundancy management methodology based on fault detection filters enhanced with the MHSSPRT for reliable change detection, isolation, and reconfiguring the extended Kalman filter (EKF) of the GPS/INS. This methodology is the theoretical basis for extending the containment integrity and continuity of a navigation system to achieve given accuracy requirements, containment integrity and continuity of a GPS/INS system is characterized by minimal time to alarm with given probability of false and missed alarm, instrument accuracy and reliability, and update rates. This methodology applies to other navigation and instrumentation schemes as well, allowing for a generic theory for determining integrity and continuity from first principles.

Hardware Implementation

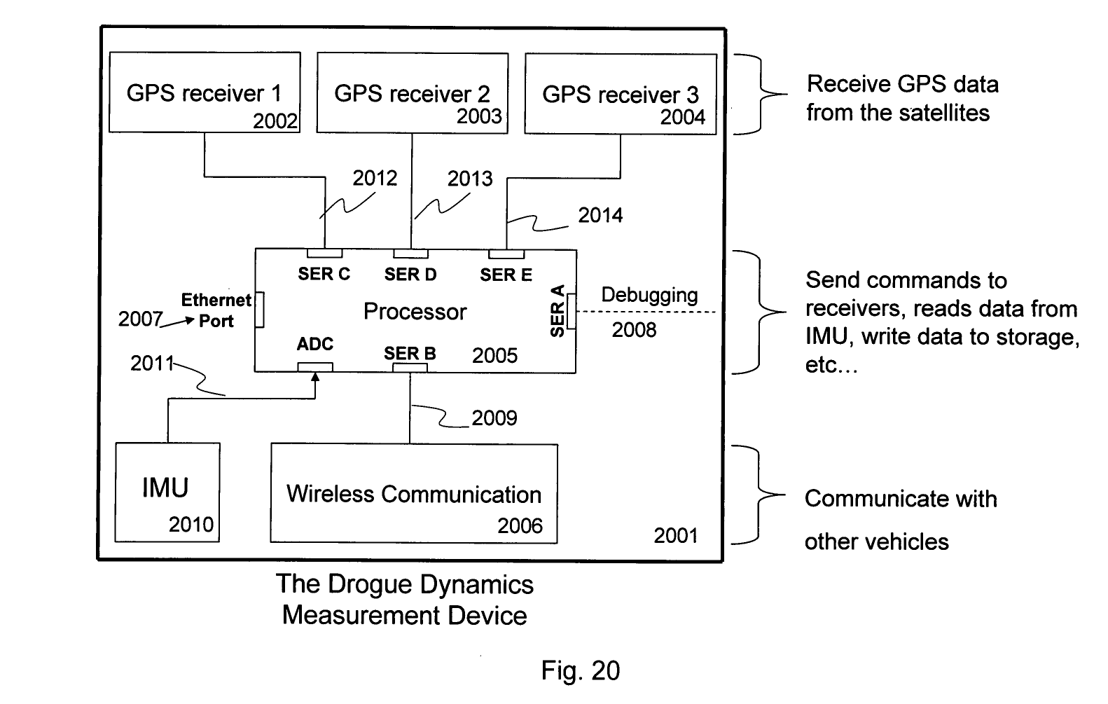

A diagram of one hardware implementation is shown in FIG. 20. This figure shows a minimal implementation in which a single device 2001 composed of three GPS receivers 2002 2003 2004, a micro processor 2005 and a wireless communication system 2006 are connected through various wired data links. The system is generic to the type of interconnections used provided sufficient bandwidth. The microprocessor receives data from the GPS receivers 2012 2013 2014, processes it to estimate the location of the Drogue using the methods previously mentioned, and then transmits the data 2009 to the receiver aircraft over the wireless communication link 2006. External interfaces for debugging 2008 or for providing information through a cable system to the tanker aircraft 2007 are also depicted. Note that the use of Ethernet or serial ports is not required and may be replaced with other, wired standard of electronic communication.

Not pictured in FIG. 20 are several other devices previously discussed such as an IMU placed on the drogue. An IMU would be connected through serial, or through an Analog to Digital Device. As previously discussed, the IMU, and/or a magnetometer could be used to enhance the navigation state and provide feedback to the GPS receiver tracking loops for each of the receivers. Data storage could also be included to backup data through a solid state memory device. Note that the particular medium of digital data transfer (RS-232, SPI, ethernet) is arbitrary and other configurations are possible. In fact, as discussed previously, it is possible to remove the processors on board the particular GPS receivers and combine that functionality onto the main receiver. In this way, the main processor would send data back commands to steer the tracking loop processes on each GPS receiver, functions that are separate from the actual micro-processor on board. A distributed or federated micro-processor architecture could also be employed to maintain the same functionality. Finally, the other configurations of instruments and algorithms previously discussed could be implemented on separate micro processors or integrated through various data links.

Decoy Measurement

This section discloses the use of differential GPS/INS to measure the motion of a towed decoy device relative to the aircraft. The instrumentation system is based on the fault tolerant relative navigation technology to measure relative motion between two moving vehicles to 10 centimeters of accuracy. The disclosed solution relies on an instrumentation package on both the decoy and the aircraft. The data may be stored during flight and post-processed or else the relative navigation solution may be computed using communication between the aircraft and the decoy through either the connecting tether or a wireless communication system.

Overview

SySense has designed a differential GPS solution to measure the relative position between the decoy and the aircraft from which it is deployed. The solution requires that instrumentation on both the decoy and the aircraft store and process data during flight. On the aircraft, it may be possible to use pre-installed instruments combined with SySense hardware and software. However, a specialized instrument, referred to as the Decoy Dynamic Measurement Device (DDMD) provides the instrumentation on the decoy. This device is very similar to and a direct extension of the Drogue Dynamic Measurement Device. A second DDMD is installed within the aircraft deploying the decoy. The data from each set of instrumentation is processed through SySense software to estimate the relative position to high accuracy.

In this concept, an aircraft deploys a decoy connected to a tether. The DDMD instrumentation system on board the aircraft measures the motion of the aircraft. The primary DDMD on the decoy measures the motion of the decoy. Data may be shared between the DDMD instruments through the tether or through a wireless interface. The data may be processed in real time, or stored to a recording device for processing after the flight. The data from each device is processed in order to estimate the relative position vector Δx in the Earth Centered Earth Fixed (ECEF) coordinate frame to centimeter level. Note that after the estimation process, the vector may be easily transferred from the ECEF coordinate frame to any desired frame such as the local tangent frame (East, North, Up) without loss of accuracy.

One example implementation is to use the DDMD devices to store data for a post-flight analysis. In this case, the DDMD on the decoy is designed to record GPS data at a 10 Hz rate for up to 4 hours of flight time. The DDMD uses multiple L1 capable GPS receivers that output both code and carrier phase measurements. This example DDMD was originally designed to fit within a 19 inch diameter Navy style refueling drogue. Multiple receivers were necessary to insure that one receiver tracked a minimum number of satellites regardless of the orientation of the drogue.

Other variations are possible including real time operation. The DDMD may use any combination of L1, L2, and L5 GPS signals provided the hardware meets the size constraint. Additional inertial instruments may be included on the decoy to estimate the decoy motion through the high dynamic motion of deployment before the DDMD can acquire GPS satellites. A wireless communication system can be incorporated to enable real time ranging and communication. The tether could also provide real time communication, timing, and synchronization.

A second DDMD on the aircraft provides measurements of the aircraft motion. This DDMD requires a GPS antenna mounted on the surface of the aircraft near the desired reference point. An IMU may be included to estimate the aircraft attitude and increase update rates. SySense software estimates the aircraft state from the GPS or GPS/IMU. This software takes into account the displacement between the GPS antenna and the IMU. The DDMD on the airplane could be configured to accept aircraft power and the small size fits easily within the aircraft bays. A data link through the tether or through a wireless communication system supplies information from the aircraft to the decoy to improve overall system performance.

SySense uses specially developed software and algorithms to estimate the relative range. This software is based upon the SySense relative navigation software and uses the Wald Sequential Probability Ratio Test to solve the carrier phase integer ambiguity between the aircraft and the decoy. Once resolved, the relative state estimates may be computed using a least squares or Extended Kalman Filter. The estimates are available after processing at the same rate at which data is measured. Using the data, estimates may be achieved with 10 cm (1σ) accuracy between a GPS receiver antenna on the aircraft and GPS antenna on the DDMD. Combining these low rate estimates with the high rate inertial measurements will result in a time history of motion between the decoy and the aircraft even during maneuvers. These time histories would be shared through the wireless communication data link or through the communication system in the tether in order to enable a wide variety of applications.

Concept of Operations

This section discusses the concept of operations for flight. This discussion is for example purposes only. Other variations are possible. Issues of installation are discussed in terms of requirements for the aircraft and decoy. Initialization is discussed. An entire flight is outlined including post-processing of data. Note that the real time communication enables real time data processing, which is discussed at the end of the section.

1, Installation

Two installations must be completed in order to implement the DDMD relative navigation system. One set of instruments is implemented on the decoy. The other set is implemented on the aircraft.

For the decoy, the DDMD is inserted inside the decoy. At least one and possibly multiple GPS antennae will be mounted flush with the surface of the decoy. The entire instrumentation package will fit within the decoy shape. Ballast will be used when necessary to adjust the weight and balance properties. Power will be drawn from either the normal decoy power in the tether or from a set of batteries within the decoy, as required by the user.

The modified decoy fits within the normal decoy deployment casing for flight test. Access to the decoy while on the ground is required for data retrieval and test. A cable from a laptop computer may be attached to the decoy while on the ground in order to retrieve data, load software, and perform pre-flight tests. Alternatively, the DDMD is optionally equipped with a low power wireless device which would allow data transfer without a direct cable connection. This option may be more useful if direct access to the decoy is difficult between flights. A third option is to output data through the decoy tether back to the aircraft.

A second DDMD instrumentation system operates inside of the aircraft. Since the DDMD uses GPS technology, the DDMD will need to have access to a GPS antenna on the aircraft. The DDMD may be connected to an antenna shared with an existing GPS receiver through an antenna splitter, or may use a separate antenna. The DDMD package does not require access to any flight critical systems, but may be configured to interface with the aircraft bus to retrieve additional data, as the user requires. This DDMD may be modified to interface with a reasonably high quality IMU to better track motion of the aircraft. The user may have access to the DDMD on the aircraft before and after flights in order to perform initialization functions, test functions, and retrieve data. Access may be accomplished through a cable from the DDMD to the laptop similar to the access required for the DDMD. This interface may be through a cable or a wireless system as before. Alternatively, both DDMD devices may be configured to automatically configure and initialize before flight tests. The DDMD receives power from the aircraft bus or through a battery system.

2. Initialization

Before each flight, the DDMD may be initialized. This consists of clearing/retrieving stored data from a previous flights, loading relevant initialization parameters (updated ephemeris, date and time), and performing preflight check tests. This action is accomplished either using a laptop computer connected to the decoy or through a wireless network between the decoy and the laptop, depending upon the option selected.

3. Deployment

In flight, both the aircraft and decoy instrumentation must record data simultaneously. The aircraft instrumentation should be on and recording before the decoy is deployed. The decoy power should be active before the decoy is deployed. When deployed, the decoy will start to acquire satellites and take data.

If either wired or wireless communication is available between the aircraft and the decoy, the aircraft DDMD will provide initialization information to the decoy DDMD in order to aid in rapid tracking. Information includes synchronization pulses, updated satellite ephemeris, and clock data.

4. Measurement

While in flight, the decoy will record data while in the air stream behind the aircraft. The GPS measurements will be recorded. Any additional instrumentation on board the DDMD such as an IMU, or magnetometer is also measured and recorded.

Inside the aircraft, the aircraft DDMD system will record GPS, GPS/IMU, or GPS combined with other instruments from the aircraft bus or included in the DDMD.

Communication between the DDMD's is accomplished through the tether or wireless communication system. The communication provides synchronization and timing to ensure that each instrument is synchronized with the other.

In real time operation, the communication system provides a means of sharing measurements between the DDMD's which are used to compute the relative state in real time. The computation of the relative state can be computed at either or both DDMD's and shared via the communication system.

5. Decoy Retrieval

When the decoy mission is completed, the decoy is reeled back into the aircraft. If required, the decoy may be deployed again for repeated tests. When the tests are complete, the decoy may be powered down. After the decoy is powered down, the aircraft DDMD system may also be powered down.

Note that each DDMD may operate independently of the other in order to generate local position, velocity, and attitude estimates. Either may be started first and when the other is started, the relative navigation algorithms are started after communication is established. Alternate versions where the DDMD on the decoy communicates with the DDMD on the aircraft through a wireless system or the tether may be included. In this case, the decoy need not be retrieved but the cable could be guillotined since the relevant would be transmitted from the DDMD to the aircraft through the communication system.

6. Data Retrieval

After a flight when the aircraft is on the ground, the data is recovered from the instrumentation system. The systems are powered on and data is retrieved from both units. Note that the DDMD may be configured to store data from another DDMD if required so that only one DDMD would require power in order to retrieve data. Alternatively, the DDMD's may be operated so that no data is recorded. To retrieve data from the decoy, a computer device is connected to either the decoy DDMD or the aircraft DDMD in order to access and remove the data. Data may be retrieved from both simultaneously if tethered or wireless communication is available.

7. Processing

Once the data is retrieved from both the aircraft and decoy DDMD, the processing of the data begins. This may occur sequentially and in real time after each measurement, or on the ground in post-processing. In post-processing mode, the data is brought back to a laboratory where the data is processed on a desktop computer running SySense software. This software processes the raw data from the experiment, estimates the relative distance between the decoy and the aircraft, and supplies an estimate of the uncertainty in the experiment using the Wald Test. The Wald Test may be operated in real time, as mentioned before so long as measurements from both DDMD's are available at either DDMD where the algorithm resides.

8. Concept Variations

Many variations of this concept are possible. The most important one, as mentioned before, is the use of a real time communication system which would enable relative state estimation in real time.

Further, if the wireless communication option is used, the system could be used to provide the relative drogue position to another aircraft or ground based system in a manner similar to the aerial refuelling drogue.

Baseline Design

The previous section described the total solution proposed with variations. This section calls out explicitly the minimal DDMD hardware and software required. This is an example.

Decoy DDMD

The DDMD on the decoy consists of at least one GPS receiver operating with a micro processor to store the GPS measurements. The DDMD may be configured to have more GPS receivers, inertial measurements of acceleration and angular rate, or other variations. The DDMD includes a communication device for transmitting digital data either wirelessly or through a wired communication system. Real time software may be included to allow the reception of data from another DDMD, or GPS receiver for the computation of real time relative position velocity and attitude between the Decoy DDMD and the other device.

Aircraft DDMD

The DDMD on the aircraft consists of at least one GPS receiver operating with a micro processor to store the GPS measurements. The DDMD includes a communication device for data retrieval, software loading, and communicating with other instruments including the DDMD on the decoy. The communication system may be wireless or wired. Real time software may be included to allow the reception of data from another DDMD, or GPS receiver for the computation of real time relative position velocity and attitude between the Decoy DDMD and the other device.

User Interface Device

SySense includes the provision for a user interface device for performing software and hardware tests on the DDMD, retrieving data, and monitoring real time updates. The interface may be connected by a cable to the DDMD or make use of the existing wireless system on the DDMD. Using this interface, a remote user may monitor the operation of the DDMD or sets of DDMD's.

Relative Navigation Software

SySense has developed real time software that estimates the relative distance between each DDMD. The software may be loaded onto each DDMD, may operate on the User Interface Device, or may be used to analyze data collected from the DDMD.

Hardware Design

The original DDMD was designed for an autonomous aerial refueling experiment to demonstrate real time Navy style probe and drogue refueling. The original instrumentation was designed to fit between the outer shroud and inner fuel flow lines of the refueling drogue.

The original DDMD minimally consisted of at least one and typically three GPS receivers on a single board, a micro-processor, and a solid state storage device. An example implementation block diagram is shown in FIG. 20. Each receiver communicated to the micro-processor through a serial port. The processor stored the data to a solid state disk card. The system could communicate the data through a serial port, an Ethernet port, or through a Bluetooth wireless device (not pictured) either during operation or after the test was completed. Other wireless communication devices may be implemented as necessary. Typically, the GPS data was stored during tests and then retrieved using one of the communication ports for post processing.

In this embodiment, the size was designed to fit within the Navy refueling drogue. A battery supplied power. The battery power was designed to be sufficient to provide power to the DDMD over several flight tests without recharging. Each of the 3 GPS receivers was roughly 50 mm×100 mm. The shape of the device was designed by fitting two receivers side by side to form a square. Each receiver is a separate device so that the shape of the device can be modified by rearranging the GPS receivers into an in-line configuration in order to meet decoy size requirements.

The original DDMD was built assuming that the drogue was reeled out slowly and that the distance between the drogue and the aircraft was less than 50 feet. The new requirements call for a much more energetic deployment and much longer ranges. To meet the requirements for the project, the DDMD must be modified in several ways in order to meet the requirements for this project. The next sections discuss how the DDMD is modified.

Variations

The DDMD inside of the aircraft can be configured in a variety of ways. Previously, the DDMD was configured only to use GPS. The DDMD may be configured to utilize additional instruments which are built in to the DDMD, or to utilize existing aircraft instrumentation. Some of the variations are listed in order to enhance performance. For instance, an IMU could be added to the system in order to estimate attitude. The shape may change as required by the aircraft. Software changes include adding the tether communication interface to the DDMD in the decoy. The necessary changes are described briefly.

Measurement During Deployment

During deployment, the GPS receivers on the DDMD may not be able to receive GPS satellite signals while underneath the aircraft because the aircraft blocks the sky. When the decoy is deployed, the GPS receivers will be exposed to the sky and will begin tracking satellites. Once the receiver has a clear view of the sky, it is expected to acquire satellites within 2-60 seconds. Before this time, GPS data will not be available. Since the decoy deploys at high rate and since it is desired to measure the motion of the decoy during deployment, SySense has developed two enhancements that will enable the ability to track the motion and decrease the time to acquisition during this phase of the test.

One way to improve acquisition time is to ensure that the DDMD has an updated satellite ephemeris set and updated clock time. An updated ephemeris set and accurate time reference will allow the receiver to find satellite more quickly than if the receiver had an old ephemeris set. This data is normally transmitted as part of the GPS signal, once satellites are acquired. However, the data degrades with time unless continually update. The longer the DDMD sits on the ground without access to GPS satellite information, the less accurate the information becomes and the more time the DDMD receivers will take to acquire satellites. Uploading a new data set an hour before flight tests should be sufficient.

Since the DDMD is mounted beneath the aircraft, it cannot receive GPS signals before flight tests. An external source must supply the information. SySense proposes one of two options. The easiest method to update the ephemeris is to load the necessary data during pre-flight initialization. An hour before the flight, a computer equipped with a GPS receiver will be used to measure the latest ephemeris set and then download it to the DDMD before flight. This method should ensure that the worst case time to acquisition to within 10-60 seconds.

An alternative is to actually link the DDMD in the decoy to the DDMD in the aircraft through the tether or through a wireless communication system. A digital link and a shared timing reference synchronize the decoy DDMD with the aircraft DDMD. The aircraft DDMD will have access to the satellite information during all phases of flight, allowing it to provide the ephemeris data and timing information in real time to the DDMD in the decoy. A simple serial interface through the tether would provide the necessary communication. A wireless communication system would provide the ability to pass information back and forth without modification to the tether system. One advantage of adding communication is that the operation of the DDMD instruments become less dependent upon human intervention since a human is not responsible for updating information on the DDMD before flight.

Note that communication or upload before flight is not necessary. The DDMD in the decoy will begin to operate. The use of additional information supplied before flight or during flight test serves to enhance performance and decrease satellite acquisition time. In addition, synchronization eliminates a common clock error between the aircraft and decoy DDMD's. This elimination will improve instrument accuracy.

In order to measure decoy motion during deployment and increase the dynamic range of the DDMD, inertial instruments may be added to the DDMD. SySense will add a module onto the DDMD that consists of a set of silicon based accelerometers and angular rate gyros. This miniature IMU will provide inertial data during deployment. Inertial measurements typically suffer from bias errors that may be calibrated using GPS measurements. The GPS data may be combined with the inertial data in order to estimate the bias errors using the EKF defined in that section. The calibrated measurements will give high quality estimates of the decoy motion before GPS satellite acquisition. The calibrated gyro and accelerometer data can be used to estimate the motion of the decoy during deployment but before GPS data is valid since the bias errors are slowly varying. In addition, these instruments provide high rate measurements during operation. Using these two enhancements, the complete motion of the decoy relative to the aircraft from time of deployment to retrieval can be estimated. A temperature sensor should be added to measure environmental conditions during flight. The addition of these low cost instruments does not significantly affect the size, power, or weight of the DDMD.

Software Variations

The software on board the DDMD will be modified slightly to take into account the changes made. The primary changes include programming the unit to measure the additional instruments, store the new data to solid state memory, and update the GPS receivers with ephemeris data in order to decrease acquisition time. If the communication option is implemented, then the software is modified to take advantage of the tether communication or wireless communication. If real time operation is used, the Wald Test and EKF algorithms are implemented in real time.

Integration Variations

The DDMD on the aircraft may have several variations. Instead of using a built in GPS receiver and IMU, the DDMD may consist of a processor operating on the existing GPS receiver and/or IMU provided that each produces the proper measurement set required to perform navigation, relative navigation and carrier phase tracking. A less accurate version of the system presented could be built without the carrier phase and only using one of the other relative navigation schemes presented or simply using differential GPS [25].

Decoy/Aircraft Communication

Two types of real time communication are possible between the DDMD in the aircraft and the decoy. Wired communication and timing through the tether provides one means of communication. Aa wireless communication system from the DDMD in the aircraft to the decoy could also be used. Both timing and communication are seen as value added, but not necessary, if the DDMD operates in post-processing mode.

The communication system timing reference helps keep the two instruments synchronized resulting in reduced error due to relative latency between the instrument in the aircraft and the instrument in the decoy. This timing system synchronizes the decoy DDMD to the aircraft DDMD during deployment when the DDMD was only taking inertial measurements and had not acquired satellites. However, GPS receivers are essentially very fancy clocks. As the decoy acquired satellites, the receivers will naturally align in time to the GPS 1 PPS sub millisecond level given a set of 6 or more satellites. Both the decoy and aircraft DDMD would be aligned to the 1 PPS. Therefore, timing becomes less of an issue once the decoy has a full view of the sky and has acquired satellites. Sometime after deployment, the decoy receiver would acquire enough satellites and would then be synchronized to the instruments in the aircraft. A timing system through wireless or through the tether would add better timing and ensure that synchronization occurs immediately and remains throughout the flight. This synchronization will improve post-processing accuracy as well as improve initial acquisition time and overall system accuracy.

In addition to timing, a digital communication system provides improved operations. Digital communication would allow the GPS receiver in the aircraft, which would have a clear view of the sky, to provide initialization information to the receiver in the decoy and decrease the amount of time required to acquire satellites. It would also make pre-flight testing simpler since the user would only need to communicate with one device rather than both. In actual flight test, it would be useful to have communication between the decoy and the aircraft so that the aircraft was aware of when the decoy had acquired enough satellites to proceed with the test. It is possible to integrate a real time system that would provide the pilot situational awareness and decoy location during actual operations. For instance, a simple handshake between the aircraft and the decoy tied to a light in the cockpit would let the pilot know the system was operational and it was okay to begin maneuvers.

The DDMD may be configured with either tether communication, wireless communication or both. Wired communication is preferred for superior timing, but timing may be accomplished through the wireless system. Implementing a wireless system also enables the sharing of information with other aircraft so that the relative navigation state may be calculated relative to other decoys or aircraft as needed. Note that the DDMD has a standard output which could be integrated with other, existing wireless communication systems.

Aircraft Attitude

If the user requires relative state information from the decoy to a location on the aircraft other than the GPS antenna, then IMU measurements can be combined with the GPS measurements used to provide an attitude reference for estimating the desired relative position. For instance, if the user requires precise relative distance between the decoy and the engine exhaust nozzle, then IMU data can be recorded and blended with the GPS in order to determine the attitude of the aircraft. The location of the decoy relative to the nozzle is calculated as the vector sum between the decoy and the aircraft GPS antenna and the vector between the aircraft GPS antenna and the engine nozzle. The latter vector requires vehicle attitude in order to calculate which requires an IMU. The IMU will also provide high rate motion data for comparison with the decoy's inertial measurements.

The DDMD may be configured to accept IMU data from the aircraft navigation system or from a separate, DDMD specific IMU. SySense recommends modifying the DDMD to measure outputs from an IMU. A more precise IMU than on the decoy may be used since installation of the larger IMU in the aircraft should not be an issue as compared with the size of the decoy. These ‘MU’s will increase the accuracy of the attitude estimates ensuring that the translation from the GPS antenna to the reference aircraft location does not degrade the relative navigation estimates. Data from the IMU will be stored on board the DDMD and used in the post-processing software.

One alternative to integrating an IMU on the aircraft is to use the installed inertial navigation system. Modern military aircraft are usually equipped with either a Litton or Honeywell inertial system. These systems are very accurate and designed for integration with the control system. It is typically easier to implement a separate IMU on the aircraft than to retrieve data from the existing system since the existing inertial system is likely tied to flight critical components.

A second alternative to estimate vehicle attitude is to employ the multiple GPS receivers within the DDMD. Three or more GPS antennae may be used to calculate attitude of a vehicle. In this way, the aircraft attitude is estimated using hardware that already exists on the DDMD.

GPS Variations

The GPS receiver could be one of several types. The GPS receiver could process data from any combination of L1, L2, or L5 carrier frequencies. It could also process C/A code, P(Y) code (with or without encryption), and eventually M-Code. The receiver could be configured to work with Gallileo, the European version of GPS, or with GLONASS, the Russian variant.

The DDMD consists of at least one GPS receiver. The DDMD may be modified to include multiple GPS receivers. These multiple receivers may be configured to take inputs from separate GPS antennae. In this configuration, the DDMD may store or estimate on line the attitude of a vehicle. In addition, the multiple antennae, positioned around the decoy circumference ensure that at least one antenna has a clear view of the sky and receives strong GPS signals when deployed.

Several anti-jam capabilities could also be included. The receiver could be configured to use ultra-tight GPS/INS processing in which additional instruments are used to correct the tracking and correlation process of the receiver. The receiver could be modified to take into account information from multiple antennae through a single RF design in order to perform beam steering types of applications in which the signals from each antenna are amplified and combined in a nonlinear fashion in order to increase signal to noise ratio.

Other Instruments

Other instruments could be incorporated for a wide variety of applications. The addition of accelerometers and rate gyros has already been described. Some instruments would help with navigation or environmental conditions. For instance, a single, dual, or tri-axis magnetometer could be incorporated in either the aircraft or the decoy. These would help aid in the navigation solution of either the decoy or the aircraft.

Temperature and air pressure measurements could be incorporated to aid in the determination of environmental conditions which or as an aid in GPS tracking to remove troposphere effects. A humidity sensor could also be incorporated for the same reasons. Differential pressure could be used to determine the air speed velocity. Finally alpha and/or beta measurements using veins could be used to help calculate air speed and air mass motion.

Integration with Aircraft Vehicle Systems

The DDMD in either the decoy or the aircraft could be configured to integrate with outputs from vehicle systems. The DDMD in the decoy could utilize an existing navigation system to provide timing and position information. If the navigation system provides carrier phase measurements, these could be transmitted to the decoy for processing through the wireless communication system or the tether. Alternatively, the decoy could be configured to transmit raw measurements to an existing navigation system, control system, data storage device, or any other computer system requiring information from the decoy (See applications below).

Display and Interfaces

The DDMD could be configured with a variety of displays and interfaces. The DDMD could provide outputs through a 1553 line, RS-422, RS-232, Ethernet, SPI. Any digital serial or parallel communication system could be utilized. In addition, the DDMD may be configured to operate with a variety of wireless communication standards. Finally, the DDMD could be configured to interface with a cockpit display to provide real time information to the pilot. Using wireless interfaces, it is possible for the DDMD to communicate with other aircraft or decoys to provide relative navigation information.

A separate device can monitor the DDMD. This device could be a vehicle control system which would utilize the data from the DDMD or DDMD's and provide feedback to the vehicle motion. The device could also be used as a separate monitoring device providing the user with updates in real time. The device could receive raw data from the DDMD's and perform the relative navigation estimation functions of the Wald Test and/or GPS/IMU EKF.

RF Spectrum Analyzer/Decoder

Additional radio receivers, antennae and Analog-to-Digital converters could be incorporated to measure a variety of radio frequency spectrums. This data could be processed on line to determine the frequency spectrum; any encoding of the energy detected and performs demodulation. The goal would be to measure the RF spectrum either emitted from another source (either the airplane, or another source such as a radar ground station). The DDMD could be configured to receive and record the data or process it through a Fast-Fourier Transform, perform digital demodulation, and decoding. The data would then be stored or transmitted to the aircraft through the tether or wireless communication system.

The GPS and IMU combination of the DDMD would provide timing, synchronization, and Doppler shift removal as well as integrated range to target measurements when combined with the RF Spectrum Analyzer. When combined with similar information on the aircraft, both DDMD devices could be used to provide real time, instantaneous measurements of RF energy enabling target location.

RF Transmitters

The DDMD could be configured to transmit a variety of RF energy types not associated with the wireless communication system. The DDMD could be configured with additional communication and wireless systems. The goal would be to either act as a radio repeater separate from the actual aircraft or to transmit energy to jam communication systems of other vehicles.

Vision Based Instruments

Vision based instruments such as video cameras, Infra-red cameras, or radar based systems could be incorporated, if they would fit within the small size of the DDMD or the decoy. These instruments could be used to provide additional range measurements either from the aircraft to the decoy or from the decoy to the aircraft. The vision system could also be used to provide mapping measurements of the terrain below.

Other Applications

The following applications are suggested as uses for the decoy in addition to simple measurement.

Aerial Refuelling Drogue

The DDMD could be used for autonomous aerial refuelling or autonomous capture of small vehicles. For instance, in NAVY style aerial refuelling, the tanker vehicle reels out a drogue which is a refuelling device on a hose, which is similar to the decoy/tether device presented. The DDMD consists of multiple GPS receivers placed in on the drogue in a known geometry. Since the geometry is known, the DDMD may then estimate the location of the center of the drogue and provide this information in real time to a refuelling vehicle. Using differential GPS techniques, the drogue may then provide centimeter level positioning measurements from the center of the drogue to the aircraft.

The other vehicle then operates a second DDMD which receives data from the tanker drogue over a wireless data network. The receiver DDMD system processes data from the drogue DDMD using the relative navigation scheme presented previously. This scheme combines differential GPS with an IMU to provide relative navigation between two aircraft to centimeter level. Using the outputs of the DDMD and combined with the processing techniques using the fault tolerant navigation. It is possible to use the relative GPS/INS on the refueling aircraft to provide precise relative position estimates to the drogue in real time. These relative navigation states would then be fed into the vehicle guidance and control system to help the vehicle connect and link with the refueling system.

The key components of this system consist of the DDMD, the GPS/INS system on the refueling aircraft, and a wireless communication link. Simplifications are possible such as data storage or only using GPS on the receiver. Other combinations of instruments may also be integrated into the DDMD and receiver aircraft as previously described.

Radio Range Receiver

If an RF spectrum analyzer is included on the decoy, then the range to target can be calculated through measuring the increase in energy. The emitter generates energy which the decoy receives. As the decoy moves, a gradient is generated in terms of the signal power. The gradient can be measured as the aircraft flies overhead with the decoy deployed in order to detect the source of the electronic transmission and pinpoint a location.

If an RF spectrum analyzer is included on both the aircraft and the decoy, then a near instantaneous gradient can be generated through the process of measuring energy and performing a correlation on the signal. The encoded signal would arrive at the decoy and the aircraft with a delay. Time aligning the signal using decoding and correlation techniques will provide an estimate of the relative position of the target which may be used in combination with the decoy.

If two decoys are deployed from a single aircraft, then the instantaneous location of the transmitter can be determined using the computed delay in the signal from 3 or more receiving sources. The integer ambiguity techniques provide relative range information between all DDMD's to within centimeters. The DDMD devices are synchronized either through GPS or through the tether. Finally, using the decoding techniques, the signal received and correlated within each aircraft/decoy combination is compared to determine the relative time delay between the received signals. Using the measured relative distance of the decoys, the relative delay between the signal, it is possible to estimate the relative range R1 using the law of cosines for each of the three triangles.

In general, the three triangles will not be coplanar resulting in one unknown in range. However, using multiple measurements in time, the relative range may be estimated as the relative time delay shifts due to the change in relative position of the decoys and knowledge of the aircraft motion and decoy motion. The methodology for measuring the relative motion in time has already been discussed.

Note that the same effect may be achieved using only a single decoy and aircraft provided that a sufficiently large area is swept out by the aircraft motion and decoy.

Air Speed Calibration

A very precise air speed calibration may be developed utilizing the decoy. If a device with known aerodynamic qualities such as the decoy is reeled behind the aircraft, the tension in the tether provides an estimate of the drag force acting on the decoy. The tether could be long enough to move out into the free stream behind the aircraft. Using the tension and known aerodynamic properties and accounting for the motion of the decoy relative to the aircraft, a precise air speed calibration could be performed.

Precise Radar Signature Re-Transmission

The DDMD can be used to detect and retransmit radar transmitted energy. The DDMD could be configured to receive, amplify, and rebroadcast radar RF energy so as to confuse a tracker trying to follow the aircraft. Further, if the aircraft receives the energy, the decoy could retransmit the same energy at a higher power that was received at the aircraft.

Engine Plume/Noise/Signature Evaluation

Measurements of the vehicle plume can be performed using the decoy. The decoy provides precise relative navigation between the aircraft and the decoy. As the decoy is reeled into the engine plume or other aircraft aerodynamic affect such as the wake-vortex, instruments on the decoy can record temperature, pressure, humidity, carbon monoxide, or other types of measurements necessary to determine the air mass motion and air composition of the plume or other aerodynamic effect as a function relative to the aircraft.

### REFERENCES

[1] R. H. Chen and J. L. Speyer, “A Generalized Least-Sqaures Fault Detection Filter,” International Journal of Adaptive Control and Signal Processing, 2000, Vol 14, pp 747-757.
[2] L. H. Mutuel, Fault Tolerant Estimation, Dissertation at UCLA, 2001.
[3] W. H. Chung, J. L. Speyer, “A game theoretic Fault Detection Filter,” IEEE Transactions on Automatic Control 1998; AC-43(2): 143-161.
[4] A. Bryson and C. Y. Ho Optimal Control Theory and Applications, Hemisphere Publishing Corporation, New York, 1975.
[5] Peter S. Maybeck, Stochastic Models, Estimation and Control, Volume 1, Navtech Book and Software Store, Arlington, Va., 1994.
[6] Hull, D. G., Speyer, J. L., and Greenwell, W. M., “Adaptive Noise Estimation for Homing Missiles”, AIAA Journal of Guidance, pp. 322-328, 1984.
[7] Ashitosh Swarup, Linear Quadratic Differential Games with Different Information Patterns, Ph.D. Dissertation, University of California, Los Angeles, USA, 2004.
[8] A. Swarup and J. L. Speyer, “LQG Differential Games with Different Information Patterns,” Proceedings of the IEEE Conference on Decision and Control, Hawaii, 2003.
[9] D. P. Bertsekas, Dynamic Programming and Stochastic Control, Academic Press, Inc., New York, 1976. pp. 139-149.
[10] D. Malladi, J. L. Speyer, “A Generalized Shiryayev Sequential Probability Ratio Test for Change Detection and Isolation,” IEEE Transactions on Automatic Control, VOL. 44, NO. 8, pp. 1522-1534, August 1999.
[11] D. Malladi, J. L. Speyer, “A New Approach to Multiple Model Adaptive Estimation,” Proceedings of the IEEE Conference on Decision and Control, December 1997.
[12] J. L. Speyer, J. E. White, “Shiryayev Sequential Probability Ratio Test for Redundancy Management,” Journal of Guidance, vol. 7 NO. 5, pp 588-595, September, 1983.
[13] J. D. Wolfe, W. R. Williamson, J. L. Speyer, “Hypothesis Testing for Resolving Integer Ambiguity in GPS,” Navigation: Journal of the Institute of Navigation, Spring 2003 Vol. 50, No. 1, p 45-56.
[14] W. Williamson, M. Abdel-Hafez, I. Rhee, E. Song, J. Wolfe, D. Cooper, D. Chichka, and J. Speyer, “An instrumentation System Applied to Formation Flight,” AIAA 1st Technical Conference and Workshop on UAV Systems, Technologies, and Operations, May, 2002.
[15] T. L. Song, J. L. Speyer, “The Modified Gain Extended Kalman Filter and Parameter Idenntification in Linear Systems,” Automatica, 22(1), January 1986.
[16] C. Park, I. Kim, J. G. Lee, G. I. Lee, “Efficient Ambiguity Resolution Using Constraint Equations,” IEEE 1996 Position Location and Navigation Symposium—Plans '96, Atlanta, Ga., pp. 277-284, IEEE, April, 1996.
[17] B. W. Parkinson, J. J. Spiker Jr., Global Positioning System: Theory and Applications, Vol. 1 and 2, American Institue of Aeronautics and Astronautics, Inc., Washington D.C., 1996.
[18] B. Hofmann-Wellenhof, H. Lichtenegger, J. Collins, GPS Theory and Practice, 4th Ed., Springer-Verlag/Wien, New York, 1997.
[19] J. A. Farrell, M. Barth, The Global Positioning System and Inertial Navigation, McGraw Hill, San Francisco, 1999.
[20] NAVSTAR GPS, GPS Interface Control Document ICD-GPS-200, Navtech Seminars and Navtech Book and Software Store, Arlington Va., February 1995,
[21] B. Hofmann-Wellenhof, H. Lichtenegger, J. Collins, GPS Theory and Practice, 4th Ed., Springer-Verlag/Wien, New York, 1997, pp. 73-79.
[22] B. W. Parkinson, J. J. Spiker Jr., Global Positioning System: Theory and Applications, Vol. 1 and 2, American Institue of Aeronautics and Astronautics, Inc., Washington D.C., 1996, Chapter 4, pp 121-176.
[23] B. Hofmann-Wellenhof, H. Lichtenegger, J. Collins, GPS Theory and Practice, 4th Ed., Springer-Verlag/Wien, New York, 1997, pp. 67-72.
[24] B. W. Parkinson, J. J. Spiker Jr., Global Positioning System: Theory and Applications, Vol. 1 and 2, American Institue of Aeronautics and Astronautics, Inc., Washington D.C., 1996, Chapter 2, pp 41-43.
[25] B. W. Parkinson, J. J. Spiker Jr., Global Positioning System: Theory and Applications, Vol. 1 and 2, American Institue of Aeronautics and Astronautics, Inc., Washington D.C., 1996.
[26] J. A. Farrell, M. Barth, The Global Positioning System and Inertial Navigation, McGraw Hill, San Francisco, 1999, p. 145.
[27] B. W. Parkinson, J. J. Spiker Jr., Global Positioning System: Theory and Applications, Vol. 1 and 2, American Institue of Aeronautics and Astronautics, Inc., Washington D.C., 1996, Chapter 11, pp. 478-483.
[28] J. A. Farrell, M. Barth, The Global Positioning System and Inertial Navigation, McGraw Hill, San Francisco, 1999, p. 150.
[29] B. W. Parkinson, J. J. Spiker Jr., Global Positioning System: Theory and Applications, Vol. 1 and 2, American Institue of Aeronautics and Astronautics, Inc., Washington D.C., 1996, Chapter 7 and 8.
[30] B. Hofmann-Wellenhof, H. Lichtenegger, J. Collins, GPS Theory and Practice, 4th Ed., Springer-Verlag/Wien, New York, 1997, pp. 83-87.
[31] J. A. Farrell, M. Barth, The Global Positioning System and Inertial Navigation, McGraw Hill, San Francisco, 1999, p. 165.
[32] L. Garin, J. Rousseau, “Enhanced Strobe Correlator Multipath Rejection for Code and Carrier,” Proceedings of the Institute of Navigation, ION-GPS, 1997.
[33] J. A. Farrell, M. Barth, The Global Positioning System and Inertial Navigation, McGraw Hill, San Francisco, 1999, p. 164.
[34] B. Hofmann-Wellenhof, H. Lichtenegger, J. Collins, GPS Theory and Practice, 4th Ed., Springer-Verlag/Wien, New York, 1997, pp. 206-208.
[35] B. Hofmann-Wellenhof, H. Lichtenegger, J. Collins, GPS Theory and Practice, 4th Ed., Springer-Verlag/Wien, New York, 1997, pp. 90-92.
[36] B. Hofmann-Wellenhof, H. Lichtenegger, J. Collins, GPS Theory and Practice, 4th Ed., Springer-Verlag/Wien, New York, 1997, pp. 96-98.
[37] B. W. Parkinson, J. J. Spiker Jr., Global Positioning System: Theory and Applications, Vol. 1 and 2, American Institue of Aeronautics and Astronautics, Inc., Washington D.C., 1996, Chapter 8, pp. 356-357.
[38] B. Hofmann-Wellenhof, H. Lichtenegger, J. Collins, GPS Theory and Practice, 4th Ed., Springer-Verlag/Wien, New York, 1997, pp. 92-93.
[39] B. W. Parkinson, J. J. Spiker Jr., Global Positioning System: Theory and Applications, Vol. 1 and 2, American Institue of Aeronautics and Astronautics, Inc., Washington D.C., 1996, Chapter 9, p. 412.
[40] B. Hofmann-Wellenhof, H. Lichtenegger, J. Collins, GPS Theory and Practice, 4th Ed., Springer-Verlag/Wien, New York, 1997, pp. 184-185.
[41] B. W. Parkinson, J. J. Spiker Jr., Global Positioning System: Theory and Applications, Vol. 2, American Institue of Aeronautics and Astronautics, Inc., Washington D.C., 1996, Chapter 1, pp. 21-26.
[42] B. Hofmann-Wellenhof, H. Lichtenegger, J. Collins, GPS Theory and Practice, 4th Ed., Springer-Verlag/Wien, New York, 1997, pp. 188-191,
[43] B. Hofmann-Wellenhof, H. Lichtenegger, J. Collins, GPS Theory and Practice, 4th Ed., Springer-Verlag/Wien, New York, 1997, p. 94,
[44] J. A. Farrell, M. Barth, The Global Positioning System and Inertial Navigation, McGraw Hill, San Francisco, 1999, p. 165.
[45] J. A. Farrell, M. Barth, The Global Positioning System and Inertial Navigation, McGraw Hill, San Francisco, 1999, pp. 167-168.
[46] B. Hofmann-Wellenhof, H. Lichtenegger, J. Collins, GPS Theory and Practice, 4th Ed., Springer-Verlag/Wien, New York, 1997, p. 325.
[47] H. Montgomery, ed., “The Institute of Navigation Newsletter,” ION, Alexandria, Va., Vol. 9, No. 3, p. 1.
[48] A. Lawrence, Modern Inertial Technology, Navigation, Guidance, and Control, Springer-Verlag, New York, 1998, pp. 9-19.
[49] P. S. Maybeck, Stochastic Models, Estimation, and Control, Volume 1, Navtech Book and Software Store, 1994.
[50] M. Wei and K. P. Schwarz, “A Strapdown Inertial Algorithm Using an Earth-Fixed Cartesian Frame,” Navigation, Vol. 37, No. 2, 1990, pp. 153-167.
[51] M. Sadaka, Tightly Coupled Relative Differential GPS, INS and Airdata Fusion Filter Applied to Formation Flight, Master's Thesis, UCLA, 1999.
[52] P. S. Maybeck, Stochastic Models, Estimation, and Control, Volume 1, Navtech Book and Software Store, 1994, pp. 291-317.
[53] P. S. Maybeck, Stochastic Models, Estimation, and Control, Volume 1, Navtech Book and Software Store, 1994, pp. 342-358.
[54] J. A. Farrell, M. Barth, The Global Positioning System and Inertial Navigation, McGraw Hill, San Francisco, 1999, pp. 246-257.
[55] J. A. Farrell, M. Barth, The Global Positioning System and Inertial Navigation, McGraw Hill, San Francisco, 1999, pp. 199-204.
[56] M. Sadaka, Tightly Coupled Relative Differential GPS, INS, and Airdata Fusion Filter Applied to Formation Flight, Master's Thesis, UCLA, 1999, pp. 23-24.
[57] M. Sadaka, Tightly Coupled Relative Differential GPS, INS, and Airdata Fusion Filter Applied to Formation Flight, Master's Thesis, UCLA, 1999, pp. 13-18.
[58] W. H. Press, S. A. Teukolsky, W. T. Vetterling, B. P. Flannery, Numerical Recipes in C, Second Edition, Cambridge University Press, 1994, pp. 710-714.
[59] W. H. Chung and R. K. Douglas, “An Analytic Redundancy Management Scheme for Gyro Health Monitoring,” Aerospace Report No. ATR-20001(3398)-2, The Aerospace Corporation, El Segundo, Calif. November 2000.
[60] R. R. Bate, D. D. Mueller, J. E. White, Fundamentals of Astrodynamics, Dover Publications Inc., New York, 1971.
[61] R. R. Bate, D. D. Mueller, J. E. White, Fundamentals of Astrodynamics, Dover Publications Inc., New York, 1971, pp. 93-98.
[62] J. A. Farrell, M. Barth, The Global Positioning System and Inertial Navigation, McGraw Hill, San Francisco, 1999, pp. 27-33.
[63] J. A. Farrell, M. Barth, The Global Positioning System and Inertial Navigation, McGraw Hill, San Francisco, 1999, pp. 145-149.
[64] S. Hong, M. H. Lee, J. Rios, and J. L. Speyer, “Observability Analysis of GPS Aided INS,” Proceedings of the 2000 Institute of Navigation, Salt Lake City, Utah, September 2000.
[65] P. S. Maybeck, Stochastic Models, Estimation, and Control, Volume 1, Navtech Book and Software Store, 1994, pp. 206-226.
[66] A. H. Jazwinski, Stochastic Processes and Filtering Theory, Academic Press, Inc., 1970, pp. 272-281.
[67] A. H. Jazwinski, Stochastic Processes and Filtering Theory, Academic Press, Inc., 1970.
[68] P. S. Maybeck, Stochastic Models, Estimation, and Control, Volume 1, Navtech Book and Software Store, 1994, pp. 373-381.
[69] B. W. Parkinson, J. J. Spiker Jr., Global Positioning System: Theory and Applications, Vol. 2, American Institue of Aeronautics and Astronautics, Inc., Washington D.C., 1996, Chapter 1, pp. 417-49.
[70] J. A. Farrell, M. Barth, The Global Positioning System and Inertial Navigation, McGraw Hill, San Francisco, 1999, pp. 168-171.
[71] J. Min, “A Carrier Phase Differential Global Positioning System Algorithm for Relative State Estimation” Master's Thesis, UCLA, 1999.
[72] B. Hofmann-Wellenhof, H. Lichtenegger, J. Collins, GPS Theory and Practice, 4th Ed., Springer-Verlag/Wien, New York, 1997, pp. 101-109,
[73] J. A. Farrell, M. Barth, The Global Positioning System and Inertial Navigation, McGraw Hill, San Francisco, 1999, pp. 156-157.
[74] B. Hofmann-Wellenhof, H. Lichtenegger, J. Collins, GPS Theory and Practice, 4th Ed., Springer-Verlag/Wien, New York, 1997, pp. 206-214,
[75] B. W. Parkinson, J. J. Spiker Jr., Global Positioning System: Theory and Applications, Vol. 2, American Institue of Aeronautics and Astronautics, Inc., Washington D.C., 1996, Chapter 5, pp. 177-207.
[76] W. R. Williamson, J. A. Rios, J. L. Speyer, “Carrier Phase Differential GPS/INS Positioning for Formation Flight,” Proceedings of the 1999 American Control Conference, San Diego, Calif., June, 1999.
[77] W. R. Williamson, J. Min, J. L. Speyer, “A Comparison of An Optimal Global and A Suboptimal Decentralized Differential GPS/INS Filter for Relative State Estimation,” Proceedings of the Institute of Navigation (ION) 2000 Technical Meeting, Anaheim, Calif., February, 2000.
[78] W. R. Williamson, J. L. Speyer, “A GPS/INS Multiple Model Adaptive Kalman Filter for Carrier Phase Integer Ambiguity Resolution and Cycle Slip Detection,” Proceedings of the Institute of Navigation (ION) 2000 Technical Meeting, Anaheim, Calif., February, 2000.
[79] W. R. Williamson, J. Min, J. L. Speyer, “Comparison of State Space, Range Space, and Carrier Phase Differential GPS/INS Positioning,” Proceedings of the 2000 American Control Conference, Chicago, Ill., June, 2000.
[80] P. S. Maybeck, Stochastic Models, Estimation, and Control, Volume 1, Navtech Book and Software Store, 1994, pp. 373-381.
[81] W. T. Thomson, Introduction to Space Dynamics, Dover Publications, Inc., New York, 1986.
[82] A. V. Balakrishnan, Kalman Filtering Theory, Optimization Software Inc., New York, 1987.
[83] A. E. Bryson Jr., Y. Ho, Applied Optimal Control, Hemisphere Publishing Corporation, Washington D.C., 1975.
[84] J. Saastamoinen, “Atmospheric Correction for the Troposphere and Stratsphere in Radio Ranging of Satellites,” The Use of Artificial Satellites for Geodesy, American Geophysical Union, Washington D.C., 1972, pp. 247-251.
[85] A. E. Niell, “Global Mapping Functions for the Atmospheric Delay at Radio Wavelengths,” Journal of Geophysical Research, Vol 101, No. B2, Feb. 10, 1996, pp. 3227-3246.
[86] J. L. Speyer, “Computation and Transmission Requirements for a Decentralized Linear Quadratic-Gaussian Control Problem,” IEEE Transaction son Automatic Control, vol. AC-24, pp. 266-9, April, 1976.
[87] J. E. White and J. L. Speyer, “Detection Filter Design: Spectral Theory and Algorithms,” IEEE Transactions on Automatic Control, vol. 32, July 1987.
[88] D. Malladi, J. L. Speyer, “A Generalized Shiryayev Sequential Probability Ratio Test for Change Detection and Isolation,” IEEE Transactions on Automatic Control, VOL. 44, NO. 8, pp. 1522-1534, August 1999.
[89] D. Malladi, J. Speyer, “A New Approach to Multiple Model Adaptive Estimation,” in Proceedings of the 36th IEEE Conference on Decision and Control, vol. 4, (San Diego, Calif.), pp. 3460-7, IEEE, IEEE, December 1997.
[90] D. Chichka, T. Chiu, G. Belanger, W. Williamson, D. Cooper, and J. Speyer, “A Real Time Hardware-in-the-Loop Simulator for Evaluation of a Distributed, Autonomous F-18 Formation Flight Control System,” Proceedings of the Institute of Navigation 2000 Technical Meeting, Anaheim, Calif.
[91] J. Mayer, “System I/O Architectures Envision a Packet-Switched Future,” Embedded Systems Development August 2000: pp. 14-22, 34.
[92] W. R. Stevens, TCP/IP Illustrated, Vol. 1, Addison-Wesley Logman Inc., Berkeley, 1994, Chapter 11, p. 143.
[93] Linux WLAN Package. Computer Software. Absolute Value Systems, 1999. Linux 2.2.X, Version 0.2.7.
[94]. A. Abbort, W. Lillo, and R. Douglas, “Ultra-Tight GPS/IMU Coupling Method,” Proceedings of the ION-GPS Conference, January 2000.
[95] W. Chung and J. Speyer, “A Game Theoretic Fault Detection Filter,” IEEE Transactions on Automatic Control, AC-43:43-161, 1998.
[96] W. Williamson, Real Time, High Accuracy, Relative State Estimation for Multiple Vehicle Systems, PhD thesis, University of California, Los Angeles, 2000.
[97] S. Hong, M. Lee, J. Rios and J. L. Speyer, “Observability Analysis of GPS Aided INS,” Proceedings of the 2000 Institute of Navigation, Salt Lake City, Utah, September 2000.
[98] B. W. Parkinson, J. J. Spiker Jr., Global Positioning System: Theory and Applications, Vol. 2, American Institue of Aeronautics and Astronautics, Inc., Washington D.C., 1996, Chapter 5, pp. 143-168.
[99] J. White and J. Speyer, “Detection Filter Design: Spectral Theory and Algorithms,” IEEE Transactions on Automatic Control, AC-32(7):593-603, July 1987.
[100] R. Douglas and J. L. Speyer, “Robust Fault Detection Filter Design”, AIAA Journal of Guidance, Control, and Dynamics, Vol. 19, No. 2, March-April 1996.
[101] R. Chen and J. Speyer, “Robust Multiple-Fault Detection Filter,” The special issue of condition monitoring, fault detection and isolation in the International Journal of Robust and Nonlinear Control, Vol. 12, Issue 8, 2002.
[102] R. Chen, D. L. Mingori, and J. Speyer, “Optimal Stochastic Fault Detection Filter,” To appear in Automatica.
[103] W. Chung and J. Speyer, “A Game Theoretic Fault Detection Filter,” IEEE Transactions on Automatic Control, AC-43:43-161, 1998.
[104] R. Chen and J. Speyer, “A Generalized Least-Squares Fault Detection Filter,” International Journal of Adaptive Control and Signal Processing, Vol 14, 2000, pg 747-757.
[105] L. Mutuel and J. Speyer, “Fault Tolerant Estimation,” In Proceedings of the American Control Conference, Chicago, Ill., June 2000.
[106] L. Mutuel and J. Speyer, “Fault-tolerant Estimator Design for a UAV,” In Proceedings of the 2000 AIAA Guidance, Navigation, and Control Conference, Denver, Colo., August 2000.
[107] L. Mutuel and J. Speyer, “Fault-Tolerant GPS/INS Navigation System with Application to UAV,” In Proceedings of the Institute of Navigation GPS 2000 Conference, Salt Lake City, Utah, September 2000.
[108] R. Chen and J. Speyer, “Fault Reconstruction from Sensor and Actuator Failures,” Proceedings of the IEEE Conference on Decision and Control, December, 2001.
[109] M. L. Psiaki and H. Jung, “Extended Kalman Filter Methods for Tracking Weak GPS Signals,” Proceedings of the ION-GPS Conference, September 2002.
[110] J. B.-Y. Tsui, Fundamentals of Global Positioning System Receivers: A Software Approach, John Wiley & Sons, 2000.
[111] D. E. Gustafson and J. L. Speyer, “Linear Minimum Variance Filters Aplied to Carrier Tracking”, IEEE Transactions on Automatic Control, Vol. AC-21, No. 1, February 1976.
[112] R. L. Peterson, R. E. Ziemer, and D. E. Borth, Introduction to Spread Spectrum Communications, Prentice Hall, New Jersey, 1995.

Although the description above contains many specifications, these should not be construed as limiting the scope of the invention but as merely providing illustrations of some of the presently preferred embodiments of this invention.

Therefore, the invention has been disclosed by way of example and not limitation, and reference should be made to the following claims to determine the scope of the present invention.

1. A method of integrity maintenance in an estimating processor including at least one system state having an estimable value, at least one dynamic system model responsive to changes in the at least one system state and receptive to one or more external inputs, a measurement model comprising at least one measurement having information pertaining to the at least one system state, and at least one hypothesized fault model, wherein the at least one hypothesized fault model describes a direction in which a fault may act on any of the at least one system state, the method comprising the steps of:
(a) determining a residual by differencing the at least one system state and the at least one measurement;
(b) projecting at least one hypothesized fault model;
(c) determining a fault-free residual by applying the at least one projected hypothesized fault to the determined residual;
(d) determining a probabilistic estimate of fault occurrence using the at least one projected hypothesized fault model and the at least one measurement based on results of or one or more residual testing wherein the one or more residual tests are selected from the group consisting of: Multiple Hypothesis Wald Sequential Probability Ratio residual testing, Multiple Hypothesis Shiryayev Sequential Probability Ratio residual testing and Chi-Square Test residual testing;
(e) updating a filter gain;
(f) updating the at least one system state with a product of the updated filter gain and the determined residual of step (a);
(g) determining fault occurrence based on the determined probabilistic estimate; and
(h) predicting a next at least one system state using the updated at least one system state and the at least one dynamic system model and
(i) updating and predicting the at least one fault direction using the at least one dynamic system model.

2. The method of integrity maintenance as claimed in claim 1 wherein the step of determining a probabilistic estimate of fault occurrence includes the steps of Wald Sequential Probability Ratio residual testing followed by the steps of Shiryayav Sequential Probability Ratio residual testing.

3. The method of integrity maintenance as claimed in claim 1 wherein the step of determining a probabilistic estimate includes Multiple Hypothesis Shiryayav Sequential Probability Ratio testing wherein one or more probability estimates are re-initialized according to the determined probabilistic estimate of fault occurrence.

4. The method of integrity maintenance as claimed in claim 1 wherein a determination of fault occurrence invokes a step of restarting the method and providing one or more system states of a reduced order.

5. The method of integrity maintenance as claimed in claim 1 wherein:
(a) the at least one dynamic system model represents a static parameter system;
(b) the at least one measurement has associated statistical error uncertainty represented by a measurement noise covariance and
(c) the step of updating the filter gain uses a portion of the measurement noise covariance and the at least one measurement; and
(d) the step of determining the probabilistic estimate of fault occurrence uses knowledge of the measurement noise covariance.

6. The method of integrity maintenance as claimed in claim 1 wherein the at least one hypothesized fault model comprises one or more nuisance fault models and one or more target fault models.

7. The method of integrity maintenance as claimed in claim 1 further including the step of adaptively estimating a measurement noise covariance using an output history of determined residual.

8. The method of integrity maintenance as claimed in claim 1 further including the steps of:
removing a portion of the system state unaffected by a specific fault direction as output of the step of determining a residual and
estimating a fault time history based on the removed portion of the system state.

9. A system for performing fault tolerant navigation comprising:
a global positioning satellite receiving device providing at least three position outputs, or pseudorange measurements, and an associated time output;
a processor for providing a plurality of state estimates by taking in the pseudorange measurements and associated time output wherein the processor comprises:
a minimum variance estimator of state estimates;
a sensor fault detecting module adapted to execute residual testing steps based on one or more testing steps selected from the group consisting of: Multiple Hypothesis Wald Sequential Probability Ratio residual testing, Multiple Hypothesis Shiryayev Sequential Probability Ratio residual testing and the Chi-Square Test residual testing; and
a sensor fault annihilator module adapted to estimate a fault time history and remove the estimated fault time history from the state estimates.

10. The system for performing fault tolerant navigation as claimed in claim 9 further comprising:
an effecter, or actuator, fault detecting module adapted to execute Wald Sequential Probability Ratio residual testing integrally with the sensor fault detecting module; and
an effecter, or actuator, fault annihilator module adapted to estimate a fault time history and remove the estimated fault time history from the state estimates.

11. The system for performing fault tolerant navigation as claimed in claim 9 further comprising:
(a) an acceleration determining device sensitive in at least three axes capable of providing acceleration measurements in at least three axes;
(b) an angular rate measuring device sensitive in at least three axes capable of providing angular rates of rotation in at least three axes; and
(c) a process further adapted to receive the provided acceleration measurements and acceleration measurement.

12. The system for performing fault tolerant navigation as claimed in claim 11 wherein:
(a) the global positioning satellite receiving device is further adapted to use a tracking loop process to track the global positioning satellite signals and provide output from a discriminator function for each satellite tracked; and
(b) the processor is further adapted to: receive the receive outputs and sensor measurements and itself output a fault free state estimate utilizing the output of the discriminator functions as additional measurements; and to provide the fault free estimate to the tracking loop process.

13. A system for autonomous relative navigation comprising:
(a) a target element, comprising;
(i) at least one target element global positioning system antenna;
(ii) at least one target element global positioning system receiver operably coupled to the at least one target element global positioning system antenna;
(iii) a target element processor for deriving a position, velocity, attitude solution for the target element; and
(iv) a transmitter for transmitting the derived target position, velocity, attitude solution as well as global positioning system measurements from any of the at least one global positioning system receivers; and
(b) a seeker element comprising:
(i) at least one seeker element global positioning system antenna;
(ii) at least one seeker element global positioning system receiver operably coupled to the at least one seeker global positioning system antenna; and
(iii) a receiver for receiving the transmitted derived target position, velocity, attitude solution and global positioning system measurements; and
(iv) a seeker element processor for deriving a seeker-relative position, velocity, attitude solution for the target element;
wherein the target element processor and seeker element processor each comprise:
a minimum variance estimator of state estimates;
a sensor fault detecting module adapted to execute residual testing steps based on one or more testing steps selected from the group consisting of: Multiple Hypothesis Wald Sequential Probability Ratio residual testing, Multiple Hypothesis Shiryayev Sequential Probability Ratio residual testing and the Chi-Square Test residual testing; and
a sensor fault annihilator module adapted to estimate a fault time history and remove the estimated fault time history from the state estimates.

14. The system for autonomous relative navigation as claimed in claim 13 wherein the target element further comprises an inertial measurement unit operably coupled to the target element processor for deriving a position, velocity, and attitude solution for the target element.

15. The system for autonomous relative navigation as claimed in claim 13 wherein the target element further comprises a magnetometer operably coupled to the target element processor for refining a position, velocity, attitude solution for the target element.

16. The system for autonomous relative navigation as claimed in claim 13 wherein the target element further comprises a vision-based instrument operably coupled to the target element processor and adapted to provide measurements for deriving a seeker-relative position, velocity, and attitude solution for the target element.

17. The system for autonomous relative navigation as claimed in claim 13, wherein the target element processor is further adapted to determine the position, velocity, attitude solution of the target and use the solution to direct the processing of any global positioning system receiver tracking loops within the target.

18. The system for autonomous relative navigation as claimed in claim 13 wherein the seeker element processor is adapted to apply a Wald test to the received target transmissions of global positioning system carrier phase measurements for use in deriving a seeker-relative position, velocity, attitude solution for the target element.

19. The system for autonomous relative navigation as claimed in claim 13 wherein the seeker element further comprises an inertial measurement unit operably coupled to the seeker element processor for deriving a seeker-relative position, velocity, attitude solution for the target element.

20. The system for autonomous relative navigation as claimed in claim 13 wherein the seeker element further comprises a magnetometer unit operably coupled to the seeker element processor for deriving a seeker-relative position, velocity, attitude solution for the target element.

21. The system for autonomous relative navigation as claimed in claim 13 wherein the seeker element further comprises a vision-based instrument operably coupled to the seeker target processor and provides measurements for deriving a seeker-relative position, velocity, attitude solution for the target element.

22. The system for autonomous relative navigation as claimed in claim 13 wherein the seeker element further comprises a system of measuring vehicle control system outputs operably coupled to the seeker element processor for deriving the seeker or seeker-relative position, velocity, attitude solution for the target element.

23. The system for autonomous relative navigation as claimed in claim 13 wherein the seeker processor further determines a seeker-relative position, velocity, attitude solution and uses the solution in the processing of global positioning system receiver tracking loops.

24. An apparatus for maintaining state estimation integrity, the apparatus including at least one system state having an estimable value, at least one dynamic system model responsive to changes in the at least one system state and receptive to one or more external inputs; a measurement model comprising at least one measurement having information pertaining to the at least one system state, and at least one hypothesized fault model, wherein the at least one hypothesized fault model describes a direction in which a fault may act on any of the at least one system state, the apparatus further comprising:
means for determining a residual by differencing the at least one system state and the at least one measurement;
means for projecting at least one hypothesized fault model;
means for updating a filter gain;
means for updating the at least one system state with a product of the updated filter gain and the determined residual;
means for determining the residual by differencing the at least one updated system state and the at least one measurement;
means for determining a fault-free residual by applying the at least one projected hypothesized fault to update the determined residual;
means for determining a probabilistic estimate of fault occurrence using the projected at least one hypothesized fault model and the at least one measurement;
means for determining fault occurrence based on the determined probabilistic estimate;
means for predicting a next at least one system state using the updated at least one system state and the at least one dynamic system model; and
means for updating and predicting the at least one fault direction using the at least one dynamic system model.
